(19) United States
(12) Patent Application Publication
(10) Pub. No.: US 2026/0231099 A1
(43) Pub. Date: Aug. 6, 2026

(54) ENHANCED RANGING AND POSITIONING SERVICES IN WIRELESS NETWORKS

(71) Applicant: KONINKLIJKE PHILIPS N.V., EINDHOVEN (NL)

(72) Inventors: Oscar Garcia Morchon, Eindhoven (NL); Noureddine Sabah, Eindhoven (NL); Walter Dees, EINDHOVEN (NL); Robert James Davies, Eindhoven (NL); Dan Jiang, Cambridge, MA (US)

(21) Appl. No.: 19/154,797

(22) PCT Filed: Feb. 5, 2024
(86) PCT No.: PCT/EP2024/052677

§ 371 Date: Aug. 8, 2025

Related U.S. Application Data
(60) Provisional application No. 63/547,100, filed on Nov. 2, 2023.
(60) Provisional application No. 63/599,581, filed on Nov. 16, 2023.
(60) Provisional application No. 63/600,146, filed on Nov. 17, 2023.

(30) Foreign Application Priority Data
Feb. 8, 2023 (EP) 23155678.8
Feb. 19, 2023 (EP) 23157432.8
Apr. 6, 2023 (EP) 23167114.0
Apr. 16, 2023 (EP) 23168151.1
May 11, 2023 (EP) 23172932.8
May 12, 2023 (EP) 23173081.3
Jul. 24, 2023 (EP) 23187213.6
Aug. 7, 2023 (EP) 23189969.1
Aug. 15, 2023 (EP) 23191449.0
Aug. 17, 2023 (EP) 23192039.8
Aug. 18, 2023 (EP) 23192065.3
Aug. 23, 2023 (EP) 23193059.5
Sep. 15, 2023 (EP) 23197568.1
Sep. 29, 2023 (EP) 23200846.6
Oct. 27, 2023 (EP) 23206528.4
Nov. 3, 2023 (EP) 23207814.7
Nov. 9, 2023 (EP) 23208867.4
Jan. 11, 2024 (EP) 24151276.3
Nov. 23, 2024 (EP) 24153351.2

(51) Int. Cl. H04W 64/00; G01S 13/76; H04W 4/02; H04W 4/08; H04W 12/033; H04W 12/106

(52) U.S. Cl. CPC H04W 64/00; G01S 13/765; H04W 4/023; H04W 4/08; H04W 12/033; H04W 12/106

(57) ABSTRACT

The invention relates to a wireless system and methods for obtaining a range or location estimate of a target mobile device (10) within a wireless network, wherein the apparatus is adapted to: request a ranging or positioning service from a positioning constellation (60) formed by one or more ranging capable anchor devices (14) and or access devices (20) of the wireless network; receive one or more response groupcast/broadcast message; perform a range or location estimate or a ranging measurement based on the information in at least one response broadcast message.

### FIELD OF THE INVENTION

The invention relates to ranging and positioning services in wireless networks, such as—but not limited to—cellular networks, such as fifth generation (5G) or higher generation networks.

### BACKGROUND OF THE INVENTION

Ranging is a process by which distance and/or angle between two wireless devices is measured as a function of radio parameters (e.g., signal quality, channel condition, round trip time etc.). In wireless systems, accuracy of ranging measurements may have direct correlation with link quality of a used radio channel, calibration of a used ranging procedure, or hardware capabilities of a used device in terms of antenna design, energy and compute resources. In addition, power consumption of the ranging procedure may have a direct correlation with frequency of operations, duty cycle, repetitions of messages from a device to a ranging service of another device. Due to this direct correlation with dynamic system parameters, accuracy and power consumption of ranging in wireless devices may become unpredictable and more often negatively impacted. Particularly in situations where ranging measurements are used to derive location coordinates (e.g., geographical coordinates) of a device, the accuracy of ranging service is vital in determining precise location coordinates.

Wireless standards offer standardized techniques to support peer-to-peer ranging, wherein requirements are set forth by multiple use cases, as described e.g. in 3GPP specification TR 22.855 “Study on Ranging-based Services”. However, there are still open challenges in improving location services using specific ranging constellations. Examples of these challenges include how to efficiently and securely share or distribute configuration parameters or measurements. Another challenge refers to the authorization and privacy checks for accessing ranging or positioning related parameters. Other challenge refers to the procedures to determine how certain parameters, e.g., positioning related configuration parameters or system information parameters, are distributed.

### SUMMARY OF THE INVENTION

It is an object to address above challenges to provide improved location estimation for deriving location information, e.g., from ranging measurements.

This object is achieved by an apparatus as claimed in claim 1, by a mobile communication device in claim 15, by a method as claimed in claim 20, and by a computer program product as claimed in claim 37.

According to a first aspect, it is proposed an apparatus for obtaining arrange or location estimate of a target mobile device within a wireless network, wherein the apparatus is adapted to:
request, by means of a ranging or positioning request, a ranging or positioning service from a ranging constellation formed by one or more ranging capable anchor devices of the wireless network;
receive at least one groupcast/broadcast message over a PC5 communication interface;
perform a range or location estimate or a ranging measurement based on the information in the at least one groupcast/broadcast message, wherein the groupcast/broadcast message includes
encrypted data protecting the information contained in the groupcast/broadcast message,
a group member ID assigned by a managing entity or generated at random by a sender of the groupcast/broadcast message, and
a MIC set to a random number if the chosen integrity algorithm is the NULL algorithm.

In accordance with a second aspect of the invention, it is proposed an apparatus for obtaining a range or location estimate of a target mobile device within a wireless network, wherein the apparatus is adapted to:
request, by means of a ranging or positioning request, a ranging or positioning service from a positioning constellation formed by one or more ranging capable anchor devices and access devices of the wireless network;
receive one or more groupcast/broadcast message from an access device;
perform a range or location estimate or a ranging measurement based on the information in at least one response groupcast/broadcast message.

According to a third aspect of the invention, it is proposed an apparatus for obtaining a range or location estimate of a target mobile device within a wireless network, wherein the apparatus is adapted to:
receive from a requesting device a ranging or positioning request for a ranging or positioning service involving a ranging constellation formed by one or more ranging capable anchor devices of the wireless network;
transmit at least one groupcast/broadcast message over a PC5 communication interface;
perform a range or location estimate or a ranging measurement based on the information in the at least one groupcast/broadcast message,
   wherein the groupcast/broadcast message includes
encrypted data protecting the information contained in the groupcast/broadcast message,
a group member ID assigned by a managing entity or generated at random by the apparatus of the groupcast/broadcast message, and
a MIC set to a random number if the chosen integrity algorithm is the NULL algorithm.

In accordance with a fourth aspect of the invention, it is proposed a method for obtaining a range or location estimate of a target mobile device within a wireless network, wherein the method comprises:
requesting, by means of a ranging or positioning request, a ranging or positioning service from a ranging constellation formed by one or more ranging capable anchor devices of the wireless network;
receiving at least one groupcast/broadcast message over a PC5 communication interface;
performing a range or location estimate or a ranging measurement based on the information in the at least one groupcast/broadcast message,
   wherein the groupcast/broadcast message includes
encrypted data protecting the information contained in the groupcast/broadcast message,
a group member ID assigned by a managing entity or generated at random by a sender of the groupcast/broadcast message, and
a MIC set to a random number if the chosen integrity algorithm is the NULL algorithm.

In accordance with a fifth aspect of the invention, it is proposed a method for obtaining a range or location estimate of a target mobile device within a wireless network, wherein the method comprises:
receiving a ranging or positioning request for a ranging or positioning service from a ranging constellation formed by one or more ranging capable anchor devices of the wireless network;
transmitting at least one groupcast/broadcast message over a PC5 communication interface;
performing a range or location estimate or a ranging measurement based on the information in the at least one groupcast/broadcast message,
   wherein the groupcast/broadcast message includes
encrypted data protecting the information contained in the groupcast/broadcast message,
a group member ID assigned by a managing entity or generated at random by the apparatus of the groupcast/broadcast message, and
a MIC set to a random number if the chosen integrity algorithm is the NULL algorithm.

In accordance with a sixth aspect of the invention, it is proposed a method for obtaining a range or location estimate of a target mobile device within a wireless network, wherein the method comprises:
requesting a ranging service from a positioning constellation formed by one or more ranging capable anchor devices and access devices of the wireless network,
receiving at least one groupcast/broadcast message from an access device;
performing a range or location estimate or a ranging measurement based on at least one groupcast/broadcast message.

In accordance with a seventh aspect of the invention, it is proposed an apparatus in an access device for obtaining a range or location estimate of a target mobile device within a wireless network, wherein the apparatus is adapted to:
receive a ranging or positioning request for a ranging or positioning service involving a positioning constellation formed by one or more ranging capable anchor devices and access devices of the wireless network;
transmit one or more groupcast/broadcast message;
perform a range or location estimate or a ranging measurement based on the information in at least one response groupcast/broadcast message.

In accordance with an eighth aspect of the invention, it is proposed a method for obtaining a range or location estimate of a target mobile device within a wireless network, wherein the method comprises an access device:
receiving from a requesting device a request for a ranging service involving a positioning constellation formed by one or more ranging capable anchor devices and access devices of the wireless network, transmitting at least one groupcast/broadcast message;
performing a range or location estimate or a ranging measurement based on information contained in the groupcast/broadcast message.

Accordingly, a managing entity (e.g., wireless access device or base station or a network function in the core network) configures one or more network devices (e.g., UEs) as anchor devices to form a ranging constellation to support ranging services, location services and/or ranging-based positioning services (i.e., a combination of ranging and location service functionality). Thereby, location accuracy can be improved with simple ranging measurements between the devices, coordinated either locally or centrally. In addition to improving localization and ranging accuracy, the ranging constellation also helps to reduce power consumption of the involved (mobile) network devices by combining ranging and location services. In particular, the moment at which the location information may be derived from ranging measurements and the methods used for ranging-based location estimation can be determined.

The ranging services, location services and/or ranging-based positioning services could be offered by a different network other than the wireless network which collects the ranging measurements. It could also be a third-party application which calculates the position based on these measurements. Furthermore, the geographical area of the positioning service may depend on the capability of the anchor device(s) and/or the characteristics of the environment in which the anchor device(s) is/are configured. It does not have to be known by the network could in advance and could optionally by configurable.

According to a first option which may be combined with any of the first to eighth aspects of the invention, the groupcast/broadcast message includes a counter such as a time-based counter as input for an encryption algorithm and/or integrity algorithm.

According to a second option which may be combined with of any the first option or with any of the first to eighth aspects, the apparatus may be adapted to determined whether the group member ID is generated by the managing entity or the sender based on a group member ID length.

According to a third option which may be combined with any of the first or second options or with any of the first to eighth aspects, the MIC is not set to zero if the chosen integrity algorithm is the NULL algorithm.

According to a fourth option which may be combined with any of the previous options or with any of the first to eighth aspects, the apparatus is adapted to verify a message freshness by checking the counter.

According to a fifth option which may be combined with any of the previous options or with any of the first to eighth aspects, the message includes a device specific identifier that is randomized or scrambled.

According to a sixth option which may be combined with any of the previous options or with any of the first to eighth aspects, the ranging or positioning request includes one or more of the following:
the ranging positioning capabilities of the apparatus,
a (ranging) group ID,
a type of requested service (ranging/positioning),
a type of reply (unicast/broadcast/ . . . ) requested,
identification/authentication/authorization credentials,
indication of emergency service,
preference for NULL security algorithms.

According to a seventh option which may be combined with any of the previous options or with any of the first to eighth aspects, the apparatus is adapted to receive at least one configuration message with configuration parameters to receive the one or more groupcast/broadcast message through an access device wherein the configuration message is a ranging service acknowledgement including configuration parameters such as one or more groupcast/broadcast keys, or chosen security algorithms, or security parameters to be used to protect groupcast/broadcast messages in the RAN and in the ranging constellation.

According to an eighth option which may be combined with the fifth or the seventh options or with any of the first to eighth aspects, the groupcast/broadcast message is an MBS message or an RRC broadcast message or a SIB.

According to a ninth option which may be combined with any of the previous options or with any of the first to eighth aspects, the groupcast/broadcast message includes an indication of a ranging positioning capability (e.g. the capabilities of physical layer) or assistance data of the anchor devices and/or devices in the positioning constellation or cryptographic values (e.g., a key, authorization token, . . . ).

According to a tenth option which may be combined with any of the previous options or with any of the first to eighth aspects, the groupcast/broadcast message is protected by one or more of encryption, scrambling, and integrity protection, and wherein the apparatus is adapted to process the protected groupcast/broadcast message to decode successfully the groupcast/broadcast message.

According to an eleventh option which may be combined with any of the fifth or seventh or eighth or ninth options, a key used to protect the groupcast/broadcast message is used to securely transport or as a seed to obtain a group key used for subsequent groupcast/broadcast communication in the ranging constellation.

According to a twelfth option which may be combined with any of the fifth or seventh or eighth or ninth or tenth or eleventh options, the apparatus is adapted to:
obtain a counter C1 by combining a value C0 received in a protected message or derived from the whole or part of another counter and/or a value DO received in the broadcast message and/or a data segment counter,
obtain a decryption key and/or integrity key by applying a key derivation function to a pre-configured key and the counter C1,
apply an encryption algorithm (e.g, AES in counter mode or NEA) together with the counter C1 and a decryption using the key to decrypt the data in the broadcast message,
apply the counter C1 and an integrity key to compute a MIC by means of a KDF or a NIA algorithm and verifies the integrity of the received response broadcast message,
pass the decrypted data to upper layers if the integrity verification is successful.

According to a thirteenth option which may be combined with any of the fifth or seventh or eighth or ninth or tenth or eleventh or twelfth options, the ranging service is bound to an MBS service.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, claim 7, 16, 20, 22, 25, 34, or 50, the method of claim 17, 18, 19, 21, 24, 33, 39 or 40 and the computer program product of claim 51 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows different concepts of providing ranging services to mobile devices with or without network coverage;

FIG. 2 schematically shows an illustration of different directions in a spherical coordinate system;

FIG. 3 schematically shows a timing diagram for data transmission between a transmitter and a receiver to explain a round-trip-time concept;

FIG. 4 schematically shows an illustration of an angle-of-arrival concept based on a phase difference consideration;

FIG. 5 schematically shows a block diagram of a wireless system for providing ranging and/or positioning services according to various embodiments;

FIG. 6 schematically shows a network architecture where a mobile terminal approaches a constellation of mobile terminals to get assisted by ranging services for location coordinates according to various embodiments; and

FIG. 7 schematically shows a signaling and processing diagram for ranging-based positioning services according to various embodiments.

FIG. 8 schematically shows an example conceptual architecture of anchor UEs supporting a subset of LMF functionality as a proxy.

FIG. 9 schematically shows a signaling and processing diagram for ranging-based positioning services according to various embodiments.

FIG. 10 schematically shows a signaling and processing diagram for ranging-based positioning services according to various embodiments.

FIG. 11 schematically shows a signaling and processing diagram for ranging-based positioning services according to various embodiments.

FIG. 12 schematically shows a signaling and processing diagram for ranging-based positioning services according to various embodiments.

FIG. 13 schematically shows a signaling and processing diagram for ranging based positioning services according to various embodiments.

FIG. 14 schematically shows a signaling and processing diagram for ranging based positioning services according to various embodiments.

FIG. 15 schematically shows a signaling and processing diagram for ranging and/or positioning based positioning services over a UE to Network relay according to various embodiments.

FIG. 16 schematically shows a signaling and processing diagram for ranging and/or positioning based positioning services over a UE to Network relay according to various embodiments.

### DETAILED DESCRIPTION OF EMBODIMENTS

Embodiments of the present invention are now described based on ranging and/or positioning (sometimes also called “localization”) services for cellular networks, where e.g. 4G network elements may be incorporated in proposed 5G solutions. Furthermore, at least some of the below embodiments are described based on a 5G New Radio (5G NR) radio access technology. However, the present invention may also be used in connection with other wireless technologies (e.g., IEEE 802.11/Wi-Fi or IEEE 802.15.4/ultra-wideband communication (UWB)) in which positioning of devices or distance measurements between devices is provided or can be introduced.

Throughout the present disclosure, the term “wireless network” is intended to mean a whole network system (e.g., 4G or 5G system) including communication devices (e.g., UEs) radio access network (RAN) and core network (CN). Furthermore, the term base station and the abbreviations “eNB” (4G terminology) and “gNB” (5G terminology) are intended to mean access device such as a cellular base station or a WiFi access point or a UWB PAN coordinator. The eNB/gNB is part of the RAN, which provides an interface to functions in the CN. The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” may be used as synonyms in this disclosure. This means for example that when it is written that the “network” performs a certain operation it may be performed by a CN function of a wireless communication network, or by one or more base station that are part of such wireless communication network, and vice versa. It can also mean that part of the functionality is performed by a CN function of the wireless communication network and part of the functionality by the base station.

In the 3GPP specifications 23.303, 23.304, 24.334 and 24.554 for 4G and 5G networks, respectively, so-called proximity service (ProSe) functions are defined to enable—amongst others—connectivity for cellular communication devices (e.g., UEs) that are temporarily not in coverage of an access device (eNB). One particular function is called ProSe UE-to-network relay, or Relay UE. The Relay UE is a communication device that helps another out-of-coverage (OoC) UE to communicate to the eNB (i.e., access device) by relaying application and network data traffic in two directions between the OoC UE and the eNB. The local communication between the Relay UE and the OoC-UE is called D2D communication or Sidelink communication or PC5 communication. The abbreviation “PC5” designates an interface for sidelink communication as defined by ProSe. Furthermore, the abbreviation “UL” is used for the uplink direction from the communication device (e.g., UE) to the access device (e.g. eNB, gNB), the abbreviation “DL” for the downlink direction from the access device (e.g. eNB, gNB) to the communication device (e.g. UE), and the abbreviation “SL” for sidelink communication between two or more communication devices (e.g. UEs).

Once a relaying relation is established, the OoC-UE is connected via the Relay UE and acts in a role of “Remote UE”. This situation means the Remote UE has an indirect network connection to the CN as opposed to a direct network connection that is the normal case (cf. 3GPP specification TS 22.261 v16.10.0).

Furthermore, 3GPP specifications TR 23.733 v15.1.0 and TR 36.746 v15.1.1 provide studies on architectural enhancements e.g. to enable an IoT device (in a role of Remote UE) to operate on very low power by using a Relay UE to connect to the wider network. Because the Relay UE is physically very close, it can be reached using very low power transmissions. This work also includes security, speed and stability improvements to ProSe. These extensions of ProSe are called enhanced ProSe (“eProSe”).

ProSe can also be used for direct communication between two UEs. Additional radio level details on ProSe, V2X and sidelink communication can be found in 3GPP specifications TR 37.985, TS 38.300 and TR 38.836.

Ranging can be defined as a process which measures a distance and/or relative directional angle between two wireless devices in a 3-dimensional space. In the initially mentioned specification TR 22.855 “Study on Ranging-based Services”, ranging-based services are defined as applications utilizing the distance between two UEs and/or the direction of one UE from the other. These ranging-based services are envisioned to be supported with or without network coverage. Next to the measurement of the distance and directional angle, a relevant measurement is whether two wireless devices are in direct Line-of-Sight or not since this is relevant for many use cases in which UEs are supposed to interact with each other if they are in Line-of-Sight, e.g., in the same room.

The term “ranging reference signals” is used herein to denote signals used for determining the distance and/or angle between two devices that may be connected through a device-to-device connection (e.g., using sidelink and/or PC5) rather than an infrastructure connection (e.g., using Uu interface). The ranging reference signals may be position reference signals and/or sounding reference signals or other signals (e.g., signals used for round-trip time (RTT) measurements) that may be used for determining distance and/or angle between the devices, possibly using resources (that may be configured or granted by an access device) for device-to-device (e.g., sidelink) communication/discovery and/or resources specifically reserved for sending the reference signals or the other signals that may be used for determining distance and/or angle between the devices.

The terms “ranging capable device” and “ranging capable UE” are used herein to denote devices which have a minimum set of components, subsystems and/or functions to perform or support distance measurement and/or angle measurement between itself and another device (e.g. using Time Difference of Arrival, Round-Trip Time, Carrier-phase or other measurements/techniques). This set of components, subsystems and/or functions does not always need to be enabled and may be enabled/triggered on demand (e.g. by request from another device or network function). Also, the components, subsystems and/or functions may not always be authorized to be used for performing distance measurements. The terms “ranging capable device” and “ranging capable UE” can therefore also be interpreted as being able to perform distance measurement and/or angle measurement between itself and another device, and being authorized/enabled to do so. Also in sentences in which the word “capable” is used, it can also be interpreted/restricted as being enabled and/or authorized.

The ranging capabilities may differ per device. For example, not every device may be capable of calculating the angle, since it requires multiple antennas. The ranging capabilities of the device (which can be exchanged as part of the discovery process) can be used to determine what a device is capable of and which measurements can be made. Note that angle calculation may need to be an explicit capability rather than based solely on a capability declaring the number of antennas. The number of antennas alone being bigger than one does not automatically imply that the device is capable of calculating an angle. The calculation of the angle may further require a sensor (e.g., magnetometer, gyroscope, accelerometer) to derive an orientation and/or angle towards a reference point, such as the magnetic north, and an angle/orientation calibration mechanism. The angle may also indicate a difference in height, and may use a reference height (e.g., meters above sea level and/or barometric pressure, floor information, terrain height data for the device position), and a height calibration mechanism.

### Section: Distance/Angle/Position Calculation Techniques

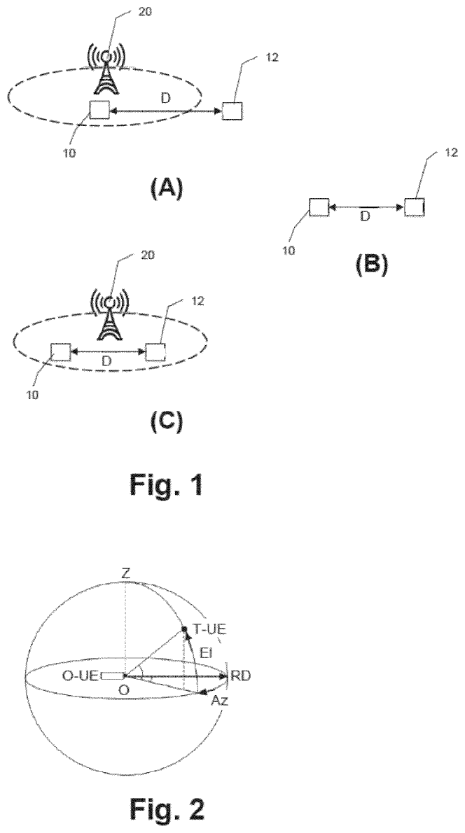

FIGS. 1A-C schematically shows different concepts of providing ranging services based on distance and/or direction (D) between two mobile devices 10, 12 with or without network coverage. The dotted elliptical line shows a perspective view of a circular coverage area around an access device (e.g., gNB) for accessing a 5G cellular network. In FIG. 1A, a first UE 10 is located within the coverage area of the access device 20, while the second UE 12 is located outside of the coverage area and thus has no network coverage.

In FIG. 1B, both first and second UEs 10, 12 have no network coverage.

In FIG. 1C, both first and second UEs 10, 12 are located within the coverage area of the access device 20 and thus have network coverage.

FIG. 2 schematically shows an illustration of different directions in a spherical coordinate system.

The distance and angle between a set of UEs (e.g., an observer UE (O-UE) and a target UE (T-UE)) can be visualized in a 3-dimensional (3D) sphere in a 2-dimensional (2D) plane as shown in FIG. 2. The horizontal direction (i.e., the azimuth (Az)) of the target UE is the angle formed between a reference direction (RD) and a line from the observer UE to the target UE projected on the same plane as a target reference direction orthogonal to the direction of the zenith (Z). The elevation angle (i.e., the elevation (El)) of the target UE is an angle above the horizontal plane, i.e., formed between the horizontal target reference direction and the direction from the origin of the observer UE to the target UE.

A ranging measurement between two UEs as described e.g. in a ranging study by Mario H. Castaneda Garcia et al.: “A Tutorial on 5G NR V2X Communications” (DOI 10.1109/COMST.2021.3057017) may result in two parameters, which are the distance between the two UEs in meters and an angle in degrees at which the target UE is elevated in a 3D plane from the observer UE.

There are multiple use cases which require a distance accuracy within 10 cm (i.e., sub-nanosecond range of time measurement accuracy) in an effective ranging distance of 20 m and a tolerance of up to +2° in horizontal and vertical planes in a coverage range of −45° to +45° angle of arrival (AoA) with respect to a reference direction of the ranging device. In some use cases a local coordinate system is proposed for ranging UEs, in which the distance and angles measured from the ranging services are translated to location coordinates. The UEs involved in ranging are expected to move at various speeds (e.g., from 1 m/s to 10 m/s) and multiple concurrent ranging operations between multiple UEs can be done in a given area and a UE can carry out multiple concurrent ranging operation with other UEs present in the area.

A so-called “peer-to-peer ranging” can be done in many ways including but not limited to:

i. Two-way ranging, which is a process where two devices A and B communicate a data packet and an acknowledgement packet back and forth with themselves. The time delay occurring due to natural radio signal propagation and due to processing delay on the device B (i.e., time taken by the device B to resend a packet to device A) is taken into consideration in this technique. The one-way time of flight is then calculated on device A as the half of the difference between a) the time spent by the device A between transmitting a packet and receiving the next packet from B and b) the time spent by the device B between receiving a packet from A and transmitting the response packet back to A. Device B may include information in its response packet such that A can calculate the time spent of B. Then at device A, the one-way time of flight may be used to calculate the distance between two devices A and B. Device B may perform the same procedure with device A such that B can also calculate this distance. The two devices' clocks need not be synchronized with each other in this technique since the processing delay is accounted for with two consecutive packet transmissions and distance may be calculated simultaneously in both devices.
ii. One way ranging, which is a process, where at least one packet is transmitted between the transmitting wireless device A and a receiving wireless device B. These devices are synchronized with each other by a common clock source. The time of flight is then measured as the difference between the time of reception at the device B and the time of transmission at the device A. Device A may include a timestamp of its time of transmission within the data packet, so that device B can calculate this time difference. The accuracy of ranging depends on the accuracy of clock synchronization achievable between the two devices.

The peer-to-peer ranging operation may depend on multiple parameters of wireless communication such as clock time synchronization between the devices, communication path (e.g., line of sight (LOS) or non-line of sight (NLOS)) over which the signal is transmitted, antenna properties, frequency of operation, transmission power and receiver sensitivity of the wireless radios. These parameters are also important for radio communication in general, resulting in multitude of standardized techniques to achieve highest communication performance for a given radio. For example, in 3GPP the sidelink radio resource protocol as described in specification 36.331 v16.4.1 ensures clock time synchronization with high accuracy between two sidelink UEs operating in multiple in-coverage and out-of-coverage scenarios.

Positioning can be defined as a process of determining, according to a location coordinate system, location coordinates of wireless devices such as but not limited to mobile phone, wearables, and IoT devices. Upon determining of the location coordinates of a device, it can be located on a map using a mapping function. Positioning is typically distinguished between absolute positioning (i.e., determine geographical coordinates (location coordinates) according to a standardized geographic coordinate system), or relative positioning (i.e., determine coordinates (e.g., using a local coordinate system) and/or angle plus distance relative to a reference point). Some examples of how absolute positions or relative positions can be expressed can be found in 3GPP specification TS 23.032. A classic example is a satellite-based location service (e.g., Global Positioning System (GPS) or Global Navigation Satellite System (GNSS)), where a device's location coordinates are calculated using at least three of the many satellites belonging to a constellation of medium earth orbit (MEO) satellites using well known processes such as triangulation and trilateration, where the satellites act as the clock synchronization source and communication delay of the transmitted packets are used to estimate the location coordinates. These coordinates can be used by any third-party mapping tool (e.g., OpenStreetMap) to pinpoint the location of a device in a geographical map of the area. Also, several indoor positioning techniques based on radio frequency technologies such as Bluetooth, UltraWideBand (UWB), or Wi-Fi are available, which can locate/determine the coordinates of a radio frequency (RF) emitting tag in an indoor environment. The position of these tags may then be mapped onto an indoor floor plan using the indoor coordinates estimated based on the RF propagation properties such as time delay, multipath reflections, received signal strength, etc., measured using RF communication between the tags and anchor nodes that are placed in pre-known locations of the building.

Positioning techniques used for obtaining a coordinate of a device's current location can be accomplished in several ways, but typically includes triangulation and/or trilateration based on a set of measured distances and/or angles between the device and a set of other devices or reference points. Distances and angles can be determined using various techniques which may include round trip time (RTT), time of flight (ToF), time difference of arrival (TDoA), angle of arrival/departure (AoA/AoD) and/or a combination thereof:

The round trip time (RTT) defines a duration from when a data packet transmitted by a transmitter (Tx, e.g., an access point/device) to when the same data packet is received and acknowledged by a receiver (Rx, e.g., a mobile phone/device), i.e., up to the moment the transmitter receives the acknowledgement. Since the data packet travels at the speed of light in air medium (approximately 3.3 ns/m), the time duration the data packet travels in air is proportional to the actual distance between the Tx and the Rx. In scenarios, where the internal clocks in the Tx and the Rx are not synchronized, a one-way time measurement cannot be based on differences between time stamps of transmission and reception, since it will also include the timing errors caused by, among others, internal clock drifts and indeterministic clock offsets between Tx and Rx. Since the internal clocks of Tx and Rx are not synchronized, the difference in time stamps when the signal travels in the reverse direction (i.e., Rx to Tx) is affected in the opposite way by the clock offset as in the forward direction (i.e., Tx to Rx).

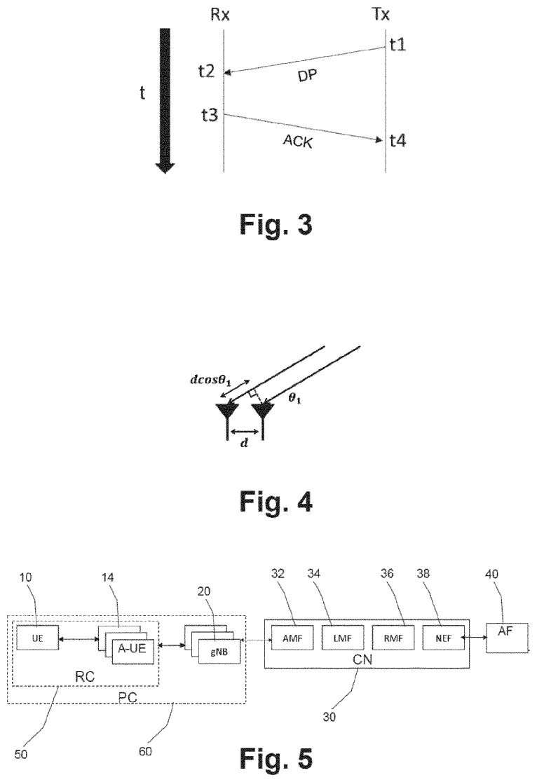

FIG. 3 schematically shows a timing diagram for data transmission between a transmitter and a receiver to explain the round-trip-time concept.

In the timing diagram of FIG. 3, the time passes from the upper side to the lower side while information flow between a transmitter (Tx) and a receiver (Rx) is indicated by respective arrows.

According to FIG. 3, a data packet (DP) is transmitted at time t1 from the Tx to the Rx and received at the Rx at time t2. An acknowledgement (ACK) is transmitted at time t3 from the Rx to the Tx and received at the Tx at time t4.

The round trip time (RTT) can be obtained without having to know any clock offsets by simple addition and subtraction of the four time stamps t1 to t4, as follows:

$$RTT = ( t 4 - t 1 + t 2 - t 3 )$$

where t1 is the time of transmission, t2 is the time of reception, t3 is the time of acknowledgement transmission and t4 is the time of acknowledgement reception.

The distance D between the Tx and the Rx can be estimated by using the following equation:

$$2 * D = ( ( t 4 - t 1 ) - ( t 3 - t 2 ) ) * c$$

where, c is the speed of light. Also note that in RTT measurements-based distance estimation there is no need of synchronization between the transmitter and receiver. The calculation of a single distance can be extended to two- and three-dimensional spaces for estimation of multiple distances, which can then be translated to estimates of location coordinates (both local and global) when the coordinates of each transmitter are known in advance. Some standardized mechanisms using an RTT based technique include Fine Timing Measurement (FTM) as defined in IEEE 802.11-2016, and Enhanced Cell-ID (E-CID) as defined in 3GPP TS 36.133.

The time of flight (ToF) corresponds to a duration from when a data packet transmitted by a transmitter (Tx, e.g., access point/device) to when the same data packet is received by a receiver (Rx, e.g., a mobile phone/device). Note that this method takes only the forward path (i.e., Tx to Rx) into account and does not account for the reverse path (i.e., Rx to Tx). In this case, internal clocks of the Tx and the Rx (or multiple Tx and Rx) need to be time-synchronized such that the time stamp of the received packet can be assumed to be correct and compensated for any timing error caused by among others internal clock drifts and indeterministic clock offsets between Tx and Rx. Assuming the Tx and the Rx of FIG. 3 are synchronized, the distance D between the Tx and the Rx can be calculated by the following equation:

$$D = ( t 2 - t 1 ) * c$$

where, t2 is the time stamp of the reception and t1 is the time stamp of the transmission, and c is the speed of light. The time of flight can be calculated by Rx knowing the time stamp t1 (which was e.g. included in the transmitted message or communicated later) and by its own measured time stamp t2. The time of flight can also be calculated by Tx knowing the time stamp t2 (which was e.g. communicated later by Rx to Tx) and its own measured time stamp t1. The calculation of a single distance can be extended to two- and three-dimensional spaces for estimation of multiple distances, which can then be translated to estimates of location coordinates (both local and global) when the coordinates of multiple reference devices (either acting as the transmitter or the receiver) are known in advance.

The time difference of arrival corresponds to a difference in time stamps at which a data packet is received by a number of clock-synchronized receivers (Rx, e.g., access points/devices which are synchronous location reference stations), whereby the data packet was transmitted by an asynchronous transmitter (Tx, e.g., a mobile phone/device, or asynchronous location tag for which the location coordinates are to be determined). Note that the roles can be the other way around, e.g., the mobile phone/device may be an asynchronous Rx and the access points/devices may be synchronized transmitters. Note that a single transmission of a data packet by the transmitter will be received concurrently by several synchronized receivers placed within a coverage area of the transmitter. It is important that the receivers are clock-synchronized and that the location coordinates of the receivers are known to a central location server, whereas the transmitter for which the location coordinates are to be determined may not be synchronized either with other transmitters or with the receivers. A central location server can receive the time of arrival of the data packet from each receiver i=0 . . . N and may compute the distance difference for any pair of receivers (i, j) for a specific transmitter based on the following equation:

$$Δ {d}_{i j} = ( {d}_{i} - {d}_{j} ) = Δ {t}_{ij} * c$$

where, c is the speed of light and Δtᵢⱼ is the difference in arrival times between receiver i and receiver j, di is the unknown Tx-to-Rx distance for a receiver i, Δdᵢⱼ is the difference in Tx-to-Rx distances between a receiver i and a receiver j. The calculation can be applied to two- and three-dimensional spaces for estimation of distance differences, which can be translated to location coordinates (both local and global) when the coordinates of the receivers are known in advance. Note that the transmitters are not able to calculate its own location locally on the device and only the location server can calculate the location of a transmitter using a localization infrastructure and a network of synchronized receiver nodes. Note that the location server may be located on one of the clock-synchronized receivers. The location of the transmitter can be communicated (e.g. to an application, to the transmitter, or to one or more receivers) via a separate communication channel or can be amended in one of the responses from the receivers to the transmitter in the same channel used for transmitting the data packet.

Alternatively or additionally, the receiver may send its measurements (e.g., time of arrival information) rather than a calculated distance and/or angle to the transmitter or a location server that will calculate the resulting distance and/or determine the resulting location coordinates. Some standardized mechanisms using a ToF difference based technique include Observed Time Difference of Arrival (OTDOA) as defined in 3GPP TS 25.305 and TS 36.133, and Uplink Time Difference of Arrival (UTDOA) as defined in 3GPP TS 25.305, typically based on a position reference signal (PRS) or sounding reference signal (SRS).

In addition to the time-based distance estimation, the angle of arrival is derived from phase information of an RF signal received at a receiver using an antenna array, which can be used to estimate the elevation angle or the azimuth angle at which the signal was received. This angle information can be used to determine the direction from which a signal was transmitted.

FIG. 4 schematically shows an illustration of an angle-of-arrival concept based on a phase difference consideration.

In the example of FIG. 4, the angle of arrival of the incoming RF signal (shown by two oblique arrows) can be calculated as follows. In principle, a receiver with at least two antennas with different phase of reception φ1, φ2, separated by a distance d, can determine the phase difference Δφ of the received signal at the receiver and then use it to estimate the angle of arrival based on the following equation:

$$Δϕ = [ ϕ 1 - ϕ 2 ] = 2 π [ ( d cos {θ}_{1} ) / λ ] + 2 k π$$

where, θ₁ is the angle of arrival to be estimated, k is the wave number which can be calculated by k=2πλ, where λ is the wavelength of the RF signal calculated by λ=c/f, where c is the speed of light and f is the radio frequency of the signal.

The angle of arrival of the RF signal at the receiver can be estimated using a naïve approach based on the measured phase difference using the following equation:

$$cos {θ}_{1} = [ ( Δ ϕ / 2 π ) - k ] * [ λ / d ]$$

Note that in addition to the approach described above, there are several well-known approaches available to calculate the angle of arrival of an RF signal including but not limited to Bartlett beamforming (cf. M. S. Bartlett: “Smoothing Periodograms from Time-Series with Continuous Spectra”), Multiple Signal Classification (MUSIC) (cf https://en.wikipedia.org/wiki/MUSIC_(algorithm)), distortion estimation (cf. J. Capon: “High-resolution frequency-wavenumber spectrum analysis”, Proceedings of IEEE, Vol. 57, issue 8), and signal and noise subspace estimation. Other complex estimation of AoA may use more than two antennas at the receiver, which enables only one receiver instead of three synchronous receivers to obtain both angle and distance measurements based on a RF signal transmitted by an asynchronous transmitter with a rather simple hardware and single antenna. Similarly, the angle of departure (of the signal at the transmitter) can be determined and used for ranging/position estimation in case the transmitter uses multiple antennas.

The process of obtaining location coordinates of a device and using a mapping function to locate the device on a map is also offered by location services (LCS) provided in 3GPP systems, where a base station may act as a synchronization source and location coordinates of the devices are obtained based on radio parameters and special messages using a variety of positioning methodologies as described e.g. in 3GPP specification TS 23.271 “Functional stage 2 description of Location Services (LCS) “, Rel-16, for 4G, and 3GPP specification TS 23.273 “5G System (5GS) Location Services (LCS); Stage 2”, Rel-17, for 5G.

A typical difference between the location service and ranging service offered by the 3GPP system is that the location service may measure geographical coordinates of a device within the coverage area of a cell (e.g., 1-5 km) and provides good accuracy in outdoor environments where line of sight (LOS) is possible with the base station and the communication path can be fairly modelled and accounted for using channel models of urban and rural environments, whereas the ranging service may measure a distance and/or angle between two devices within a short range (e.g., 20 m) and provides good accuracy in outdoor and especially indoor environments where two ranging devices can also be in line of sight (LOS) with each other.

The functionality of the location service and ranging service may be combined to offer e.g. a location service with improved accuracy and better indoor position estimation. A location service or ranging service or combination thereof may also be able to verify the integrity/measure the accuracy/determine errors of the measured distances, angles, location information (e.g. coordinates), etc., and possibly compensate for them, and/or provide distances, angles, location information to UEs, core network functions, application or other location/ranging service, and/or store distances, angles, location information into non-volatile storage, and/or combine distances, angles, location information with distance, angles, location information from other sources or resulting from various location/ranging mechanisms.

Note that a location service may also offer ranging services (and vice-versa), e.g. in case the location of two devices can be observed/determined for example through GNSS, the distance and/or angle between the two devices can be calculated and may be exposed as part of a ranging service that may allow a device to request its distance and/or angle between itself and another device. In such case, the two devices may still be requested to perform ranging measurements between each other to improve the accuracy of the distance and/or angle between the two devices or for determining deviations to the observed/determined location.

A translation of distance to coordinates can be achieved e.g. based on ranging measurements by which a first device A can obtain a distance (d) and the angle (tc) towards a second device B. If the coordinates of the device A are known, and its orientation with respect to the coordinate system is known, the distance and angle measurements between the device A and the device B can be used by the device A to obtain the coordinates of the device B.

For example, in case of geographical coordinates expressed in radians, the latitude (lat1) and longitude (lon1) of the device A are assumed to be known. Then, the geographical coordinates (lat2, lon2) of the device B can be calculated using the following equations when using a spherical-Earth approximation model:

$$lat 2 = a sin ( sin ( lat 1 ) * cos ( d ) + cos ( lat 1 ) * sin ( d ) * cos ( t c ) )$$

$$dlon = a tan 2 ( [ sin ( tc ) * sin ( d ) * cos ( lat 1 ) ] , [ cos ( d ) - sin ( lat 1 ) * sin ( lat 2 ) ] )$$

$$lon 2 = [ mod ( lon 1 - dlon + π , 2 * π ) ] - π$$

Here the distance d is expressed as a relative distance equal to the distance measured between A and B divided by the average radius of Earth.

As another example, in case of a local 2D Cartesian coordinate system used for an area the X and Y coordinate of the device A (x1 and y1 respectively) may be assumed to be known. Then, the X/Y location coordinates of the device B (x2 and y² respectively) can be calculated using the following equations:

$$x 2 = d * cos ( alpha ) + x 1$$

$$y 2 = d * sin ( alpha ) + y 1$$

where all coordinates and distance d are expressed in meters and the angle (alpha) towards device B was measured by A.

Alternatively, translation of distance to coordinates of a coordinate system may be done using other concepts, such as reverse Havershine formula, length of degree, Molodensky's method and block shift method, depending on the required accuracy and the type of coordinate systems used by the application. Current techniques for ranging and position estimation can be improved in the following areas:

i. Location accuracy is highly dependent on signal path loss and degrades with loss of signal quality in indoor and deep indoor environments, where cellular coverage is very poor. Moreover, in remote outdoor environments, where the number of base stations is limited and results in a sparse to no signal coverage, the accuracy of location services becomes poor. In such areas, depending on the positioning methods used, trilateration or triangulation of a mobile device (e.g., UE) may require a longer initial latching time to be able to simultaneously receive at least three different signals from at least three different base stations. If the mobile device is moving in such poor coverage areas, continuity and reliability of location services offered by base stations may become severely disrupted, resulting in a service that becomes non-usable for real time location tracking.
ii. Ranging accuracy in outdoor environments depends largely on channel variability and reflective properties of objects surrounding the devices that carry out ranging operations. In indoor environments, a user of a mobile device (e.g., UE) can fairly control the environment with respect to objects and surrounding environment prior to ranging between two devices, whereas in outdoor environments it is uncertain to have control over the environment and more often it will negatively impact ranging accuracy. In addition, the movements of mobile devices in outdoor environments may also have a large impact on ranging accuracy due to the probable Doppler effect in the RF propagation channel. Ranging measurements between two devices in an outdoor environment may thus become non-usable due to largely deteriorating effects in the RF channel.

In the following, embodiments are described, in which ranging and/or positioning concepts are complemented by using ranging measurements (e.g., distance, angle and altitude) between transmitters and receivers to thereby improve accuracy of positioning and/or reduce power consumption pertaining to these concepts.

Some use cases may require translation of ranging measurements into location coordinates, which enables UEs that are not capable of using a positioning service or an additional positioning module to get a location coordinate derived from ranging information. In addition, devices with very poor positioning accuracy especially in indoor environments may benefit from ranging, such that the positioning accuracy is increased from hundreds of meters to sub-meter accuracy in indoor and/or out of coverage environments. Moreover, accurate positioning and continuous tracking of low power IoT devices is a requirement for yet another use case, which can enable adaptive delivery of quality of service (QoS), e.g., high bandwidth is offered at a location X, whereas only low bandwidth is offered in location Y, to a mobile UE depending on the location. Some of the identified suitable use cases may require formation of a cluster of UEs based on location information to deliver location based QoS to a group of UEs.

It is important to note that throughout this disclosure, at places where a ranging and/or positioning concept is mentioned, any of the above ranging and/or positioning methods or combinations thereof, or other ranging or positioning methods known to the skilled person can be used.

Section: Ranging Constellation (Incl. Its Configuration)

FIG. 5 schematically shows a block diagram of a wireless system for providing ranging and/or positioning services according to various embodiments.

In FIG. 5, a ranging constellation (RC) 50 is provided, which is a group of one or more anchor UEs (A-UE) 14 adapted/prepared to let one or more device UEs 10 join that group. A device UE 10 may join the ranging constellation 50, e.g., for the purpose of initiating a ranging procedure or to participate in ranging of other UEs by acting as an additional anchor UE 14. In order to determine the (absolute or relative) location of a UE, a single distance and/or angle resulting from a ranging procedure may not be sufficient. In an example, the ranging constellation 50 may have at least two or more anchor UEs 14 in order to determine a location of the device UE 10 by determining a distance and/or angle between device UE 10 and the anchor UEs 14 of the ranging constellation, and use the determined distances and/or angles to calculate a location using trilateration and/or triangulation. If additional information is known or can be determined beforehand, such as certain coordinates, whether or not devices involved in ranging are at the same height (e.g. a certain number of meters above sea level, same floor) or in the same reference plane, the ranging between device UE 10 and a single anchor UE 10 in a constellation may be sufficient to determine its relative or absolute location.

The devices constituting the ranging constellation 50 may be selected based on a set of one or more selection criteria for a candidate device, such as its support for GPS/GNSS, whether or not its position is known, its particular ranging capabilities, its existing membership of other ranging constellation(s), its distance to a particular reference point (e.g., a nearby access device), its velocity and/or determination of whether the device is stationary or mobile, or whether or not such candidate device is within sidelink discovery range of another device (e.g., an anchor device). The formation of a ranging constellation and selection of its members is typically done by a managing entity but may also be self-configured based on the selection criteria.

A device UE 10 may be added to or removed from an existing ranging constellation. Similarly, an anchor UE 14 may be added to or removed from an existing ranging constellation. The ranging constellation 50 may be given an identity (e.g., by a managing entity), and this identity may be transmitted to each device joining/constituting the ranging constellation 50. The identity may also be used during discovery of ranging capable devices and/or during connection setup between ranging capable devices and/or exchanging messages to initiate a ranging session. Multiple identities may be assigned to the ranging constellation (e.g., both a unique constellation instance identifier and a constellation type identifier).

Note that adding, removing and joining of a device UE 10 to a ranging constellation does not imply that a device UE 10 needs to have information about all Anchor UEs of a ranging constellation or that a session needs to be established with all Anchor UEs of a ranging constellation. For example, the set of other UEs of a ranging constellation may only be known by the LMF or other managing entity. The UEs of a ranging constellation may form a trusted group/domain, whereby the UEs that are part of a ranging constellation may share same/similar group/domain credentials or authorization token(s), through which (if needed) a UE may be able to prove to other UEs of a ranging constellation that it is part of the same ranging constellation if it can provide a proof of possession of the group/domain credentials or authorization token (e.g. by transmitting a correct response to an authentication/authorization request, or transmitting a correctly signed token/message). The shared group/domain credentials may be used to protect (e.g. encrypt and/or integrity protect) message exchanges between the UEs that are part of the ranging constellation. This may include protection of multicast/groupcast messages. UEs that don't possess the group/domain credentials cannot decrypt those messages. In this manner, the UEs don't directly need to know which other UEs are part of a constellation or that may join a constellation. Alternatively or additionally, a UE of a ranging constellation may be provided with separate credentials for each other UE in the ranging constellation.

The device UE 10 corresponds to a wireless device that requires ranging and/or positioning services, also known as the Target UE. It is noted that in the following description of embodiments, the term “device UE” and “UE” are used interchangeably and are intended to mean the same device. Also, the terms position and location are used interchangeably and can be relative (e.g. a coordinate in a reference plane) as well as absolute (e.g. a geographical coordinate).

Each anchor UE 14 corresponds to a wireless device that offers ranging and/or positioning signals to the UE 10. Additionally, the anchor UEs 14 may offer ranging/positioning services to UEs and other anchor UEs.

It is noted that the device UE 10 and the anchor UEs 14 may be a mobile phone or any type of connected device and can support Uu and PC5 3GPP interfaces. These devices may be capable of supporting multiple radio access technologies including but not limited to 2G/3G/4G/5G networks as described by 3GPP, non-3GPP wireless technologies operating in an unlicensed wireless spectrum such as the Wi-Fi spectrum, the Bluetooth spectrum, and ISM bands. The mobility of the device UE 10 and the anchor UE 14 does not affect the capability of a device UE 10 to become an anchor UE 14 or vice versa. Depending on the application, the anchor UE 14 can also be a fixed device (e.g., smart television) and a mobile device UE 10 (e.g., mobile phone) may even be authorized to become an anchor UE 14 either when it is moving or when it becomes and remains fixed in one location. Typically, an anchor UE 14 knows its own location or is able to obtain its own location from a location service, or is able to provide/determine a reference plane and reference direction for distance/angle measurement using ranging procedures with a device UE 10, and should also be able to do so when out-of-coverage of the network. Preferably, an anchor UE is in coverage of the network so that it can access location services offered by a core network, can obtain its position, can remain synchronized with the network, can obtain authorization of the ranging procedure, etc).

Both the device UE 10 and the anchor UE 14 may have a receiver unit for receiving ranging reference signals and/or other wireless signals used for distance/angle measurement and which may be able to determine the timing of these signals, and may have a computational unit for calculating/determining distance/angle/positioning measurements (e.g., reference signal time difference (RSTD), reference signal received power (RSRP), Rx-Tx time differences between a device UE 10 and an anchor UE 14 and/or a device UE 10 and a wireless access device (e.g., base station or gNB) 20). The computational unit (or another computational unit at device UE 10 or anchor UE 14) may also be able to calculate a distance, angle, or (relative) position based on these distance/angle/positioning measurements (possibly augmented with data from other sensors, such as barometric pressure sensors) and/or distance/angle/positioning measurements (possibly augmented with data from other sensors, such as magnetic sensor) received from other device. In addition, the device UE 10 and the anchor UE 14 may have a transmitter unit for transmitting signals used for distance/angle measurements (e.g., position reference signals or sounding reference signals) and which may be able to determine the timing of these signals. An anchor UE may have a known/fixed position, and hence may be a Position Reference Unit as described in 3GPP document R2-2109489 and, in addition, may transmit this information to device UEs 10 and/or other anchor UEs 14. The device UE 10 and anchor UE 14 may support transmission of signals and receiving signals to enable communication with a wireless access device (e.g., as defined in 3GPP specification TS 38.300) and may be able to communicate with a (cellular) core network and its services (e.g., as defined in 3GPP specification TS 23.501), such as a location service (e.g., as defined in 3GPP specification TS 23.273) using protocols such as LTE Positioning Protocol (LPP) as defined in 3GPP specification TS 36.355 or NR Positioning Protocol A (NRPPa) as defined in 3GPP specification TS 38.455. Furthermore, the device UE 10 and anchor UE 14 may support discovery and communication over PC5/sidelink (e.g., as defined in 3GPP specifications TS 38.300, TS 23.287, TS 23.304 and TR 37.985) with another device UE and/or anchor UE.

The device UE 10, the anchor UE(s) 14 and the wireless access device 20 may together form a positioning constellation (PC) 60.

Ranging or sidelink-based positioning might be done between the device UE 10 and one or more anchor UEs 14 depending on the application and accuracy needs. For instance, a simple application such as rough ranging may be used by a single anchor UE 14 to provide an indication of a rough range/area. Other applications may require three or more anchor UEs 14 tightly clock-synchronized with the device UE 10.

The ranging constellation 50 comprises a set of UEs, e.g., the device UE 10 and at least one anchor UE 14 that performs ranging and that can support each other in determining a geographical location and/or in the provisioning of relative positioning services (e.g. determining a location in a reference coordinate system). In the ranging constellation 50, one of the anchor UEs 14 may be the head or lead anchor UE in charge of managing the remaining set of anchor UEs 14 (e.g. act as synchronization source for the other anchor UEs). Additionally, an anchor UE may be configured to support a managing entity e.g. to select, configure, reconfigure etc. other anchor UEs 14.

At least one wireless access device 20 (e.g., base station or gNB) is configured to handle the connectivity of UEs to a core network (CN) 30. It may also support a number of positioning techniques either in an isolated manner or in combination with other wireless access devices 20. The wireless access device 20 is responsible for among others, radio resource allocation and scheduling, clock time synchronization and power control of connected devices.

The wireless access device 20 may also provide positioning signals and may provide (access to) positioning services for the devices in the ranging constellation 50. A positioning constellation 60 comprises a set of at least one wireless access device 20 (possibly in conjunction with a positioning service in the core network such as LMF) that provides positioning services to at least one device UE 10 or anchor UE 14. The device UE 10 or anchor UE 14 might not always be connected to the wireless access device 20, i.e., they might be out of coverage, but a device UE 10 or an anchor UE 14 might have connected before to a positioning service related to a positioning constellation 60 to get its position; it might have also received the position from a managing entity (e.g. an installer UE). Later, when the anchor UE is not in coverage, it can still send ranging signals and/or information about its position while not being connected to the wireless access device 20.

Furthermore, a core network (CN) 30 provides networking functions that control the access network and manage the UE devices 10 and anchor UEs 14 subscribed to core network services and served by means of the access network. It may be, e.g., a 5G core network. The core network 30 can include a number of network functions including an access and mobility management function (AMF) 32 configured to manage access and mobility of subscribed UEs, a location management function (LMF) 34 configured to manage positioning services offered to UEs 10 and anchor UEs 14, a ranging management function (RMF) 36 configured to manage ranging services between (ranging) UEs 10 and anchor UEs 14, and a network exposure function (NEF) 38 that allows an application function (AF) 40 to connect to the core network 30.

It is noted that a network controller device may perform the role of the core network 30 in the described embodiments. It is also noted that an LMF 34 or RMF 36 may comprise or connect to a set of services/functions (e.g. Gateway Mobile Location Centre, (GMLC)) that may together be responsible/capable of determining, verifying, providing and/or storing a set of locations, distances, angles, coordinates, and other relevant information for location and/or ranging services, and/or managing/configuring/operating a set of location and/or ranging services, and/or combining distances, angles, location information with distance, angles, location information from other sources or resulting from various location/ranging mechanisms. The term LMF or RMF denotes any such service/function or combination thereof. The LMF and RMF are also considered to be a position service, ranging service or a combined position-ranging service. The application function 40 may be a third-party application that may be interested in leveraging the services provided by the core network 30 and the wireless connectivity offered to UEs 10 and/or anchor UEs 14.

According to various embodiments, a managing entity is provided that configures one or more UEs as anchor UEs 14 to form the ranging constellation 50 and support ranging services, location services and/or ranging-based positioning services (i.e., a combination of ranging and location service functionality). In addition to improving localization and ranging accuracy, the ranging constellation 50 also helps to reduce power consumption at least for the involved UEs 10 by combining ranging and location services.

More specifically, location accuracy can be improved with simple ranging measurements between the devices, initiated and/or coordinated either locally or centrally. In examples, this can be realized by using ProSe discovery messages and/or carrier phase based ranging/positioning techniques and/or ranging/positioning signals transmitted combining FR1 (e.g., low/mid bands, typically up to 7.125 GHz) and FR2 frequency ranges (e.g., mmWave bands, typically above 24 GHz).

The core network 30 (e.g., network controller device), together with the wireless access device 20 (e.g., base station or gNB), may support ranging and/or positioning services needed by one or more device UEs 10 and offered by one or more anchor UEs 14 via the managing entity. A managing entity can typically support one or more of the following:
provide a user interface through which a user can select and (re-)configure a set of UEs to form a ranging constellation, and/or through which it can manage ranging and/or location procedures and/or ranging services and/or location services, such as configuring the requirements and parameters of the ranging procedures/service and/or location procedures/service including but not limited to:
which ranging/positioning method to use (e.g. RTT based, TDOA based, AoA/AoD based),
which Radio Access Technologies to use (e.g. 3GPP LTE, 3GPP 5G NR, Wi-Fi, Bluetooth, UWB, . . . ),
which bands to use (incl. whether unlicensed/licensed spectrum is to be used),
which bandwidth to use,
minimum/maximum/default measurement duration and/or timing of ranging reference signals/measurements,
minimum/maximum/default transmit power to use,
desired/minimum accuracy of ranging,
constellation size (e.g. number of devices, identities of the involved devices, area information, maximum distance),
constellation configuration (e.g. known positions and/or initial position estimation of one or more devices constituting the constellation and/or estimated distance/angles),
area map,
coordinate system to be used (incl. which device or anchor point is used as the primary reference point/center),
sampling frequency of ranging and positioning measurements,
credentials (e.g. security keys, identities) to be used during discovery and/or ranging procedures;
provide intermediary/proxy configuration functionality through which a network entity (e.g. a location/ranging management function), an access device (e.g. a base station) or an application function (e.g. through a network exposure function) can select and (re-)configure a set of UEs to form a ranging constellation, and/or through which it can remotely manage ranging and/or location procedures and/or ranging services and/or location services (such as configuring the requirements and parameters of the ranging procedures/service and/or location procedures/service, as described in the previous bullet). The configuration by a network entity may be done directly (e.g. through a set of messages as part of a configuration protocol) or indirectly (e.g. through a set of policies/rules that the managing entity can use to decide e.g. how to determine/select anchor UEs or e.g. how to configure parameters to perform ranging).
collect information relevant for ranging (e.g. device identities, ranging capabilities, configuration parameters used for ranging) from UEs of a ranging constellation and send it to a ranging or location service, and/or store it in a non-volatile storage.
collect ranging results (e.g. distances, angles, relative or absolute coordinates) and/or ranging measurements (e.g. round-trip times) from UEs of a ranging constellation and send it to a ranging or location service, and/or store it in a non-volatile storage.
collect information about ranging devices as discovered by UEs of a ranging constellation (e.g. discovered device identities, discovered ranging capabilities) and/or ranging results (e.g. distances, angles, relative or absolute coordinates) and/or ranging measurements (e.g. round-trip times) from a set of UEs and determine if a set of UEs form a valid ranging constellation.

A managing entity may be:
a function offered by a UE (e.g. an anchor UE 14 or an installer UE) through which a user can manually manage and/or through which a network entity (e.g. location service to which the anchor UE is communicatively coupled) can remotely manage the ranging constellation, the ranging and/or location procedures and/or ranging/location services (such as configuring the requirements and parameters of the ranging procedures/service and/or location procedures/service as mentioned above)
a user or an application communicatively coupled to the core network 30 (e.g., network controller device) via e.g. the network exposure function 38, and/or the location management function 34, and/or the ranging management function 36 and/or other core network function through which the ranging constellation and/or the ranging and/or location procedures/services can be managed (such as configuring the requirements and parameters of the ranging procedures/service and/or location procedures/service as mentioned above);
a selected one of the wireless access device 20 and/or the core network 30 (e.g., network controller device or a visiting core network) that can (automatically) manage the ranging constellation and/or the ranging and/or location procedures of a set of UEs connected to it and/or the ranging and location services it offers to a set of UEs connected to it or that is offered by a set of UEs connected to it, e.g., after being configured by the location management function 34, and/or the ranging management function 36 (e.g. operated by the home core network); or
a location management function 34 and/or a ranging management function 36 inside or outside of the core network 30, which may manage the ranging and/or location procedures/service (such as configuring the requirements and parameters of the ranging procedures/service and/or location procedures/service and/or configuring a ranging constellation) based on operator managed default operation settings, policies, location databases, historical measurement data, Artificial Intelligence model, possibly in cooperation with core network functions, such as Network Data And Analytics Function (NWDAF, e.g. to determine density of devices, how many devices are typically registered at a certain time of day etc.), or User Data Management (UDM, e.g. for subscription related data), and/or Policy Control Function (PCF, e.g. for policy related data).

The location management function 34 and/or ranging management function 36 or other managing entity may configure the (managing entity of) one or more device UEs 10 and/or one or more anchor UEs 14 and/or wireless access devices 20 based on the requirements and parameters of the ranging and/or location service (e.g., that have been provided through the network exposure function). The configuration may be done by sending a secure message via the PCF or AMF or directly from a location management function or ranging management function to the respective device UEs 10 and/or anchor UEs 14 and/or access devices 20 upon connection establishment with an access device or core network function (e.g. AMF or location/ranging management function), upon receiving a configuration update request and/or upon receiving a request to initiate ranging and/or position estimation by one of the involved devices. To this end, the device UEs 10 and/or anchor UEs 14 may need to support a protocol for configuration of the ranging procedures/service (e.g. an extension to the LTE Positioning Protocol (LPP) as defined in 3GPP specification TS 36.355). In case one or more of the UEs in a ranging constellation are out-of-coverage or are not directly connected to or directly managed by a ranging/location management function, the configuration may be provided to these UEs by a UE in coverage, or forwarded to the these UEs by a UE in coverage, or provided/forwarded by a managing entity (e.g. that may be supported by a (head) anchor UE and may operate out-of-coverage) In an example, an LMF is used for the configuration of ranging capable UEs receive for static and/or dynamic configuration information. For configuration aspects that are unlikely to change for each procedure or possibly even during a procedure, i.e. static configuration aspects, such as default coordinate system to use or other default values to take when device gets out of coverage and/or dynamic configuration is not available, or a policy determining the conditions (e.g. whether the device's position is stable) when to take a certain role, or which device identity and/or security credentials to use during discovery and/or ranging procedures, provisioning may also be performed by other core network functions such as PCF or DDNMF.

Possible dynamically configurable parameters of a ranging-capable UE to consider are:
which ranging/positioning method to use (e.g. RTT, TDOA, . . . ),
which frequency bands and which bandwidth to use,
sampling frequency of ranging and positioning measurements,
timing/period/duration of ranging and position signals and measurements,
minimum/maximum transmit power to use,
role of a device (e.g. Anchor UE, Target UE),
ranging “constellation” information or ranging session related information (e.g. identities of Anchor UEs working together to provide ranging/sidelink position service),
coordinate system to be used,
which device or location/ranging service or location/ranging service proxy will collect the measurements and calculate a distance, angle or position..

The above mentioned dynamic parameters may change for each ranging session/procedure or may even change during a procedure. The parameters may also change and/or be configured per tracking area or per network (e.g. Visiting-PLMN versus Home-PLMN). These dynamic parameters may be exchanged as part of a negotiation procedure (e.g. during discovery, during capability exchange or during connection setup over sidelink or initiating a ranging session/procedure) between device UE 10 and one or more anchor UEs 14, whereby one UE may inform the other about its preferred values for one or more of these configurable parameters or a possible set of values (e.g. based on its capabilities), after which the other UE (typically one of the anchor UEs, a head anchor UE, with/without cooperating/requesting the LMF, possibly taking into account the preferences and/or capabilities of the one UE) may determine which values to use for the configurable parameters and send a message to the one UE including the selected values. This could be done for example by extending the Direct Communication Request and the related Direct Communication Response message with additional fields for this. Also, for some configuration parameters that may change during a ranging session/procedure, such as the role of a device, a change to one or more of the configuration parameters may be provided through a message exchange with the other UE (e.g. by extending the Direct Link Modification Request/Accept messages with additional fields), upon which the session/procedure may be adjusted or aborted and/or a new negotiation procedure may be started. Similarly, when a device UE 10 or anchor UE 14 may take part in a negotiation procedure with the LMF (e.g. during capability exchange or during connection setup with the LMF), whereby the UE may inform the LMF about its preferred and/or possible values for one or more of these configurable parameters, after which the LMF may determine which values to use for the configurable parameters and send a message to the UE which includes the selected values. Additionally or alternatively, a device UE 10 or anchor UE 14 may not directly provide a list of capabilities or preferred values for configuration parameters to another UE or LMF, but instead an identifier is provided by which the another UE or LMF can retrieve a list of capabilities and/or preferred values for configuration parameters of the device UE 10 or anchor UE 14, by a message exchange with a core network function or database that stores such list of capabilities and/or preferred values for configuration parameters for ranging capable UEs, which may be linked to one or more identifiers of a ranging capable UE. An identifier of the device UE 10 or anchor UE 14 provided during a message exchange can be used to retrieve the respective list of capabilities and/or preferred values for configuration parameters.

The configuration of the requirements and parameters may be done in the form of a set of policy rules (e.g. provided through RRC, or through a PCF policy container), which may define a set of conditions based on which a device can determine which configuration/method/parameters/values to apply, e.g., a condition defining a minimum measured signal strength above which a ranging measurement in a certain frequency may take place.

In another example, the UEs of the ranging constellation may be provided with the (group/domain) credentials and/or authorization tokens upon configuration by the LMF or other managing entity, e.g. after the LMF has received information about a ranging constellation (e.g. from an external application (e.g. through NEF), LCS Client or other core network functions, which may provide the (group/domain) credentials to be used) or has dynamically established that a set of UEs form a ranging constellation (upon which the LMF, possibly in cooperation with other core network functions, may determine which (group/domain) credentials are to be used). The LMF or other managing entity may use e.g. the LPP protocol to provide the (group/domain) credentials to be used for a ranging constellation to a Target UE or Anchor UE. Alternatively or additionally, the PCF may provide the (group/domain) credentials to be used for a ranging constellation as part of the UE configuration data, e.g. during initial network configuration or using the UE Configuration Update procedure as specified in 3GPP TS 23.502). Alternatively or additionally, the (group/domain) credentials to be used for a ranging constellation may be stored in the USIM (e.g. during initial provisioning or (e)SIM profile downloading).

Furthermore, a (new/different) Target UE or Anchor UE may join a ranging constellation (e.g. a target UE may temporarily get associated with a ranging constellation in order to determine the target UE's location, possibly automatically when the LMF or other managing entity determines the Target UE is in vicinity of one or more Anchor UEs of the constellation (e.g. based on tracking area or cell-ID information provided during attach/registration to the network, or based on sidelink discovery information received from/by a Target UE or Anchor UE, or based on a last known position of the Target UE) and/or when the LMF or other managing entity determines the Target UE to be part of the same trusted group/domain as other UEs in a constellation (e.g. part of a set of identities provided by an application (e.g. through NEF), and/or belonging to a same Closed Access Group, Non-Public Network, (private) Network slice), and/or upon request of the Target UE or an Anchor UE to perform location estimation of the Target UE, and/or upon a request (e.g. by the Target UE or an application (e.g. through NEF)) for a Target UE to be added to the ranging constellation, after which the LMF or other managing entity (e.g. PCF during initial network configuration) may provide the (group/domain) credentials to be used for a ranging constellation to a Target UE or Anchor UE. Note that every time a UE joins or leaves a constellation, a new set of group/domain credentials may need to be determined and provided to all remaining UEs of the ranging constellation.

Providing the (group/domain) credentials to be used for a ranging constellation may be done e.g. upon the Target UE or Anchor UE successfully attaching/registering to a given Closed Access Group, Non-Public Network, Network slice, or trusted group/domain, the result of which may be provided to the LMF (or other managing entity) by the involved core network functions (e.g. AMF, AUSF or UDM), and/or the LMF (or other managing entity) may issue a request to the UDM (or other core network function) to verify for a given Target UE's identity or Anchor UE's identity if a Target UE or Anchor UE has access to the given Closed Access Group, Non-Public Network, Network slice and/or trusted group/domain, and/or by the LMF or other managing entity verifying that the Target UE's identity or Anchor UE's identity belongs to a set of UE identities that may also join the ranging constellation (provided as part of the ranging constellation configuration information). To this end, the LMF (or other managing entity) may provide a protected message or protected container containing information about the (group/domain) credentials to the AMF and/or gNB to transmit to the respective UE. This may be separate procedure or the AMF and/or gNB may include this protected message/container as part of its responses to the respective UE. Alternatively or additionally, this may be part of an authorization procedure to perform ranging (as described in other embodiments). In case of partial coverage or out-of-coverage situations, the protected message or protected container containing information about the (group/domain) credentials may be provided by the Anchor UE (on behalf of the LMF (e.g. issued and protected by its own local subset of LMF functionality) or as a relayed message from the LMF) to the Target UE.

In a further example related to the configuration of devices to enable ranging, the configuration of the device UE 10 by the managing entity may be achieved by assigning security keying materials and ProSe discovery information as described in 3GPP specifications TS 33.303 and TS 33.305. In particular, a set of discovery user confidentiality keys (DUCK), discovery user integrity keys (DUIK) and/or discovery user scrambling keys (DUSK) can be assigned to enable integrity protection, scrambling protection, and/or confidentiality protection. The device UE 10 may also be provided with, e.g., an identifier identifying the ranging application. These parameters may be used in combination with discovery messages to allow devices allowed to perform ranging with each other to discover each other. The configuration/parameters related to a ranging constellation 50 may not be static and may change over time. In an example, the wireless access device 20 (possibly in combination with the ranging and location services), may be communicatively coupled to the device UE 10 and/or an anchor UE 14. The device UE 10 may report its device capabilities and application requirements to the RMF 36 and/or the LMF 34 or other managing entity (e.g. via the wireless access device 20 or via another/head anchor UE which may be connected to the wireless access 20). The anchor UE 14 may report its current configuration and may report information about the current status/evolution of the members of the ranging constellation 50 (such as number of devices, their identities, their capabilities, their estimated positions, their estimated speed/mobility, information about their battery levels/capabilities, information about their resource capacity, or information about which devices are in coverage and which are out-of-coverage) to the RMF 36 and/or the LMF 34 or other managing entity either directly (e.g. via the wireless access device 20), or via a another/head anchor UE which may operate a managing entity or which may be connected to the RMF 36 and/or the LMF 34 or other managing entity (e.g. via to the wireless access device 20). The RMF 36 and/or the LMF 34 or other managing entity might configure the device UE 10 and/or anchor UE 14 with a policy determining the parameters to perform ranging, ranging services and/or location services, the parameters of which may be based on the (latest) information received about the ranging constellation. For example, if the information about the current status/evolution of the constellation show that the number of available anchor UEs of the constellation has reduced since the ranging constellation 50 was established/determined, e.g. because a number of anchor UEs have been switched off or moved too far away from the other anchor UEs in the constellation, the parameters for the ranging procedures or ranging/location services may be adapted, in order to reflect the new situation, and may be reconfigured/updated on the respective devices involved in the ranging constellation 50 and/or device UEs 10 that may make use of the ranging constellation 50. If it is discovered that an insufficient number of anchor UEs of the constellation is available (e.g. in a particular area previously identified to be covered by a ranging constellation), then the constellation may be discarded and information about the constellation and/or the configuration parameters regarding the constellation may be removed from the device UE 10 and/or anchor UEs 14, and may also be removed from the managing entity.

Additionally or alternatively, the network exposure function 38 may be used (e.g., by an external application) to control network level parameters and other parameters/configuration settings required for optimal performance of ranging and location service for the intended mobile devices. These parameters may be combined with configuration parameters received from the involved device UEs 10 and/or anchor UEs 14 and/or (other) managing entities. In case of overlapping configuration parameters with different values a priority scheme may be applied whereby configuration parameters received from a device UE 10 and/or anchor UE 14 and/or (other) managing entity may have precedence over a configuration parameter received via the network exposure function, or vice versa. Upon detection of an overlapping configuration parameter with different value, the location management function 34, and/or the ranging management function 36 and/or other location/ranging service or proxy thereof may discard the measurements and/or measurement results and/or calculated distance/angle and/or may send an error message and/or may send a message to the respective device UEs 10 and/or anchor UEs 14 involved to update the configuration parameter.

Similarly, if a device UE 10 and/or anchor UE 14 receives a configuration parameter or a desired parameter value to be used that conflicts with a configuration parameter (e.g., range of valid values, or maximum/minimum values) received from a managing entity with a higher priority, it may discard the ranging request, discard a measurement/measurement result, discard a calculated distance/angle, generate an error message, request an update of the configuration parameters or request an exception from the higher priority managing entity. In case of multiple managing entities, the core network may configure a policy with priority rules for different managing entities. The conflict resolution may also be done on a first come first serve basis, or e.g. use the configuration received from the closest anchor UE.

### Section: Ranging Based Positioning

In the following, specific ranging-based positioning is described in more detail with reference to the network architecture of FIG. 5.

According to various embodiment, the ranging or positioning may be executed between the device UE 10 and an anchor UE 14, according to the configured parameters of a managing entity in the anchor UE 14 or a managing entity which may provide the configured parameters via the anchor UE 14. To this end, the anchor UE 14 or the managing entity may expose one or more of the configured parameters and/or the values that the anchor UE or managing entity selected and/or decided to use for the parameters to perform a ranging procedure (e.g. the ranging method used, bandwidth/frequency used, number of antennas used) for a ranging or location service to one or more device UEs 10 and/or one or more other anchor UEs 14, e.g., through ProSe discovery messages and/or by transmitting the configured parameters after establishing a sidelink/PC5 connection with the one or more device UEs 10 and/or the one or more other anchor UEs (e.g., through a PC5 signaling message or RRC message or Direct Communication Request/Accept message or through a LPP/NRPPa protocol message, whereby these messages may be new ones or existing ones with additional/different fields specified for the purpose of ranging). According to some embodiments, the ranging service or positioning service may be executed by the wireless access device 20 or by the core network 30 (e.g., network controller device) or by proxy through an anchor UE 14. The devices UEs 10 and/or anchor UEs 14 that are involved in the ranging/positioning may send the configuration parameters that they selected and/or used to perform ranging (e.g., the ranging method used, bandwidth/frequency used, number of antennas used) (additionally or separately from the respective distance/angle measurements) to the ranging service (or proxy thereof) or location service (or proxy thereof) or a managing entity (which may collect the information from multiple UEs involved and send it to the ranging or location service). The ranging service or location service can use this information to determine how to calculate a position/distance/angle estimation and/or determine an accuracy estimation of the measurements, a threshold for accepting measurements, a value for measurement/calculation error compensation and/or to determine a change to the configuration of one or more UEs involved.

According to some embodiments, in order to initiate ranging, the device UE 10 may send a signal to an anchor UE 14, or an anchor UE 14 may send a signal to a device UE 10, or in case of a ranging constellation consisting of more than two UEs, a device UE 10 or anchor UE 14 may send a signal to another device UE 10 and/or another anchor UE of the ranging constellation to request the start of a ranging session. This may be a separate signal or message, or may e.g. be indicated by setting an attribute during connection setup between the two UEs (e.g., a boolean ‘rangingrequest’ attribute as part of a Direct Communication Request message or an RRCSetupRequest). This is typically done during or after a discovery phase through which it may find out the configured parameters (as described above) and/or possibly other properties of the ranging service or location service provided by the other device (e.g. supported ranging capabilities, whether or not it acts as an anchor UE, which (preferred) ranging method to use, location information, device identifier, ranging constellation identity/identifier, list of anchor UE identities (of a ranging constellation), position information of one or more anchor UEs (of a ranging constellation), key identifier, credentials (e.g. public keys), nonces, position information (e.g., its geographical/GPS coordinates), (supported) signal type(s), frequency/band information, which PLMN it supports or it can connect to, which location service or location service capabilities it supports or it can connect to, which ranging service or ranging service capabilities it supports or can connect to, synchronization/clock/timing information, whether or not it is in or out of coverage of an access device, and if in coverage which access device and its properties, whether or not it support ProSe relay or other ProSe or V2X or sidelink/D2D services, antenna information/configuration). Note that the above mentioned parameters may also be transferred during a (pre-)configuration phase (e.g. received as part of policy information from the PCF when the UE was in coverage), or (e.g., through a PC5-signalling or RRC message) after discovery, e.g. after a PC5/sidelink connection has been set up. Note also that if a request to initiate a ranging session is received by one of multiple anchor UEs in a ranging constellation, the anchor UE that receives the request may forward the request or issue a request to other anchor UEs in the ranging constellation, or may forward the request or issue a request to a ranging service or location service (which in turn may forward or issue a request to other anchor UEs in the ranging constellation.

In an example, multiple Anchor UEs 14 can work together to perform sidelink positioning of a Target UE 10 in various coverage scenarios. A Target UE may connect to multiple Anchor UEs to perform the ranging procedure. By collecting the information from the various ranging measurements the sidelink position can be calculated more accurately than when only a single Anchor UE would be used. These multiple Anchor UEs may form a so-called ranging “constellation” whereby these anchor UEs may have a fixed position and together can cover a certain area, such as a room or building. A Target UE may discover multiple Anchor UEs or may discover a constellation of anchor UEs (which could have an identity of its own) in its vicinity, and invite them all to participate in the same ranging session/procedure. Alternatively, the Target UE may discover one Anchor UE (of a ranging “constellation), after which the anchor UE or LMF (or other managing entity) will invite other Anchor UEs to join the ranging session/procedure. To this end, information about a session identifier or constellation identifier may be exchanged amongst the Target UE and Anchor UE(s) involved. Additionally or alternatively, the Target UE may discover an Anchor UE, which may in its discovery response message (or in a PC5 groupcast/multicast/broadcast message or via a PC5 unicast link between the Target UE and the Anchor UE, e.g. using an extended encapsulated LPP assistance or similar command) provide to the Target UE a list of identities (e.g. L2 identities for discovery or Direct Communication Request (DCR), or L2 groupcast/multicast/broadcast identifiers) of other Anchor UEs in vicinity (e.g. as discovered by the Anchor UE) and possibly other information about other Anchor UEs in the vicinity (e.g. as part of Metadata field in a discovery message from that Anchor UE to the Target UE), whereby the list may be subsetted to only include Anchor UEs of a ranging constellation, so that the Target UE perform targeted discovery (e.g. by including the identifier of the Anchor UE to be discovered in its discovery solicitation messages) and/or can directly issue a DCR message to connect to these Anchor UEs, without having to discover them first. Additionally or alternatively, the LMF (or other managing entity) may request one or more Anchor UE(s) 14 to perform discovery of a Target UE 10, after which they may establish a ranging connection with each other and may join the ranging session/procedure.

In an example, the LMF (or other managing entity) instructs each invited Anchor UE to use the same session identifier or constellation identifier by including such identifier when setting up a connection or send a message to initiate ranging with the Target UE 10. In another example, the Target UE 10 uses information received about a constellation to derive a single session identifier or the constellation identifier itself, and includes this identifier when setting up a connection or send a message to initiate ranging to each Anchor UE that it has discovered that matches an identity of an Anchor UE of the constellation or that has provided through its discovery announcement or discovery response a constellation identifier that matches the constellation identifier. An Anchor UE 14 may provide a session identifier (e.g. provided by the LMF or other managing entity as part of its invitation to join a ranging session procedure or as part of the Anchor UE's configuration information) through its discovery announcement or discovery response that a Target UE 10 may compare with its known session identifiers. If the session identifier matches a known session identifier, the Target UE 10 may identify the discovered Anchor UEs 14 as an additional Anchor UE that may be part of a constellation, and hence set up a connection with that Anchor UE to join the ranging session with that session identifier or send a message to initiate ranging with that session identifier.

In another example, Anchor UEs of a ranging constellation are configured/invited to participate in the ranging and/or location estimation of a Target UE but don't need to actively set up a ranging session with the Target UE. This may be done by the LMF 34 or RMF 36 (or other managing entity) providing configuration information to a respective Anchor UE of the ranging constellation which may include information about PRS/SRS or other ranging reference signals (e.g. signal characteristics/type, resource schedule, frequency bands/bandwidth used, etc.) that a Target UE or other Anchor UE will use. This information can be used to monitor the relevant signals and perform measurements on these if it receives a relevant signal (e.g. determine its arrival time at the respective Anchor UE) and report these measurements (or a calculated ranging result such as a distance or angle) to the LMF 34 or RMF 36 or proxy thereof. The configuration information provided to the respective Anchor UE may include an identifier of a target UE or other Anchor UE or identifier related to a ranging reference signal configuration or configuration item therein (e.g. a particular resource schedule), that the Anchor UE may use in its reporting of the measurement/ranging results to the LMF 34 or RMF 36 or proxy thereof by associating a particular reception of a relevant signal to this identifier. The timing of the measurements or signal characteristics or frequency being used may be sufficient information for the Anchor UE to determine to which ranging procedure or for which other UE the measurement applies, based on this configuration information, so that it can determine which identifier it may use in its reporting. The configuration information may also include information about PRS/SRS or other ranging reference signals (e.g. signal characteristics/type, resource schedule, frequency bands/bandwidth used, etc.) that the respective Anchor UE should use to transmit those ranging reference signals. The Target UE may be configured by the LMF 34 or RMF 36 or other managing entity with similar configuration to receive those signals, but may not be configured with information about which Anchor UE will actually send those signals. Instead, the Target UE may configured with an identifier related to a ranging reference signal configuration or a configuration item therein (e.g. a particular resource schedule), that the Target UE may use in its reporting of the measurement/ranging results to the LMF 34 or RMF 36 or proxy thereof by associating a particular reception of a relevant signal to this identifier. The timing of the measurements or signal characteristics or frequency being used may be sufficient information for the Target UE to determine to which ranging procedure or for which other UE the measurement applies, based on this configuration information, so that it can determine which identifier it may use in its reporting. The configuration information may also include relevant security credentials to be able to decrypt or encrypt the payload of certain signals. Since the Target UE may not even need to know that another Anchor UE is involved in ranging and/or location estimation of the Target UE, the LMF 34 or RMF 36 or proxy thereof has to ensure that the Anchor UE is authorized to be involved in the ranging of the Target UE and/or that that Target UE has provided consent for this. As mentioned in other embodiments the Target UE may provide consent for individual Anchor UEs to be involved in the ranging of the Target UE or to all Anchor UEs of a constellation at once. The LMF 34 or RMF 36 or proxy thereof has to verify the consent given for a Anchor UE and make sure the Anchor UE is properly authenticated and/or authorized providing configuration information to a respective Anchor UE that includes information about PRS/SRS or other ranging reference signals that a Target UE or other Anchor UE will use.

In yet another example, the Target UE discovers multiple Anchor UEs, sets up a connection, and initiates a ranging session with each Anchor UE individually using a separate session identifier. the Target UE (directly if in coverage or if out-of-coverage via an Anchor UE that may forward the message or issue a corresponding message) may report these session identifiers and/or a set of identifiers of the Anchor UEs that it has performed ranging with and/or the ranging measurements or results to the LMF 34 or RMF 36 or proxy thereof. Based on the identifiers of the Anchor UEs, the LMF 34 or RMF 36 or proxy thereof determines for each identifier if the identifier corresponds to an Anchor UE identifier in one or more ranging constellations. In this way, the LMF 34 or RMF 36 or proxy thereof can determine if all Anchor UEs of a ranging constellation have been discovered by the Target UE and/or that the Target UE has performed ranging with. If not, the LMF 34 or RMF 36 or proxy thereof may instruct the Target UE to discover and/or connect to the remaining Anchor UEs of a constellation and/or may configure and/or invite the remaining Anchor UEs to discover the target UE and/or perform ranging with the target UE.

According to some embodiments, before the ranging session begins (e.g. during discovery) or during the ranging session, the Target UE 10 receives an identity of each Anchor UE 40. If the identity matches one of the Anchor UE identities in one or more ranging constellations in the ranging constellation information that the Target UE may have received (e.g. from the managing entity during (pre-)configuration), the Target UE may check if it has discovered all the Anchor UEs of the respective constellation and/or has connected to all the Anchor UEs of the respective constellation to perform ranging. If it has not, the Target UE may initiate discovery or connection setup with the remaining Anchor UEs of the respective constellation which the Target UE has not yet discovered or performed ranging with. If a remaining Anchor UE cannot be discovered or cannot be connected to, the Anchor UE may be out of range of the Target UE (i.e. too far away from the Target UE). This information (i.e. that an Anchor UE is out of range) together with area information of the constellation and/or position information of that Anchor UE can be used in the calculations to determine the Target UE's position since it will rule out that a Target UE is close to that Anchor UE and must be somewhere else, for example by excluding a circular or elliptic or hyperbolic shaped area/volume around that Anchor UE with radius, respectively a semi-minor axis, respectively a focus distance minus semi-major axis being equal or less than the (expected/calculated) wireless signal range of a target UE for sidelink communication (on a given frequency) length, or for example by excluding the area behind a “virtual” line (or a further parallel line) between two other Anchor UEs with which the Target UE was able to calculate its distance with, or for example by excluding a set of circular areas with the Target UE as the center and radius being the wireless signal range for sidelink that includes that Anchor UE (e.g. as a point on the circle), but that does not contain one or more of the other Anchor UEs that the Target UE has discovered and was able to calculate its distance with, or for example by excluding those parts of the area as indicated for arranging constellation that are not close to the Anchor UEs that the Target UE were able to discover and perform ranging with. Additionally or alternatively, the Target UE (directly if in coverage or if out-of-coverage via an Anchor UE that may forward the message or issue a corresponding message) may report the Anchor UE identities that it has discovered and/or has performed ranging with to the LMF (or other managing entity). The LMF can determine based on the received identifiers the constellation(s) to which the discovered Anchor UEs belong. If the Target UE has not reported that it has discovered or was able to discover or perform ranging with one or more other Anchor UEs of such constellation(s), the LMF can use this information in the calculations to determine the Target UE's position since it will rule out that a Target UE is close to those Anchor UEs and must be somewhere else. Additionally or alternatively, an Anchor UE may report to the LMF (or other managing entity) that it has discovered a Target UE or that a Target UE is trying to discover the Anchor UE or that a connection is being or has been established between the Target UE and the Anchor UE (e.g. to perform ranging) or that it has not discovered a Target UE or that the Target UE has not tried to discover or establish a connection with the Target UE. The LMF can this information in the calculations to determine the Target UE's position since it may rule out that a Target UE is close to those Anchor UEs and must be somewhere else if a Target UE has not been discovered or has tried to discover the respective Anchor UE.

As mentioned above, sidelink positioning should work in various coverage scenarios. If the Target UE as well as the Anchor UEs are in coverage of the NG-RAN, the Target UE may connect to the LMF and indicate a preference to collect the measurements and calculate the Target UE's position at the Target UE or indicate a preference to let the LMF to calculate the Target UE's position. In the first case, the Anchor UEs will provide their measurements and information about their position (or reference plane/angle information) to the Target UE. The Target UE needs to be authorized to receive the location of Anchor UE(s). In the latter case, the Anchor UEs provide their measurements and information about their position to the LMF. The Target UE also needs to send its measurements to the LMF in that case. The LMF may configure the Target UE and the Anchor UE(s) accordingly.

Similarly, in case of partial coverage, if the Target UE is out-of-coverage and the Anchor UE(s) (at least one of them) is in coverage of NG-RAN, the Target UE may connect to one or more Anchor UE(s) and indicate a preference to collect the measurements and calculate the Target UE's position at the Target UE, or indicate a preference to let the LMF to calculate the Target UE's position. In the first case, the Anchor UEs will provide their measurements and information about their position (or reference plane/angle information) to the Target UE. The Target UE needs to be authorized to receive the location of Anchor UE(s). In the latter case, the Anchor UEs provide their measurements and information about their position to the LMF. The Target UE would also need to send its measurements to the LMF, but since it is out of coverage, the Anchor UE needs to forward the measurements, for example by using ProSe UE-to-Network relay functionality.

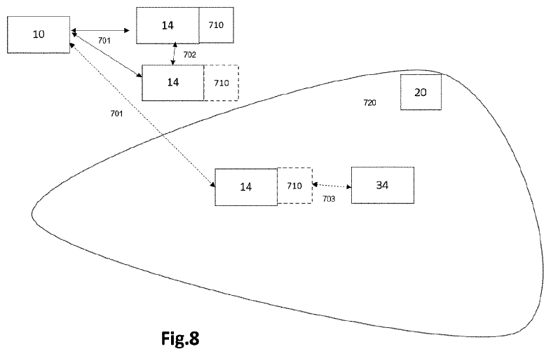

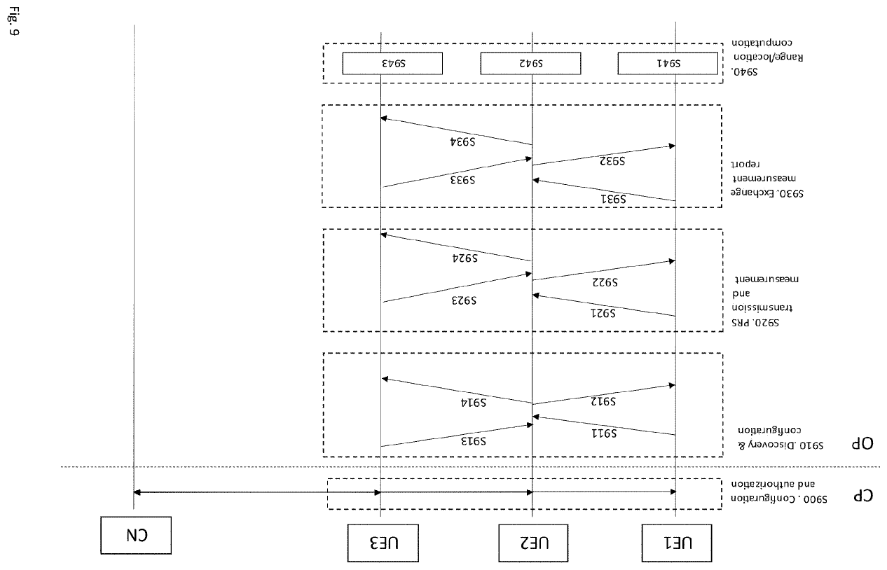

Alternatively, in case of partial coverage and also for out-of-coverage situations an Anchor UE may support a subset of the LMF's functionality (i.e. acts as a location service proxy), e.g. to collect the ranging measurements and calculate a position of the Target UE (as depicted in FIG. 8). An Anchor UE should be able to indicate this capability to a Target UE, e.g. during discovery, or as a response to a request/preference of the Target UE to let the LMF calculate the Target UE's position. If an Anchor UE or other UE (e.g. Target UE or external UE outside the constellation) supports a subset of the LMF's functionality, this support may be indicated as support for a SL Positioning Server UE/role. If the Target UE agrees, the Target UE can send its measurements to the respective Anchor UE/SL Positioning Server UE. If multiple Anchor UEs/SL Positioning Server UE are involved in the sidelink positioning, then one of the Anchor UEs/SL Positioning Server UEs is selected and the other Anchor UEs need to send their measurements and positions to the selected Anchor UE/SL Positioning Server UE. An Anchor UE/SL Positioning Server UE needs to be authorized to receive the measurements of a Target UE and the measurements and location of other Anchor UEs, and calculate a position of the Target UE. In order to calculate the position of a target UE using as many measurements as possible, it is important that an anchor UE/SL Positioning Server UE that supports a subset of the LMF's functionality (e.g. the ability to calculate a position) is in coverage or can connect directly (e.g. over PC5) or indirectly (e.g. via a base station or core network via Uu, or via a relay device over PC5) to other anchor UEs (e.g. the other anchor UEs in a ranging constellation) as well as to the target UE. Hence, an anchor UE/SL Positioning Server UE may indicate during discovery (e.g. in a message field during model A/B discovery) to how many other anchor UEs it is directly or indirectly connected or can connect to. It may also indicate the connection quality/speed/latency indicators, such as signal quality, error rate, number of hops, minimum/average/maximum latency, congestion ratio, distance, line-of-sight connection between the UEs (or not, e.g. obstacles detected). The target UE may use this as a selection criterium for selecting an anchor UE. The anchor UE/SL Positioning Server UE may also indicate if it has a stable connection to a base station/core network (e.g. good signal quality, anchor UE is not moving at the moment) and may indicate that it expects or has calculated (e.g. through signal analysis or other sensors) that it has line-of-sight connection to the target UE. Additionally or alternatively, in case of partial coverage, an anchor UE may use one or more of the above mentioned indicators (as discovered from another one or more anchor UEs) and other information about the other anchor UEs (e.g. as discovered or provided during connection setup), such as their capabilities, to negotiate with another anchor UE which of the anchor UEs needs to acts as the head anchor UE, which anchor UE to calculate the position of a target UE, which anchor UE to announce itself as supporting a subset of the LMF's functionality, and/or which anchor UE to connect to the LMF. Additionally or alternatively, an anchor UE may use one or more of the above mentioned indicators (as discovered from another one or more anchor UEs) and other information about the other anchor UEs (e.g. as discovered or provided during connection setup), such as their capabilities to determine whether or not to act as the head anchor UE, whether or not to calculate the position of a target UE, whether or not to announce itself as supporting a subset of the LMF's functionality, whether or not to connect to the LMF.

After or when receiving a signal to initiate a ranging session, the UEs involved may verify if the request comes from an authorized UE. To this end, the UEs may need to exchange credentials, may perform authentication and/or authorization, either standalone or supported by the core network, e.g. may contact the core network to authenticate the UEs involved and verify their authorization. Once the authorization is successful, one or more of the UEs may start to transmit ranging reference signals (e.g., position reference signals/sounding reference signals or other signals (e.g., ProSe discovery message), possibly using radio spectrum resources for sidelink communication or sidelink discovery. This may be a repeated signal for a configured number of times (e.g., with a certain pause/quiet interval between the signals) or until a signal to stop the ranging session is received. The (required) timing of these signals (e.g. the start time of the first signal) may depend on or determine a configured timing/delay, sending/receiving of a synchronization signal, sensing of a quiet period, QoS or quality of experience (QoE) information (e.g., of the ranging/location service or e.g. of other traffic), scheduled resources (e.g., semi-persistent resources), DRX/sleep information that may be configured and/or exchanged between the devices, a timing randomization function, signal quality measurements, doppler-shift/coherence time/hysteresis of measured signals, speed of the devices, etc.). The device UE and/or anchor UE(s) 14 perform ranging measurements on the received ranging reference signals (e.g. determine the arrival time of the ranging reference signal(s), measure angle of arrival of the ranging reference signals), and may calculate a distance or angle based on the techniques described earlier or in other embodiments.

According to some embodiments, the signal to initiate a ranging session may be sent by an access device or a core network function (such as the location management function 34, and/or the ranging management function 36) to one or more of the UEs involved. In an example, the access device and/or core network function may be aware that two UEs are in vicinity (e.g., because they are both connected to the same access device), so that the access device or core network function may instruct the two UEs to initiate a ranging session, without the UEs having to perform a discovery phase. The access device or core network function may provide the necessary configuration parameters so that each UE knows exactly how to perform the ranging session (e.g., which frequency band or bandwidth to use, which mechanism, which type of signal, (temporary) device or ranging/session identifiers and/or credentials to be used during ranging, etc.), and it may also indicate the exact timing at which each UE is supposed to send a signal and in which order.

Note that any embodiment that describes a device UE 10 discovering and/or performing a ranging session with an anchor device UE 14 can be equivalently replaced with two device UEs 10 discovering and/or performing a ranging session with each other.

### Section: Switch to Local Location/Ranging Service Proxy

According to some embodiment, the device UE 10 can determine (when and how) to obtain its location coordinates from a location service or from a ranging service based on ranging measurements, wherein one or more UEs in the ranging constellation 50 can act as a proxy for the location service and/or ranging service e.g. in a given geographical area e.g. by supporting similar protocols (e.g. LPP or NRPPa) and (a subset of the) functions provided by a location service or ranging service (e.g. determine a distance/angle/position based on location/ranging measurements, providing a location/coordinate in a reference coordinate system based on a set of distances and/or angles and/or other relevant location information). A UE that acts as a proxy for the location service and/or ranging service may be called a SL Positioning Server UE. The device UE 10 may automatically turn off its use of location services provided by the core network/access device (e.g. terminate its connection to an LMF 34) if it discovers that the ranging constellation 50 of ranging capable anchor UEs 14 offers location coordinates, operates a location/ranging service, and/or acts as a proxy for the location/ranging service in the vicinity, and/or if it determines a poor signal coverage of access devices in a given geographical area (which would prevent proper/efficient own use of location services), and/or if it enters a certain tracking area or gets in vicinity of a particular access device, and/or if it meets a set of conditions defined by a preconfigured policy (e.g. if it can discover a certain minimum number of anchor UEs), and/or may turn off its use of location services provided by the core network/access device if it receives an explicit signal from an anchor UE, location/ranging service or managing entity.

FIG. 8 shows an example conceptual architecture according to various embodiments, whereby one or more Anchor UEs may act as a proxy for a location/ranging service by support a subset of LMF functionality 710 (e.g. the ability to collect ranging/location measurements, calculate a position of a device UE 10 or Anchor UE 14, or share the position with other entities (incl. device UE 10 or Anchor UE 14)). The Anchor UE may announce/provide information about such ability to act as a proxy for a location/ranging service over sidelink/PC5 (e.g. during discovery) 701 to a Device UE 10. Also a Device UE 10 may specifically provide a request/filter in it's discovery request messages over 701 to only discover Anchor UEs that are able to act as a proxy for a location/ranging service. If multiple Anchor UEs work together, e.g. as part of a constellation, not all Anchor UEs need to support such subset of LMF functionality. The other Anchor UEs may provide their measurement reports (e.g. ranging/position measurements) or distance/angle measurements over sidelink/PC5 702 (e.g. over a direct connection) to the Anchor UE that supports a subset of LMF functionality 710. Similarly, the Device UE 10 may need to provide its measurement reports (e.g. ranging/position measurements) or distance/angle measurements to the Anchor UE that supports the subset of LMF functionality. That Anchor UE may then calculate a position of the Device UE 10 and provide it to Device UE 10 over 701. In this manner, the position of the Device UE 10 can be determined even when one or more Anchor UEs are out of coverage of an access device 20. In FIG. 8 the coverage area of access device 20 is depicted as 720. An Anchor UE that is in coverage 720 of the access device 20 may still offer a local proxy using the subset of LMF functionality 710, but may also switch off (part of) its local proxy functionality and interact with the LMF in the core network instead whereby it may forward messages/information from the out-of-coverage device UE 10 or Anchor UE(s) 14 to the LMF in the core network, and vice versa. To this end it may implement a (subset of) ProSe relay functions and/or provide a gateway function for repackaging or translating incoming LPP messages coming from the AMF or coming over TCP/IP from a managing entity onto PC5/Sidelink messages (e.g. PC5-Signalling messages with LPP payload) and vice-versa. By acting as a gateway or ProSe Relay, the Anchor UE may also provide indirect communication between the other core network functions, such as the Authentication Server Function (AUSF) or ProSe Key Management Function to enable the Device UE 10 exchange authentication and authorization information with the core network to verify if the Device UE 10 and/or Anchor UE 14 are authorized to be involved in ranging of Device UE 10, or for example to forward a Mobile Originated Location Request (MO-LR) (which may include a request and/or information related to ranging such as a discovered Anchor UE or information about a ranging constellation) from Device UE 10 to the AMF/GMLC/LMF or to forward a Mobile Terminated Location Request (MT-LR) (which may include a request and/or information related to ranging such as a information about a ranging constellation or ranging configuration information) from the AMF/GMLC/LMF to Device UE 10.

According to some embodiments, the device UE 10 can be self-configured or be configured by the managing entity to use ranging services within a given geographical area (e.g., inside a building) and to use location services outside the given geographical area (e.g., outside the building). The ranging measurements may be sent to the RMF 36 and/or the LMF 34 and/or another location/ranging service, or proxy thereof to translate the ranging measurements into geographical or relative location coordinates. The measurements may be sent by the device UE 10 and/or by an anchor UE 14 of the particular ranging constellation 50 and/or by a head anchor UE of the ranging constellation 50. The ranging measurements between the device UE 10 and multiple anchor UEs 14 in the vicinity may be sent separately or may be combined in a single report forwarded to the RMF 36 and/or the LMF 34 or another location and/or the ranging service, or proxy thereof. To this end, the UEs involved may send their measurements and/or estimated distances/angles between itself and one or more other UEs of the ranging constellation to the head anchor UE. If one or more anchor UEs are out of coverage, another (head) anchor UE that is in coverage may also act as a proxy for the RMF, LMF or other location service or ranging service. In this case, the in-coverage UE may send the measurements or the report. When the entire constellation including the head anchor UE is out of coverage, then the head anchor UE may act as a proxy for certain functions (e.g., a subset of functions) of the RMF and/or LMF or other location service and/or ranging service. These functions may include translation of distance and/or time and/or angle measurements to location coordinates, calibration of ranging measurements, temporary storage of measurements until a communication link with an access device is restored, etc.

According to some embodiments, the device UE 10 may be configured with a list of approved constellation identifiers and/or anchor UEs 14 it can select for ranging and/or connect to in order to initiate ranging, and possibly credential information to allow secure communication setup with the devices of the constellation respectively the anchor UEs 14. This list may be prioritized. Alternatively or additionally, the device UE 10 may be configured with policies that specify a minimum number of anchor UEs 14 and/or requirements on the capabilities and/or characteristics of the anchor UEs 14 (such as their (relative) movement being below/within certain threshold values, minimum/maximum distance from device UE 10, signal strength thresholds, geographical area information, tracking area information, PLMN information) within a constellation and/or that can be discovered in the vicinity of device UE 10, to determine whether or not the device UE 10 should switch on ranging or initiate a ranging session or to determine which constellation/set of anchor UEs to select/connect to for ranging. The device UE 10 may also use its estimated position based on other means (e.g., GPS, Wi-Fi, or dead reckoning based trajectory interpolation based on e.g. built-in accelerometer) to determine if ranging services should be used.

Once the device UE 10 has determined to use ranging services, it may switch on discovery of other ranging capable UEs in its vicinity and/or may connect (directly via Uu or via a relay device) to a ranging service or location service provided by the network (e.g. provided or managed by LMF 34 or RMF 36) which may further instruct/configure the device UE 10. Alternatively, discovery of other ranging capable UEs is always switched on, and the determination to use ranging can be based on discovered information from the other ranging capable UEs (e.g., whether or not the discovered UEs are anchor UEs or based on (discovered/configured) information about one or more ranging constellations within the area, e.g., based on a constellation identity discovered via one of the ranging capable UEs, or discovering the presence of one or more UEs that constitute a ranging/positioning constellation).

The UE 10 may still use other existing positioning services.

Similarly, the anchor UEs 14 may be configured by the managing entity or may configure themselves to switch on ranging/ranging services (e.g., start transmitting and/or receiving discovery messages and/or initiate a ranging session) upon entering a geographical area or upon a device UE 10 entering the area. Note that each time a device UE 10 or anchor UE 14 enters a new area or comes in vicinity of a new ranging constellation, it may need to request or may have to receive a new/fresh authorization and/or obtain a new/fresh set of credentials from the core network/access device/RMF/LMF/(head) anchor UE through a Uu direct connection or PC5 direct/indirect connection before or upon establishing a new ranging session or joining the new ranging constellation.

According to some other/independent embodiments, the device UE 10, upon temporarily disconnecting from the LMF 34 or other location service offered by the core network, e.g., when out of range, can automatically turn on the ranging services and search for nearby ranging-capable anchor UEs 14 and/or a constellation (e.g., ranging constellation 50). To this end, the device UE 10 may be configured with a policy determining the conditions to do so, e.g. minimum/maximum signal strength (e.g., RSRP) or other signal quality parameters (e.g., RSRQ, number of failed connection attempts) for signals received from nearby access devices, below/above which to switch on or switch off its usage of ranging and/or positioning service.

According to some embodiments, the device UE 10 may not be aware of the coverage situation of one or more of the anchor devices 14, or the coverage situation has changed or is changing at the moment a ranging operation has just been initiated or is ongoing, or it is allowed that in in-coverage and partial coverage situations not only centralized location (e.g. using LMF/RMF of the core network via direct Uu connection or via a UE-to-NW relay operated e.g. by an anchor UE) but also out-of-coverage ranging operation (e.g. using a local proxy of the LMF, using decentralized localization) may be performed. In those cases, the device UE 10 may perform an operational mode that is not the expected or desired mode by the anchor devices 14 or the core network, or may be different from the operating mode selected by the anchor devices 14. Therefore, a device UE 10 may include a flag in a message to one or more anchor devices 14 (e.g. a Direct Communication Request message) indicating the solution choice that it has made (e.g. out-of-coverage solution). Upon reception of this message, the one or more anchor devices 14 may need to (based on a policy received when in-coverage) check whether the connectivity environment is out-of-coverage (e.g. the one or more anchor devices 14 indeed being out-of-coverage) and the out-of-coverage solution is applicable or whether e.g. a partial coverage solution is applicable (if one or more of the anchor devices can connect to the Core Network/LMF). If the policy of the one or more anchor devices 14 determines that there is a solution mismatch, e.g. out-of-coverage solution is not allowed at this moment because one or more anchor devices 14 are in coverage, then the one or more anchor devices 14 may not respond to the message or may send a response message including an indication that the requested solution by device UE 10 is not allowed/accepted by the anchor devices 14. In principle, an Anchor UE may take one of the following alternative steps:
not send a message to the device UE 10 (e.g. ignore, or continue with the selected solution) or send a message that includes a field that indicates its coverage situation.
send a message to the device UE 10 to go on with the selected solution.
send a message to the device UE 10 that the selected solution is not feasible, whereby the message may include information about which different solution the device UE 10 should select.
send a message to the managing entity asking permission to proceed with the selected solution, after which it may inform device UE 10 about the decision.

Note that the selected solution (e.g. out-of-coverage, partial coverage, or in-coverage solution) typically also determines which authorization procedure to execute and/or which security parameters (e.g, passwords, cryptographic keys) are to be used, hence it is important that all UEs involved in the ranging/sidelink positioning operation agree on using the same solution. Hence, it is advantageous if the verification of the type of solution and parameters to use is performed before a key establishment and authentication phase. In particular, it is advantageous if the verification of the Source UE authorization (Step 4 in Solution #4 in TR 33.740) is performed before the Direct Authentication and Key Establishment Procedure (Step 3 in Solution #4 in TR 33.740). It is advantageous since in this case the risk of Denial of Service is reduced.

Note also that the solution indication in a request message sent by device UE 10 may not be an explicit flag, but may be implicit by transmitting one or more parameters that are specific to a particular solution, e.g. if it includes an authorization token to be used during out-of-coverage operation, it is clear to the anchor UE 14 that device UE 10 has selected an out-of-coverage solution.

Note further that the negotiation about the type of solution/protocol or parameters (in-coverage or out-of-coverage) to use may be negotiated or signaled or verified in the initial discovery phase.

### Section: Discovery and Requesting the Use of a Ranging Constellation

According to some embodiments, an anchor UE that offers a ranging service and/or location service (e.g., arranging based positioning service or proxy thereof) may offer a ProSe/V2X/D2D service to access such ranging and/or location service over sidelink, e.g. to be able to acquire/provide position information or to initiate ranging. Such ProSe service may be announced through sidelink discovery through a specific ProSe/V2X/D2D service identifier or application code, after which other UEs may set up a connection over sidelink to such service and use such service. The LMF 34, RMF 36 or other ranging service and/or location service or other managing entity may provide credentials that allow and/or that can be used for protecting the discovery and/or message exchange between the ranging capable device UE 10 and the anchor UE(s) 40.

In further embodiments, the device UE 10 may be configured to obtain or request its location coordinates based on ranging measurements from one or more of the anchor UEs 14 of the ranging constellation 50. An anchor UE 14 may advertise ranging reference signals (which may be detected by a device UE 10 in vicinity, e.g., based on their frequency, timing, signal characteristics/type, waveform, bandwidth, configured resources), or advertise ranging-based positioning (combining ranging and location service functionality) as a proximity service or advertise support for ranging/location services and/or other ranging/position capabilities and/or provide information about its (last known) location, or transmit discovery messages in a configurable time interval known to a ranging service and/or configured on the UEs involved (e.g., by a managing entity) for the particular ranging constellation 50 with which the anchor UE 14 is affiliated. Thereby, the device UE 10 may identify and may check the integrity of the advertisement/discovery messages, may determine the arrival time of the advertisement/discovery message, and may extract, e.g., timing information (e.g. time of transmission of the advertisement/discovery message included in the message, processing time of a message for which this message is a response (e.g. t3−t2 in case of FTM), time between reception of a message for which this message is a response, clock synchronization information) from the messages to calculate the distance between the device UE 10 and one or more of the anchor UE(s) 14 of the ranging constellation. Furthermore, the device UE 10 may calculate a confined area which approximates its location coordinates, based on e.g. one or more distance(s) obtained from round-trip-time measurement(s) and/or time-of-flight estimation(s) between the device UE 10 and the one or more anchor UE(s) 14. Moreover, the device UE 10 may receive a list of authorized anchor UEs 14 in its vicinity via the RMF 36 or LMF 34 or managing entity and, upon approaching an authorized anchor UE 14 within its ranging distance, e.g. after it discovers such authorized anchor UE, connects to it and/or requests the use of a ranging/location service or service proxy offered by such anchor UE, the device UE 10 may obtain location coordinates (e.g., calculated coordinates of device UE 10, location coordinates of the anchor UE 14 and/or the location coordinates of one or more access devices or Position Reference Units) and/or an estimated relative position/distance/angle between one or more devices of the constellation from the anchor UE 14 without using RMF 36 or LMF 34 or any other location service of the core network 30 (e.g., network controller device). In this case, the anchor UE 14 might measure the distance and/or angle between itself and the device UE 10 using the ranging procedure/service and translate the distance into location coordinates based on its current location coordinates, locally on the device. Alternatively, the device UE 10 may measure the distance and/or angle using the ranging procedure/service and forward it to the anchor UE 14 to request for translating the measured distance into geographical coordinates.

According to some embodiments, the anchor UE 14 may provide its geographical coordinates to device UE 10, which the device UE 10 can use after measuring the distance and/or angle between itself and the anchor UE 14. Transmitting the geographical coordinates of anchor UE 14 should be done in a secure manner in terms of integrity and/or confidentiality, hence the anchor UE may only provide its coordinates after a secure communication channel between device UE 10 and anchor UE 14 has been established and/or sends the geographical coordinates protected by a key that only allows device UE 10 or a set of authorized devices UE 10 to decrypt this information and/or that allows device UE 10 or a set of authorized devices UE 10 to verify the integrity (by means of a message integrity code or a digital signature) of the information.

According to some embodiments, instead of transmitting information about the location (e.g. geographical coordinates) of an anchor UE 14 to device UE 10 or to another anchor UE, the anchor UE 14 may transmit an identifier (e.g., a location identifier, which may e.g. be preconfigured/allocated by a location service/database to the anchor UE or self-allocated) to the device UE 10 or the other anchor UE (e.g., in a discovery message, connection setup message, PC5 signaling message, or user plane message (e.g. message over IP layer)), possibly together with an identifier or address of a location service/database, which can be used by the device UE 10 or the other anchor UE that receives this identifier to retrieve the location coordinates of the anchor UE through a secure connection with a location service/database (e.g., as identified by the optionally provided location/database identifier or address, or a default location service/database known to the UE or the Core Network to which the UE connects). To enable this, the anchor UE (e.g. as configured/authorized by its user or a managing entity) or the anchor UE on behalf of the managing entity or the managing entity on behalf of the anchor UE may grant permission to retrieve the location of the anchor UE by doing one (or more) of the following:
by providing authorization credentials (e.g., an authorization token) to the device UE 10 or the other anchor UE that can be used to authenticate/verify the authorization (i.e., provided by the connected anchor UE 14) is authentic, e.g. by performing an authentication procedure with the respective anchor UE 14, or by verifying if the credentials match or can be securely correlated to previously stored credentials of anchor UE 14 in device UE 10, the other anchor UE or the LMF 34, RMF 36 or other location and/or ranging service or a proxy thereof or other managing entity, or a core network function (e.g., UDM/AUSF) that device UE 10 or the other anchor UE can connect to. The anchor UE may register the given consent to a particular device UE 10 or the other anchor UE or provide a copy of the authorization credentials (e.g. authorization token) given to device UE 10 or the other anchor UE to the LMF 34, RMF 36 or other location and/or ranging service or a proxy thereof or other managing entity, or other core network function (e.g., UDM/AUSF). The device UE 10 or the other anchor UE can include the provided authorization credentials/token in a message request to the LMF 34, RMF 36 or other location and/or ranging service or a proxy thereof or other managing entity or anchor UE 14, after which the receiving entity may verify the authorization credentials/token to be genuine, and if so provide the location of the anchor UE 14 to device UE 10 or the other anchor UE.
by providing authorization message/credentials to the respective LMF 34, RMF 36 or other location service or ranging service or proxy thereof, or other managing entity, or location database, whereby the message/credentials can be verified to originate from the respective anchor UE (e.g., performing an authentication procedure with the respective anchor UE 14), or by verifying if the credentials match or can be securely correlated to previously stored/credentials of the anchor UE 14 in the LMF 34, RMF 36 or other location and/or ranging service or proxy thereof, or other managing entity, or a core network function (e.g., UDM/AUSF). Such authorization message may include some fields/payload containing information about the given consent, e.g. the validity period, to which UEs (e.g. set of identities) the consent is given, information about credentials or token that would have to be provided by a given UE before it can be given the anchor UE's location). The authorization message may be sent by the Anchor UE 10 upon registration to the network, or upon receiving a ranging request (e.g. a device UE 10 connecting to the anchor UE 14 and requesting use of the ranging service), or e.g. first time it connects to the LMF 34, RMF 36 or other location and/or ranging service or proxy thereof, or other managing entity, or may be sent in response to the LMF 34, RMF 36 or other location service or ranging service or proxy thereof, or other managing entity, that has sent a message requesting permission to the anchor UE to share its location with device UE 10. In case group/domain credentials or authorization tokens or a closed access group or NPN or (private) network slice are/is associated with a ranging constellation that are used to protect the communication between UEs of arranging constellation and/or to restrict the communication only between UEs belonging to that group/domain/closed access group/NPN/slice, the anchor UE may only need to provide consent once for all UEs of a ranging constellation (e.g. by including the ranging constellation id and/or group/domain credentials and/or closed access group or NPN or (private) network slice information with which the consent will be associated in a message that the anchor UE sends to the LMF 34, RMF 36 or other location and/or ranging service or proxy thereof, or other managing entity). For example, this may be done during a message exchange when the Anchor UE joins the ranging constellation. The consent may also be provided by an application that manages (through the NEF) the ranging constellation and/or the UEs involved, e.g. by providing this implicitly or explicitly in the ranging constellation configuration information that it may send to the LMF or other managing entity. The consent may also be stored in the UDM or GMLC (typically in the home network of the Target UE), which may be verified e.g. by the AMF or other core network function.
by granting permission for this by providing consent in its subscription (e.g., UDM), or through providing consent through the Network Exposure Function (NEF) (e.g. by an application that manages the respective anchor UE). Note that the consent provided in the subscription or provided through the NEF may be configured per ranging constellation or per group/domain/closed access group/NPN/(private) network slice that may be associated with a ranging constellation.

According to some embodiments, the device UE 10 may calculate its location coordinates based on ranging reference signals obtained from one or more anchor UEs 14 via a sidelink channel (e.g., through sidelink discovery messages or other signals transmitted using sidelink resources), and position information of the one or more anchor UEs 14. To this end, the device UE 10 and the one or more anchor UEs 14 may exchange messages to initiate a ranging session. One or more of these messages may include a ranging session ID (which may be used by all UEs involved in joining the ranging session) and/or may include a ranging constellation identity and/or may include ranging reference signals. The ranging reference signals may include (encoded) information about the type of reference signal, identity information of a UE, ranging session ID, ranging constellation identity, identity information of the constellation, credential information, nonces, timing information, and/or distance/angle/position information.

According to some embodiments, if a device UE 10 wants to initiate ranging with two or more anchor UEs it may indicate the number of anchor UEs and/or a set of anchor UE identifiers and/or a constellation identifier as part of the messages to initiate a ranging session (e.g. a Direct Communication Request with a field indicating a request for ranging service (using e.g. an application or service identifier defined for this)). These messages may be sent as multicast/broadcast messages to all anchor UEs involved upon which the anchor UEs initiate ranging with device UE 10, and/or send device UE 10 the respective configuration parameters for ranging, or may be sent via unicast message to one of the anchor UEs (e.g., the head anchor UE), upon which the anchor UE that receives this unicast message will send respective messages to other anchor UEs within the constellation or in vicinity to invite them become part of the ranging session and/or to initiate ranging with device UE 10, and/or to send them the respective configuration parameters for ranging.

According to some embodiments, the location coordinates of the anchor UEs 14 may be exchanged with the device UE 10 via the sidelink channel and the calculation of the position may be done after the device UE 10 has (simultaneously) achieved a clock time synchronization with those anchor UEs 14 and/or after being connected to one or more anchor UEs 14. By using Time Difference of Arrival, Round Trip Time and/or Time of Flight measurements based on the ranging reference signals, the distances between the device UE 10 and the one or more anchor UEs 14 can be calculated and may be exchanged between the device UE 10 and the one or more anchor UEs 14 (e.g. over the established connection between device UE 10 and the one or more anchor UEs 14). Also, the angle may be determined if the device UE 10 or anchor UE 14 has multiple antennas. Assuming the device UE 10 and the one or more anchor UEs 14 are in the same horizontal plane (i.e., are at similar altitude) and that the distance and/or angle between the anchor UEs 14 is known or can be calculated (e.g., based on the geographical coordinates of the anchor UEs 14 and/or distance/angle measurements performed between two or more anchor UEs 14, the results of which may be shared with the device UE 10 and/or a ranging/location service), the position of the device UE 10 can be estimated based on trilateration and/or triangulation by using the distance measurements between the device UE 10 and at least two anchor UEs 14 (and the information about the known or calculated distance and/or angle between the anchor UEs, and/or the location coordinates of anchor UEs 14) or the distance and angle measurement between the device UE 10 and at least one anchor UE 14 (and the information about known or calculated distance and/or angle between the anchor UEs, and/or the location coordinates of anchor UEs 14).

In order to deal with possible altitude differences between UEs in the ranging constellation, the device UE 10 may require a distance and/or angle measurement with an additional anchor UE as additional reference.

### Section: Centralized Localization

According to various embodiment related to centralized localization based on ranging measurements with the anchor UE nodes 14, the device UE 10 may approach an anchor UE 14 of the ranging constellation 50 to perform a ranging measurement. Upon receiving a ranging request from the device UE 10, the anchor UE 14 may notify the device UE 10 about the ranging constellation 50 via the LMF 34, RMF 36 or other location or ranging service or via another communication channel. The device UE 10 can store the constellation information and as long as it is in the vicinity of the ranging constellation 50, it can decide if it wants to receive location coordinates from one or more of the anchor UEs 14 or other UEs part of ranging constellation 50 (which may offer ranging services and/or can function as a proxy for a location service) based on the ranging measurements. The device UE 10 and the other device UEs 10 and anchor UEs 14 may be part of a positioning constellation 60, whereby a location service may (centrally) determine the location of device UE 10. The device UE 10 may connect to the LMF 34, RMF 36 or other location or ranging service offered by the network and/or receive information from the LMF 34, RMF 36 or other location or ranging service either directly through Uu interface or via a relay connection between the device UE 10, another UE and an access device 20 providing access to the LMF 34, RMF 36 or other location or ranging service (e.g., through a secure connection or e.g. exposed via a discovery message of the relay device). An anchor UE 14 or a ranging capable device UE 10 may act as such relay device (e.g., using ProSe relay services) for other UEs, e.g., other UEs as part of the positioning constellation. The UEs that are part of the ranging or positioning constellation may be configured with a specific identity and parameters, e.g., a Relay Service Code (RSC) and/or discovery credentials that allows other UEs that are part of the constellation and/or that are in the vicinity and/or that are capable of ranging and/or location services to access the LMF 34, RMF 36 or other location service and/or ranging service via a ProSe relay connection based on that specific Relay Service Code. The LMF 34, RMF 36 or other ranging service and/or location service or other managing entity may provide credentials that allow and/or that can be used for protecting the discovery and/or message exchange between the ranging capable device UE 10 acting as a remote UE, the respective UE acting as relay device and the ranging/location service.

When the device UE 10 needs to obtain its location (e.g., geographical) coordinates, it can initiate a ranging request via a ranging service with any anchor UE 14 of the ranging constellation 50 and indicate its need for location coordinates. Upon receiving the request for location coordinates, (at least) one anchor UE 14 of the ranging constellation 50 may perform a ranging measurement and share its ranging measurements, e.g., with the RMF 36 and/or the LMF 34, to obtain the geographical coordinates of the device UE 10 based on the ranging measurements between the device UE 10 and the anchor UE 14 of the ranging constellation 50. If more than one anchor UE 14 perform ranging measurements, then the ranging measurements may be combined in a single report (e.g. by the head anchor UE collecting the ranging measurements from the various anchor UEs and transmitting the combined ranging measurements to the LMF 34 or RMF 36). Note that the device UE 10 may create such a report since it may perform ranging with each and every anchor UE 14, if these anchor UEs 14 are explicitly involved in the ranging of device UE 10 (e.g. by participating in the same ranging session). The report may be sent directly to, e.g., the RMF 36 and/or the LMF 34, or indirectly via the (head) anchor UE 14. As mentioned earlier, anchor UEs may also be implicitly involved without the device UE 10 being aware of this or without having joined the same ranging session, e.g. by receiving information (e.g. reference signal characteristics/type, timing or resource information) from the LMF or other managing entity that allows the Anchor UEs to monitor ranging reference signals being transmitted by device UE 10.

It is noted that the LMF 34 and/or RMF 36 may request the anchor UE 14 to provide, if known, its own known location coordinate information and/or the antenna orientation information to the LMF 34 and/or RMF 36. The antenna orientation information may then be used by the LMF 34 and/or RMF 36 to improve ranging methods for e.g. customized beamforming to improve an angle-of-arrival calculation between the anchor UE 14 and the device UE 10 for the given antenna orientation. Additionally, the LMF 34 and/or RMF 36 may request a 5GS infrastructure to assess the location and orientation of anchor UEs 14. This may require the anchor UEs 14 to, e.g., measure PRS signals (transmitted by one or more access devices 20) and send these measurements to the LMF 34 and/or RMF 36 for location estimation. These measurements can also be used to determine the orientation of the anchor UE. For instance, if the anchor UE 14 returns its beamforming settings (e.g., transmission power, direction) when performing measurements of e.g. reference signal time difference (RSTD) and/or reference signal received power (RSRP) with one or more different wireless access devices 20 (e.g., gNBs), the 5GS infrastructure may determine the orientation of the anchor UE 14. In this case, the wireless access devices 20 (e.g., gNBs) may carry out a beam sweeping during the initial access or the broadcast of the SSBs or beam determination in idle mode (e.g., as described in section 6.1.6.1 of 3GPP TS 38.802 “Study on New Radio Access Technology”, V14.2.0). This allows the gNBs to determine the location of the anchor UE 14. Similarly, the anchor UE 14 might transmit, e.g., a synchronization signal (SS), in multiple directions. The wireless access devices might measure the received power of different synchronization signals and combine the measurements to compute the orientation of the anchor UE 14 depending on the signal/response received by the wireless access devices 20 (e.g., gNBs) from the anchor UE 14 in different beam directions.

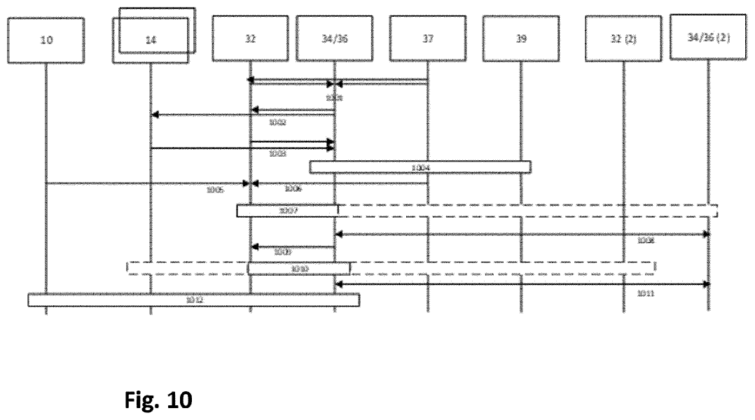

According to other embodiments related to centralized localization, as illustrated in FIG. 10, the LMF 34 (or RMF 36 or other managing entity) may be instructed/configured (e.g. by the GMLC 37 via the AMF 32 or by the AMF 32 directly) to monitor the location of a set of anchor UEs (e.g. for a given set of anchor UEs 14 in a ranging constellation 50 or for anchor UEs in a certain area (e.g. based on area information such as (a set of) tracking areas, (a set of) gNB/cell identifiers, (a set of coordinates) associated with a ranging constellation 50)) for a period of time, based on a Periodic Mobile Terminated Location Request (MT-LR) 1001, e.g. issued by the GMLC 37, for the respective set of anchor UEs. The LMF will 1002 configure the set of Anchor UEs and/or AMF (and/or NG-RAN (not shown)) to 1003 regularly provide the LMF with updated location information and/or perform measurements and send ranging/location measurements to the LMF to enable the LMF to determine a fresh location of the anchor UEs. The LMF may 1004 store the up to date location of all these anchor UEs in its own storage or requests another core network function (e.g. GMLC 37 or Unified Data Repository (UDR) 39) to store the location information of these UEs. The location information of the anchor UE may be further updated every time the anchor UE issues a Mobile Originated Location Request (MO-LR) to the network, upon which the LMF will retrieve or determine the location of the anchor UE and store the updated location information in the respective storage.

In order to determine the position of a target UE 10 using ranging/sidelink positioning, the target UE may 1005 issue a MO-LR to the network (e.g. via Uu connection if the Target UE is in coverage or indirectly (e.g. via ProSe UE-to-Network relay or gateway functionality e.g. offered by an anchor UE, or by the anchor UE itself reporting a MO-LR on behalf of the target UE (e.g. after PC5 discovery or PC5 connection setup)), or the GMLC 37 (or other LCS client) may 1006 issue a MT-LR to the network. These Location Requests are typically sent to the AMF 32, which will then 1007 select an LMF 34 (or RMF 36 or other managing entity) to handle this request. In case of ranging, it is important that the LMF selected to handle the location request for a target UE is the same LMF that is selected to handle the location requests and/or location determination for the anchor UEs (e.g. of the ranging constellation 50) with which the target UE will perform ranging. Otherwise, this poses issues for ranging and/or sidelink positioning procedures, since ranging measurements/results may end up in different LMFs if the Target UE and an Anchor UE would be served by different LMFs. Also the ranging configuration and resource allocation (e.g. the timing when to send which ranging reference signal and in which frequency) may not be aligned. To enable this, the AMF 32 may select an LMF that serves a particular area which overlaps/corresponds to area information that it may have received (e.g. from the NG-RAN or the Target UE itself, e.g. as part of the location request or registration request or a separate message) related a Target UE, such as Tracking Area Identifier (TAI) or gNB/Cell-Id, since the Target UE and the anchor UEs will communicate over PC5/sidelink and hence, the anchor UEs and Target UE are likely to reside in the same area served by the LMF. The AMF may retrieve information about the area that the LMF serves (e.g. set of Tracking Areas, set of gNB/Cell-ids, set of coordinates to denote the area that it covers) from the LMF itself, or e.g. from GMLC 37, UDR 39 in which this information may be stored). Alternatively, the AMF 32 may select an LMF that serves a majority of other UEs in the area that overlaps/corresponds to area information that it may receive (e.g. from the NG-RAN or the Target UE itself) related a Target UE, such as Tracking Area Identifier (TAI) or gNB/Cell-Id, to increase the chance that it selects the same LMF. In case the AMF has information about both the Target UE as well as one or more anchor UEs that will be involved in ranging/sidelink positioning with the Target UE (e.g. based on discovery information from the Target UE about which Anchor UE(s) it has discovered via PC5/sidelink, that the Target UE may have provided to the AMF (e.g. as part of a MO-LR or in a separate message) or e.g. by an Anchor UE providing discovery information or connection setup information related to the Target UE to the AMF, or e.g. by an Anchor UE having information about a ranging constellation 50, or e.g. by receiving a Location Request including not only information about the Target UE, but also information e.g. identities of one or more anchor UEs to be used for ranging/sidelink positioning of the Target UE, or e.g. by receiving information e.g. from NG-RAN or Target UE or Anchor UE that an Anchor UE is used for relaying a message from the Target UE (e.g. by acting as a ProSe UE-to-Network relay or gateway, for example when the Target UE is out-of-coverage)), the AMF may check if it already serves one or more of the anchor UEs, and if so use information about the LMF that serves or has been selected for the one or more of the anchor UEs to select the same LMF for the Target UE. If the AMF does not currently serve one or more of these anchor UEs, it may request the UDM (not shown) to provide information about which AMF is the serving AMF of the UE not served by the current AMF. The current AMF 32 can ask the serving AMF 32 (2) of that UE which LMF it has selected for that UE, and then select the same LMF. Alternatively, the GMLC or UDR may store information about serving LMF per UE. The AMF (or LMF) may retrieve this information from the GMLC or UDR, or request the GMLC or UDR to provide this information, when a Target UE or Anchor UE registers to it and/or issues a location request, so that the AMF can select the same LMF (or for the LMF to provide or request the UE context of one or more anchor UEs to/from the serving LMF).

In the case that the AMF(s) did select a different LMF for one or more anchor UEs than for the Target UE, then if an LMF discovers that it does not have UE context information of both Target UE and the one or more anchor UEs that need to be involved (e.g. based on the ranging constellation information), then the LMF 34 may 1008 request other LMFs 34 (2) if they have UE context information of the one or more UEs for which the UE context information is “missing” (e.g. using the NL7 reference point (as specified in TS 23.273 and which may need to be extended for this purpose), and if so request them to perform a UE context transfer of the “missing” UE context information to this LMF (or vice versa), for example using steps 5-10 of the LMF Change Procedure in clause 6.4 of TS 23.273. If none of the LMFs have UE context information available for the “missing” UE, then the LMF may issue a request 1009 to the AMF to assign the “missing” UE to the same LMF. If the AMF does not yet serve the “missing UE”, it may 1010 verify (e.g. by requesting the UDM) if another AMF is serving that UE, and if not, issue a network triggered service request to that UE. Otherwise, it may align with the serving AMF of that “missing” UE to select the same LMF. Additionally or alternatively, the different LMFs selected for two or more UEs involved in ranging may 1011 coordinate with each other before or during the ranging procedures, e.g. by exchanging ranging configuration parameters, synchronize their clocks, exchanging schedule/resource information, exchanging security credentials, etc. This may be done by extending the NL7 reference point. The LMFs may even be located in different core networks, e.g. to enable an Inter-PLMN ranging, whereby two or more UEs performing ranging may be served by different core networks, and hence are served by different AMF and LMF. The AMF, LMF or other core network function may determine that such situation occurs based on the identity (e.g. SUCI, User Info ID, PRUK ID) of an anchor UE or target UE discovered over PC5/sidelink, or PLMN ID, NID, CAG or NCGI information that may have been provided during discovery over PC5/sidelink or during/after PC5 connection setup, that may have been provided by the Target UE or Anchor UE to its AMF, LMF or other core network function. To this end, an LMF may set up connection to an LMF in another core network, e.g. via a Service Based Interface if the two networks are in close cooperation, or e.g. via a tunneled, relayed or proxied connection via its GMLC communicating with the GMLC of the other core network, or setting up such connection via the NEF of the other core network). In case of roaming of a target UE or anchor UE, the respective UE is typically served by the AMF and LMF of the serving (i.e. visiting) network, and hence the AMF can select the same LMF in the same manner as mentioned earlier.

Once the same LMF is selected for the target UE and the anchor UEs to be involved, or the LMFs have coordinated their configuration, the LMF(s) can then 1012 configure the Target UE and the Anchor UEs to enable ranging to be performed between the Target UE and one or more Anchor UEs (and possibly also between the Anchor UEs themselves). The configuration information may include a session or ranging constellation identifier e.g. to initiate a joint ranging session or for reporting the respective ranging measurements or ranging results to the LMF, but the ranging may also be performed “session-less”, in which case the timing of the measurements or signal characteristics or frequency being used may be sufficient information for the Target UE or Anchor UE to determine to which ranging procedure or for which other UE the measurement applies. To this end, the configuration information provided to the respective Target UE or Anchor UE may include an identifier of a target UE or other Anchor UE, or an identifier related to a ranging reference signal configuration or configuration item therein (e.g. a particular resource schedule), as described in other embodiments.

Note that in case a ranging constellation is associated with a set of group/domain credentials or authorization tokens, the Target UE and/or the Anchor UEs of the ranging constellation may need to provide a proof of possession of the group/domain credentials or authorization token (e.g. by transmitting a correct response to an authentication/authorization request, or transmitting a correctly signed token/message)) upon registration of the Target UE and/or Anchor UEs to the core network (typically with the AMF), preferably before the AMF selects the LMF, for example to do this as part of the primary authentication procedure or as a separate procedure with the AMF and/or AUSF/UDM. If the AMF does not have this information, the AMF may request the LMF or GMLC or UDR or UDM that may have stored this information as part of the ranging constellation information to provide this information, or alternatively the LMF may perform such request or ask the AMF or AUSF/UDM to perform such check. Similarly, if the ranging constellation information includes information on Closed Access Group identifier indicating a Closed Access Group (e.g. operated by a Non-Public Network) or Non-Public Network identifier or (private) Network Slice identifier to which the Anchor UEs or Target UE need to subscribed with or have access to in order to (temporarily) join the ranging constellation (e.g. to take part in the ranging of a Target UE), then the AMF (e.g. upon the Target UE or Anchor UE registering to that AMF) needs to check that the Target UE or Anchor UE has access to that Closed Access Group, NPN or Network slice, preferably before it selects the LMF. Also, similarly, if the AMF does not have this information, the AMF may request the LMF or GMLC or UDR or UDM that may have stored this information as part of the ranging constellation information to provide this information, or alternatively the LMF may perform such request or ask the AMF or AUSF/UDM to perform such check. Alternatively or additionally, the AMF may provide the LMF with the necessary information (e.g. CAG ID, NPN ID, Network Slice ID for the respective UE) so that the LMF can perform this check. Similarly, if the ranging constellation information includes information about a set of target UEs that may be served by the ranging constellation and that hence may e.g. (temporarily) join the ranging constellation, e.g. indicated by a set of target UE identities and/or by a set of network identities (e.g. PLMN IDs) that indicate which home network that a Target UE needs to be subscribed with/belong to in order to be allowed to be served by that ranging constellation (i.e. whether the ranging using Anchor UEs of a ranging constellation can be performed for a visiting/roaming Target UE that is subscribed/belongs to a different PLMN than the serving network of one or more Anchor UEs of the ranging constellation), then the AMF (e.g. upon the Target UE registering to that AMF) needs to check that the Target UE identity is indeed in the list of target UE identities and/or that the network identity to which the Target UE belongs/is subscribed to (e.g. HPLMN ID) is in the list of indicated network identities, preferably before it selects an LMF for that UE. If the AMF does not have this information, the AMF may request the LMF or GMLC or UDR or UDM that may have stored this information about a set of target UE identities and/or set of network identities as part of the ranging constellation information to provide this information, or alternatively the LMF may perform such request or ask the AMF or AUSF/UDM to perform such check. Alternatively or additionally, the AMF may provide the LMF with the necessary information (e.g. identity, e.g. SUPI, and/or the home network identity (e.g. HPLMN ID) for the respective UE) so that the LMF can perform this check. Similarly, if the ranging constellation information may include a set of network identities (e.g. PLMN IDs) that indicate which home network that an Anchor UE needs to be subscribed with/belong to in order to be allowed to operate in a ranging constellation in a visiting network (i.e. if the Anchor UE is roaming/visiting a different network than its home network), then the AMF needs to check (e.g. upon the Anchor UE registering to that AMF) that the network identity to which the Anchor UE belongs/is subscribed to (e.g. HPLMN ID) is in the list of indicated network identities, preferably before it selects an LMF for that UE. If the AMF does not have this information, the AMF may request the LMF or GMLC or UDR or UDM that may have stored this information about a set of network identities as part of the ranging constellation information to provide this information, or alternatively the LMF may perform such request or ask the AMF or AUSF/UDM to perform such check. Alternatively or additionally, the AMF may provide the LMF with the necessary information (e.g. identity, e.g. SUPI, and/or the home network identity (e.g. HPLMN ID) for the respective UE) so that the LMF can perform this check.

### Section: Detailed Architecture and Procedures for Decentralized Localization

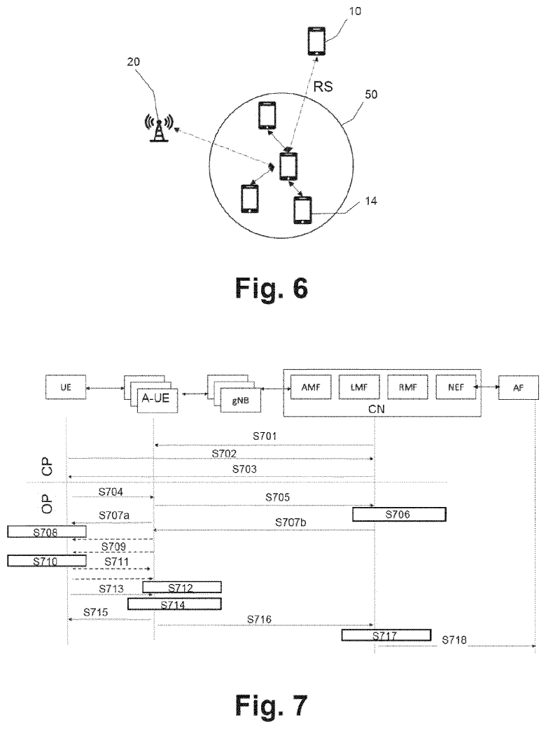

FIG. 6 schematically shows a network architecture where a mobile terminal (e.g., device UE) 10 approaches a ranging constellation 50 of mobile terminals (e.g., anchor UEs) 14 to get assisted by ranging services (RS) for location coordinates obtained from a location service (LS), according to various embodiments.

According to some embodiments related to decentralized localization based on ranging measurements with the anchor UEs 14, one of the anchor UEs 14 may receive a request for location (e.g. geographical) coordinates from the device UE 10 either directly or via another device UE close to the ranging constellation 50 and may acknowledge the request. The ranging measurements corresponding to device UE 10 and the ranging constellation 50, i.e. ranging measurements performed on the ranging reference signals between device UE 10 and one ore more anchor UEs of a ranging constellation, may be used by an anchor UE 14 to locally calculate the location coordinates of the device UE 10 (using any of the concepts described in the present disclosure) based on its own location information obtained from a location service or an additional location module provided on the anchor UE 14 and the ranging measurements with the device UE 10.

It is noted that the anchor UE 14 could also inform the device UE 10 about the local coordinate system used by the ranging constellation 50 and the expected level of accuracy for a given ranging measurement performed between the device UE 10 and the anchor UE 14. If the ranging constellation 50 supports multiple coordinate systems, then the anchor UE 14 may inform the device UE 10 about the different types of coordinate systems supported by the ranging constellation 50. The device UE 10 may select one of the supported coordinate systems or let the anchor UE 14 decide about a default coordinate system for the given device UE 10 depending on its device characteristics. Note that a local coordinate using such coordinate system can be translated to geographical coordinates either by an anchor UE 14 or other device UE 10 that can act as a proxy for the location service or by the location service of the wireless access device 20 or the LMF 34, RMF 36 or other location or ranging service offered/accessible by the core network upon request by the device UE 10. To this end, a ranging capable UE may transmit a message to a LMF 34, RMF 36 or other location and/or ranging service in the core network or offered by an access device or a proxy of the LMF 34, RMF 36 or other location and/or ranging service offered by another ranging capable UE (e.g. anchor UE 14) over a secure interface, the message containing a distance and/or angle measurement (e.g. based on ranging reference signal) and optionally including other information such as ID and/or timing information, or a distance and/or an angle calculation result (e.g. based on a ranging measurement), and optionally a location coordinate system to use, and optionally including altitude and/or velocity/accelerometer information, whereby upon receiving the message by the LMF 34, RMF 36 or other location/ranging service or location/ranging service proxy a response message is returned which includes the resulting calculated location coordinate using the indicated optional location coordinate system or a default (e.g. geographical) coordinate system.

In order to allow the LMF 34, RMF 36 or other location and/or ranging service or a proxy thereof to calculate the position or distance/angle the device UE 10 may grant permission by providing authorization credentials to the LMF 34, RMF 36 or other location and/or ranging service or a proxy thereof as part of the same message or subsequent message, that can be used to authenticate/verify the authorization is authentic (i.e., provided by device UE 10), e.g. by performing a respective authentication procedure with device UE 10, or by verifying if the credentials match or can be securely correlated to previously stored credentials of device UE 10 in the LMF 34, RMF 36 or other location and/or ranging service or a proxy thereof, or a core network function (e.g., UDM/AUSF), and/or by granting permission for this by providing consent in its subscription (e.g., by UDM), or through providing consent through the Network Exposure Function (NEF). The message that may be sent by device UE 10 to grant consent for this may include some fields/payload containing information about the given consent, e.g. the validity period, to which entities (e.g. location service proxy (provided by a particular UE for which the identity may be included)) the consent is given, information about credentials or token that would have to be provided by a given entity before it is allowed to be involved in calculating the position or distance/angle of device UE 10). In case group/domain credentials or authorization tokens or a closed access group or NPN or (private) network slice are/is associated with a ranging constellation that are used to protect the communication between UEs of a ranging constellation and/or to restrict the communication only between UEs belonging to that group/domain/closed access group/NPN/slice, the device UE 10 may only need to provide consent once for all UEs of a ranging constellation to be involved in the calculation of the position or distance/angle of device UE 10 (e.g. by including in a message the ranging constellation id and/or group/domain credentials and/or closed access group or NPN or (private) network slice information with which the consent will be associated that the device UE 10 sends to the LMF 34, RMF 36 or other location and/or ranging service or proxy thereof, or other managing entity). For example, this may be done during a message exchange when the Target UE joins the ranging constellation (e.g. when issuing a request for ranging or location estimation to the LMF or proxy thereof). The consent may also be stored in the UDM or GMLC (typically in the home network of the Target UE), which may be verified e.g. by the AMF or other core network function. The consent may also be provided by an application that manages (through the NEF) the ranging constellation and/or the UEs involved, e.g. by providing this implicitly or explicitly in the ranging constellation configuration information that it may send to the LMF or other managing entity.

Similarly, with a similar message that may include also position information or an identifier of a device or reference point, a ranging capable UE may request a location and/or ranging service (or a proxy thereof) to provide/calculate/return a distance and/or angle between the ranging capable UE and the indicated device or reference point, after which the LMF 34, RMF 36 or other location and/or ranging service (or a proxy thereof) will return the resulting calculated distance and/or angle.

According to some other embodiments related to decentralized localization based on ranging measurements with the anchor UEs 14, the ranging constellation 50 may be configured and deployed in an indoor environment or a known target area such that it can have its own local coordinate system relative to a reference geographical coordinate system. A device UE 10 approaching the ranging constellation 50 and authorized to use the ranging constellation 50 may request a location coordinate from an anchor UE 14 of the ranging constellation 50. Upon receiving the request, the anchor UE 14 itself or the head device of the ranging constellation 50 on its behalf may select at least one of the anchor UEs 14 (typically 2 or 3) of the ranging constellation 50 to perform ranging measurements with the device UE 10, such that the selected device(s) are within a required ranging distance of the device UE 10 and can perform ranging with the device UE 10 in order to calculate the position of device UE 10 according to the local coordinate system of the ranging constellation 50. The selected anchor UEs 14 of the ranging constellation 50 may initiate the ranging measurements with the device UE 10, e.g., in a synchronous or coordinated manner, to obtain ranging measurements. The ranging measurements may be used either by the head device of the ranging constellation 50 or by the ranging service in combination with the location service (or proxy thereof), to position the device UE 10 in a local coordinate system of the ranging constellation 50. The coordinated manner may be to perform sequenced ranging measurements in time to avoid all measurements initiated at the same time thereby causing mutual interference. It could also mean to perform the ranging measurements relatively closely together in time in order to get an accurate result for cases where the device UE 10 is moving.

It is noted that to protect the privacy of the ranging procedure, specific ranging parameters (e.g., constellation identifiers, anchor UE identifiers, information about the ranging reference signal used at a given instant of time by a first UE), and/or information embedded/added/multiplexed into a ranging reference signal (e.g. an identifier), and/or ranging measurements/results may only be communicated to a second UE once the second UE has been authorized to use the ranging reference signal of the first UE. To prevent tracking of a UE based on ranging reference signals and/or positioning messages broadcasted by the UE, an identity and/or resources (timing/frequency) of the ranging reference signals and/or positioning messages may be randomly allocated. For instance, instead of following a well-known or deterministic pattern (e.g., a periodic pattern of signals/messages transmitted at periodic/specific time/frequency), the signals/messages might follow a random looking pattern only known to authorized devices. Additionally, after each ranging session, the UEs may need to request or may have to receive a new/fresh authorization and/or obtain a new/fresh set of credentials from the core network/access device/RMF/LMF/(head) anchor UE through a Uu direct connection or PC5 direct/indirect connection, before or upon establishing a new ranging session.

In an example, a device UE 10 might approach an area and may be provided with ProSe discovery parameters (e.g. ProSe service/application identifier for a ranging/localization service or discovery keys for discovering an anchor UE and/or a ranging/localization service) if authorized for a ProSe-based ranging/localization service. Based on these ProSe discovery parameters, the device UE 10 can discover other ranging capable UEs (e.g., anchor UEs 14) that are in the area, which may use one of the ProSe discovery procedures. Once discovery is performed and using a PC5 secure connection, or directly in the discovery messages themselves (e.g., as part of a metadata field), the anchor UEs 14 may provide the ranging/localization services requested by the device UE 10 with specific parameters (e.g., a positioning signal ID or a timing/frequency of the positioning signal) required for ranging/positioning. It is noted that, as indicated in the initial section above, ranging can be performed in multiple ways. For instance, a device UE 10 may be equipped with beam forming capabilities, such that a ranging measurement can be directed to a certain anchor UE 14 and this “angular” information may be used for determining its position.

According to some embodiments related to decentralized localization based on ranging measurements with the anchor UEs 14, the device UE 10 may receive an updated list of anchor UEs 14 located in its vicinity, e.g., from the LMF 34 or the RMF 36 or other managing entity. Note that the LMF 34 and/or the RMF 36 or other managing entity may create and keep updating this list of anchor UEs 14 resulting in a constantly updated constellation of ranging capable UEs whose locations are known a priori to the LMF 34 and/or the RMF 36 or other managing entity. Optionally, to provide control for the network operator, the device UE 10 may be required to report the measurements (e.g. as performed on the ranging reference signals received from one or more anchor UEs) to the LMF 34 and/or the LMF 36 or other managing entity together with an indication of the position of the device UE 10.

It is noted that if a PC5 interface is required, then device UEs 10 and anchor UEs 14 need to discover each other. Thus, the LMF 34 or RMF 36 or other managing entity may need to interface with a network function in the 5G CN (e.g., the direct discovery name management function (DDNMF) or policy control function (PCF)) capable of authorizing the device UE 10 to discover anchor UEs 14 by means of (PC5) discovery messages.

The device UE 10 upon approaching and entering a ranging distance of one of the anchors UEs 14 of the ranging constellation 50, may be assisted to obtain its location coordinates through ranging measurements without actually being positioned by the network access devices 20 and/or the LMF 34.

According to some other embodiments related to decentralized localization based on ranging measurements with the anchor UEs 14, which can be used as an alternative to or in combination with the above corresponding embodiments, an out-of-coverage device UE 10 may request its current location information from a communicatively coupled anchor UE 14, that is calibrated for ranging measurements with device UE 10, e.g., by sending a message with a measurement result related to a ranging reference signal (whereby such measurement result may include e.g. ID of the device or ID of the ranging reference signal and/or timing information) and/or estimated distance/angle to the anchor UE 14, optionally including information about a coordinate system to use, and optionally including altitude and/or velocity/accelerometer information. The message type (e.g., PC5_Location Request or RRCLocationRequest) may indicate to the anchor UE 14 that the device UE 10 requests position information based on the provided information, which it may return (after calculation) in a response message to device UE 10.

Similarly, with a similar message that may include also position information or an identifier of a device or reference point, device UE 10 may request anchor UE 14 to provide/calculate/return a distance and/or angle between device UE 10 and the anchor UE 14 and/or the indicated device or reference point, after which the anchor UE 14 will return the resulting calculated distance and/or angle. The anchor UE 14 may know its own location or can request the LMF 34 or RMF 36 or other location service of the core network 30 (e.g., network controller device) for its own location coordinates based on positioning measurements with the network access devices 20 (e.g., gNBs) and translate the ranging measurement of the device UE 10 to a local location coordinate of the device UE 10.

Alternatively, the anchor UE 14 may report the ranging measurement of the device UE 10 along with its device ID to the LMF 34 or RMF 36 for obtaining the location coordinates of the device UE 10, which are then calculated by the LMF or RMF.

Alternatively, the location coordinates of the anchor UE 14 may be shared with the device UE 10 which can use its ranging measurement and the location coordinate of the anchor UE 14 to calculate its own location coordinates.

According to some embodiments related to decentralized localization based on ranging measurements with the anchor UEs 14, the anchor UEs present in the ranging constellation 50 may be configured to advertise the (ranging-based) positioning service (or proxy thereof) as a proximity service. Note that this may require some of the anchor UEs 14 to be assigned to a ranging proximity service. This may require the LMF 34 or RMF 36 or other managing entity to interact with a direct discovery name management function (DDNMF) or policy control function (PCF) in charge of assigning discovery parameters to UEs. Upon connection to, subscription to and/or authorization for the proximity service for ranging-based positioning, the device UE 10 may receive discovery keys/parameters for accessing the ranging/positioning service (or proxy thereof) (e.g., via a PC5 sidelink channel). Then, the device UE 10 may securely send (or receive) discovery messages for the ranging-based positioning service (or proxy thereof) of the anchor UEs 14 of the ranging constellation 50 (e.g. via PC5 sidelink discovery messages).

The managing entity, PCF, AUSF, LMF 34 or RMF 36 may provide the credentials (e.g. during initial provisioning of the ranging/location service on device UE 10, or during authorization/connection setup procedure between a device UE 10 and anchor UE 14, that may involve a message exchange between the anchor UE and the respective network function after which the anchor UE 14 may forward the data to device UE 10 and/or message exchange between device UE 10 and the respective network function via a relayed connection via the anchor UE 14) to device UE 10, which device UE 10 should use to securely connect to the ranging/location service (or proxy thereof) and/or use to protect the data that device UE 10 sends to the ranging/location service (or proxy thereof) or receives from the ranging/location service (or proxy thereof). Alternatively device UE 10 together with a managing entity, PCF, AUSF, LMF 34 or RMF 36 may derive credentials (e.g. keys) to use to securely connect to the ranging/location service (or proxy thereof) and/or use to protect the data that device UE 10 sends to the ranging/location service (or proxy thereof) or that device UE 10 may receive from the ranging/location service (or proxy thereof), based on a set of pre-configured credentials (e.g. root credential in the SIM, or e.g. a session key such as Kamf or Kausf, or an application key).

Upon receiving (or sending) the discovery messages, an anchor UE 14 of the ranging constellation 50 may reply with (or include) the location and/or ranging measurements or calculated ranging results according to its device capabilities. This may be achieved by means of discovery messages or by configuring lower protocol layers (e.g., the physical (PHY) layer) to start transmitting positioning signals, communicating the timing and/or frequency and/or identity of the positioning signals to the device UE 10 (e.g., through the PC5 interface) and gathering the UE measurements of the received positioning signals or calculated ranging results based on the measurements over the PC5 interface.

The anchor UE 14 may provide the device UE 10 with a set of ranging parameters (e.g., the timing and identities of the positioning signals assigned to the anchor UE 14 or other configuration parameters or desired ranging parameters) through direct device to device communication or discovery (e.g., using sidelink/PC5), e.g., upon successful discovery as described in other embodiments. This approach is useful for a device UE 10 that is out of coverage since the device UE 10 can then only receive those parameters from other ranging capable UEs through direct device to device communication or discovery (e.g., using sidelink/PC5). Alternatively, the device UE 10 may receive the ranging parameters of anchor UEs 14 when joining a ranging service and/or location service and/or ranging-based positioning service, e.g., after authentication and authorization.

According to some embodiments, if there are several ranging capable UEs, e.g., anchor UEs 14 that had responded to the device UE 10 with a ranging reference signal (e.g. a discovery message) or had voluntarily transmitted arranging reference signal (e.g. a discovery message), then the device UE 10 can estimate the distance and/or angle based on timing measurements on the respective ranging reference signals (e.g. discovery messages), and use the estimated distances and/or angles to estimate the location by means of e.g. triangulation/trilateration. To this end, the UEs transmitting ranging reference signals (e.g. discovery messages) (e.g., anchor UE 14) may transmit synchronization signals and/or timing information to the receiving device (e.g., device UE 10). Alternatively, or additionally the timing of the scheduled resources for discovery (e.g., the sidelink discovery pool) or a ranging/ranging reference signal pool can be used to determine the originating time of transmitting a ranging reference signal (e.g. a discovery message). The ranging reference signal (e.g. the discovery message) may include timestamp information about when it was transmitted or time difference information (e.g., t4−t1 and/or t3−t2 in case of an FTM based technique). The ranging reference signal (e.g. the discovery message) may include Angle of Departure information. Device UE 10 may do the same in its ranging reference signals (e.g. discovery messages) to another ranging capable UE (e.g., an anchor UE 14). Alternatively, when only a few, e.g., 1, UEs 14 responded to the device UE 10 and/or if the ranging reference signal (e.g. the discovery message) includes location and the time of departure (TOD) information while the clocks of the device UE 10 and anchor UE 14 are synchronized, then the device UE 10 may calculate the distance based on the ranging reference signal (e.g. discovery message) only and if sufficient information is available (e.g., if it can also measure the angle and/or if information about the altitude is provided to/from the other UE) it can estimate its position. This reduces the need of the device UE 10 to send other messages (such as particular ranging/position/sounding reference signals) to anchor UEs 14 for positioning information.

### Section: Randomized Ranging Reference Signals

According to some embodiments related to positioning signals from anchor UEs 14 or target UE 10, a configuration entity (e.g. the managing entity) may assign a random looking assignment of positioning signals, e.g., a transmission time/schedule and/or a positioning signal ID and/or a timing/frequency pattern, which may not be regular, to the anchor UEs 14 or target UE 10. At a time t0 a positioning signal p0 is used, at a time t1 a positioning signal p1 is used, at a time t2 a positioning signal p2 is used, . . . , at a time ti a positioning signal pi is used, . . . , at a time tj a positioning signal pj is used. The positioning signals pi and pj may be chosen at random or in a random looking fashion from an available set of positioning signals, which may be identified by a positioning signal ID and for which the characteristics may be pre-configured by a configuration entity. Also, the resources used for transmitting the positioning signals may be chosen at random or in a random looking fashion from an available set of resources in an area. Furthermore, the time interval (ti+1−ti) between successive signal transmissions may not be a fixed value. Thereby, it is difficult to track a UE transmitting positioning signals over a sidelink channel and a UE can only use those positioning signals if it is informed about the timing and identities over time. The positioning signal identities may have a one-to-one or many-to-one relation with an anchor UE identity or target UE identity at a given time, or many-to-many relation with a set of identities of the anchor UE or target UE at a given time. Both the transmitter UE and receiver UE involved in ranging using the respective random looking positioning signals would need to be configured with the information about the timing and the positioning signal identities and/or UE identities over time. The above positioning signals p1, p2, . . . , pi might be as standard ones (e.g., defined in TS 36.211) or may differ e.g. in waveform, bandwidth, preamble, carrier, guard band and/or may include a pattern indicative of a positioning signal ID or anchor UE identity or target UE identity and may correspond to a different positioning signal ID or anchor UE identity or target UE identity at times t1, t2, . . . , ti. This positioning signal ID or anchor UE identity or target UE identity is the one that determines, e.g., the pseudo-random sequence (e.g., associated with the positioning signal ID or anchor UE identity or target UE identity at a given instant of time) or an encrypted/scrambled positioning signal ID or anchor UE identity or target UE identity that is transmitted as part of, encapsulated by, or over the positioning signal, or may determine a frequency shift of the positioning signal. The anchor UE identities, target UE identities and/or positioning signal IDs may also be used to determine/select the radio resources to use for transmitting/receiving the positioning signals. To this end, an access device or managing entity may define the resources per position signal ID or per anchor UE identity or per target UE identity and provide the resource allocation information to the UEs involved (e.g., all UEs part of a constellation). The managing entity may have to ensure that multiple anchor UEs and/or target UEs in close vicinity do not interfere with each other. Thus, the managing entity may have to assign anchor UE identities, target UE identities and/or positioning signal IDs at times t1, t2, . . . , ti to each anchor UE or target UE in an area in a way that they do not collide (e.g., to make sure that they do not use the same radio resource elements at the same time), and may use a secure connection or encrypted message (that only the intended recipient(s) can decrypt) to inform the UEs involved (e.g., all UEs of the ranging constellation) of the respective identities. Alternatively, the positioning signal IDs or anchor UE identities or target UE identities may be self-selected by the respective anchor UE 14 or a target UE 10 e.g. according to a preconfigured randomization function (e.g., based on UTC time/System Frame Number (SFN)), that may be shared securely with UEs of the constellation and may use a secure connection or encrypted message (that only the intended recipient(s) can decrypt) to inform the UEs involved (e.g., all UEs of the ranging constellation) of the respective identities. Alternatively, the positioning signal IDs or anchor UE identities or target UE identities may be self-selected by the respective anchor UE 14 or a target UE 10 according to a preconfigured pseudo-randomization function (e.g., based on UTC time/System Frame Number (SFN)), whereby the configuration of the pseudo-randomization function may be shared securely with UEs of the ranging constellation, and which the respective UEs can use to derive the same identities.

According to some embodiments related to the previous one, the managing entity makes use of random looking assignment of positioning signals for service authorization and revocation. A managing entity might only distribute, i.e., disclose, the random looking assignment of positioning signals, which are assigned to an anchor UE 14 or a target UE 10, to a device UE 10 or anchor UE 14 that is authorized to use the service, e.g., authorized during an initial configuration phase. A given positioning signal pi out of the random looking positioning signals p1, p2, . . . pi, . . . pj, might have a limited lifetime, for instance, a few seconds, a few minutes, etc. In this case, if a UE 10 has already been configured with positioning signals pi+1, pi+2, . . . , the UE 10 might be prevented (revoked) from using the ranging service by updating the random looking assignment of positioning signals pi+1, pi+2, . . . of anchor UE 14, and any other anchor UEs the UE 10 might rely on. Alternatively, the managing entity might only disclose to a UE 10 the positioning signals, which are assigned to an anchor UE, that are valid for a very limited amount of time so that the UE 10 can automatically no longer access the service as soon as this limited amount of time elapses. The above two described alternatives provide a practical way to revoke the use of the ranging/location service, rather than having to update the credentials in all related devices to reflect a revoked authorization.

### Section: Process for Ranging-Based Positioning Services

FIG. 7 schematically shows a signaling and processing diagram for ranging-based positioning services, that summarizes the multiple operation options according to some embodiments. In this diagram, exchange of information and its direction is indicated by a corresponding arrow and processing steps are indicated by respective blocks, while the time proceeds from the top to the bottom of FIG. 7. The places where the processing steps take place or the start and end points of the information exchanges are indicated by the vertical dotted lines below the respective system component. Not all the steps might always be required and some steps might be executed multiple times for increased accuracy or continuous ranging-based positioning.

In an initial configuration step S701, the CN configures the anchor UEs (A-UE) as such, this may include forwarding control information for configuring e.g. discovery parameters, ranging constellation identifier(s), positioning signals and parameters, and/or positioning techniques. The anchor UEs might also be configured at this step with their specific location. This location might also be known (only) to the CN. Then in a subsequent step S702, the device UE sends to the CN a request to use/subscribe to a ranging-based positioning service. In response thereto, the CN checks whether the device UE is authorized to use this service, and if so, it provides the device UE in step S703 with e.g. discovery parameters, positioning signal parameters, and/or (preferred) ranging methods to use. Similarly, the CN may also check whether the anchor UEs are authorized to be involved in the ranging of the device UE. This step finishes an initial configuration phase (CP).

Now, an operational phase (OP) starts with step S704, where the device UE sends a discovery message to anchor UEs to request ranging services. This message may be a restricted discovery message (e.g., ProSe Model B Solicitation) or may be skipped in ProSe Model A, or may be a ProSe ModelA Announcement where the device UE requesting ranging services plays the role of an announcing UE. Note that by the time this message is sent by the device UE, the device UE might have first received sidelink synchronization signals that allow it to become synchronized to the anchor UEs.

The anchor UEs may collect the presence of the received discovery or connection setup or ranging session initiation message(s), and/or information from these message(s) (e.g., UE identity information, ranging capabilities, timing information, signal strength information) and send it to the CN in step S705. In an example, the lead anchor UE may send a combined report on behalf of the anchor UEs. Alternatively, each anchor UE may send the received messages that are aggregated in the CN.

In step S706, the CN may estimate the location (e.g. a rough initial estimate) of the device UE based on the (combined) report(s) received in step S705 and the locations of the anchor UEs. Alternatively, the CN may perform an initial estimate of the location of the device UE based on anchor UE report message(s) received in step S705. Depending on the accuracy of the estimated position, the CN may indicate (cf. step S707b) a need for more accurate ranging measurements between anchor UE(s) and the device UE, e.g., PRS based ranging estimates in subsequent steps. In this step, the CN may also verify/obtain the authorization and/or user consent for using the ranging-based positioning service to determine the location of the device UE and/or whether the anchor UE(s) are authorized to be involved in this.

In step S707a, the anchor UEs may reply to the device UE with a response message when a ProSe restricted discovery model B has been used. This message may also indicate that the anchor UEs are configured as announcing UEs and use ProSe Announcement discovery messages (model A). The discovery messages may be used (e.g., directly) for ranging purposes by the device UE or may be used to transmit configuration data required by the device UE to perform ranging in subsequent steps (e.g., if the device UE is out of range and initially lacks positioning parameters sent by the anchor UEs) and/or perform an initial position estimate (e.g., in case some or all of the messages contain location coordinate information of the respective anchor UE).

As an option, a further step 707b can be used, by means of which the CN sends an indication about the achieved or required accuracy to the anchor UEs. Depending on this indication from CN, the anchor UE can (re-)configure the ranging procedure, e.g., the transmission of PRS signals for ranging-based location estimation. This might imply that the ranging messages in steps S704-S715 might be exchanged longer or shorter or more often and/or with different signal characteristics. This might also imply that the anchor UEs skip the ranging procedure (steps S709 to S717) if the accuracy obtained in step S706 is already sufficient. If this optional step S707b is not present, then the usual flow of ranging steps S709 to S717 is followed.

In step S708, the device UE may obtain an initial range/location estimation based on the messages received from anchor UEs in step S707a, and potentially combined with (the timing and contents of) the message sent in step S704. The messages of steps S704 and S707a might be exchanged multiple times to increase the accuracy.

It is noted that if there are multiple anchor UEs that had responded to the device UE in step 707a, and some or all of the response messages contain location coordinate information of the respective anchor UEs, then the device UE can estimate its location based on these messages received in step S707a by triangulation/trilateration.

In step S709, the anchor UEs may send one or more positioning signals that are received by the device UE. Then, in step S710, the device UE may be able to perform an estimation of its range/location based on the positioning signals received in step S709. In case an initial estimation was made in step S708, the estimate of step S710 may improve the accuracy of the initial estimate.

Alternatively or in combination with the previous step S709, the device UE may also send in step S711 positioning signals that may be received/measured by the anchor UEs. A lead anchor UE may be in charge of collecting these measurements of the anchor UEs.

It is noted that the UE might also use other (types of) positioning signals (e.g., Sounding Reference Signals (SRS signals), or Channel State Information Reference Signals (CSI-RS)) or multiple types of positioning signals in a channel as prescribed by or requested by an anchor UE for more precise ranging measurement.

In step S712, the lead anchor UE may obtain the location/range of the device UE, locally, based on the positioning signals received by the lead anchor UE and/or one or more other anchor UE(s).

In step S713, the device UE may send measurements and/or calculated distances/angles/positions to one or more of the anchor UEs based on the exchanged discovery message(s) or positioning signals.

Then, in step S714, the lead anchor UE may obtain the location/range of the device UE, locally, based on the reported measurements and/or calculated distances/angles/positions of step S713. In case the location/range of the device UE was already locally determined in step S712, this may be an improved estimate based on the additional information provided by the reported measurements in step S713.

If the lead anchor UE computes the location/range of the device UE, the lead anchor UE may send this information in step S715 to the device UE. Similarly, if another anchor UE computes its distance to the device UE it may send this information in step S715 to the device UE as well.

Furthermore, in step S716, the lead anchor UE (or any other anchor UE or ranging capable UE or relay device) may send the received measurements to the CN which then estimates the location/range of the device UE in step S717. Typically, the lead anchor UE would send these measurements directly via an access device when it is in coverage, but it may delegate this task to another UE of the ranging constellation, or it may send these measurements indirectly via a relay device (e.g., ProSe UE-to-Network Relay UE), when out of coverage.

Finally, in step S718, the CN may export the ranging/position information to an external application function (AF) after authentication and authorization of the AF.

Section: Protection of Prs Signal Privacy and/or Using Multicast/Broadcast for Ranging

According to some embodiments as illustrated in FIG. 9, a positioning/ranging procedure may comprise session-less ranging, but the techniques in this embodiment may be also applicable to other procedures or implemented independently. The benefits of session-less ranging include: (i) it allows focusing on the protection of a limited set of messages and (ii) Such session-less ranging operation allows for enhanced performance. The multiple steps as described in FIG. 9 might not always be needed. In FIG. 9, three UE (10) devices, namely UE1, UE2, and UE3, perform a ranging/positioning operation. Note that the figure is only illustrated with 3 UE devices, but can be generalized to involve more than 3 UE devices. The group of UE devices in FIG. 9 may together form a ranging constellation.

The three UE devices receive support from the CN (30) and all entities (network functions) in it to, e.g., get authorization or receive ranging parameters. Although not explicit in FIG. 9, an external AF might also be involved.

This supporting phase is explicit in an initial configuration phase (CP) and illustrated by means of step S900 in which an initial configuration and authorization of each UE device (i.e., UE1, UE2, and UE3 in FIG. 9) is performed by the CN.

A possible variant of FIG. 9 is that UE2 is a UE requiring a ranging/positioning operation and UE1, UE3 are anchor UEs providing ranging/positioning services.

In a first step 900, UEs authorized to use or provide ranging/positioning services are configured with ranging/location parameters, e.g., as described in above embodiments and description.

Furthermore, if authorized to participate in the ranging/positioning, the UE devices are provisioned with certain cryptographic keys used in the subsequent message exchanges. For instance, these cryptographic keys might be the discovery keys as per TS 33.503, namely DUIK, DUCK, and DUSK, that allow performing the discovery of the ranging/positioning in a secure manner. Or for instance, the UE devices are provisioned with credentials to be used for protection of groupcast/multicast/broadcast messages (e.g. group keys) over PC5/sidelink, whereby the groupcast/multicast/broadcast may be performed according to TS 23.304 (i.e. with group discovery) or TS 23.287 (i.e. without group discovery) and whereby the group discovery may be protected with different credentials (e.g. using DUIK, DUCK and/or DUSK shared amongst members of a group) than the groupcast/multicast/broadcast messages.

Each UE is also set with a configuration of ranging parameters that allows performing ranging in a privacy aware manner, e.g., prevents UE2 from being tracked. In a possible variant, UE1 and UE3 are anchor UEs, e.g., at a fixed known location, e.g., at fixed locations along a road where UE2 is moving as in a V2X scenario, and thus, are provided with discovery keys and/or groupcast/multicast/broadcast credentials.

These discovery keys and/or groupcast/multicast/broadcast credentials may be rotated/changed over time (e.g., remain valid only for a limited period of time, e.g., 1 minute, or 1 hour, or 1 day). These discovery keys and/or groupcast/multicast/broadcast credentials might be configured to UEs in close locations, e.g., anchor UEs that are close, e.g., within a range of 100 m, a range of 1 km, a range of 10 km. Furthermore, to ensure service continuity, discovery parameters such as discovery keys and/or groupcast/multicast/broadcast parameters such as group keys might be deployed with some overlap in the temporal/location settings.

Each reference UE (e.g., UE1 and UE3) are assigned in Step S900 one or more PRS to use in message S911 or S913 and one or more PRS' that UE2 can use in message S912 or S914. To avoid tracking and reduce interferences, adjacent reference UEs should be assigned different PRS and PRS' signals. To avoid tracking, the assigned PRS and PRS' signals may be rotated/changed in a regular basis. Note that for simplicity the PRS is used here, but PRS can be similarly be replaced with another type of positioning/ranging reference signal (such as SRS).

In this phase S900, each UE interacts with the CN (e.g. LMF, AUSF/UDM) or other managing entity to get authorization to either offer (e.g., UE1 and UE3) or use (e.g., UE2) the ranging service. Upon authorization, each UE is configured with ranging information to provide or use the ranging service and discovery information for the ranging service and/or the necessary information to perform groupcast/multicast/broadcast for ranging. This discovery information includes discovery keys. The information to perform groupcast/multicast/broadcast includes groupcast/multicast/broadcast credentials.

In this phase, each UE may be configured with a policy determining whether the UE is allowed to offer/use a session-less ranging operation, i.e., a ranging operation with a reduced signaling overhead.

According to some embodiments that may be used independently, the PRS assigned to a UE (e.g., an anchor UE) is derived from an identifier determined and/or managed by RAN or CN so that RAN or CN can ensure that different UEs receive different sets of PRS as described above. This “application identifier” may be used as input in the PRS generation process, e.g., as in the current PRS definition is in Clause 7.4.1.7 in TS 38.211 where it is described how the PRS is derived from several parameters including identifiers. This “application identifier” may be used as input parameter for the PRS generation instead of, e.g., the dl-PRS-SequenceID. Additionally, or alternatively, an “application identifier” may be used as an additional input parameter in the process to derive the PRS signal, e.g., based on Clause 7.4.1.7 in TS 38.211.

In a second step S910 already in the Operational Phase (OP), UE devices perform the discovery and/or configuration of the ranging/positioning operation. In this second step, anchor UE UE1 (and UE3) sends message S911 (S913).

This message may be a Solicitation Discovery message as per Discovery Model B protected with the discovery keys configured in Step 900, or may be a groupcast/multicast/broadcast message that may include configuration information of the ranging/positioning operation protected by using the groupcast/multicast/broadcast credentials configured in step 900.

The discovery message (e.g. solicitation discovery message) or groupcast/multicast/broadcast message might include a Service Code that identifies the ranging/positioning service or session that is offered.

This discovery message (e.g. solicitation discovery message) or groupcast/multicast/broadcast message may also include an indication of the support of a session-less operation capability.

A UE device (e.g., UE2) requiring or a UE device (e.g. UE3) involved in the positioning/ranging operation will receive the message and process it by means of the pre-configured discovery keys or groupcast/multicast/broadcast credentials.

If the discovery keys or groupcast/multicast/broadcast credentials are suitable (this also means that the UE is authorized), the UE will be able to unscramble, decrypt and integrity verify the message. When doing so, UE2 (and other UEs (e.g. UE3) involved in the position/ranging operation) can have access to ranging/positioning parameters required for a ranging/positioning operation with the anchor UE UE1 (similarly for UE3).

Such ranging/positioning parameters might be as described in previous parameters and include the PRS used, timing parameters, or their location.

Upon reception and processing of message S911 (S913), UE2 prepares message S912 (S914) towards device UE1 (UE3). Other involved UEs (e.g. UE3) may do the same (not shown in the figure).

This message S912 is prepared in a similar manner and may correspond to a discovery response message as per discovery model B. If UE2 has been authorized to use a session-less operation, then the discovery response message can include an indication of the acceptance/usage of the session-less operation. Alternatively, the discovery response message is only sent if the session-less operation is accepted. The ranging/positioning parameters exchanged in the discovery messages may be exchanged in the metadata field of the discovery messages (e.g. using encapsulated (extended) LPP commands or similar commands).

Similarly, in case of groupcast/multicast/broadcast operation, message S912/S914 may correspond to a groupcast/multicast/broadcast message (which may either use the L2 identifier used in received message S911/S913 or a pre-configured L2 groupcast/multicast/broadcast identifier as a destination address). This message may include an indication of the acceptance/usage of the session-less operation and may include a set of ranging/positioning parameters.

When UE2 sends messages S912 and S914, both messages may be of the same type and may be protected with the same keys, e.g., they may be discovery response messages protected with the corresponding discovery keys. Thus, it may be important to include a parameter in those messages so that the receiving UE, e.g., UE1 and UE3) know which message is for them. For instance, message S912 (S914) may include an identifier that was first included in message S911 (S913). This identifier might be an explicit (short) (session) ID that UE1 (or UE3) choose or are assigned or may be another parameter exchanged in message S911 (S912) and indicative of the whole message such as the MIC in message S911 (S912). This identifier of message S911 may be included in message S912 so that the receiving UE device knows the message was intended for it. This can also be done for message S914.

Messages S912 and S914 may be combined, e.g., they may be a single broadcast message intended to both UE1 and UE3 (e.g. when both UE1 and UE2 are expected to be involved in ranging/sidelink positioning operation with UE2, e.g., because they are both part of the same ranging constellation or the same group).

This message flow in Step S910 is described in the context of Discovery Model B or a groupcast/multicast/broadcast communication model whereby an anchor UE (e.g. UE1 or UE3) is the initiating UE. In the case of Discovery Model A, a single message is transmitted by the announcing UE that might be (i) UE2 or (ii) or UE1 (and UE3). In the first case, UE2 sends a discovery message, which may include a field indicating the support of a session-less ranging operation capability and/or a request to initiate a session-less ranging operation. In the second case, UE2 receives two discovery messages. In the case of a groupcast/multicast/broadcast communication model whereby UE2 is the initiating UE, UE2 sends a groupcast/multicast/broadcast message that will then be received by the Anchor UEs (e.g. UE1 and UE3), whereby the groupcast/multicast/broadcast message may include a field indicating the support of a session-less ranging operation capability and/or a request to initiate a session-less ranging operation.

In Step S920 the UE devices transmit and measure ranging/positioning signals such as PRS/SRS/etc. PRS signals may be assigned to a UE in S900 (e.g. by the LMF or other managing entity) or configured in S910 (e.g. by a head anchor UE).

PRS signals should be assigned in such a way that privacy issues are minimized, e.g., a UE, e.g., UE2, rotates the broadcasted PRS in a regular basis.

According to some embodiments, the CN (e.g. LMF) or RAN (e.g. gNB) or other managing entity has assigned a UE, e.g., UE2, in Step S900 a given schedule of the PRS to be used. The CN or RAN needs to configure the same schedule in UE1 (and UE3) to make sure that UE1 (and UE3) can determine the UE that sent the information.

According to some embodiments, an option consists in having UE1 to assign a PRS to UE2 in message S921. This allows for distributed operation reducing the signaling between RAN and CN during operation. For instance, UE1 might have a few allocated PRS' (allocated by the CN or other managing entity in S900) that UE1 can assign to UEs, e.g., UE2, requiring the ranging service.

In a special case of this last option, each UE providing a ranging service is assigned a single different PRS. Upon exchange of messages S911 and S912, UE2 is made aware (using the provided configuration information) of the PRS that is assigned to UE1 and that UE1 will use in message S921. Upon reception of message S921 (UE1's PRS), UE2 replies with message S922 using the same PRS or its own UE2's PRS. This approach ensures that a UE requiring ranging/positioning services (e.g., UE2) uses different PRS avoiding tracking and avoids collisions between UEs requiring ranging.

In a special case of the last options, adjacent UEs providing a ranging service are assigned different PRS or a different timing/frequency of PRS in such a way the interferences are minimized.

In a special case of the last options, adjacent UEs providing a ranging service are assigned (in S900) different PRS random looking sequences of PRS to be used over a given period of time. For instance, UE1 might be configured with a PRS set: PRS1, PRS3, PRS7, . . . to be used at timeslots t0, t1, t2, . . . and UE3 might be configured with a PRS set: PRS2, PRS1, PRS6, . . . to be used at timeslots t0, t1, t2, . . . Then, UE1 and UE3 can further assign such PRS to a UE such as UE2 requiring ranging/positioning services in steps S921 and S923.

In a special case of the last options, a UE providing a ranging service is assigned (in S900) different PRS random looking sequences of PRS to be used over a given period of time by itself and by a UE requiring the ranging/positioning service. For instance, UE1 might be configured with a PRS set: PRS1, PRS3, PRS7, . . . to be used attimeslots t0, t1, t2, . . . and UE1 might be configured with a PRS' set: PRS2, PRS1, PRS6, . . . to be used at timeslots t0, t1, t2, . . . by a UE requiring ranging/positioning services (e.g., UE2). This has the advantage of increasing the resiliency of the ranging protocol since an attacker aiming at interfering in the ranging procedure (by sending a fake PRS in message S922 or S924) is not aware of the PRS to be used.

In a special case of the last options, a first UE providing a ranging service is assigned (in S900) a set of PRS that can be used by a second UE requiring the ranging/positioning service. For instance, UE1 might be configured with a PRS' set: PRS2, PRS1, PRS6. This PRS' set can be indicated in e.g., message S911 or S913 to a UE such as UE2 that can then pick up at random one of the possible PRS in the PRS' set and securely send this choice to the other party in, e.g., message S912 or S914.

In Step S930, ranging measurements, e.g., as in above embodiments/description, are exchanged. Messages S931 and S932 for UE1-UE2 (similarly S933 and S934 for UE2-UE3) are used to securely exchange the measurements, e.g., timing measurements in a RRT method by means of discovery keying materials. In case of groupcast/multicast/broadcast communication model these messages may be groupcast/multicast/broadcast messages will then be received by the/all UEs involved in the ranging/sidelink positioning operation and that are protected with the groupcast/multicast/broadcast credentials.

In an option, to ensure that the messages in Step S910 and Step S930 are linked to each other, the messages in Step S910 and S930 might include at least a session identifier

In another option, the messages are discovery messages that are reused for the exchange of the measurements, e.g., in a metadata field. These discovery messages can be protected with the discovery keying materials. These discovery messages might be differentiated from the discovery messages in Step S910 by the usage of a different service code. To ensure that the messages in Step S910 and Step S930 are linked to each other, the messages in Step S910 and S930 might include at least a session identifier that might e.g., be assigned by the UE starting the discovery process or that sent the initial groupcast/multicast/broadcast message to initiate ranging. This ID might explicit (a new ID) or implicit e.g., be one or more fields exchanged in the discovery messages or groupcast/multicast/broadcast messages in Step S910, e.g., a MIC included in messages S911 and S913.

As a second alternative, message S931 is a Direct Communication Request extended to include the measurements protected, e.g., according to Clause 6.3.5 in TS 33.503. Message S932 is a Direct Communication Accept extended to include the measurements protected that is also to be protected in a similar way as the DCR message in Clause 6.3.5 in TS 33.503.

As a third alternative, messages S931 and S932 are PC5 protected messages where the key used to protect the messages may be based on:
A PC5 key established with or without support of the network,
A PC5 key pre-distributed, e.g., in Step S900.

In Step S940, the range/location is obtained. For instance, the ranges between UE1 and UE2 and between UE2 and UE3. For instance, if a RTT method is used and directional information is available (or e.g., the altitude of UE2 is known) and messages S911 and S913 included the location of UE1 and UE3, then UE2 can determine by itself its location in Step S942. For instance, if UE1 and UE3 exchange the received measurements, UE1 and/or UE3 might determine the location of UE2. In case of groupcast/multicast/broadcast communication model the UE(s) that calculate a range/location may send a groupcast/multicast/broadcast message including the calculated range/location, which will then be received by the UEs involved in the ranging/sidelink positioning operation and that is protected with the groupcast/multicast/broadcast credentials.

This solution addresses needs on privacy protection for ranging positioning services since the usage of existing discovery procedures addresses privacy concerns since the scrambling operation in the protection of discovery messages prevents or at least makes more difficult the tracking of a UE.

This solution addresses privacy protection for ranging positioning services since any authorized UE engaging in a ranging operation with any authorized reference UE will use the same PRS as the authorized reference UE. This also means that a UE requiring the ranging service changes the used PRS when it performs the ranging operation with different reference UEs making tracking more difficult.

This solution addresses authorization for ranging positioning services since in the initial authorization and provisioning phase, only authorized UEs are provided with ranging parameters and discovery keys so that only authorized UEs can engage in the procedure.

This solution addresses protection of discovery messages by reusing existing discovery procedures.

According to some embodiments that may be used independently, the PRS assigned to a UE (e.g., an anchor UE) is derived from a RAN identifier such as an RNTI or a L2 identifier used for PC5 communication. For instance, as in the current PRS definition is in Clause 7.4.1.7 in TS 38.211 where it is described how the PRS is derived from several parameters including identifiers, e.g., dl-PRS-SequenceID, a RAN identifier may be used as input parameter for the PRS generation instead of, e.g., the dl-PRS-SequenceID. Additionally, or alternatively, a RAN identifier may be used as an additional input parameter in the process to derive the PRS signal, e.g., based on Clause 7.4.1.7 in TS 38.211. This has the advantages of (1) simplifying the PRS management since PRS are linked to existing RAN allocated identifiers, (2) avoiding PRS collisions, and (3) implicitly reducing security risks because RAN identifiers may already be rotated.

Thus, in accordance with a general definition of a first aspect of this embodiment, it is proposed an apparatus for obtaining a range or location estimate of a target mobile device (10) within a wireless network, wherein the apparatus is adapted to be provisioned with a ranging positioning signal identifier, SL-PRS sequence ID, by a managing entity and the apparatus is configured to use the SL-PRS Sequence ID to generate and broadcast a ranging positioning signal over the PC5 interface and use the ranging positioning signal to perform a range or location estimate or a ranging measurement. Optionally, the apparatus may be provisioned with a ranging positioning signal identifier, SL-PRS sequence ID, assigned to a ranging capable anchor device by the ranging capable anchor device or by a managing entity, and the apparatus uses a received ranging positioning signal determined by the provisioned SL-PRS sequence ID to perform a range or location estimate or a ranging measurement.

In accordance with another aspect of this embodiment, it is proposed a method for obtaining a range or location estimate of a target mobile device (10) within a wireless network, wherein the method comprises:
the target mobile device receiving from a managing entity a ranging positioning signal identifier, SL-PRS sequence ID, and
the target mobile device using the SL-PRS sequence ID to generate and broadcast a ranging positioning signal over the PC5 interface and using the ranging positioning signal to perform a range or location estimate or a ranging measurement.

### Section: Multicast/Broadcast-Based Ranging

According to some embodiments—illustrated by means of FIG. 6.19.3.1-1 in 3GPP TR 23700-86 v1.2.0—a similar positioning/ranging procedure is described in the context of ranging protocols —exchanging messages over the SR5 reference point, running on top of the PC5 interface—enabled in the particular case of FIG. 6.19.2.1-1 by Device and Service Discovery Function (DSDF), Sidelink Positioning and Ranging Function (SPRF), and Group Support Service Function (GSSF) services/protocols. The procedure in FIG. 6.19.3.1-1 involving n>=2 UEs is similar to the session-less procedure of FIG. 9. The techniques may be also applicable to other procedures or used independently. In FIG. 6.19.3.1-1, Step 1 is the discovery carried out by means of a Ranging Discovery Protocol, e.g., enabled by DSDF; Step 2 may establish a positioning/ranging session using GSSF and/or SPRF; Step 3 involves the exchange of positioning/ranging capabilities using, e.g., SPRF over PC5; Step 4 includes the configuration of the transmission and measurement of Sidelink Reference Signals. Step 5 in FIG. 6.19.3.1-1 describes the Transmission and measurement of Sidelink Reference Signals. Step 6 in FIG. 6.19.3.1-1 describes exchange of the measurements. Step 7 in FIG. 6.19.3.1-1 describes the range/location computation. Step 8 in FIG. 6.19.3.1-1 involves the sharing of the range/location values. In reference to the procedure in FIG. 6.19.3.1-1, techniques as described in the previous embodiments (such as described for FIG. 9) related to the steps of 6.19.3-1-1 for discovery, establishing a positioning/ranging session, exchange of capabilities, configuration of the transmission of ranging reference signals, exchange of measurements, computation of the range/location, sharing of range/location value are applicable. For example, the Device and Service Discovery Function (DSDF) relies on the PC5 discovery procedures, and thus, techniques in other embodiments are applicable. The function of the SR5 services may run over different PC5 RATs (e.g. ProSe over NR, ProSe over LTE, V2X over NR, V2X over LTE).

According to some embodiments, for discovery, connection setup and other ranging procedures, the devices may reuse the keys that are already provisioned for one or more of these PC5 RATs, such as the DUIK, DUSK, DUCK for ProSe discovery, or may derive a new set of keys for ranging procedures over the SR5 reference point, running on top of PC5, based on these already provisioned keys and one or more ranging related parameters such as a ranging specific ID or nonce (e.g. by using a Key Derivation Function as defined in Annex B of 3GPP TS 33.220), or may be provisioned (e.g. by the AUSF upon authorization or a NF in charge of managing ranging keys) with a new set of keys specific for the ranging procedures over the SR5 reference point, running on top of PC5. The ranging protocol messages may be protected (e.g., encrypted or integrity protected or scrambled) and may be encapsulated (e.g. as extended LPP message) before being passed to the PC5 RAT.

According to some embodiments, the PC5/SR5 discovery keys are preconfigured before performing DSDF.

According to some embodiments, the PC5 discovery keys or groupcast/multicast/broadcast credentials are preconfigured based on the (rough) UE location. This UE location may be provided/obtained by the LMF or by the UE. The PCF or other provisioning/managing entity may retrieve/receive said location and restrict provisioning of the keys only to UEs that are within a certain distance from a reference point or anchor UE or target UE.

According to some embodiments, the location (e.g., restrict provisioning of the keys only to UEs that are within a certain distance from a reference point) might also be generalized, e.g., considering same location in the future (taking into account the trajectory/movement/speed of UEs. For instance, the CN might have information related to the trajectory/movement/speed of a UE (e.g., a car) and predict where the UE will be located at time t so that the UE is configured with keys/parameters associated to UEs that are at that location at that point of time.

According to some embodiments, the UEs in a group (e.g. a ranging constellation) are configured to perform discovery and/or connection setup (e.g., DSDF-based) by means of multiple underlying RATs (e.g., V2X and ProSe). The UEs exchange their underlying RAT capabilities and the UEs then agree which RAT to be used in later phases. For instance, assume that a UE wishes to determine its position with reference to some anchor UEs that maybe be V2X or ProSe RAT. The UE (that might be both V2X and ProSe RAT capable) will then discover said anchor UEs determining their type, e.g., there might be a single V2X anchor UE and two ProSe anchor UEs so that the UE will select the two ProSe anchor UEs and will perform later phases with said ProSe anchor UEs using the ProSe RAT.

In a related variant, the RAT selection is based on a configuration policy, e.g., that might determine that in a context (time, location, . . . ) only a given type of RAT is to be used, and therefore, discovery (e.g., DSDF-based) should be based on that said RAT discovery technology.

In a related variant, the RAT selection is based on a configuration policy, e.g., that determines the selection of the RAT to use for the later ranging/positioning procedures, it determines whether discovery should rely on multiple RATs or a single RAT.

According to some embodiments, the ranging protocols (e.g. SPRF, GSSF) are used in groupcast/broadcast mode where the ranging protocol messages (e.g., SPRF) are protected by means of one or more group keys.

According to some embodiments, the one or more group keys are based on the discovery keys in Step 1, e.g., derived from one or more discovery keys, e.g., derived by means of a KDF (as defined in TS 33.220) and using as KDF inputs the selected discovery key (e.g., DUIK) and, e.g., the identities of the UEs involved in the ranging/positioning session and/or a time-based counter. This provides a simple and efficient approach to derive a group-based key.

According to some embodiments, the group key(s) is/are renewed according to a policy configured on the UEs, e.g., a policy that determines that the group key needs to be renewed every T seconds or when a new discovery phase (step 1 in FIG. 6.19.3.1-1) is executed.

According to some embodiments, the ranging protocol/service (e.g., GSSF) is enhanced to manage one or more group keys by determining a group key UE owner (that might be the managing entity) that is in charge of determining a group key (e.g., by generating a key at random) and managing (e.g., storing, distributing, updating, revoking) said key.

According to some embodiments, the group key UE owner (e.g., a UE in the group (or a managing entity) may receive one or more root group keys from which such secondary (e.g. randomized) group keys may be derived from an application (e.g. through NEF or GMLC) or from a core network function that manages and/or determines such group of UEs (e.g. a group of anchor UEs that together form a constellation) or from a core network function that manages the ranging (group) keys.

According to some embodiments, the discovery keys or groupcast/multicast/broadcast credentials may be (pre)configured based on the (rough) UE location that may be provided/obtained by the LMF or by the UE, whereby e.g. the PCF or other provisioning/managing entity may restrict provisioning of the keys only to UEs that are within a certain distance from a reference point or anchor UE or target UE.

According to some scenarios, a first set of keys (e.g., discovery keys) and a second set of keys (e.g., groupcast/multicast/broadcast credentials/keys) may be (pre)configured and some of those keys may be used preferably, e.g., (e.g., second set of keys, in this example, the groupcast/multicast/broadcast credentials/keys) as provided by a NF such as PKMF or LMF. However, if this preferred set of keys is not available, then another set of keys (the first set of keys may be used). This increases the security of the system, because it ensures that groupcast/broadcast ranging messages can be protected, but it leads to a problem determining which keys should be used to process/protect the secure groupcast/broadcast messages. To address this problem:

According to some embodiments, the set of keys used to protect the groupcast/broadcast messages is indicated in the broadcast/groupcast message, e.g., a bit may be used to indicate whether the first set of keys or the second set of keys are used.

According to some embodiments, the set of keys used to protect the groupcast/broadcast messages contains discovery keys. A value related to the discovery keys (e.g., relay service code, hash/scrambling of relay service code, KDF of one of the keys, etc) is used as identifier. This identifier may be rotated as in other examples to avoid privacy issues such as trackability.

According to some embodiments, UEs may belong to different PLMNs. For instance, sending UE1 may belong to PLMN1 and receiving UE2 may belong to PLMN2. The receiving UE2 may contact a PKMF1 associated to PLMN1, e.g., after getting the PKMF address from its PCF, and may receive the corresponding keying materials. UE1 may also contact PKMF1. When UE1 sends its broadcast/groupcast message, UE1 includes in its broadcast/groupcast message the identifier of PLMN1 so that the receiving UE2 knows that the broadcast/groupcast message is protected with keys that are associated with PKMF1. UE2 then loop up its groupcast/broadcast parameters associated to PLMN1. Similarly, in case that there are multiple PKMFs per PLMN, UE1 includes the PKMF ID in the broadcast/groupcast message, and UE2 uses PKMF ID to determine the set of groupcast/broadcast keys to use.

In some embodiments, above PLMN ID or PKMF ID may extend a Group ID.

It is to be noted that a Group ID is defined in TS 23.586 [2], which indicates a Ranging/Sidelink Positioning group that the UE belongs to and can be mapped to Destination Layer-2 ID, but this Group ID may be too short (8 bits) to accommodate PLMN ID and/or PKMF ID or allocate multiple Group IDs that can be rotated, thus, the Group ID should be much longer than 8 bits.

According to some embodiments, the group key UE owner may set up secure unicast channels with each of the UEs in the group, e.g., relying on a secure unicast link (e.g., SPRF based running over PC5) and may use said secure channel to distribute the group key to each of the group members.

According to some embodiments, the group key UE owner may be integrated in the managing entity so that the managing entity is in charge of the management of the group key.

According to some embodiments, the group key UE owner may be not integrated in the managing entity that takes care of responsibilities, e.g., authorization of a UE in the ranging constellation, but is not in charge of the management/distribution of the group key.

According to some embodiments, the ranging protocol/service (e.g., GSSF) or a UE in the group or a managing entity may receive a request from the upper layer or application (e.g. through NEF) or from a core network function that manages and/or determines such group of UEs (e.g. a group of anchor UEs that together form a constellation) to, e.g., add/remove a group member or manage the group (e.g., merge two groups), in this situation, the group key used to protect the group communication may be refreshed, e.g., in a distributed manner (e.g., if the group key is derived from one or more discovery keys as in above embodiment variant) or centralized manner (e.g., if there is a group key UE owner).

According to some embodiments, the group key may be used to protect the PC5 traffic or Non-IP PDCP SDUs.

According to some embodiments, the group key may be used to protect one or multiple protocol interactions, e.g.:

Establishment of a ranging/positioning session.

Exchange of the UE capabilities.

Configuration of Transmission and Measurement.

Exchange of measurements.

Exchange of location results.

According to some embodiments, the group keys may be used for encryption, integrity protection or scrambling.

According to some embodiments, one or more group keys may be used to derive an encryption key and/or a scrambling key and/or an integrity key, e.g., by means of a KDF (such as described in Annex B of TS 33.220).

According to some embodiments, said encryption/scrambling/integrity keys may be session keys that are refreshed, e.g., before or after a ranging session.

According to some embodiments, the group key and/or the encryption key and/or the integrity key may be used in combination with aNR Encryption Algorithm (NEA) and/or aNR Integrity Algorithm (NIA).

According to some embodiments, transmitted broadcast/groupcast messages may be protected using a NEA/NIA DIRECTION parameter of, e.g., 0 and/or a counter that is a UTC-based counter.

According to some embodiments, the group key and/or the encryption key may be used together with a KDF (such as described in Annex B of TS 33.220) and input parameters such as a time-based counter to derive a pseudo-random sequence that is used to encrypt and/or scramble (e.g., XOR) a subset of the fields of the message.

According to some embodiments, the SPRF (GSSF) signaling may be used for the control signaling between the UEs to determine the corresponding Sidelink Positioning and Ranging operation, e.g. the channel to use for the Sidelink Positioning or Ranging reference signal, the sequence and time slot for each of the UE to perform the signal transmission and measurements. In particular, it is used to ensure that a UE is assigned a Positioning or Ranging reference signal so that it does not endanger the privacy of the user, e.g., as described in above FIG. 9 related embodiments and/or by rotating it, and/or by randomizing it where some of these actions might depend on the shared group key(s), e.g., the allocated positioning signal (or an identifier determining the positioning signal) might be derived from the group key, e.g., by means of a KDF (such as described in Annex B of TS 33.220).

According to some embodiments, a ranging constellation (e.g., the n UEs in FIG. 6.19.3.2-1 in TR 23700-86-120) might rely on the CN (e.g. LMF) to determine the range/position. In such a case, while discovery (e.g., DSDF-based) may be open to a wide range of UEs, e.g., all UEs in an area, an anchor UE in a potential ranging constellation, upon discovery, might request the CN to check the authorization of specific UEs (e.g., UEs requiring ranging/positioning services and/or potential anchor UEs. In this context, a procedure as described in FIG. 6.19.3.2-1 may be extended so that the authorization is requested (e.g., by an anchor UE that might be UE1 in said figure) and a group key is returned in case that authorization is granted by the CN. For instance, as an extension to the ranging procedure (e.g. after discovery), a UE (e.g. target UE or anchor UE) may request authorization of one or more other UEs to a core network function (such as UDM) or other managing entity and a group key is returned in case that authorization is granted

According to some embodiments, each participating UE in the potential ranging constellation (after discovery) may prepare a message (e.g., a DCR based message) that may include one or more of the following parameters a UE identifier (PRUK ID or SUCI or ranging ID), a service code, a key freshness parameter such as a K_NRP freshness parameter 1, or the least significant bits of a time-based counter or a MIC. Said message prepared by each UE may be shared with the CN through the anchor UE as a “key request message” that may contain said parameters. Some fields might be hop-by-hop protected between UE and anchor UE, e.g., the PRUK ID might be hop-by-hop protected as in TS 33.503, Clause 6.3.5 while some fields might involve end-to-end protection between UE and CN, e.g., the MIC might be computed using a key shared by the UE and the CN, e.g., a K_AF derived by means of AKMA (TS 33.535) so that the CN (or an AF in the CN) can verify that the UE is the UE that is claimed to be. The input in the computation of the MIC might involve a time-based counter or other parameters in the message. The MIC might be computed by means of a KDF (such as described in Annex B of TS 33.220) or a NR Integrity Algorithm where the input key might be (derived from) K_AF.

When the anchor UE has to share this input from multiple UEs in the ranging constellation, the anchor UEs might combine the fields of all received messages in a single “key request message” towards the CN.

If there are end-to-end protected fields, e.g., MICs, then the CN (AF/NF) can verify that the CN (AF/NF) is communicating with the right UE (I.e., authenticates the UE) by means of said shared secrets, e.g., K_AF.

The CN may prepare a “key response message” that may contain a key, e.g., a group key that is sent protected to each of the authorized devices (I.e., there are up to N−1 protected group keys). This group key is included if the CN manages this key. Authorized UEs might need to be authenticated (e.g., based on the MICs) and then authorized based on a policy that might be held by the PCF. The group key might be (end-to-end) protected, e.g., using a protection key derived from a root secret associated to each of the UEs, e.g., K AUSF. For instance, it might be used K_AF derived by means of AKMA as per TS 33.535. The “key response message” may also contain for each of the authorized UEs (<N−1) a key similar to K_NRP and a freshness parameter, e.g., K_NRP freshness parameter 2. 5GC NFs and internal signaling are not described for brevity. The similar security procedure as Security for 5G ProSe Communication via 5G ProSe Layer-3 UE to-Network Relay as defined in TS33.503 [6] can be reused. The “key response message” may also include an explicit indication of which devices are authorized, I.e., the identities of the authorized UEs.

Upon reception of “key response message”, the anchor UE, e.g., UE1 in FIG. 6.3.2.1-1 is aware of which UEs are authorized by the CN to join the ranging/positioning session, e.g., by observing which UEs are receiving the protected group key. Next, the anchor UE distributes the received information (except the K_NRP if present) towards the UEs by means of a single groupcast message or by means of up to N−1 unicast messages. In the case of a unicast message, each unicast message includes the protected group key and/or the K_NRP freshness parameter 2. Note that if the group key is not end-to-end protected, then the K_NRP freshness parameter 2 is required. Note that if the CN does not manage/provide the group key, then the anchor UE has to generate/manage/provide it. This might be received by means of a Direct Security Mode Command message. If K_NRP freshness parameter 2 is available, then this message may be protected with K_NRP-SESS derived from K_NRP and the freshness parameters. From K_NRP-SESS the corresponding encryption and integrity keys can be derived as per TS 33.536. If keys based on K_NRP-SESS are used, then the group key does not need to be end-to-end protected but it can be protected hop-by-hop. Upon reception of the unicast message (e.g., Direct Security Mode Command message) from the anchor UE, each of the UEs receiving the message can determine the same keys (e.g., based on K_NRP-SESS) and verify that the anchor UE is actually authorized to act as anchor UE. The UE then sends a Direct Security Mode Complete to the anchor UE so that the anchor UE can actually verify that the UE is the claimed UE and it is authorized. If the anchor UE only distributed the group keys, end-to-end protected, then the UEs can decrypt/integrity verify said group keys. The advantage of not involving NRF related keys or freshness parameters is that less unicast messages are involved improving performance.

According to some embodiments related to the previous one, a UE in the ranging constellation might send its request to the CN directly and may receive an answer from the CN directly. In other words, a UE might not rely on a (n anchor) UE to collect such a message (above DCR message) and send to the CN as a “key request message”, but the UE might send the request directly, e.g., when the UE is in-coverage.

According to some embodiments related to the previous one, the anchor UE might have been pre-configured with an authorization policy that allows determining which UEs are authorized.

According to some embodiments, the CN or the anchor UE might distribute pairwise keys (e.g., instead of, or next to a group key) to one or more members of the ranging constellation so that they can ensure secure communication between each pair of devices respecting the privacy of each of the UEs. For instance, a target UE might receive its location computed by an anchor UE (with a local LMF functionality) protected with a pairwise key shared between target UE and anchor UE.

According to some embodiments, the UEs might receive instead of pairwise keys, a keying material that allows deriving pairwise keys, e.g., a polynomial share derived from a symmetric bivariate polynomial f(x,y) of degree t where the polynomial share of a UE is obtained from f(x,y) by evaluating f(x,y) in x=ID where ID is the identity of the UE.

According to some embodiments, previous authorization step and group key establishment is performed after discovery and after obtaining the UE capabilities of the UEs in a potential ranging constellation and before verifying said capabilities/requesting assistance data/requesting location information to the CN.

According to some embodiments, initial communication in a ranging constellation may be initially protected by means one or more temporary group key derived from, e.g., discovery keys (e.g., the initial exchange of UE capabilities) and said temporary group key is replaced by a session group key upon UEs have been distributed and/or authorized by the CN.

According to some embodiments, the session group key is not distributed and/or authorized by the CN, but it is locally (I.e., in the ranging constellation) generated and distributed upon local user authorization. For instance, the involved discovered UEs might prompt a password/key request to the user so that the user can enter the same password in all involved devices. This password/key might be used as the (root) group key or it might be used in a Password Authenticated Key Establishment protocol (e.g., whose usage is, e.g., illustrated in the case of UE-to-UE relay in TR 33.740, Sol #10) to setup a secure communication link between UEs through which a group key can be securely exchanged. An advantage of this embodiment variant is that ranging can performed even in out-of-coverage when devices lack pre-configured keying materials (e.g., a group key) or pre-configured keying materials have expired.

According to some embodiments, the CN might share a key associated to a UE in the ranging constellation (e.g., K_AF or a key derived from it or a key known to the UE) with the anchor UE so that the anchor UE may:
Manage the group key
Locally authenticate the UE

According to some embodiments, the group key, or keys derived from it, may be used to protect the configuration of transmission of measurements and/or the exchange of measurements.

According to some embodiments, the UEs are configured with a policy that determines at which layer security is provided. For instance, the PC5-U might not be protected by default and the policy might request to secure PC5-U or may request to secure at the higher layer (e.g. SR5 or application layer). For instance, ranging specific security might be done as part of ranging protocols that are transported over unsecure PC5-U.

According to some embodiments, the ranging/positioning protocols (e.g., DSDF, GSSF, SPRF) are configured with a policy determining the preferred type of security protection used (e.g., groupcast or unicast based).

According to some embodiments, the security protection used is negotiated in an initial discovery phase (e.g., DSDF-based) or in the ranging protocol connection setup/configuration phase (e.g. SPRF-based) or in an initial authorization procedure with the CN as in above embodiments.

According to some embodiments related to the usage of the V2X RAT, V2X does not have a discovery phase as in ProSe RAT, and thus, initial negotiation may not be protected in a similar way and/or lack protection. Thus, in the case of V2X RAT, the discovery procedure triggered by the ranging functionality over the SR5 interface might add security provisions to ensure security, e.g., it might scramble certain fields (e.g., XOR with a pseudorandom sequence generated from a pre-configured key and, e.g., a time-based counter by means of a key derivation function) before passing them to the V2X RAT.

According to some embodiments, to ensure a similar protection of V2X and ProSe RATs, security protections are provided by the ranging protocols, e.g., by applying similar protection of ProSe messages (e.g., discovery messages), instead of the underlying RAT.

According to some embodiments, since V2X lacks a discovery phase as in ProSe, the negotiation exchange may happen during the ranging procedure.

According to some embodiments, identifiers used by a UE might be rotated before or after a ranging procedure or in a periodic manner.

According to some embodiments, ranging parameters such as discovery parameters are time limited, e.g., they are valid for a limited period of time so that UEs can only engage in the ranging procedure as long as they have the proper parameters. These parameters might be discovery keys that a bound to a period of time, but they might also be identifiers, e.g., an identifier of the ranging procedure or of the UEs.

According to some embodiments, in order to further protect the privacy of the location of a target UE, an anchor UE in a group of UEs (e.g. a ranging constellation) that has calculated distance, angle or position information related to a target UE may be configured to transmit the resulting distance, angle or position information to the target UE using unicast communication instead of groupcast/broadcast and may be configured to use a separate key for communicating the resulting distance, angle or position information. This helps to prevent leaking sensitive location information to other UEs, including other UEs of the group. This may be configured or provided as part of a privacy profile of a target UE that may be shared beforehand with other UEs of the group of UEs or may be included as part of a ranging/location request to an anchor UE.

According to some embodiments, a first UE, e.g., an anchor UE, may transmit certain messages (e.g., the resulting distance, angle or position to a central location database/server/service, after which only the target UE may be able to retrieve or receive the resulting distance, angle or position information from the respective database/server/service) using a secure unicast connection and certain messages using a secure groupcast message. This may be configured or provided as part of a privacy profile of a second UE (e.g., a target UE) that may be shared beforehand with other UEs of the group of UEs (e.g. UEs in the ranging constellation) or may be included as part of a ranging/location request to a first UE (e.g., an anchor UE).

According to some embodiments, in order to prevent long-term tracking of a location of a first UE (e.g., a target UE (also within a group of UEs)) the first UE may include a temporary identity in the ranging/location request (e.g. a mobile originating ranging/location request) to a second UE (e.g., an anchor UE) that is to be used in the ranging procedure, e.g. to be included in the reporting of the measurement or calculated distance, angle or position information. This temporary identity may only be known by the first/second UEs (e.g., target UE, or the target UE) may share the temporary identity with a ranging service (e.g. LMF, RMF) in the core network or other managing entity, or may be configured with one or more temporary identities (e.g. on a rotation basis or a pseudo-randomization function) to be used for a ranging procedure.

According to some embodiments, a UE (e.g., target UE) may determine a new temporary identity or may request a new temporary identity or may receive a new temporary identity every time it is involved in a ranging procedure.

According to some embodiments, the ranging service (e.g. LMF, RMF) or other managing entity may keep a mapping of temporary identities used for ranging to a permanent identity (e.g. SUPI, 5G-GUTI) used in the core network to uniquely identify the respective target UE.

According to some embodiments, each UE, e.g., an anchor UE, for which the location is known or determined and/or for which the location is to be used for calculating the position of the target UE may use or be given a temporary identity, for which the ranging service or other managing entity may keep a mapping of these temporary identities to a permanent identity used in the core network to uniquely identify the respective anchor UE. Additionally or alternatively, the mapping is maintained in the UDM/UDR and the ranging service or other managing entity may request the permanent identity of a target UE and/or anchor UE when required to calculate a distance, angle or position of the target UE (e.g. after receiving a ranging/location request from the target UE or after receiving measurement request or calculated result related to a target UE from an anchor UE, using one or more of these temporary identities) and/or to share the calculated resulting distance, angle or position information with e.g. the target UE or other core network service. In case of a mobile terminated ranging/location request or a network induced ranging/location request, the ranging service (e.g. LMF, RMF) may include a temporary identity for the target UE and/or the anchor UEs in the configuration and/or a ranging/location request towards the target UE and/or anchor UEs. In such case it may also use the mapping as described above to link the temporary identities to a permanent identity when receiving measurements/results, calculating or sharing the calculated results.

In a related approach, a UE may send a key request to the CN. The key request may include a group ID (e.g. constellation identifier) as well as the UE security capabilities. Based on this key request, the CN may check the supported security capabilities and provide in a key response message parameters such as a group key, a group member identifier, group key identifiers, algorithm identifiers, . . . The group member identifier may also be locally generated by a UE at random. The UE may then derive security keys, in particular, given a group key the UE may derive a transport key, and given the transport key, it may derive an encryption and an integrity key. The UE may then form a secure message including parameters such as (group ID, group member ID, group key ID, transport key ID, counter, payload, and MAC). The first four parameters may be used by a UE receiving the groupcast/multicast message to derive the transport key/integrity key/encryption key used to protect the message. Then given the encryption key and/or integrity key, the receiving UE may decrypt the message (e.g., payload) and verify the integrity/freshness of the message, e.g., based on the counter and MAC.

This approach may still be subject to several considerations that are addressed by embodiments in this disclosure.

In a first consideration, a key request based on a group identifier may not be sufficient. A reason is that the group identifier may not be protected, and thus, an eavesdropper (UE) capturing it may be able to send a request to the CN to retrieve the group key, when the eavesdropper is not authorized.

Thus, according to some embodiments, the above approach may benefit from sending such a key request as described in above embodiments, e.g., including a UE identifier and an authentication value so that the CN can verify whether the requesting UE is authorized or not.

According to some embodiments, the key request message is exchanged over the PC8 interface as defined in Clause 5.2.5 in TS 33.503.

Thus, according to some embodiments, the fields that may be subject to eavesdropping (e.g., group ID) may be scrambled with a scrambling key. In general, the whole message may also be scrambled. Thus, the processing of a message when sending it may involve the following steps: Compute MIC
Encrypt chosen fields (e.g., payload or/and MIC)
Scramble (chosen message fields or the whole message).
The processing of a message by a receiving UE may involve the following steps:
Unscramble (the scrambled message fields or the whole message)
Derive decryption key/integrity key based on the unscrambled fields.
Decrypt (the encrypted fields (e.g., payload))
Verify the message integrity (e.g., based on counter/MAC fields)

The scrambling key may be derived from the group key, e.g., based on a counter, e.g., a time-based counter. This scrambling key should not be dependent on other parameters such as the Group member ID since it is not known.

In a second consideration, parameters such as the group ID or the group ID member are static fields, and thus, a UE may be subject to tracking or it may give an indication about the type of ranging service it is using. Thus:

According to some embodiments, the approach may benefit if message fields such as the group ID or the group member ID are scrambled so that tracking or privacy issues are mitigated.

According to some embodiments, the messages may rely on identifiers that are not static, but are temporary. For instance, the group ID that is broadcasted may be rotated by deriving a temporary group ID identifier by means of, e.g., a key derivation function or a hash function and, e.g., a counter (e.g., a time-based counter) or a nonce.

According to some embodiments, the group member ID is also rotated in a similar way.

According to some embodiments, the group member ID is rotated implicitly by making its derivation dependent of the group ID itself (e.g., by means of a KDF that takes as input the current temporary group ID and a fixed group member ID or a long-term UE identifier). If the group member ID depends on the group ID, then group member IDs are automatically rotated.

In a third consideration a UE may choose its group member ID at random. However, this may lead to collisions, I.e., two different UEs may use the same group member ID, and this may lead to a situation in which both UEs use the same keys. It may also lead to operational issues if the group member IDs are used in the ranging/positioning procedure itself, e.g., if the group member IDs are bound to a given location as in the case of reference UEs. The following procedures are used to deal with this situation.

According to some embodiments, a UE monitors the group member IDs used by other UEs and verifies whether a message includes a group member ID equal to the group member ID of the receiving UE. If the receiving UE detects a collision:
1. the receiving UE may not change its own group member ID if its group member ID was configured by the CN. The reason is that it is assumed that the CN will select group member IDs in such a way that collisions are avoided. The receiving UE may send a request (broadcast) to said group member ID to update its group member ID.
2. the receiving UE may decide to update its group member ID if its group member ID was generated by the UE itself. The UE may then send an information message to inform other group members of the change.

According to some embodiments, the group member identities may be divided into two ranges, a first range used for group member IDs allocated by the CN and a second range used for group member IDs that are self-allocated. For instance, a short range of identities may be reserved for identities allocated by the CN since the CN may allocate those, e.g., in a sequential way or in any other way that collisions are avoided. For instance, a longer range may be reserved for identities that are self-assigned to avoid collisions.

According to some embodiments, whether a group member ID is self-generated (or not) may be indicated as part of the message, explicitly or implicitly. For instance, group member ID may have two lengths that may be used for implicit indication of the type of identifier used.

In still a different approach, a key hierarchy can be defined for groupcast/broadcast including, e.g.:

Positioning Group Key (PGK): A key is provided by a key management function (KMF) in the CN to a group member. This key is used to derive the PTK for a group member in the group.

Positioning Traffic Key (PTK): This key is bound to a group member. It is derived using the PGK based on Group ID, Group member iD, and Group key ID.

Positioning Session Key (PSessK): This key is generated by a group member using its PTK based on key generation time and a nonce. The key is used to generate PSK, PEK and PIK.

Positioning Scrambling Key (PSK): This key is generated using PSessK and used for message privacy protection through scrambling.

Positioning Encryption Key (PEK): This key is generated using PSessK and used for message encryption protection.

Positioning Integrity Key (PIK): This key is generated using PSessK and used for message integrity protection.

The message sending UE performs the following operations:

Construct the message including one or more of group ID, group member ID, group key ID, key generation time, nonce, message generation time, message counter, payload, MAC.

Selects a valid PGK stored locally, generates/derives the PTK using the PGK based on Group ID, Group member ID and Group key ID, generates/derives PSessK using the PTK based on current time and a nonce, and generates/derives PEK, PSK, and PTK using the PSK.

If message integrity protection is enabled, calculate MAC of the message, otherwise the MAC field will be filled with all zeroes or a random value. The integrity algorithms specified in Annex D in TS 33.501 [8] are used to calculate MAC.

If message's privacy/confidentiality protection is enabled, encrypt/scramble the Payload and MAC. The ciphering algorithms specified in Annex D in TS 33.501 [8] are used for the confidentiality protection.

The message receiving UE performs the following operations:

Select a locally stored PGK using the Group key ID carried in the message, calculate PTK, PSessK, PEK, PSK, and PIK in the same way as sending UE based on the parameters carried in the message.

If message's privacy/confidentiality protection is enabled, unscramble/decrypt the ciphertext.

If message integrity protection is enabled, verify integrity protection by checking the MAC of the message.

According to some embodiments, PTK and/or PSessK and/or PEK and/or PSK and/or PIK may be derived by means of a key derivation function (KDF), e.g., based on HMAC-SHA256 taking as input a key and some personalization parameters, e.g., PTK=KDF(PGK, personalization_parameters) where the personalization parameters may be in the case of PTK the concatenation of group ID, group member ID, and group key ID, and, e.g., their respective lengths. The personalization parameters may also include a time value e.g., a UTC-based time counter.

According to some procedures, e.g., as described in Tdoc S3-233882, the input parameters to the KDF may be the group key identifier, or a transport key identity, or a group member ID. These parameters may also be exchanged in broadcast/groupcast messages sent by a sending UE so that the receiving UEs can compute the same derived keys. If a single device uses those identifiers, it is possible to ensure that the identifiers are unique. However, if multiple devices may be assigned/may select those identifiers, there may be collisions. Self-selection of identifiers (e.g., group member ID) is however a useful approach, e.g., when a set of devices perform ranging without network coverage. To address this problem, the following embodiments can be applied:
According to some embodiments, the UEs that self-select the identifiers, e.g., group member ID may do it from a different identifier set or range than the identifier set or range used by a network function (e.g., LMF or (SL)PKMF) to assign said identifiers. This has the advantage of reducing the chances of collision.

According to some embodiments, the self-selected identifiers are selected from a larger range than identifiers allocated by a network function. This allows reducing the communication overhead and differentiating messages originating from devices with self-selected identifiers (e.g., out of coverage) and with assigned identifiers. For example, self-selected identifiers may be 8 bytes long while assigned identifiers may be 3 bytes long. This also allows reducing the chances that two devices with self-selected identifiers select the same identifier. Thus, these self-selected identifiers may be used as input to a KDF as in other embodiments.

According to some embodiments, the identifiers may have a fixed part e.g., prefix e.g., most significant bit, determining whether they are assigned by the network or are self-selected so as to reduce the chance of collision between the two sets of identifiers.

According to some procedures, e.g., as described in Tdoc S3-234279, identifiers such as the SLPTK ID is a UE specific identifier that is incremented every time a new SLPTK needs to be derived. This is similar to the counter value that is transmitted in broadcast/groupcast messages. If the SLPTK is updated in this way, the usage of these UE specific increasing counters can allow, e.g., tracking a UE. Thus, to address this issue, in some embodiments that may be used independently or combined with other embodiments, the SLPTK ID should be updated by applying a randomized function. For instance, a UE can keep track of used SLPTK IDs by using a bitmask of 2\hat{ }b/8=2\hat{ }13=8 kBytes when b=16, I.e., SLPTK ID is 16 bits long. The UE sets the bitmask to 0. The UE can generate random number r, e.g., by applying a function (e.g., KDF) on a random seed and a time counter. The UE can check then whether said r has already been used by checking whether bit r is zero or one. If it is zero, it sets bit r, and uses r as SLPTK ID. If r is one, then it tries again by generating a new random value r and repeating the process. This allows changing SLPTK ID in a non-sequential manner, and thus, avoid tracking. Other functions may be used to update SLPTK ID with the same purpose.

Similarly, in some embodiments that may be used independently or combined with other embodiments, the counter value that as per Tdoc S3-233882 is device specific, and thus can allow for tracking, may be replaced by a time-based counter value, e.g., derived from the UTC-based counter as described in other embodiments. This time-based counter is used with a NIA or NEA algorithm as defined in Annex D in TS 33.501. The counter input of the NIA or NEA algorithms are 32 bit long and it is needed that its input is always unique. If the time-based counter increases every 1 millisecond, and 32 bits are exchanged, then the time overflows after 48 days. The timing may also be different, e.g., it may increase every 10, 100, 1000 ms depending on configuration. The timing with each counter is updated and may depend on the maximum data rate and/or maximum number of messages per second. This value is configurable.

In some embodiments, NIA and NEA algorithms need further inputs such as DIRECTION or BEARER whose input may be set to a configured/fixed value or may be set to a variable value, e.g., MSBs of a time counter, e.g., MSBs of a UTC-based counter.

Similarly, in some embodiments that may be used independently or combined with other embodiments, the LSBs of the time-based counter can be exchanged, e.g., the last 8 or 16 bits, and a counter reconciliation procedure may be applied so that the receiving UE determines exactly the same time-based counter as the sending UE.

Similarly, in some embodiments that may be used independently or combined with other embodiments, the time-based counter may be used directly as the counter input of the NEA/NIA algorithms, or it may be used in the most significant bits of the NEA/NIA algorithm. For example, if the broadcast/groupcast message is 1024 AES (NEA0) blocks long where an AES block is 128 bits long, then the NEA counter may be set as the 22 LSBs of the time-based counter concatenated with a 10 bit digit set to 0, I.e., 00 0000 0000. If the time-based counter runs fast (e.g., changes per millisecond, in general, as fast or faster than the number of messages per second), then the MSBs of the counter will always be unique when passed to the NEA/NIA. The LSB of the counter are initialized to zero and the number of LSBs set to zero should be enough to cover the length of the message measured in the number of blocks of the NEA/NIA algorithm.

In some embodiments, the broadcast/groupcast messages may include a time value, e.g., a time-counter. The receiving UE may check the freshness by verifying that the time-counter is within a time window from its own time, e.g., the absolute value of the difference between the received time-counter from the sending device and the time-counter from the receiving device is not greater than a threshold. The time value included in the broadcast/groupcast message may also be used as an input parameter in the key derivations e.g., SLPTK key derivation.

In another embodiment, the receiving UE may check the freshness of the broadcast/groupcast messages based on the bit value associated with the time-counter, whereby the receiving UE performs an XOR operation between the bit value of the time-counter received, and the bit value of its own timer-counter, wherein the threshold is determined by the position of the MSB set to 1, such that if the result of the XOR operation yields a bit value lower than the threshold, the message is deemed fresh/valid.

According to some embodiments, the PSessK may only depend on the nonce or the time.

According to some embodiments, the time value included in the message is not a complete time value, but only the least significant bits of a time value, e.g., a UTC-based value.

According to some embodiments applicable to above approach and others, which security protections (e.g., encryption, and/or integrity protection and/or privacy protection (e.g., scrambling)) are applied are determined by a policy configured in the devices performing broadcast/groupcast. When a UE sends/receives a message, the UE applies the configuration policy related to the group ID and/or device ID and/or key ID in the message. For instance, within a group, some devices might require confidentiality and other devices may not.

In a further consideration applicable to above approach and others, the transmission of group ID and/or device ID and/or key ID may pose a privacy risk (e.g., allow for tracking), and thus, it may be protected as in other embodiments, e.g., by scrambling it or by rotating it. This is a feature that may be combined with other embodiments or used independently. For instance, a sending UE may scramble said identifiers before transmission, e.g., with a scrambling key that may be derived from PSessK e.g., PSK. The scrambling sequence may only be applicable to those privacy sensitive parameters. The scrambling sequence may be generated, e.g., by using a KDF or a NEA algorithm taking as input the scrambling key and the time and/or a nonce, e.g., the nonce in the message. For instance, a receiving UE may try to unscramble the received scrambled fields and check whether the unscrambled value corresponds to an ID (e.g., group ID) linked to the scrambling key used. If it corresponds to it, the receiving UE can further process the message. Similar logic applies if the fields are not scrambled but if a pseudo-identifier is used, e.g., a pseudo-identifier derived somehow from one of the privacy-sensitive identifiers.

In a further consideration applicable to above approach and others, integrity protection may not be always required. If not required, the MIC field may be set to a predefined value by the UE transmitting the groupcast/broadcast value, e.g., to all zeros. However, this behavior may disclose whether the message is integrity protected or not. This is a problem since it can allow a passive attacker to determine faster which messages can be replayed. To address this issue one or more of the following embodiments may apply.

According to some embodiments that can be combined with other embodiments or used independently, the MIC used to protect the ranging information in groupcast/broadcast is always encrypted even if the rest of the message is not (e.g., if the policy does not require confidentiality protecting the groupcast/broadcast message).

According to some embodiments that may be combined with other embodiments or used independently, the MIC used to protect the ranging information in groupcast/broadcast is set to a random value if the policy does not require integrity protecting the groupcast/broadcast message.

According to some embodiments, the MIC is verified based on a configuration policy or integrity protection indication’ in the message (e.g., a field that may be confidentiality protected). If the configuration policy requires integrity protection, the MIC is verified; if it does not require integrity protection, the MIC is not verified.

According to some embodiments that may be combined with other embodiments or used independently, the groupcast/broadcast includes an integrity protection indication field indicating whether the message is integrity protected or not.

In still a different approach, the LMF may manage the groupcast/broadcast encryption keys to be used in one or more tracking areas, registration areas or cells. The LMF may share them with the AMF. In particular, the LMF may share one or more sets, each set may include the encryption key, encryption key identifier, a validity period, set of applicable tracking areas or registration area or cell IDs, and set of applicable types of positioning/ranging broadcast/groupcast data. The AMF may store those sets. A UE (e.g., a target or Reference UE) may use a registration request as per TS 23.502 to obtain broadcast/groupcast encryption keys for positioning/ranging. The request may include an indication of the broadcast/groupcast encryption keys required. If authorized to receive encrypted positioning/ranging broadcast data, the AMF includes in the Registration Accept one or more positioning broadcast keys applicable to the current tracking area, registration area or cell. Given the provided keys, a reference UE may send encrypted positioning/ranging groupcast or broadcast data. The Target UE may start to use a broadcast/groupcast encryption key for positioning/ranging once the validity period for the encryption key has started and if the UE is currently in an applicable tracking area, registration area or cell. The UE may cease using a broadcast/groupcast encryption key for positioning/ranging when entering a tracking area, registration area or cell not applicable to the broadcast/groupcast encryption key. The UE shall cease using and shall delete a broadcast/groupcast encryption key for positioning/ranging when the validity period for the SL positioning broadcast/groupcast ciphering key has expired. In a related approach designed to protect groupcast/broadcast sidelink positioning data in, e.g., out of coverage, multiple UEs (e.g., a target UE, reference UEs, and a server UE) may be capable of communicating with each other. The server UE may initially generate some encryption keys, for each key it may include metadata that includes a key value, a key identifier, a validity period, a set of applicable tracking areas or registration area or cell IDs and a set of applicable types of SL positioning broadcast/groupcast data. The UEs (e.g., target UE or reference UE) may send a sidelink positioning encryption key request to the server UE. This may be part of a normal PC5-signalling procedure or part of a ranging protocol. The UE may include an indication of the required encryption keys. The server UE may then return the requested keys as well as related metadata. Then the UEs can use the encryption keys to protect the group communication.

A first consideration in these approaches is that only encryption keys are handled. Even if encryption keys may be used to protect the privacy of the messages, messages may still be modified.

Thus, according to some embodiments, the CN (e.g., LMF and/or AMF and/or other NF) should handle also integrity keys or group keys used to provide integrity protection as in other embodiments in this filing.

A second consideration in these approaches refers to the process of performing authorization at the AMF whether a UE is entitled to receive certain keys.

According to some embodiments, the AMF may receive from the LMF not only one or more sets, each set including the encryption key, encryption key identifier, a validity period, set of applicable tracking areas or registration areas or cell IDs, and set of applicable types of positioning/ranging broadcast/groupcast data, but also the identities of the UEs that are authorized/are subscribed to said broadcast/groupcast data.

According to some embodiments, the AMF may request said subscription data from the AUSF/UDM/UDR

A third consideration in these approaches related to the UE behavior when the validity period of a key is about expiring because a sending UE may use an old key, and when receiving (a message (e.g., containing a measurement) from the sending UE) the receiving UE may use the new key so that the decrypted payload, e.g measurements, would be wrong/garbage. This impact is even bigger since messages are only encrypted, and thus, decrypted data will be accepted as valid and further processed. A similar issue as with this timing boundary happens with location boundaries, e.g., when keys are bound to tracking areas (or registration area or cell) and a UE is moving from a tracking area (or registration area or cell) to another adjacent tracking area (or registration area or cell).

Thus, according to some embodiments, the sending UE and receiving UE should make use of an integrity check, e.g., a MIC, to make sure that the data has been decrypted with the correct key. This serves as implicit verification that the correct keys are used.

Thus, according to some embodiments, the message may include the identity of the key used for encryption. This serves as an explicit verification of the used keys. The receiving UE should use said key.

According to some embodiments, the receiving UEs may (try to) process the incoming messages with both the current and old encryption/integrity keys. Note that this approach also allows for keys that are simultaneously valid, at least, for some time. For instance, K1 may be valid from T0 to T2 and K2 may be valid from T1 to T3 and T0<T1<T2<T3. This ensures that the broadcast messages are properly processed even in the key validity boundaries. A similar approach can be used for tracking areas (or registration area or cell) where a UE that is moving to a second tracking area (or registration area or cell) may use, e.g., to decrypt, both the key of the old tracking area (or registration area or cell) and the key of the new tracking area (or registration area or cell).

According to some embodiments related to the previous one, the CN (e.g., AMF) may deliver to a UE not only the group keys associated to the current validity period or tracking area (or registration area or cell), but also to subsequent validity periods and/or adjacent tracking areas (or registration area or cell). This embodiment combined with previous embodiments aims at improving (ranging/positioning) service continuity.

In a fourth consideration, the LMF requires information about the tracking areas (or registration area or cell) in order to provide meaningful key configurations back to the AMF.

Thus, according to some embodiments, the LMF may send a request to the AMF to retrieve such configurations.

According to some embodiments, the key management functionality may be at the AMF so that the LMF just indicates the requirements (e.g., a key per tracking area/given area/etc) and the AMF is in charge of key management (generation, distribution, deletion, etc). This provides a better split of responsibilities between AMF and LMF.

In a fifth consideration, the LMF handles sets of keying material where each set may include an encryption key value, an encryption key identifier, a validity period, a set of applicable tracking areas (or registration area or cell) and a set of applicable types of SL positioning broadcast/groupcast data. This may be an issue because many sets of keys may then be needed (per tracking area (or registration area or cell) and service).

According to some embodiments is to link key to locations and keys to services. A UE that is subscribed to services A and B receives then keys KA and KB and if the UE is in area 1 and area 2, then the UE receives K1 and K2. Then when a UE is using service A in area 1, then the UE can compute a group key as K=F(K1, K2), I.e., K is a function F( ) of K1 and K2, e.g., a hash function, or an HMAC, or a KDF. Such an approach allows for simpler key management since keys related to locations may be managed solely based on location information and keys related to services are managed solely based on the subscribed services. Such an approach allows for stronger security because even if a key of a type (e.g., location 1 and service A) is compromised, then UEs of a second service at same location 1 can still communicate in a secure manner.

According to some embodiments, the broadcast messages are not integrity protected by means of a Message Integrity Code, but the encryption covers at least a field known to all UEs in the group, and in particular, to the receiving UEs. If a receiving UE does not use the correct decryption key, the well-known field is wrongly decrypted, and thus, the receiving UE knows that the message has not been properly decrypted and the wrong decryption key was used. For instance, a sending UE might include in the message a field such as the group ID. The sending UE may encrypt both the payload and group ID, e.g., by using an encryption key (derived e.g., from a group key) and a NEA algorithm. The receiving UE might not know to which group the broadcast/groupcast message belongs, and thus, the receiving UE might need to try out multiple (decryption) keys. The UE knows that the right decryption key is chosen if the decrypted group ID field in the received message matches the group ID linked to the decryption key used in decryption. This approach may have the advantage of being more lightweight (since a MIC does not need to be computed and a MIC does not need to be transmitted). This embodiment variant may be used to improve above approaches.

In certain situations, a UE may leave a group or may lose its authorization to be part of the group. When this happens, the following embodiments might apply.

According to some embodiments, the entity handling/managing the group keys may send a group key update message to all group members that are still authorized. The group key update message may require updating any keys that were known to the UEs that have left the group. The entity handling the group keys may be notified/may ask the entity managing the group whether/when the group membership changes so that key update messages can be sent as soon as possible. The key update message might include conditions to perform the key update, e.g., that a minimum of UEs in the group (e.g., a minimum of reference UEs and a minimum of target UEs) have received the new group keys so that the ranging service operation is not compromised.

According to some embodiments, the group keys might be linked to a short lifetime so that an active key update procedure is not required because compromised group keys rapidly expire. This, however, may require setting/configuring a schedule in the UEs/group key owner to ensure that new group keys are timely delivered before the old ones expire.

According to some embodiments, a UE may be configured with a policy or receive a message (e.g. from the LMF) that determines whether certain SL positioning data (e.g. SL positioning assistance information) is to be transmitted using groupcast/broadcast over sidelink. Different policies may be configured for different types of devices or scenarios, e.g. an Anchor UE that is in coverage of the network that needs to broadcast SL positioning assistance information to other Anchor UEs and/or to a Target UE may be configured differently than a Target UE that needs to broadcast SL positioning assistance data to a set of Anchor UEs, and may be configured differently from a ProSe UE-to-Network or UE-to-UE relay node that simply needs to “forward” received information.

Such policies or message received to determine whether certain SL positioning data is to be transmitted using groupcast/broadcast over sidelink may include:

The context for broadcasting the data, e.g.,
if a UE is aware of other UEs that are out-of-coverage, then the UE is required to perform broadcasting/groupcasting; or
broadcasting/groupcasting may only be allowed/required at specific times (e.g., rush hour) or in a given location/area; or
broadcasting/groupcasting may only be allowed when network load (e.g., number of UEs) is higher than a threshold, or
broadcasting/groupcasting may only be allowed to a UE when the UE receiving a message that includes SL positioning data, has not seen/received said message and/or its information (e.g. SL positioning data) (re-)broadcasted/(re-)transmitted over the local interface (sidelink/PC5), e.g., at least once or at least a minimum number of times, e.g., N.
broadcasting/groupcasting may only be allowed to a UE (UE1) when the UE receiving a message including SL positioning data is aware of other UEs (e.g., UE2, an out-of-coverage UE) that are interested/have registered to the data included in the received message. For instance, if UE2 has indicated to UE1 that is interested in positioning/ranging assistance data, then UE1 would broadcast/distribute the received SL positioning data.
broadcasting/groupcasting may only be allowed if the UE has received discovery messages from a minimum number of other UEs.
broadcasting/groupcasting may only be allowed if the forwarding of the message has not reached a maximum number of times (e.g. based on number of hops between the UE and the network).
broadcasting/groupcasting may only be allowed if the UE acts as a particular type of relay (e.g. Layer-2 ProSe UE-to-Network relay, Layer-3 ProSe UE-to-Network relay, Anchor UE in coverage forwarding messages (e.g. LPP messages) to/from the network on behalf of a target UE that is out-of-coverage)

The role of the UE for broadcasting/groupcasting the data, e.g., only anchor UEs or reference UEs may be allowed to perform broadcasting/groupcasting, or even only UEs (e.g., Reference UEs) with this specific broadcasting/groupcasting role; e.g., only devices with relay capabilities such as UE-to-Network relays or UE-to-UE relays.

Security policy determining how the broadcasted message is to be protected.

Which subset of the received data (e.g. only SL positioning assistance data received as part of the SL positioning data that is intended for other UEs than the UE receiving the data (e.g. indicated with a different (set of) device IDs)).

TS 33.533-100 includes procedures for secure groupcast and broadcast in Clause 6.4.4 according to some embodiments in this invention. However, these procedures still have a number of problems that need to be addressed:
First, Clause 6.4.2 in TS 33.533-100 includes the following requirement: “The 5G system shall support a means to provide confidentiality, integrity and anti-replay protection of SL positioning signaling during broadcast/groupcast communication for Ranging/SL positioning.” However, the procedure in Clause 6.4.4 does not provide means for anti-replay protection.
Second, Clause 6.4.4 states that the Group member ID may be generated randomly if not assigned by the SLPKMF. Self-generated IDs have the advantage of being able to rotate them to prevent an attacker from linking/tracking. However, if the IDs are short, two UEs may select the same IDs.
Third, the usage of a constant or device specific SLPGK ID allows linking UEs. Similarly, the usage of a constant or device specific SLPTK ID, counter allows linking messages and tracking specific UE.
A time counter may need to be exchanged to ensure freshness. Instead of exchanging the whole-time counter only the b least significant bits may be exchanged for performance reasons. However, this requires that all UEs can recover the sending UE's time counter.

It is an aim of the invention to address above shortcomings by means of the embodiment variants in this invention and/or one or multiple of the following approaches.

In a first approach, the UEs (e.g., sending/receiving UEs) are configured with a freshness time threshold. This is a parameter used by the UEs to determine whether the messages and/or keys are still fresh. This parameter can be configured in Step 1b in Clause 6.4.4 in TS 33.533-100. This parameter may be related to the maximum time difference allowed between the times of different UEs.

In a second approach, a sending UE selects security parameters on the basis of their validity time. For example, a sending UE has to choose security parameters (I.e., SLPGK, SLPGK ID, . . . ) that are valid according to their validity time, e.g., the sending UE has to check that they have not expired based on validity time and/or its local time and/or the freshness time threshold, or selects the parameters that have the longest remaining validity time. When the freshness time threshold is used, the sending UE should only use some security parameters when the time of the sending UE has not reached a function of the validity time and the freshness time threshold, e.g., the validity time minus the freshness time threshold. If a UE determines that its current time is very close to the validity time expiration, closer than the freshness time threshold, the UE may wait till other set of security parameters becomes active, or it may try using that set of security parameters and (re-)transmit as soon as another set of security parameters becomes active.

In a third approach, the receiving UE checks that (1) the security parameters (e.g., the SLPGK, . . . ) are valid or fresh according to the validity time of the SLPGK, the freshness time threshold, and the receiving or sending UE time (2) the time difference between the received time counter and its own time counter is within the freshness time threshold. If both checks succeed, the receiving UE proceeds to step 2. in Clause 6.4.4.3.2 in TS 33.533-100. Otherwise, the receiving UE drops the received message.

In a further related approach to the previous one, when only the least significant bits of the time counter are exchanged, the receiving device may not be able to make one or more checks, e.g., the second check. In this case, the receiving UE proceeds to decrypt and verify the message integrity. The successful message integrity verification implicitly ensures message freshness if the recovered time value is used in the key derivation functions used to obtain the integrity key. In a further approach, the procedure for deriving the keys from SLPTK outlined in Clause 6.4.4.4 in TS 33.503-100 is improved to ensure the freshness of the messages. In particular, the time counter is used as input in the key derivation function as in Annex A.4 (additionally/alternatively in A.3) in TS 33.503-100. This ensures that the time counter is used as input in the computation of the encrypted sequence and the MIC, so that if a different time counter is used, the decryption and/or integrity verification will fail. In particular, Annex A.4 may take as additional input:
P2=Time counter
L2=length of Time counter.

In a further approach, instead of transmitting the complete time counter, e.g., an UTC-based time counter, only the m least significant bits of the time counter are transmitted under the assumption that the time of the transmitting and sending UEs are roughly synchronized. For instance, if the times are synchronized up to 2\hat{ }m−1 time units, then the m least significant bits may need to be exchanged.

In a further approach, when the SLPKM assigns a group member ID to a UE in Step 1b in Clause 6.4.4 in TS 33.533, the SLPKMF shall ensure that the group member IDs are unique per SLPKG.

In a further approach, a UE receives the current time from the core network in Step 1b in Clause 6.4.4. in TS 33.503-100. Upon reception, the UE has to check that its local time is close to the received current time from the core network, e.g., up to function of the freshness time threshold.

In a further approach, the SLPTK may be derived from a time counter instead of from the SLPTK ID. This allows reducing the number of fields and message size of the message shown in FIG. 6.4.4.3.1-1 in TS 33.503-100.

In a further approach, the fixed or device specific IDs such as SLPKG ID, SLPTK ID, group member ID, etc are scrambled with a time-changing sequence to mitigate trackability/linkability attacks. This time-changing sequence may be directly derived from SLPGK for performance reasons. The the k least significant bits of the time-based counter may be set to zero for performance reasons, I.e., to avoid the frequent re-computation of time-changing pseudorandom sequences. The scrambling parameter k may be configured in Step 1b in Clause 6.4.4 in TS 33.503. The scrambling parameter k determines the number of least significant bits set to zero. If k is equal to the length of the time counter, scrambling is not applied. Whether scrambling is applied or not may also be indicated in a different manner, e.g., an explicit manner. When calculating a scrambling sequence from SLPGK, the following parameters shall be used to form the input S to the KDF that is specified in Annex B of TS 33.220 [12]:
FC=TBD
P0=Time counter setting the k least significant bits to zero where k equals the scrambling parameter k.
L0=length of Time counter

The input key shall be the 256-bit SLPGK.

In above embodiments, the time counter needs to be exchanged to ensure freshness. Instead of exchanging the whole-time counter only the b least significant bits may be exchanged for performance reasons. However, this requires that all UEs can recover the sending UE's time counter. To achieve this, a counter reconciliation procedure may be applied. For instance, a time counter may be n bits long. A sending UE may reduce communication overhead by only transmitting S0, the b<n least significant bits of its time counter S=S1*2\hat{b}+S0, in the groupcast/broadcast message. The receiving UE with local time counter R=R1*2\hat{b}+R0 determines S from R and S0 as follows under the assumption that S and R differ up to T<=2\hat{ }m=2\hat{ }{b−1}time units:

```
If ABS(R0-S0)>=2\hat{ }m,
  if R0 > S0
    C1= R1 + 1
  Else
    C1 = R1 − 1
Return S = C1 | S0
```

### Section: Mbs Supported Ranging

In some scenarios, ranging and positioning may exhibit low performance since the delivery of ranging related parameters may lack adequate performance. In some scenarios, existing procedures for the broadcast/multicast of positioning related parameters (e.g., assistance information) may not be secure enough. Thus, an aim is to provide performing and secure procedures for the broadcast/multicast of ranging and positioning information.

According to some embodiments, broadcast may be done by means of Multicast-Broadcast Services (e.g., as in TS 23.247, TS 26.502 or TS 33.501 (Clause W)). Broadcast distribution may be useful for the distribution of ranging related parameters. UEs subscribing to the ranging service may then subscribe to a related MBS service used for the distribution of ranging related parameters so that subscribed UEs can rapidly receive parameter updates, e.g., a subset of subscribed UEs that are going to perform a ranging procedure. This may be especially useful for ranging use cases in which many mobile UEs are involved, e.g., as in V2X scenarios.

According to some embodiments, the multicast/broadcast from the network to a group of UEs involved in arranging session may be performed as in Clause 7.5.1 (Group Message Delivery via MBS Broadcast) in TS 23.247 v18.0.0.

According to some embodiments, the multicast/broadcast from the network to a group of UEs involved in a ranging session may be performed as in Clause 7.2.4 (Support of Local multicast service and Location dependent multicast service) in TS 23.247 v18.0.0.

According to some embodiments, a ranging service is bound to one or more MBS services used to deliver ranging related parameters where the ranging service/MBS service may be bound to, e.g., an area (e.g., a tracking area), a period of time (e.g., during the day), or a context. For instance, a ranging service might use multiple MBS services/sessions, each bound to a different area.

According to some embodiments, the PCF includes the function to provision UE and AMF with parameters to support ranging including the provisioning of a policy with parameters for ranging over Uu reference point for MBS.

According to some embodiments, an AF or a NF (such as LMF) may:
request NEF/MBSF for allocation/de-allocation of a set of TMGIs, and/or
   initiate multicast or broadcast service from the 5GC by providing service information including QoS requirement to 5GC.

According to some embodiments, an AF or a NF (such as LMF) may distribute ranging parameters (in an area) over MBS to the UEs subscribed to the ranging service (in that area).

According to some embodiments, ranging message transfer via MBS may be achieved by locating the MBS CN NFs (e.g. MB-UPF) closer to the RAN (e.g., gNB) to meet the latency requirement.

According to some embodiments, the MBS CN NF and the ranging CN NF may be both located close to the RAN to better meet latency requirements.

According to some embodiments, a broadcast session is established, e.g., by using a method (e.g., as in TS 23.247) where an AF or a NF (such as LMF) may request the broadcast session establishment.

According to some embodiments, a UE may register to the network and it may report its ranging requirements and/or capabilities. The UE may also report its (rough) location (e.g., position, speed, direction, . . . ). This information may then be shared to the rest of UEs to be part of a ranging constellation by means of multicast/broadcast.

According to some embodiments, if a multicast/broadcast session is not established yet, as in previous embodiments in which the UE indicates its ranging requirements/capabilities, the 5G network may establish a multicast/broadcast session.

According to some embodiments, upon establishment of the multicast/broadcast session, the network may start multicasting/broadcasting ranging information related to one or more of the following properties and procedures:

An establishment request for a ranging/positioning session,
UE capabilities,
Configuration parameters for transmission and measurement,
Measurements,
Location results.

According to some embodiments,

A target UE sends a request (e.g., unicast message) including its UE capabilities to the network to establish a ranging/positioning session,

The core network identifies the rough area of the target UE and sends a (MBS) multicast/broadcast message to configure parameters for transmission and measurement in the (e.g., selected anchor) UEs to be part of the ranging/positioning session,

The target UE and selected UEs engage in performing measurements that are then shared (e.g., unicast message) with the network and/or among themselves (e.g., by means of unicast/local (PC5) multicast,

The network may compute location/ranging information and may share the results with the UEs, e.g., by means of unicast or multicast/broadcast if the security policy allows it.

According to some embodiments, the procedures are executed in an iterative manner via broadcast (network to UEs) and unicast (UEs to network) in which (1) the network may broadcast information related to a first procedure, (2) the UEs may process the received broadcast information and may provide input to the network via unicast links, (3) the network may wait to receive information from the UEs, and (4) the network may broadcast information from a subsequent (second) procedure.

According to some embodiments, a UE may have an apparatus and/or method to:
receive information of a first ranging procedure through an MBS multicast/broadcast channel, e.g., related to one of the procedures in previous embodiments, e.g., configuration parameters for transmission and measurement and/or a group key for a local communication interface,
And perform one or more of the following actions:
perform local or PC5 operation (e.g., ranging procedure),
Securely exchange ranging information (e.g., measurements or results) over the local communication link,
inform via unicast the network (e.g., a NF such as LMF) of the results of the previous local operation,
(Securely) inform close by UEs via local unicast/multicast of the results of the previous local operation,
receive information of a second ranging procedure through the same multicast/broadcast channel.

According to some embodiments, a NF in the CN and/or an AF and/or RAN may have an apparatus and/or method to:

Send information of a first ranging procedure through an MBS multicast/broadcast channel, e.g., related to one of the procedures in previous embodiments, e.g., configuration parameters for transmission and measurement and/or a group key for a local communication interface,

And optionally, receive via unicast from at least a UE information related to a local operation or PC5 operation,
and optionally, prepare or computed information of a second ranging procedure based on the received unicast information,
and optionally, send information of the second ranging procedure through the MBS broadcast channel.

According to some embodiments, (a NF in) the CN or an AF may have certain ranging/broadcast requirements affecting RAN, e.g.:
allocation and broadcast of PRS signals in such a way that is done in a privacy aware manner preventing tracking, and/or
allocating resources for performing local ranging/positioning over PC5, and/or
MBS broadcasting to certain UEs subscribed to a ranging service), etc so that:
The CN and/or an AF may interact with the AMF and/or RAN to inform about the ranging/positioning request affecting the communication resources managed by RAN,
The RAN may then
allocate resources and inform the affected UEs (e.g., via NAS and/or RRC message), and/or
Allocate resources and provide details about the allocated resources to the CN and/or AF so that CN and/or AF may allocate those resources on behalf of RAN.

According to some embodiments, the network may distribute by means of secure multicast/broadcast (e.g., based on MBS) a group key to be used to protect the local (PC5/sidelink) ranging communication.

According to some embodiments, the group key to be used to protect the local (PC5/sidelink) ranging communication may be derived from or based on the MSK or MTK used for secure multicast/broadcast (e.g., based on MBS).

According to some embodiments, MBS is also used for the management of the group key to be used to protect the local (PC5/sidelink) ranging communication. For instance, for the distribution of a group key to be used for local communication where the group key is determined by a NF in the CN.

According to some embodiments, MBS is only used for the management of the group key to be used to protect the local (PC5/sidelink) ranging communication.

According to some embodiments, MBS capabilities for group management are reused for the management of ranging groups.

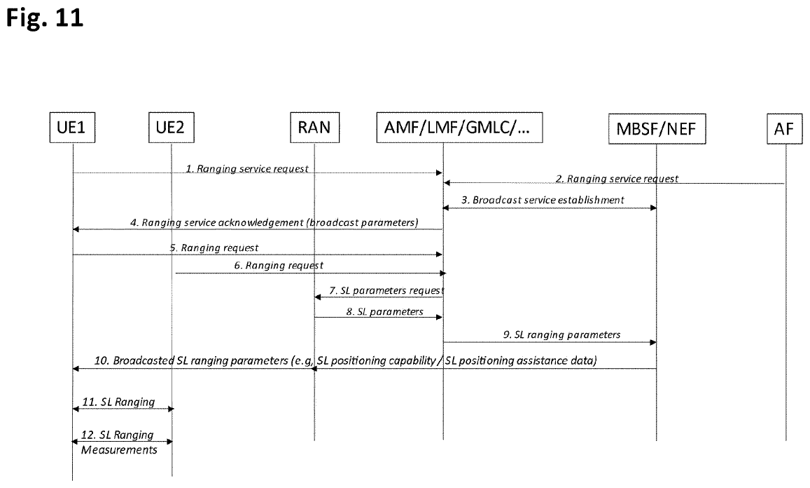

According to some embodiments illustrated by means of FIG. 11, a possible procedure for performing ranging supported by MBS is described. The steps below are illustrative, their order may change, steps may be executed multiple times, and additional steps (e.g., related to other embodiments) may be added.

In step 1, a UE may request the establishment of a ranging service.

Additionally, or alternatively, the request may be sent by an AF in Step 2. The receiving entity may be a NF in the core network of the telecommunication system, e.g., AMF, LMF, GMLC, etc.

Next (Step 3) the receiving entity may interact with an NF in charge of MBS such as the MBSF to establish a broadcast service.

In step 4, the receiving entity may send a ranging service acknowledgement that may include, e.g., the broadcast parameters. Alternatively, said parameters may be distributed by the NF in charge of MBS. These parameters may include group/broadcast keys such as MTK and MSK as used in TS 33.501, Annex W.

In steps 5 and 6, one or more UEs (e.g., UE1) may send a ranging request to start a ranging session.

The receiving entity may interact with RAN to retrieve/receive sidelink(SL)/PC5 parameters to perform the ranging operation (Steps 7 and 8).

The receiving entity (e.g., AMF/LMF/GMLC/etc) may then send ranging messages/information to a broadcast NF (e.g., MBSF) in Step 9.

The broadcast NF may then broadcast the SL/PC5 ranging information in the broadcast message in Step 10.

UEs (e.g., UE1 and UE2) may perform ranging measurements in Step 11 based on the received information in Step 10.

UEs (e.g., UE1 and UE2) may perform secure local communication in Step 12, e.g., based on a local group key that is managed/distributed based on MBS or derived from MBS keys.

According to some embodiments, a first UE may exchange through a local PC5 interface information (e.g., a security token) to a second UE and the second UE may report this value to the network so that the network can validate that both the first and second UE are within communication range and are part of a/the same (MBS)/channel broadcast session/channel/ranging procedure.

According to some embodiments, the security token may be a value generated by the first UE or provided by the network to the first UE.

According to some embodiments which can be combined with the previous embodiment, the security token may be a value generated by a first UE and provided to the network—via unicast—so that the network can validate the value (e.g., security token) when received from a second UE.

According to some embodiments, the network can validate that a value—received via unicast from a second UE—has been broadcasted by the first UE to the second UE via a local PC5 interface.

According to some embodiments,
the network may provide the first UE with a cryptographic value (e.g., a key) in a secure manner (e.g., through secure unicast connection, e.g., a NAS message, UPU message, or RRC message)
   the first UE may use said cryptographic value to compute and transmit over a local communication interface (e.g., PC5) an authentication value (e.g., a MIC), e.g., bound to each of above iterations, e.g., by taking as input a counter (e.g., a UTC based counter and/or a function dependent of the distributed information),

The second UE may receive the authentication value through the local communication interface,

The second UE may send the authentication value (e.g., in a secure uplink unicast message) to the network for verification.

According to some embodiments, the network may:

Confirm that a second UE is within local communication range with the first device if the network received the authentication value of the first device from the second UE.

Exclude a second UE from a ranging group/MBS session if the network did not receive the authentication value from the second UE.

In a related embodiment variant, the anchor UEs, e.g., in an area, may be part of a first MBS broadcast session,
the target UEs, e.g., in an area, may be part of a second MBS broadcast session, and
   the anchor UEs and target UE, e.g., participate in a common ranging/positioning session.

According to some embodiments,

a second UE may securely send an authentication value to the network and/or the network might compute such authentication value given some information known to/configured into the second UE (e.g., a key).

Moreover, the network may securely share said authentication value with a first UE, and the first UE may broadcast said authentication value through a local communication interface (e.g., PC5) so that the second UE can verify that the first UE is authorized to perform the ranging/broadcast action.

### Section: Ran-Broadcast Supported Ranging

In some scenarios, UEs need to receive ranging (also positioning) information that is required to perform the ranging/positioning operations. However, it is not clear how to distribute said information efficiently and security.

In an embodiment of this disclosure that may be combined with other embodiments or used independently, ranging related parameters may be broadcasted by means of a RAN broadcast channel. This is advantageous because it allows for improved performance since UEs can listen to broadcast messages in the RAN and have direct access to them.

In a related embodiment variant, the ranging information may be_broadcasted in a broadcast RRC message or in a SIB (Ranging SIB, R-SIB), this might be an existing SIB or in a new SIB.

In a related embodiment, resources and/or approach to retrieve R-SIB may be specified in SIB1 or communicated in a secure RRC message or communicated in a secure NAS message or by means of UPU.

In a related embodiment variant, the R-SIB includes ranging information required for performing ranging in a given area. This may include:

Ranging/configuration parameters to be used in the area such as communication resources used for ranging;

Identities/locations of ranging UEs (e.g., anchor UEs) to be used in the area;

PRS allocated to given UEs, e.g., reference UEs;

Ranging/positioning methods that may be used;

In a related embodiment variant, the R-SIB may be broadcasted on demand upon UE request, e.g., when a UE enters a given area and the UE tries to access ranging services.

In a related embodiment variant, the R-SIB might be broadcasted in a regular basis, e.g., in areas where ranging services are offered.

In a related embodiment variant, the RAN (e.g., gNB) may request and/or receive an update from the CN (e.g., AMF, or LMF, or RMF, etc) related to the type of R-SIB to broadcast and/or periodicity and/or required parameters.

In a related embodiment variant, the RAN (e.g., gNB) may request and/or receive an update from the CN (e.g., AMF, or LMF, or RMF, etc) related to the UEs, e.g., anchor UEs, present in an area and the ranging related parameters associated to those UEs.

In a related embodiment variant, the RAN (e.g., gNB) may request and/or receive an update from a UE related to ranging and/or positioning parameters associated to or measured by that UE. For instance, if the UE acts as a reference UE with a known position, the UE may report (e.g., in a RRC message) to the gNB its (differential) measurement of a PRS broadcasted by the gNB, so that the gNB can broadcast such (differential) measurement to other UEs in the area.

In a related embodiment variant, a UE may receive R-SIB and use it to (1) search (over sidelink/PC5) potential UEs (e.g., anchor UEs) in its area offering ranging services and/or (2) perform ranging with said UEs.

In a related embodiment variant, a UE may receive R-SIB and use it to (1) search (over sidelink/PC5) potential UEs (e.g., anchor UEs) in its area offering ranging/positioning services and/or (2) perform an improved positioning measurement (e.g., based on a differential positioning method) by receiving and processing positioning measurements (e.g. differential measurements) from said UEs.

In a related embodiment variant, the positioning measurement/parameter may be received

from the UE through a PC5 communication link and/or

From an access device whereby the access device may receive the positioning measurement/parameter directly from the UE (e.g., via RRC) or indirectly from the UE via a NF (e.g., LMF) in the CN.

In a related embodiment variant, the contents in R-SIB may be protected (encrypted and/or integrity protected and/or scrambled) in a similar manner as above embodiments. Note that this has the advantage compared with TS 38.305 (Clause 7.5) that messages cannot be subject to modification or injection.

In a related embodiment variant, a UE that has registered/subscribed to a ranging service is distributed/assigned/allocated a group/broadcast key, e.g., by an entity in the CN in charge of the ranging service or in charge of managing group/broadcast keys of the ranging service.

In a related embodiment variant, the group/broadcast key may be a symmetric key used directly or derived for scrambling and/or encryption and/or integrity protection.

In a related embodiment variant, the message is only encrypted/scrambled and it does not include a MIC, but integrity protection is achieved by:

The RAN/CN including a message field (e.g., group identifier) in the message that is known to the receiver (UE) and linked to the encryption/scrambling key;

The RAN/CN performing encryption/scrambling the whole message with a key linked to that message field (e.g., identifier);

The RAN transmitting said message;

A UE receiving said message;

The UE doing blind decryption/unscrambling of the message by trying keys linked to the message field (e.g., group identifier);

The UE checking that the decrypted message field (e.g., group identifier) matches the message field (e.g., its group identifier) or is linked to the key used for decryption/unscrambling upon decryption/unscrambling.

This procedure has the advantage of achieving a certain degree of integrity protection with lower computational needs.

In a related embodiment variant, the group/broadcast key may be a public key used to verify the source origin of the ranging information broadcasted in the R-SIB.

In a related embodiment variant, the broadcasted R-SIB includes a digital signature that protects the contents of the data so that a UE receiving the signed data can verify the origin of the data.

In a related embodiment variant, the integrity check (e.g., signature) includes a counter (e.g., C1 computed as C0+D0 as in TS 36.355) to ensure freshness.

In a related embodiment, the R-SIB includes an authorization token.

In a related embodiment, the authorization tokens included in the R-SIB are managed and distributed by a NF in the CN or an AF.

In a related embodiment, the authorization tokens are added to the data included in the R-SIB by a NF in the CN or an AF.

In a related embodiment, the authorization tokens are provided to the RAN, when RAN is authorized, so that RAN can add/append/attach the authorization tokens to the broadcasted R-SIB.

In a related embodiment variant, the group/broadcast key may refer to an anchor of a hash chain used to verify the source origin of the ranging information broadcasted in the R-SIB by means of a TESLA like scheme where the hash chain may be maintained/managed by a NF in the CN (e.g., LMF) or RAN.

In a related embodiment, the R-SIB or a protected field in R-SIB includes a counter value such as a time-based counter used as input in the decryption, integrity verification routines.

For instance, the counter may be the least significant bits of a UTC-based counter, e.g., a UTC-based counter with a time resolution of around ten seconds (the SFN length is 10*2 =10.24 seconds) so that it is only necessary to transmit, e.g., one (1) least significant bit to resolve inconsistencies if the messages are transmitted with latency lower than 10 seconds.

For instance, the counter may be enhanced/extended with the SFN in which the R-SIB is broadcasted. This extended counter may then be constructed as the time-based counter and SFN. This extended counter may then be used as input to, e.g., the NEA or NIA algorithms.

For instance, this time resolution might be lower, e.g., in the order of 1 day and as well, a single (1) least significant bit might need to be transmitted to resolve inconsistencies if the messages are transmitted with the latency of 1 day.

For instance, this time resolution may be configured/specified in SIB1 or configured by means of a NAS or RRC message.

The advantage of using a time-based counter is that this value may not need to be communicated to the receiving devices as is the case in TS 36.355 where in Clause 7.3 it is specified that the C0 counter value is provided as the initial counter.

In a related embodiment, above time-based counter is used next to or instead of C0.

In a related embodiment, instead of a time counter, a nonce is used.

In a related embodiment, a time-based counter or nonce may not be enough since some data might be segmented into multiple data segments and broadcasted in multiple SIBs. Thus, a function such as a key derivation function (e.g., HMAC-SHA256 as in TS 33.220) may be used to derive a session group/broadcast key. The inputs of the KDF may include the time-based counter/nonce and/or a segment counter and a configured group/broadcast. The session group/broadcast key may be used as input in the NEA/NIA/encryption (AES in counter mode) algorithm where a counter value that is included in the R-SIB and refers to the segment that that R-SIB contains may be used as input as well.

In a related embodiment, this counter is used instead of or next to D0 in TS 36.355, Clause 7.3.

A further advantage of the counter management as specified in this application is that it reduces management complexity compared with TS 36.355 and it reduces the risk of reusing a key for a too long period of time. A further advantage of the counter management as specified in this application is that it reduces management complexity compared to TS 36.355 and it reduces the risk of reusing a key for a too long period of time.

In a related embodiment variant, a UE that has registered/subscribed to a ranging service is distributed/assigned/allocated a group/broadcast key, e.g., by an entity in the CN in charge of the ranging service or in charge of managing group/broadcast keys of the ranging service.

In a related embodiment variant, a NF in the CN or RAN is in charge of using said key to protect the contents distributed in the R-SIB, e.g., by applying a KDF to compute a MIC or use a NEA (encryption) or NIA (integrity) algorithm.

In a related embodiment variant, if data related to ranging/positioning needs to be fragmented over multiple R-SIBs, each R-SIB includes a MIC so that the integrity of each R-SIB can be verified upon reception.

In a related embodiment variant, if data related to ranging/positioning needs to be fragmented over multiple R-SIBs, only the last R-SIB includes a MIC used to verify the integrity of all data received in multiple R-SIBs.

In a related embodiment variant, if data related to ranging/positioning needs to be fragmented over multiple R-SIBs, each R-SIB includes a MIC to verify each R-SIB and one or multiple R-SIBs include a MIC or integrity value used to verify integrity of all received data. For instance, the integrity value may be the hash of all the data and it may be included in one or multiple R-SIBs. In this case, upon reception of all R-SIBs, the data is extracted (removing MICs and integrity value), and the hash of the data is computed and compared with the received integrity values.

In a related embodiment variant, if protection is done by a NF in the CN, it is performed on a data container whose data is transferred to RAN including some metadata (e.g., how long said data is valid for broadcast). RAN then includes the data container in R-SIB and broadcasts it.

In a related embodiment variant, if protection is done by RAN, the NF in the CN transfers data to RAN including some metadata (e.g., how long said data is valid for broadcast). RAN then performs protection as required (e.g., uses a counter that may, e.g., depend on the UTC time or SFN where the data is broadcasted as input in the NEA or NIA or protection algorithms) and includes said protected data in the R-SIB and broadcasts it.

In a related embodiment variant, one or more of the following steps may be executed by a UE receiving a ranging/positioning related groupcast/broadcast message from an access device:
obtaining a counter C1 by combining a value C0 received in a protected message (e.g., NAS, RRC, UPU) or derived from a UTC-based counter and/or a value D0 received in the response broadcast message and/or a data segment counter,
obtaining a decryption key and or integrity key by applying a key derivation function to a pre-configured key and the counter,
applying an encryption algorithm (e.g, AES in counter mode or NEA) together with the counter C1 and a decryption key to decrypt the data in the response broadcast message,
applying the counter C1 and an integrity key to compute a MIC by means of a KDF or a NIA algorithm and verify the integrity of the received response broadcast message,
passing the decrypted data to upper layers if the integrity verification is successful.

In a related embodiment variant, existing counters (e.g., C1, C0, D0) might need to be reused, e.g., to ensure compatibility with TS 36.355, however, new encryption/integrity algorithms may be needed (e.g., NEA, NIA) that take as input a shorter counter. In this case, the input counter may then be computed as, e.g., as the 32 least significant bits of C1.

In a related embodiment variant, the content delivered in R-SIB may depend on the UE requesting the delivery of ranging information via R-SIB. For instance, if a UE requests the R-SIB and the UE gives its rough location, the RAN may only include in R-SIB relevant information about other UEs (e.g., reference UEs) that are close by. For instance, if a UE requests the R-SIB indicating a specific group/ranging session ID, the RAN may only include relevant information for that group/ranging session ID and protect said data with a key that is bound to that group/ranging session ID.

In a related embodiment variant,
(1) a UE such as a reference UE or anchor UE may monitor R-SIB broadcasted by gNB
(2) Determine whether the R-SIB includes information indicating that its services are required in a ranging operation (e.g., by decrypting/unscrambling R-SIB and/or by checking whether its identity or the identity of its ranging constellation is part of R-SIB),
   And (3) in positive case of (2), start broadcasting positioning/ranging (PRS) signals over sidelink/PC5.

In a related embodiment variant,

a UE (e.g., target UE) may send a request to receive R-SIB where its request may include an identifier such as a ranging session ID,

The UE may monitor for the reception of R-SIB that may be used to retrieve parameters for reference UEs to be used in the ranging operation,

The UE may monitor and measure positioning/ranging signals (e.g, PRS) transmitted by UEs (e.g., reference UEs) over sidelink/PC upon reception of R-SIB.

In a related embodiment, the reception of R-SIB serves as implicit or explicit indication to a reference UE on the need to start broadcasting positioning/ranging (PRS) signals over sidelink/PC5.

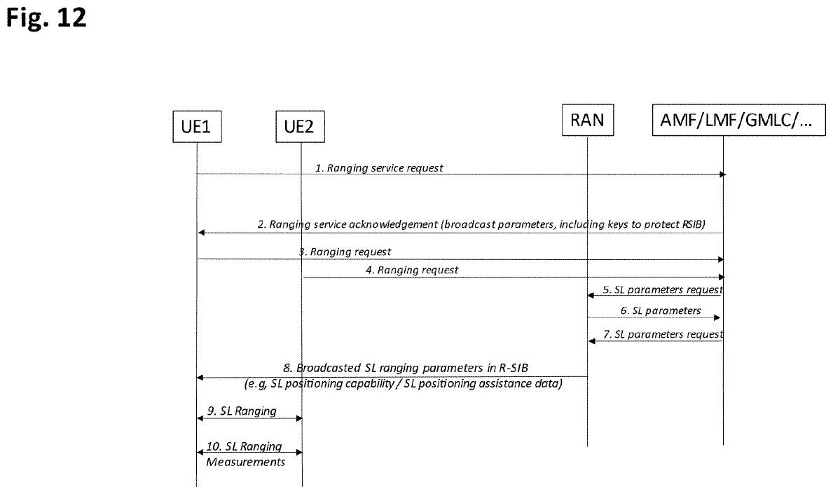

In a related embodiment variant illustrated by means of FIG. 12, a possible procedure for performing ranging supported by RAN-broadcast is described. The steps in this embodiment are illustrative, their order may change, steps may be executed multiple times, and additional steps may be added, e.g., by combining them with other embodiments.

In step 1, a UE may request the establishment of a ranging service. The receiving entity may be one or more NFs in the core network of the telecommunication system, e.g., AMF, LMF, GMLC, etc.

In step 2, the receiving entity(ies) may send a ranging service acknowledgement that may include, e.g., the broadcast parameters. These parameters may include, e.g.:
group/broadcast keys, e.g., to be used to protect/invert protection of (data fields in) R-SIB when protection is done by the receiving entity,
group/broadcast keys, e.g., to be used to protect/invert protection of (data fields in) R-SIB when protection is done by RAN,
group/broadcast keys, e.g., to be used in subsequent ranging operations, e.g., to receive ranging data over PC5/sidelink,
a schedule for R-SIB related to the specific ranging service/group the UE is interested in,
Algorithms and parameters used to process the security of R-SIB,
   . . .
Here, invert protection may mean, e.g., decrypt and/or verify a MIC and/or unscramble a message.

Additionally or alternatively, the receiving entity may indicate RAN or AMF that the UE requires the reception of R-SIB so that the UE can be configured by RAN or AMF with (part of) above information in a secure manner, e.g., by means of a secure RRC message or a NAS message.

Additionally or alternatively, RAN may require the configuration with certain keys, e.g., keys used to protect data fields in R-SIB if those data fields are managed by RAN.

In steps 3 and 4, one or more UEs (e.g., UE1) may send a ranging request to start a ranging session. The UE may also include its ranging parameters that may request to distribute to other UEs via broadcast.

Additionally or alternatively, the ranging request may also be sent directly to RAN as a request to retrieve R-SIB. This request may be a secure RRC message. RAN may know which R-SIB (contents) to deliver based on, e.g., a ranging session ID or a UE ID included in the request and that can be mapped by the RAN to ranging parameters known by RAN or provided to RAN, e.g., by LMF.

The receiving entity may interact with RAN to retrieve/receive sidelink(SL)/PC5 parameters to perform the ranging operation (Steps 5 and 6), e.g., parameters that RAN should use for ranging. Additionally or alternatively, the receiving entity may also configure/provide RAN with relevant parameters, e.g., keys used to protect (data in) R-SIB.

In Step 7, the receiving entity (e.g., AMF/LMF/GMLC/etc) may then send ranging data (e.g., protected or unprotected) to RAN.

In Step 8, if data is not protected, RAN may protect said data based on a policy. RAN may also add sidelink/PC5 parameter to be used for ranging before protection. RAN then broadcasts the protected data in R-SIB. UEs receive R-SIB and unscramble and/or decrypt and/or integrity verify the MIC.

UEs (e.g., UE1 and UE2) may perform ranging and/or enhanced positioning measurements in Step 9 based on the received information in Step 8.

UEs (e.g., UE1 and UE2) may perform secure local communication in Step 10, e.g., based on a local group key (I.e., used to protect sidelink/PC5) that is managed/distributed by the managing entity, e.g., in the keys distributed in step 2, and/or in the data contained in R-SIB and/or is derived from the keys distributed in step 2.

In a related embodiment variant, ranging data, e.g., contained in the broadcast message, may include, e.g., SL positioning capability and/or SL positioning assistance data and/or location information and/or others.

In a related embodiment variant, steps 9 and 10 may also refer to positioning procedures, e.g., in which the UEs also rely on or use/transmit/receive positioning signals distributed/received by RAN, either directly or through another device, e.g., UE1 may receive those signals through UE2.

In an embodiment, the procedure in, e.g., FIG. 11, may correspond or involve the following steps that may be PC5-only positioning and/or PC5 and UU positioning based and may include in-coverage and out-of-coverage UEs between the LMF/positioning server UE/NG-RAN/candidate Anchor UE(s) and Target UE(s):
Triggering event
Sidelink positioning capability exchange
Sidelink positioning assistance data transfer
SL Positioning Request Location Information
Measurement of SL-PRS
Location calculation
SL Positioning Provide Location Information
In particular,

Step a) may correspond to Step 1 in FIG. 11, but it may also be based on a different triggering event, e.g., by AF.

Step b) may correspond to Step 1 and 2 in FIG. 11 wherein the UE provides certain capabilities and the UE is configured with certain parameters to later receive positioning assistance data.

Step c) may correspond to Step 8 in FIG. 11 wherein, e.g., the positioning assistance data is distributed and other embodiments may apply.

Step d) may refer to Step 1 in FIG. 11 or step 10 etc.

Steps e), f), g) may correspond to steps 9 and 10 in FIG. 11.

In a related embodiment variant, whether and how R-SIB is protected may be based on a policy that may be configured by an AF.

In a related embodiment variant, whether and how R-SIB is protected may be based on a policy that may be configured by PCF/LMF and/or may be deployed to LMF and/or RAN and/or UE.

In a related embodiment variant, above procedures/embodiments may be applied to enable ranging and/or positioning purposes, as applicable, even if in some cases only ranging or only positioning are mentioned.

In a related embodiment variant, above procedures/embodiments may be applied to enable multicast and/or broadcast, as applicable, even if in some cases only broadcast or only multicast are mentioned.

In a related embodiment variant, the broadcast message (e.g., R-SIB or the MBS broadcast message) sent from the access network/access device/RAN/gNB, may be received by a UE (e.g., an anchor UE) and the UE may re-broadcast it over the local communication interface (sidelink/PC5). This has the advantage that UEs that may be potentially out-of-coverage from the access device may still receive the broadcast message containing the positioning/ranging data.

In a related embodiment variant, the previous UE receiving the broadcast message may be configured with a policy determining whether it may re-broadcast the received broadcast message.

In a related embodiment variant, the broadcast message (e.g., R-SIB) or other broadcast message (e.g., SIB) includes a message field (or policy) that determines whether the broadcast message is to be re-broadcasted over the local interface (PC5).

In a related embodiment, a NF in the core network or an access device protects the (ranging) information as described above, e.g., as in TS 36.355, and provides/sends said information to the UE in charge of performing local groupcast/broadcast, e.g., an anchor UE, not in a SIB (R-SIB), but e.g., by means of a unicast message, e.g., in an RRC message or a NAS message. In an example, the protection procedures in TS 36.355 (or in above embodiments) to protect the data as a container are reused, but the data itself is not broadcasted by the access device to all UEs in a SIB, but the protected data container is sent by means of a unicast message to one or more specific devices, e.g., anchor devices. The devices can then further groupcast/broadcast said data over a local communication interface, e.g., PC5.

In a related embodiment, the device receiving a broadcast message (e.g., R-SIB), do not rebroadcast/groupcast the message, but unicast it, e.g., if a single UE has registered to the message/data.

In a related embodiment, the device receiving a broadcast message may be configured to unicast broadcast messages according to a policy contained within the message. For example, a broadcast message may contain a policy that indicates that the broadcast message should not be unicast to UEs that are out of coverage. Alternatively, the broadcast message may contain a policy that indicates that the broadcast message should not be unicast to UEs that are connected to the device but which are also in coverage of the access device. In the absence of such a policy, the device may assume that the broadcast message may be unicast to all UEs regardless of their coverage status.

The device receiving a broadcast message may be informed of the coverage status, marked as ‘in coverage’ or ‘out of coverage’ of the UE by the location service, the UE itself, the gNB or another network entity. In an alternative, according to a policy, the coverage status of the UE may be marked according to a policy as ‘indeterminate’ or ‘unstable’ for cases where a UE falls in and out of coverage frequently or is otherwise unable to be clearly determined. For example, a policy might take the form, if the UE undergoes more than N changes between in coverage and out-of-coverage within time T, then the coverage status may be marked as unstable’.

The device receiving a broadcast message may be informed of the potential change of the coverage status of a UE, based on location measurements e.g., current location, direction, and velocity, which may be combined with the policy, as described in previous embodiments, to decide whether to cache the received messages for an estimated time period T based on said measurements. For instance, a device receiving a broadcast message with a policy indicating that the broadcast message should be unicast only to UEs that are in coverage, may also be informed that an out-of-coverage UE is estimated to move in-coverage within a particular time frame, e.g., 4 seconds; the device may cache the broadcast message for another particular time frame e.g., 5 seconds and only then unicast it to said UE.

A remote UE that is about to use one of its stored messages may check for the presence of a policy within the message and, according to information including management policies and its current coverage status, decide whether to use, discard, retain or otherwise handle the message.

In an embodiment related to the previous one, the received data is protected according to TS 36.355 (TS 37.355), i.e., encrypted. A first device (e.g., an Anchor UE, relay UE) receiving said information (e.g., in a unicast message (e.g., RRC or NAS) or broadcast (e.g., SIB)) is in charge of integrity protecting the data, e.g., by means of an integrity key and in combination with an integrity algorithm capable of generating a MIC of the broadcasted data, e.g., a NIA algorithm or by using a KDF using as input the integrity key and/or a UTC-based counter and/or a counter and/or the message to broadcast. This first device is to retransmit/forward/broadcast/groupcast said data. Both the first device performing the retransmission/forwarding/broadcasting/groupcasting of the data and the devices (e.g., a target UE) receiving it need to be configured with an integrity key. The target UE will then first integrity verify the received message from the first device, and if the integrity verification succeeds, the target UE will decrypt the received data.

This embodiment variant has the advantage of reusing the encryption routine in TS 37.355 and only requiring new logic for integrity protection of the ranging-based communication.

In an embodiment related to the previous ones, the first device is in charge of scrambling the message or part of the message, e.g., by means of a scrambling key that may be available to devices that are in an area. Scrambling may be done by XORing the message or part of it with a pseudo-random sequence, e.g., generated by means of a KDF, or by means of a NEA algorithm by using the scrambling key. This first device is to broadcast/groupcast said scrambled data. Both the first device performing the broadcasting of the data and the devices (e.g., a target UE) receiving it need to be configured with the scrambling key. The target UE will then descramble the message, and, e.g., check if it is for it, e.g., by checking if the message contains its group identifier/ranging identifier. If it does, the target UE further processes the message (e.g., integrity verifies the message and/or decrypts the message). If it does not, it drops the message.

This has the advantage of reusing the encryption routine in TS 37.355 and only requiring new logic for scrambling protection (privacy protection) of message fields that may be privacy sensitive in the ranging-based communication.

In a related embodiment variant, the policy or message field that determines whether a broadcast message (R-SIB, . . . ) is to be rebroadcasted and how it is to be rebroadcasted over the local interface includes:

The context for rebroadcasting it, e.g.,
if a UE is aware of other UEs that are out-of-coverage, then the UE is required to perform rebroadcasting; or
rebroadcasting may only be allowed/required at specific times (e.g., rush hour) or in a given location; or
rebroadcasting may only be allowed when network load (e.g., number of UEs) is higher than a threshold, or

Rebroadcasting may only be allowed to a UE when the UE receiving the broadcast message, as broadcasted by the access device/RAN/gNB over the Uu interface, has not seen/received said broadcast message rebroadcasted over the local interface (sidelink/PC5), e.g., at least once or at least a minimum number of times, e.g., N.

Rebroadcasting may only be allowed to a UE (UE1) when the UE receiving the broadcast message is aware of other UEs (e.g., UE2, an out-of-coverage UE) that are interested/have registered to the data included in the received broadcast message. For instance, if UE2 has indicated to UE1 that is interested in positioning/ranging data, then UE1 would rebroadcast/redistribute the received broadcast message.

Rebroadcast may only be allowed if the UE has received discovery messages from a minimum number of other UEs.

Rebroadcast may only be allowed if the forwarding of the broadcast message has not reached a maximum number of times (e.g. based on number of hops between the UE and the network).

Rebroadcast may only be allowed if the UE acts as a particular type of relay (e.g. Layer-2 ProSe UE-to-Network relay, Layer-3 ProSe UE-to-Network relay, Anchor UE in coverage forwarding messages (e.g. LPP messages) to/from the network on behalf of a target UE that is out-of-coverage)

The role of the UE for rebroadcasting it, e.g., only anchor UEs or reference UEs may be allowed to perform rebroadcasting, or even only UEs (e.g., Reference UEs) with this specific rebroadcasting role; e.g., only devices with relay capabilities such as UE-to-Network relays or UE-to-UE relays.

Security policy determining how the broadcasted message is to be protected.

In a related embodiment variant, the policy may be configured on the UE performing the re-broadcasting by RAN, and/or PCF, and/or LMF, and or a NF in the CN.

In a related embodiment, the UE performing the rebroadcasting of the received broadcast message may:

Not apply local security (e.g., security as per the local communication interface, e.g., PC5 security), if the R-SIB is protected or the policy indicates that,

Securely protect the broadcast message according to the security policy/algorithms and using the keys for the local communication interface.

In a related embodiment, the UE performing the retransmission (e.g. forwarding a broadcasted message received from a RAN node or a unicast message received from LMF to other UEs) may be enabled/capable/authorized to perform the retransmission (e.g., rebroadcasting, groupcast) but may not be authorized to access the information in the (e.g., broadcast) message itself, e.g., because this information may be private. The UE performing the retransmission of a received message may however be required to somehow verify the received information before performing the retransmission. To address this need, one or more of the following variants may apply:

The data in the (broadcast) message is protected with two (sets of) keys:

a first (set of) keys for the secure processing (e.g., integrity verification) at a first device performing the retransmission;

A second (set of) keys for the security processing (e.g., confidentiality processing) at a second (end/remote/target) device receiving the retransmitted message.

The data in the (broadcast/groupcast) message is protected with a first set of keys including, e.g.:
a confidentiality key to encrypt the data
an integrity key to integrity protect the data.

The (set of) keys may include integrity/confidentiality/scrambling keys.

The (set of) keys may be derived from a master key, e.g., by applying a KDF.

The (set of) keys may be rotated, e.g., by deriving session keys from a root key, and a nonce/UTC-based counter, etc.

The first device may do one or more of:

receive the (e.g., broadcast/unicast) message that may be protected according to or by means of: 1) a first set of keys and 2) a second set of keys)

Verify and/or remove said protection, e.g., verify and remove a Message Integrity Code (or signature) by using an integrity key in the first set of keys.

Rebroadcast/forward the message protected only with the second set of keys towards one or more target UEs.

This has the advantage that the first device can check the forwarded information by means of the first set of keys (because an integrity key is used that shared between the source of the data and the device rebroadcasting the data) without having access to it (because it is protected with a confidentiality key (in the second set of keying material) that is shared between the source of the data and the target device consuming the data).

In an additional or alternative variant, the first device may also apply further protection to the message, e.g., the first device may have an integrity key and/or a scrambling key (keys, that may be part of the second set of keys), and use them to add a MIC to the retransmitted message and/or scramble the retransmitted message.

In this variant,
the confidentiality key in the second set of keys may be an encryption key shared between LMF and target UE as in TS 37.355,
the integrity and scrambling keys in the second set of keys may be key shared between LMF and/or RAN and/or first UE and/or target UE.

The integrity key in the first set of keys may be a key shared between LMF/AMF/RAN and first UE.

The first device may:
receive the (e.g., broadcast) data/message that may be protected (e.g., according to or by means of a first set of keys),
verify and/or remove said protection, e.g., verify and remove a Message Integrity Code (or signature) by using an integrity key in the first set of keys,
retransmit the message protected with the first set of keys.

In a related embodiment variant, the public-key used in above procedures may be based on an identity-based encryption scheme.

In a related embodiment variant in reference to FIG. 12, message 8 may be received by UE2, but not UE1 (e.g., out of coverage). UE2 may then rebroadcast message 8 over the local communication interface, e.g., based on policy, so that UE1 can receive message 8.

In a related embodiment, R-SIB may refer to the IE AssistanceDataSIBelement used in the IE SystemInformationBlockPos as specified in TS 36.331 [12] and IE SIBpos as specified in TS 38.331. In other words, R-SIB may be formatted as a Positioning SIB/PosSIB.

In a related embodiment, embodiments that only described in the context of broadcast (or groupcast) may be adapted for groupcast (or broadcast).

In general, it is described a method and apparatus that can be implemented in a UE for securely receiving and processing a SIB containing ranging data.

In general, it is described a method that may be implemented on a device for assisting and/or for obtaining a range or location estimate of a target mobile device (10) within a wireless network, wherein the apparatus is adapted to:
receive a broadcast message from an access device;
retransmit (e.g. forward) the message if allowed by a policy and/or indication of the broadcast message.

In general, above method may be adapted to:
retransmit by means of broadcast/groupcast/unicast and/or
perform security process on the received broadcast message before retransmitting where security process may involve one or more of:
checking a MIC on the received data,
encrypting the data,
computing and attaching a MIC to the transmitted (groupcast/broadcast) message,
scrambling (part of) the transmitted (groupcast/broadcast) message.

In general, it is described a method and apparatus that can be implemented in a NF and/or RAN for securely protecting ranging/positioning data and broadcasting said protected data in a SIB.

In accordance with a general definition of a first aspect of this embodiment, it is proposed an apparatus to assist in obtaining a range or location estimate of a target mobile device within a wireless network, wherein the apparatus is adapted to:
receive a first message containing positioning/ranging assistance data from an access device;
retransmit at least part of the first message over a PC5 interface.

In accordance with a general definition of a second aspect of this embodiment, it is proposed a method to assist in obtaining a range or location estimate of a target mobile device within a wireless network, wherein the method comprises a wireless device:
receiving a first message containing positioning/ranging assistance data from an access device;
retransmitting at least part of the first message over a PC5 interface.

In a first option of the first or second aspect, the apparatus may be adapted to retransmit the first message over the PC5 interface as a local groupcast/broadcast message. Optionally, the apparatus may retransmit the first message over the PC5 interface as a local groupcast/broadcast message, if allowed by a policy configured in the apparatus or by an indication in the received message.

Further, the first message containing positioning/ranging assistance data from an access device may be a groupcast/broadcast message. The retransmission of the first message may apply to whole or part of the first message and whereby the policy or indication may map the whole or part of the first message to a local identifier. In an example, the apparatus may perform a security process on the first message before retransmitting where the security process may involve one or more of:
checking a MIC on the received data,
encrypting the data,
computing and attaching a MIC to the transmitted (groupcast/broadcast) message,
scrambling (part of) the transmitted (groupcast/broadcast) message,
transmitting an unprotected SIB if the apparatus determines it is involved in emergency service,
decrypting the data and determine if the data also relates to the apparatus itself,
decrypting the data and determine if the apparatus needs to initiate a ranging/sidelink positioning procedure.

In another example, the message from the access device may be a Positioning SIB.

In another option, the apparatus may:
receive a second message from a wireless communication device over PC5 that includes one or more of the following data elements:
   keying material identifier
   request for ranging/positioning assistance data
   indication of emergency service,
   preference for NULL security algorithms
store a binding between an identifier of the wireless communication device and one or more of the received data elements;
issue or forward a request to the network containing one or more of the received data elements;
retransmit whole or part of the first message based on the binding.

### Section: Further Details on Protection of Groupcast/Broadcast of SL Positioning Data

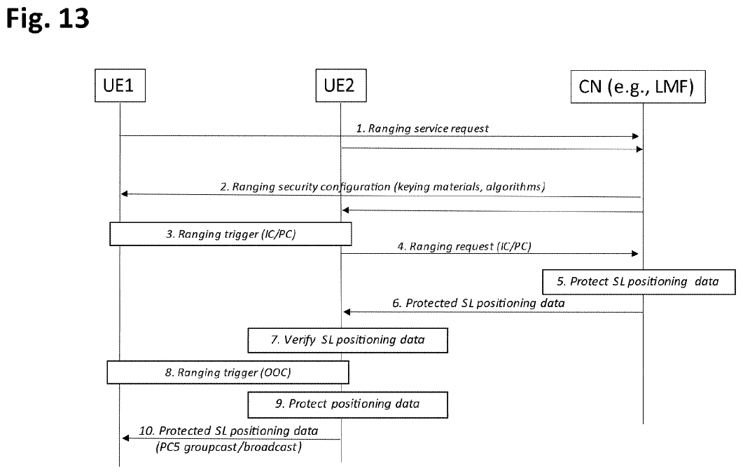

FIG. 13 describes a potential message flow in which combining several embodiments and embodiment variants. This message flow indicates a way to protect the groupcast/broadcast of SL positioning data (over Uu and/or PC5), in particular, SL positioning capability and SL positioning assistance data, by reusing and adapting the communication flow and security mechanisms in TS 38.305 (Clause 7.5) and TS 37.355 (Clause 7.5) used for the protection of positioning assistance data. The overall message flow proposed by this solution is as follows. Note that the steps are exemplary, I.e., they may be skipped, may be done in a different order, and/or may be executed multiple times:

Step 1: UE1 (and UE2) send a request to join a ranging service.

Step 2: UE 1 (and UE2) are configured with the corresponding security information as it might be applicable to the ranging service if the UEs are authorized.

Step 3: UE 1/UE 2 determine a ranging trigger that requires the distribution of SL ranging data when in in-coverage (IC) or partial coverage (PC).

Step 4: A UE (e.g., UE2) sends a ranging request to retrieve/obtain SL positioning data.

Step 5: CN, e.g., LMF, determines suitable SL positioning data, and protects it e.g. as in TS 37.355 (note that the assistanceDataElement can be replaced here and in the following embodiments with Assistance Data IEs as defined in clause 6.5 of TS 37.355, which may be extended to include Assistance Data IEs specific for Ranging/SL Positioning containing for example configuration parameters to perform ranging such as ranging constellation related information as described in other embodiments).

Step 6: Protected SL positioning data is transferred to UE2 in charge of local groupcast/broadcast.

Step 7: Optionally, UE2 verifies received SL positioning data before broadcast/groupcast.

Step 8: UE 1/UE 2 determine a ranging trigger that requires the distribution of SL positioning data when in out-of-coverage.

Step 9: Optionally, UE2 adds further protection to SL positioning data.

Step 10: Protected SL positioning data is sent by means of groupcast/broadcast.

Furthermore, in Step 2, UEs may be configured, e.g.:

with a key as in TS 37.355 for confidentiality protection when UEs are IC/PC. with a key as in TS 37.355 for usage when UEs are in OOC. In this case, UE2 may use this key for the confidentiality protection of SL positioning data.

With a key for the computation of a MIC that allows UE1 to verify SL positioning data transmitted in groupcast/broadcast.

With a key for the scrambling of SL positioning data transmitted in groupcast/broadcast to prevent privacy threads.

Furthermore, if devices are out-of-coverage, Steps 3-7 are not executed.

Furthermore, if devices are in-coverage/partial coverage, it is preferable to use Steps 3-7, although these steps may be skipped based on policy/configuration.

Furthermore, protection in Step 5 can be based on TS 37.355.

Furthermore, message in Step 6 may be securely transferred, e.g., as aNAS message containing the protected SL positioning data (e.g. as LPP payload) or as a SIB (e.g. PosSIB) containing the protected SL positioning data broadcasted by a RAN node. Additionally or alternatively, the SL positioning data itself is unprotected but included as LPP payload in a NAS message which is protected using the keys derived for the respective NAS security context.

Furthermore, protection in Step 9 can be based on TS 37.355 for confidentiality and may include further protection (e.g., integrity protection and/or scrambling protection).

Furthermore, note that if an encryption approach as in TS 37.355 is used, the receiving UEs need to be configured with certain information, e.g., a part of the counter. This information may be included in the broadcast message (in the clear), or it may be securely provided in unicast (e.g., in a NAS message, or in a secure PC5 message, etc).

Scrambling may be required to scramble, e.g., an identifier in, e.g., Step 10 in FIG. 13 wherein this identifier is used to identify the ranging group (e.g. ranging constellation identifier or group ID configured for groupcast). Alternatively or additionally, in an embodiment that may be implemented independently or combined with other embodiments, a pseudo-identifier may be used, e.g., a pseudo-identifier computed as a subset of bits of the key derivation function of a key and a long-term identifier (ranging group ID) and a nonce/counter (e.g., UTC-based counter). A sending UE sends this pseudo-identifier next to the nonce/counter. Then a UE receiving that pseudo-identifier (and nonce/counter) can determine that the message is addressed to it by checking that the receiver pseudo-identifier equals the one locally generated.

In general, it is described a method and apparatus that can be implemented in a UE for securely receiving and processing a SIB or other message containing ranging/sidelink positioning data.

In general, it is described a method that may be implemented on a device for obtaining a range or location estimate of a target mobile device (10) within a wireless network, wherein the apparatus is adapted to:
receive a broadcast message from an access device or to receive a unicast message from the core network (e.g. from LMF) that may contain ranging/sidelink positioning data;
retransmit (e.g. forward) the message if allowed by a policy and/or indication of the broadcast message.

In general, above method may be adapted to:
retransmit by means of broadcast/groupcast/unicast and/or
perform security process on the received broadcast message before retransmitting where security process may involve one or more of:
checking a MIC on the received data,
encrypting the data,
computing and attaching a MIC to the transmitted (groupcast/broadcast) message,
scrambling (part of) the transmitted (groupcast/broadcast) message.

In general, it is described a method and apparatus that can be implemented in a NF and/or RAN for securely protecting ranging/positioning data and broadcasting said protected data in a SIB and/or for transmitting said protected ranging/sidelink positioning data in a unicast message from the core network and/or for (re-)transmitting said protected using groupcast/broadcast over sidelink to other UEs.

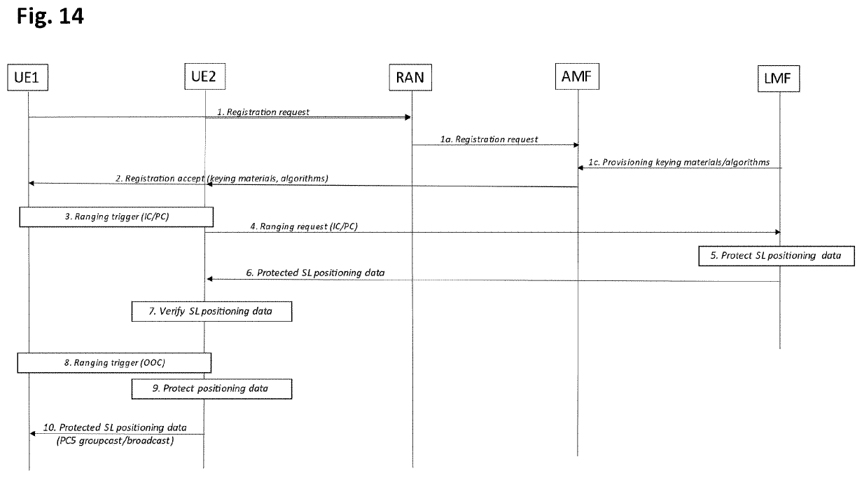

FIG. 14 describes a slightly different message flow. When compared with FIG. 13, the main difference refers to Step 1 and 2. In Step 1, UE1 (and UE2) sends a Registration Request (similar to TS 23.271/23.273, Clause 6.14.2)). In Step 2, UE 1 (and UE2) are configured by means of a Registration Accept (similar to TS 23.271/23.273, Clause 6.14.2)) with the corresponding security information as applicable to the ranging service, if the UEs are authorized.

In an embodiment, the message fields required for data protection, in particular, confidentiality protection, are related to TS 37.355, and fields can be confidentiality protected in a similar way. The fields required for confidentiality include a cipherSetID, as in TS 37.355, that identifies a cipher set comprising a cipher key value and the counter value.

In an embodiment, the message fields required for data protection, in particular, integrity protection, require including a message integrity code. In the message. The definition of cipherSetID in TS 37.355 can be extended to also identify the integrity key used in the computation of said message integrity code.

In an embodiment that may be combined with others or used independently, e.g., in the context of TS 37.355, the cipherSetID is an identifier that may be fixed and may be tracked. To avoid this, the cipherSetID is scrambled by means of a scrambling key K associated to the cipherSetID. For instance, the scrambled cipherSetID may be computed as:

scrambledCipherSetId=cipherSetId XOR KDF(K, UTC-based-time)

A UE sending a broadcast/multicast message including the cipherSetId scrambles this identifier before sending it out. A UE receiving a broadcast/multicast message uses scrambling key K associated to cipherSetID to unscramble scrambledCipherSetId. If the unscrambled cipherSetID’ matches cipherSetID, the receiving UE knows that the broadcast/multicast message is intended for it, and further processes the message, i.e., decrypts/integrity verifies the message. This step can be realized by means of blind decryption.

In an embodiment, the cipherSetID, and related keying material (key, counter, etc) is configured after a key request, service registration request, etc (e.g., Step 1 in FIG. 14) by means of a key configuration message, e.g., Step 2 in FIG. 14. The keys may be provided by the LMF or by another key managing entity such as Sidelink/ProSe Key Management Function.

In TS 37.355, if cipheringKeyData is present, the assistanceDataElement octet string is ciphered using the key indicated by cipherSetID. In an embodiment that may be combined with others or used independently, e.g., in the context of TS 37.355, to protect said cipherSetID in terms of privacy-protection, e.g., as in the scrambling related embodiment, the cipherSetID may also be ciphered next to the assistanceDataElement. This ciphering step is equivalent to the scrambling approach above. An advantage is that it reuses the same logic.

In another embodiment that may be combined with others, other fields in AssistanceDataSIBelement (e.g, valueTag, expirationDate) may be integrity protected and/or confidentiality protected. When integrity protected, these fields (e.g, valueTag, expirationDate) also allow a receiving UE to verify the freshness of the received messages. For instance, if a UE receives a message whose expirationDate is in the past, the UE will then reject the message.

In an embodiment variant that may be combined with other embodiments or may be used independently, the keys configured for protecting groupcast/broadcast over sidelink may be configured independently of the cipher sets used to protect the assistanceDataElement or Assistance Data IEs that are transmitted to a ranging UE from the RAN/LMF, and may use these cipher sets independently to protect SL positioning information to be multicasted/broadcast to other ranging UEs (e.g. the other UEs in ranging constellation or other UEs involved in a ranging session). These independent cipher sets for protecting groupcast/broadcast over sidelink may use a cipherSetID to identify the related keying material. In order to avoid that such cipherSetID (which is an identifier that may be fixed and may be tracked), the cipherSetID is scrambled/ciphered by means of a scrambling/ciphered key K associated to the cipherSetID. For instance, the scrambled cipherSetID may be computed as:

scrambledCipherSetId=cipherSetId XOR KDF(K, UTC-based-time)

A UE sending a sidelink broadcast/multicast message including the cipherSetID scrambles/ciphers this identifier before sending it out. A UE receiving a broadcast/multicast message uses scrambling/ciphering key K associated to cipherSetID to unscramble/decipher the scrambled/ciphered CipherSetId. If the unscrambled/deciphered cipherSetID’ matches cipherSetID, the receiving UE knows that the broadcast/multicast message is intended for it, and further processes the message, i.e., decrypts/integrity verifies the message. This step can be realized by means of blind decryption.

FIG. 14 describes a situation in which UEs, UE1 and UE2, may belong to the same network or to different networks. If they belong to different networks, e.g., UE1 is roaming, UE1 may still receive keying materials from the LMF of the serving network as described in Clause 6.14.2 in TS 23.271/23.273 NAS protected from the AMF. In case that the LMF (LMF2) in UE2's home network (UE1's serving network) does not have some information from UE1, LMF2 and LMF1, i.e., LMF in UE1's home network, may interact with each other. For instance, when UE1 is requesting ranging services in the serving network, or when UE1 is performing primary authentication through the serving network. A network function in the serving network or the home network may request and/or send assistance related data to the other network, e.g., LMF1 may send ranging-related assistance data of UE1 to LMF2. Additionally, or alternatively, UE1 may also share its assistance data with a network function in the visiting network, e.g., LMF2, when requesting ranging related services in the serving network so that said network function (e.g., LMF2) can share that information with other UEs in the serving network.

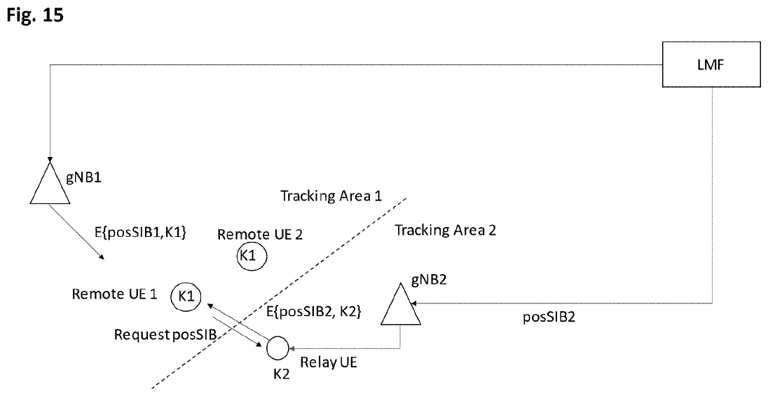

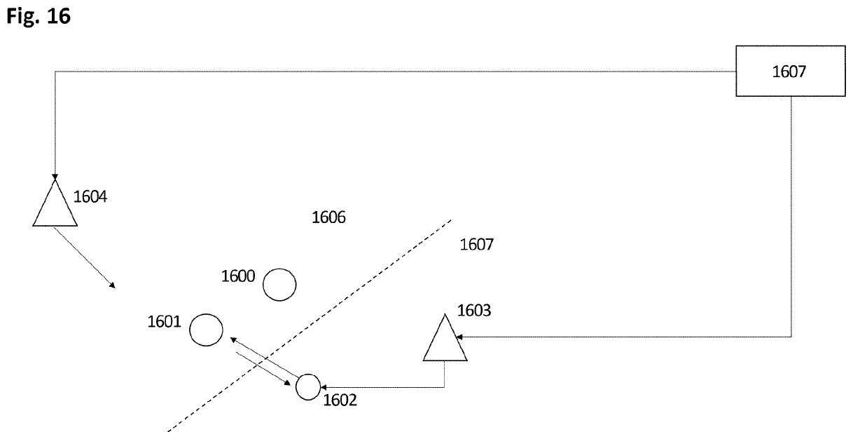

FIG. 15 and FIG. 16, describe a related scenario for the broadcast or groupcast or unicast of a message, e.g., SIB, e.g., with positioning or ranging purposes. FIGS. 15 and 16 represent a similar scenario wherein in FIG. 15, K1 and K2 refer to keying materials in different UEs, E{posSIB1, K1}indicates that a SIB (posSIB1) is protected using K1 and E{posSIB2, K2}indicates that a SIB (posSIB2) is protected using K2. The arrows in the figures indicate a possible delivery/exchange of messages as described in subsequent embodiment variants.

In the case of FIG. 16, 1600, 1601, 1602 represent UEs, e.g., UEs in a ranging constellation or UEs in a given area seeking positioning services. 1602 may also be a UE-to-Network relay that may also act as an anchor UE, or an Anchor UE forwarding messages to a Target UE that is OOC. UE 1602 may forward information between UEs 1600, 1601 and the core network 1607, e.g., LMF. Said information may be assistance information issued by the LMF in the core network and transported in broadcast or groupcast or unicast messages for ranging or positioning services. UEs 1600, 1601 may also be remote UEs (UEs out of coverage from the access devices 1603 and 1604) that access the network/RAN (e.g., access device 1603) via UE 1602. UEs 1600, 1601 and UE 1602 may be connected via the PC5 interface and UE2 may be connected with access device 1603 via the Uu interface. In the following description, SIBs (e.g. posSIBs) received via broadcast from a RAN node are used as an example of messages received/requested by a UE, however these may be replaced with other ranging/sidelink positioning related messages received/requested from the network, such as LPP messages received via unicast from the LMF containing SL positioning data.

In this scenario, UEs 1600 and 1601 may have joined the network originally through access device (gNB) 1604 that may be in a first tracking area 1606. Problems with radio coverage may mean that UEs 1600 and 1601 can no longer access the network via gNB 1604 and, instead, access the network via UE 1602, which acts as a relay between UEs 1600 and 1601, and the network (sometimes referred to as a UE-to-Network (U2N Relay). UEs 1600, 1601 may be interested in receiving SIBs related to tracking area 1606 and may have received from LMF (or other key management function such as Sideilnk/Prose Key Management Function) corresponding keying materials, e.g., as per above embodiments, e.g., extending TS 23.273 Clause 6.14.2. Those keying materials may be bound to tracking area 1606.

UEs 1600 and 1601 may be unable to receive SIBs broadcast by a gNB in tracking area 1606. In this situation, UEs 1600, 1601 may request SIBs from the network through UE 1602 or may request that UE 1602 collect and deliver SIBs. In this case, UE 1602 may collect SIBs from broadcast transmissions or may request them directly from the network.

UE 1602 may be connected to access device 1603 that may be in a second tracking area 1607. In some cases, tracking areas 1606 and 1607 may be different. Similarly, UE 1603 may be bound to tracking area 1607 and may have received keying materials bound to that tracking area. In this situation, UEs 1600, 1601 may request UE 1602 to deliver ranging/positioning SIBs. However, since the tracking areas during registration may have been different, the keying materials configured in the UEs are also different. UE 1602 may have not been configured with keying materials. In some cases, UEs 1600, 1601 may have not been configured with keying materials. This can lead to multiple problems, e.g., a situation in which, e.g., UE 1600, 1601 receive a SIB that was actually not addressed to them and cannot be deciphered. To address this situation, the following solutions and embodiment variants may be applicable, alone or in combination with other embodiment variants in the present disclosure.

In an embodiment variant that may be combined with other embodiment variants, a UE, e.g., 1600, 1601, 1602, discerns whether encrypted assistance data is suitable or not for itself or for the remote UE (UE 1600 (1601)) based on metadata associated with the assistance data, for example, keying material identifier used to identify the cryptographic key used to cipher said assistance data or, for example, a tracking area identifier or a geographical area identifier.

In an embodiment variant that may be combined with other embodiment variants, UE 1602 may have been configured with a policy to offer the provisioning or provide UE 1600 (1601) with positioning capabilities upon receiving a request to monitor a positioning SIB. This may require that relay UE also requests positioning SIB for itself (1602) and/or requests ranging assistance data for itself (1602) and/or the requesting UE 1600 (1601). This may involve the relay UE 1602 offering positioning services to UE 1600 (1601).

In an embodiment variant that may be combined with other embodiment variants or used independently, UE 1600 (1601) includes requests a positioning/ranging message, e.g., posSIB, by sending a request message for SIBs or posSIBs that includes one or more identifiers (e.g, a keying material identifier such as cipherSetID or tracking area identifier or geographical area identifier or ranging group ID) related to the keying materials known to the UE to securely process the SIB. Upon reception of said request message, UE 1602 checks whether received SIBs or posSIB messages include the same identifier (e.g., cipherSetID) as in the request message.

If UE 1602 does have a SIB/posSIB with keying materials bound to said identifier, UE 1602 can provide UE 1600 (1601) with the SIB/posSIB when available or received wherein UE 1602 may check upon reception of said SIB/posSIB (e.g., from RAN) whether the SIB/posSIB contains the same identifier as previously indicated by UE 1600 (1601) or not, and only forward those SIBs/posSIBs containing the same identifier to make sure that UE 1600 (1601) is able to decipher them.

Additionally, or alternatively, e.g., if UE 1602 does have keying materials bound to said identifier, UE 1602 stores in a table the binding between UE 1600 (1601) and said identifier. This table is used by UE 1602 to determine which SIB/posSIBs are forwarded to UE 1600 (1601).

Additionally, or alternatively, e.g., if UE 1602 does have keying materials bound to said identifier, UE 1602 can provide UE 1600 (1601) with the SIB when available wherein UE 1602 may check whether a SIB contains the same identifier or not, and only forward a SIB containing the same identifier and for which an integrity check (e.g., checking a MIC) is successful (as in other embodiments) to make sure that UE 1600 (1601) is/will be able to decipher said SIB.

If UE 1602 does not have keying materials bound to said identifier, UE 1602 may indicate/request UE 1600 (1601) to obtain keying materials for a given identifier (e.g., for a given cipherSetID own by UE 1602 or valid in tracking area 1607 where UE 2 is located). UE 1600 (1601) may then perform a procedure, e.g., similar to TS 23.273 Clause 6.14.2, to retrieve those keying materials.

Additionally, or alternatively, If UE 1602 does not have keying materials bound to said identifier, UE 1602 may provide UE 1600 (1601) with keying materials linked to a given identifier (e.g., cipherSetID) valid in the area where UE 1602 is located where said provisioning step may be protected by means of the PC5 security link. UE 1602 may provide said keying materials to UE 1600 (1601) if allowed by the core network (e.g., LMF, PCF) where this may be configured in the UE by means of a policy.

Additionally or alternatively, If UE 1602 does not have keying materials bound to said identifier, UE 1602 may request the core network 1607 (e.g., LMF) to receive SIBs linked to the cipherSetID provided by UE 1600 (1601). The core network 1607 may then provide UE 1602 with said keying materials bound to the identifier provided by UE 1600 (1601). The core network 1607 may also instruct other network function or RAN to deliver UE 1602 said SIBs protected with keying materials linked to the identifier indicated by UE 1600 (1601).

In an embodiment variant that may be combined with other embodiment variants or used independently, UE 1600 (1601) may send a request to the RAN 1603/core network 1607 through UE 1602 to retrieve a given SIB, e.g., posSIB. The RAN, 1603 e.g., gNB, may have been configured by the AMF/LMF 1607 with the posSIBs valid not only in its tracking area, but in surrounding tracking areas. The LMF/AMF may do this when, e.g., UEs in the area are capable of forwarding posSIBs or based on a policy. Upon reception of the request, the RAN/gNB 1603 may provide UE 1600 (1601) with said SIB, e.g., posSIB (similar to step 3 in Clause 6.14.1 in TS 23.273) and/or contact the AMF/LMF requesting the delivery of keying materials valid for the tracking area of gNB/RAN to said UE 1600 (1601) so that gNB/RAN can deliver SIBs, e.g., posSIB, valid for the current tracking area to UE 1600 (1601). This delivery may be done by means of a Registration Accept message as in Steps 6 and 7 of Clause 6.14.2 in TS 23.273).

In some scenarios, the keying material identifier is used to determine the tracking area/group/scope the SIB belongs to. However, the presence of a keying material identifier in the SIB, e.g., posSIB, implies that the SIB, or part of it, is ciphered. In some situations, it is preferable to indicate the tracking area/group/scope a SIB belongs to without having to cipher the SIB, or part of it. Thus, in an embodiment variant, the SIB includes an identifier identifying the tracking area/group/scope and a flag indicating whether the SIB, or part of it, is protected (ciphered) or not. For instance, an existing (keying material) identifier (e.g., cipherSetID) may be considered as

cipherSetID=flag|tracking area/group/scope identifier

meaning that the most significant bit of cipherSetID indicates whether the message is protected or not and the remaining bits indicate the tracking area/group/scope identifier.

In an embodiment variant that may be combined with other embodiments or implemented independently, the fields of the groupcast/broadcast message may include the following fields:
ExpirationDate (how long the message is valid)
ValueTag (whether the broadcast value changed since the last message)
CipherSetID (identifier used to identify the keys used for integrity/confidentiality protection)
Counter (a counter used for encryption)
SL positioning data (data that is confidentiality protected)
MIC (protecting integrity of the message)

In a related embodiment variant, when a UE sends a groupcast/broadcast message with SL positioning signaling data associated to CipherSetID, the UE processes the message as follows:

When integrity keys are available, integrity protection in Steps 6 and 9 is done by including a message integrity code (MIC) in the message. The MIC is computed using as input the SL positioning signaling data as well as the fields valueTag, and expirationDate, as defined in TS 37.355.

When confidentiality keys are available, confidentiality protection in Steps 6 and 9 is done as in TS 37.355 [13] using the corresponding confidentiality key. Confidentiality is applied to the SL positioning signaling data that corresponds to the AssistanceDataSIBelement in TS 37.355. Confidentiality protection requires a cipherSetID that identifies a cipher set comprising a cipher key value and the counter value, as in TS 37.355.

When a scrambling key is available, the CipherSetID is scrambled. Scrambling is performed by XORing the CipherSetID with the output of the KDF taking as input the scrambling key and the UTC-based counter setting b least significant bits to zero.

In a related embodiment variant, when a UE receives a protected groupcast/broadcast message with SL positioning data, the UE processes the received message as follows:

When a scrambling key is available, the CipherSetID is unscrambled. The UE determines whether the groupcast/broadcast message with SL positioning signaling data is addressed to the UE group if the CipherSetID matches.

When a confidentiality key is available, the SL positioning signaling data is decrypted according to TS 37.355.

When an integrity key is available, the integrity of the SL positioning signaling data is verified.

The UE rejects the message if the expirationDate is in the past.

In a related embodiment variant, the freshness check may be performed prior to the security processing of the message, including unscrambling/decryption/integrity check to save resources. In other words, if the freshness value is in the past, the message is not processed, e.g., as in the previous message.

In an embodiment variant that may be combined with other embodiment variants or used independently, UE 1600 (1601) may request emergency access, e.g., by including an emergency relay service code, e.g., as described in Solution #27 in TR 33.740 or draftCR “Living document for 5G_ProSe Ph2” with Tdoc S3-233374. The emergency access may involve a request to provide UE 1600 (1601) with location/ranging assistance data to determine the location/range of UE 1600 (1601) and return said location/range. In this situation, UE 1600 (1601) may not have the required keying materials, and thus, UE 1600 (1601) may not be able to decipher said information. UE 1600 (1601) may also have said keying materials but it may be preferred to skip protection, e.g., for performance reasons. To address this concern, the following approaches may apply: UE 1602 may have a policy/configuration determining that if it receives a request for emergency access/positioning (e.g., a discovery message including an emergency relay service code), UE 1602 may provide UE 1600 (1601) only with positioning/ranging SIB that are unprotected.

Additionally, or alternatively, UE 1602 may receive a protected SIB, and securely process it, e.g., decipher it and/or integrity verify it, e.g., with keying materials owned by UE 1602, UE 1602 may then forward the plaintext/unprotected SIB to UE 1600/1601.

Additionally, or alternatively, UE 1600 (1601) may be configured with a policy determining that it may require or only accept an unprotected SIB if it previously requested emergency access and emergency positioning/ranging services.

Additionally, or alternatively, UE 1602 may send a request to the core network 1607 (e.g., LMF) to deliver unprotected positioning/ranging SIB in case of emergency access.

Additionally, or alternatively, UE 1602 may engage in a positioning procedure determining its own position and may obtain a rough range of UE 1600 (1601) (i.e. between UE 1602 and UE 1600) e.g., by means of a ranging procedure wherein UE 1600 (1601) may be actively engaged (e.g., exchange PRS/SRS or measurements) or passively engage (e.g., does not exchange PRS/SRS or measurements, whereby such engaging may be based on assistance data (e.g. PosSIB) received from the RAN 1603/core network 1607; UE 1602 may determine range from signal strength measurements and/or directional information (beamforming)) and/or by performing ranging (e.g. through round-trip time measurement) and may provide the (rough) location/range of UE 1600 (1601) on behalf of UE 1600 (1601) to the core network 1607.

In general, it is described an apparatus for requesting and receiving a SIB (e.g. PosSIB) with positioning/ranging assistance data wherein the apparatus may be implemented in a remote UE and is adapted for:
requesting from the LMF (or other core network entity) ciphering keys used to securely process positioning/ranging SIBs,
connecting to a UE-to-Network relay,
sending a request to the UE-to-Network relay or the network via the UE-to-Network relay including an identifier characteristic of the requested SIB, e.g., the keying material identifier used to protect the SIB,
receiving a SIB and checking whether it includes the identifier,
securely processing said SIB using the associated keying material.

In general, it is described an apparatus (wherein above apparatus is) adapted to send a discovery message and/or a direct communication request including an emergency relay service code or other emergency service indication, and wherein the apparatus is configured to only accept or require an unprotected SIB if said discovery message and/or direct communication request including an emergency relay service code has been sent previously. This apparatus may be implemented in a remote UE.

In general, it is described an apparatus adapted to (re-)transmit an unprotected SIB to a remote UE if the apparatus has determined it is involved in emergency service, e.g. after it received a discovery message and/or direct communication request including an emergency relay service code from the remote UE previously. This apparatus may be implemented in a UE-to-Network relay device.

In general, it is described an apparatus for processing a SIB request and delivering a SIB with positioning/ranging assistance data wherein the apparatus may be implemented in a UE-to-Network relay wherein the apparatus is adapted for:
receiving a request from a remote UE including an identifier characteristic of the requested SIB, e.g., the keying material identifier used to protect the SIB,
storing the binding between remote UE and identifier,
checking whether it is allowed or capable or subscribed to receive said SIB,
receiving a SIB,
delivering the SIB to the remote UE if the SIB includes the stored identifier.

The apparatus may be further adapted to engage in a positioning procedure determining its own position and/or obtain a range and/or initiate a ranging/sidelink positioning procedure between the remote UE and the UE-to-Network relay, and may be adapted/configured to do so automatically upon receiving an emergency service indication or unprotected positioning SIB.

Section: RAN-Broadcast Supported ULLRC Time Synchronization 3GPP SA WG2 is working on the study item “Study on 5G Timing Resiliency and TSC & URLLC enhancements (FS_5TRS_URLLC)”, documented in TR 23.700-25 where one of the key problems relates to the 5GS time synchronization status report towards the UE(s). The 5GS should support informing UE and AF about the 5GS clock quality, including informing the UE and AF about 5GS clock quality degradation/improvement at different levels of degradation and improvement.

Different methods on how the RAN time synchronization status (i.e., the time synchronization status of an NG-RAN node) can be provided to UE(s) are documented in TR 23.700-25 Annex A. One method proposes to use a SIB approach that is used for broadcast of assistance data for positioning. A possibility is to distribute such SIBs in encrypted manner, as described in TS 36.355, however, this has multiple challenges including at least
whether the architecture used for the ciphering of assistance data is reusable in the context of ULLRC and
whether an approach in which only ciphering is available (as in TS 36.355) is enough or those techniques need to be enhanced to ensure other security features such as integrity, freshness/replay protection, or source authentication.

An aim is to address the above challenges by means of the following embodiments that may be combined as required.

In an embodiment, the techniques/embodiments described above are applied for the secure distribution of time synchronization status report in a SIB, TS-SIB, from RAN to UEs.

In an embodiment, the RAN has some keying material such as:
a symmetric key used in combination with an algorithm for generating message integrity codes,
a private key used in combination with a digital signature algorithm,
the seed of a hash chain used in combination with a protocol similar to TESLA,
   that is used to compute an integrity check over the data included in a SIB, e.g., TS-SIB or R-SIB, where this integrity check may be a MIC or a digital signature.

In an embodiment, the RAN includes a counter or a time stamp in the data before computing the integrity check where the counter may be a time-based counter, and the counter may only be the least significant bits of the counter to allow for small synchronization errors.

In an embodiment, the hash chain link the RAN includes refers to a hash chain link that serves as counter/time stamp to ensure freshness/replay protection.

In some scenarios, the RAN performs the broadcast of TS-SIB, e.g., as in Figures A.1.1-1, A.1.3.1-1, or A.1.4.1-1 in TR 23700-25 where the TS-SIB may refer to SIB, or SIB9. This SIB may include a time report that may contain 5GS time synchronization status report that may include multiple parameters required for time synchronization as in TR 23.700-25.

In some of these scenarios, it may be beneficial if the RAN can perform the protection of the 5GS time synchronization status report, itself, e.g., at least to protect certain fields of the report without having to involve the TSCTSF (e.g., as in case of the procedure in Clause A.1.4.1.1 and indicated in other embodiments). In this case, a NF in the CN (e.g., TSCTSF) may manage one or more keys used to perform the protection of the report. The NF may keep one key K_NF for itself, and it may allocate one key to the RAN K_RAN. The procedure for managing said keys may be as in Clause A.1.4.1.2, but enhanced to distribute to the AMF also keys for RAN (K_RAN) such that the AMF would provide RAN, where applicable (e.g., based on policy) with said key K_RAN. This may be done in a N2 transport message.

These keys may be, e.g., symmetric keys used for ciphering, e.g., as per TS 36.355, or they may be symmetric keys for integrity protection in combination with a MIC, or they may refer to a pair of public/private key, or they may be the seeds of a hash chain for a TESLA type of scheme. An authorized UE might obtain one or more keys, e.g., by means of a NAS message or an RRC message. An authorized UE might also obtain a counter, e.g., by means of a NAS message as in TS 36.355. The RAN may then receive a RAN time synchronization status from the TSCTSF (e.g., as in Step 4 in Clause A.1.4.1.1) that might already be protected as per TS 36.355 or as per other embodiments using K_NF, the RAN may then add additional fields that may also be protected as per TS 36.355 or as per other embodiments where the protection is based on K_RAN, and then the RAN may then send the broadcast message including the RAN time synchronization status (Step 5 in Clause A.1.4.1.1).

In a further embodiment, a key may be linked to some metadata including:
key value,
key identifier,
validity period,
applicable tracking areas,
Purpose (integrity/confidentiality).

In a further embodiment, since multiple security properties need to be fulfilled (e.g., integrity and/or confidentiality), there may be a root key used to derive one or more keys (e.g., an integrity key and/or a confidentiality key) where key derivation may be performed by means of a key derivation function, e.g., as per TS 33.220.

In a further embodiment, since the data needs to be integrity protected, the NF in the CN delivering the data to the RAN may include, next to the data, metadata that may contain the time when the data is to be broadcasted. In this embodiment, the CN is in charge of integrity protecting the data, and the RAN is in charge of distributing the data on time to ensure that the UEs can integrity/freshness verify the data.

In a further embodiment, since the data needs to be integrity protected, the NF in the CN delivering the data to the RAN may only be in charge of delivering (ciphered/encrypted) data and the RAN may be in charge of integrity protecting the data (including freshness protecting) by adding a counter to the received data and computing an integrity check by using an integrity key (e.g., a symmetric key or a private key or . . . ) to integrity protect the received (encrypted) data (e.g., as received from the CN) and the counter.

In a further embodiment, since multiple security properties need to be fulfilled (e.g., integrity and/or confidentiality), there are one or more keys (e.g., an integrity key and/or a confidentiality key) that are not derived by means of a KDF.

In a further embodiment, data in TS-SIB is confidentiality protected and/or integrity protected.

In some embodiments, it is referred to the ciphering methods in TS 36.355. Similar procedures appear in TS 37.355 and are applicable or adaptable in a similar manner.

In a further embodiment, if a first entity (e.g., UE, RAN, AMF) has been provided by a second entity (e.g., NF in the CN (e.g., TSCTSF or LMF) or a UE in charge of a group of UEs) with a groupcast/broadcast key to protect data (e.g., decrypt data or verify data), where the data may be exchanged in a SIB (e.g., TS-SIB or R-SIB) or in a local groupcast/broadcast message and the first entity notices that the key is about to expire, or the first entity notices that security fails (e.g., integrity check fails), then the first entity may send
an error message (that may indicate the error cause) and/or
a key update message,
to the NF, e.g., by means of a NAS message, registration request, or a N2 message, etc.

In a further embodiment, if a first entity (e.g., UE, RAN, AMF) has been provided by a second entity (e.g., NF in the CN (e.g., TSCTSF or LMF) or a UE in change of a group of UEs) with a groupcast/broadcast key to protect data (e.g., decrypt data or verify data), where the data may be exchanged in a SIB (e.g., TS-SIB or R-SIB) or in a local groupcast/broadcast message and the second entity notices that the key is about to expire, and/or the key may be/have been compromised (e.g., because a UE left the group), the NF may then—e.g., based on a policy—trigger a key update procedure.

In a further embodiment, source authentication can be achieved by means of a TESLA based protocol wherein two SIB messages (e.g., TS-SIB) need to be broadcasted. The first SIB includes the data to be broadcasted/distributed and a MIC computed with a link of the hash chain that has not been broadcasted/distributed yet. The second SIB includes the link of the hash chain that allows the verification of the previously received data.

In a related embodiment, the second entity (e.g., NF in the CN (e.g., TSCTSF or LMF) or a UE in change of a group of UEs may have a hash chain seed used to compute a hash chain by applying a hash function to the seed K times. For instance, applying a hash function to the seed two times returns Hash(Hash(seed)) that is denoted Hash\hat{ }2(seed). The anchor of the hash chain is Hash\hat{ }K(seed). In a related embodiment, upon reception of the first SIB, the UE caches the contents of the first SIB and waits for the reception of the second SIB. Upon reception of the second SIB, the UE performs two checks:

Computes the MIC using the link of the hash chain in the second SIB to verify the data received in the first SIB,

Uses the hash chain anchor that has been provided/configured to verify that the received link is ok. This can be done if the hash chain anchor is bound to a time T0 and a hash chain link is to be disclosed per time unit, e.g., 1 second. Thus, if the second SIB is received at UTC time=T0+N*unit_of_time seconds, then computing hash of the hash of the hash . . . (N times) of the received hash chain link, I.e., Hash\hat{ }N(seed) has to match the pre-configured hash chain anchor. Note that N cannot be greater than K.

If both checks pass, then the UE accepts the received data.

In a related embodiment, if the time accuracy of the UE/gNB is TA (e.g., 1 ms), and a hash chain link is disclosed ever unit_of_time (e.g., 1 second), then the UE may not accept a received SIB if the SIB has been received in the last TA before the disclosure of the next hash chain link.

In general, it is described an apparatus and method that can be implemented in a user equipment for securely obtaining a time report from an access device within a wireless network, wherein the apparatus is adapted to:
Requesting or registering in a time service,
Receiving keying materials for the secure delivery of the time reports associated to the time service,
receiving a broadcast message from an access device containing timing data,
Deciphering the received data and obtaining decrypted data,
Integrity verifying the decrypted data by means of an integrity check,
Checking the freshness of the decrypted data based on a freshness value such as a counter.

In general, it is described an apparatus and method that can be implemented in an access device and/or in a NF for securely distributing a time report from an access device within a wireless network, wherein the apparatus is adapted to:
receiving or forwarding a request for a time service,
distributing keying materials for the secure delivery of the time reports associated to the time service,
creating or receiving a time report,
ciphering the time report with at least a first key into a ciphered time report,
(optionally) adding a counter to the ciphered time report,
computing at least an integrity check of the ciphered time report using at least an integrity key,
creating a protected time report as the combination of the ciphered time report, counter, and MIC,
broadcasting the protected time report.

### Section: Further Details on Privacy Protection of Location Information

In some scenarios, since sharing the location of an anchor UE is privacy sensitive, information about whether or not an anchor UE is willing to share its location with other ranging enabled UEs may be added to a privacy profile for ranging (e.g. by extending privacy profile for location services as described in 3GPP TS 23.273). This information may include whether or not an Anchor UE (also called Located UE if its location is known or can be determined) supports sharing its location publicly, or only to (authorized) Target UEs and/or to other (authorized) Reference UEs and/or only to Target UEs or Reference UEs that are part of the same constellation or that share the same group ID/credentials and/or to the LMF 34, RMF 36 or other location and/or ranging service or proxy thereof, or other managing entity, or a core network function (e.g., UDM/AUSF). The privacy profile of an anchor UE or information thereof (e.g. profile identifier, profile type, summary of certain aspects of such profile, subset of values (possibly in a different data format)) may be shared (e.g. by the anchor UE itself, or indirectly via LMF 34, RMF 36 or other location and/or ranging service or proxy thereof) with other UEs of a ranging constellation, for example during discovery or an initial capability exchange or session/connection setup. For example it may use an LPP “RequestCapabilities” message to indicate whether or not it will share its location to the entity receiving the message (e.g. the entity sending a “RequestCapabilities” message upon which the anchor UE sends a “ProvideCapabilities” message in return) based on its privacy profile, e.g. by including a field/argument locationinformation=“private” or locationinformation=“public”, whereby such message may also include additional information about which entities it will be able to share its location with (e.g. group ID to indicate that it only will share its location to members of the same group. Additionally or alternatively, an anchor UE may indicate its support/preference for sharing its location using a location privacy field that e.g. may include some values for the different options (e.g. setting a certain bit if sharing with a Target UE is supported) in a discovery message or capability exchange message or session/connection setup message.

In a particular example, the anchor UE may include a “Location sharing with other UEs allowed” indicator during LPP Capability Exchange with a Target UE or another Anchor UE or with the LMF or proxy thereof (e.g. SL Positioning Server UE) if it supports sharing its location with another UE, such as Target UE or another Anchor UE or SL Positioning Server UE, and may omit such indicator or include a “Location sharing with other UEs not allowed” indicator if it does not support sharing its location with another UE. A Target UE or SL Positioning Server UE may use such indicator (or omission thereof) to determine whether or not to select a particular Anchor UE to be involved in the ranging/sidelink positioning procedure, or may use such indicator to select a different location procedure to be used (e.g. network-based SL Positioning procedure instead of UE-based SL Positioning procedure). Similarly, the LMF may use such indicator to determine whether or not to include the Anchor UE to be involved in a ranging/sidelink positioning procedure, and/or may use it to determine whether or not to share the Anchor UE's location to a Target UE, a SL Positioning Server UE or an Anchor UE different from the Anchor UE for result calculation, and/or may use it to determine whether or not to provide the location of a Anchor as assistance data to a Target UE, SL Positioning Server UE or other Anchor UE. The benefit of using the LPP capability exchange mechanism for this is that the same message can be used over PC5/Sidelink between the Anchor UE and the other UEs involved in a manner that works on top of ProSe as well as V2X framework (e.g. using generic PC5 groupcast/broadcast/unicast messages), as well as between the Anchor UE and the LMF. The same/similar indicator could be provided during discovery using a transparent LPP container in a ProSe discovery message containing the same/similar message content.

Additionally or alternatively, an anchor UE may indicate its support for sharing its location indirectly by indicating a list of supported ranging and/or positioning methods (which may include information about which entity will perform measurements and/or calculate a position, and which may include information about support for particular location requests (such as MO-LR), and which may include information about support for particular positioning methods (such as RTT, TDOA)) in a discovery message or capability exchange message or session/connection setup message, whereby the anchor UE adds a supported ranging and/or positioning methods if it matches its privacy profile/preference/indicator and/or does not include it if it does not match its privacy profile/preference/indicator. For example, the anchor UE may indicate that it supports only “network assisted SL positioning” and/or only MT-LR location request if it does not support sharing its location with a target UE. The target UE or other anchor UE that discovers/receives information about the anchor UE's support for sharing its location can use this to select this anchor UE or a different anchor UE to initiate ranging with and/or initiate a ranging/sidelink positioning procedure or issue a location request that matches the anchor UE's support for sharing its location and that is supported in the given coverage situation. This may depend on a pre-configured policy, or a policy or instructions (e.g. as part of a location request message, such as MT-LR) provided by the LMF 34, RMF 36 or other location and/or ranging service or proxy thereof or other managing entity to determine the criteria how to handle the various options. For example, if an anchor UE does not support sharing its location to the target UE, but only to the LMF, then target UE may initiate a direct connection (via Uu) with the LMF or indirect connection (e.g. via a relay) with the LMF and request the LMF to calculate the position of the target UE, rather than the target UE doing that itself. The target UE may provide information about which ranging/sidelink positioning procedure and/or which anchor UEs it has selected and/or information about which entity will perform ranging measurements and/or perform distance/angle/position calculation (e.g. target UE, anchor UE, LMF 34, RMF 36 or other location and/or ranging service or proxy thereof, or other managing entity) to the entity that issued a location request to the target UE and/or which requested the results of the ranging/sidelink positioning procedures (e.g. the resulting location of the target UE).

An additional way to indirectly indicate to a target UE that an anchor UE may or may not support sharing its location is by the network providing discovery security material to a target UE (e.g. restricted ProSe discovery code and/or related discovery keys, such as DUSK, DUCK, DUIK) to discover an anchor UE only after the network has verified that the anchor UE allows its location to be obtained by the network. As indicated above, it would be beneficial that a target UE can select which ranging/sidelink positioning procedure to use or select a different anchor UE based on the discovery results. So if an anchor UE allows sharing of its location with the LMF, but not with a target UE directly, then it should be possible for a target UE to distinguish those cases.

Therefore, in an embodiment that may be combined with other embodiments or implemented independently, the network (e.g. LMF, PCF, DDNMF or other managing entity) provides the target UE and/or anchor UE with different discovery codes (e.g. different restricted discovery codes or different ProSe/V2X service codes/types) and/or different discovery security materials to convey different privacy cases (e.g. as identified by the anchor UE's privacy profile/preference/indicator), for example as follows:
if anchor UE is willing and/or able to share its location, but only with the network and/or with a proxy of the LMF/RMF, the target UE (e.g. as discoverer, session initiator) and/or the anchor UE (e.g. as discoverer, session acceptor) get one set of discovery codes/security materials;
if anchor UE is willing and/or able to share its location with target UEs (e.g. in the same constellation or other identified group), the target UE and/or anchor UE get another set of discovery codes/security materials.

The information provided by the network related to the different discovery codes and/or different discovery security materials may be augmented with information about which privacy configuration/profile/preference (e.g. an identifier indicating a certain privacy configuration/profile/preference) was applied or to which the discovery code or security materials relate to, and/or with information about which anchor UE role (e.g. Located UE willing to share its location with a target UE, Located UE not willing to share its location with a target UE, or normal Reference UE (e.g. in case the Located UE is not willing to share its location or in case its location is not available)) the discovery code or security materials relate to. In that way the target UE can differentiate between the different cases and can then select a different ranging/sidelink positioning procedure. To enable this, a UE (e.g. anchor UE) may include information related to its privacy profile/preference (e.g. privacy profile identifier or other indicator, such as “Location sharing with other UEs not allowed” indicator) in a request to be provisioned with codes, identifiers and/or security profile to the respective network service responsible for providing the different discovery codes and/or different discovery security materials (e.g. as part of a Discovery Key Request to the DDNMF the UE may include an attribute to indicate that is willing and/or able to share its location with other UEs and/or to the LMF).

In an embodiment variant that may be combined with other embodiments or implemented independently, an anchor UE may be provided with at least one set of discovery security materials A related to the anchor UE willing and/or able to share its location with a target UE and at least one set of discovery security materials B related to the anchor UE not willing and/or able to share its location with a target UE. If the anchor UE receives a discovery message (e.g. a Model B solicitation request) from a target UE using discovery security materials A or B, then the anchor UE may provide a response to the discovery message using discovery security materials of the other set of discovery security materials (e.g. use B in the response instead of A used in the received discovery message if the anchor UE is not willing or able to share its location with the target UE). If the target UE is also provided with sets of discovery security materials A and B, then the target UE can determine what to expect from the anchor UE by checking which discovery security set was used in the response, without having to issue multiple discovery messages. In order to deal with the situation that a target UE may not be provided with both sets of discovery security materials A and B, but e.g. only B if it is not authorized to receive location information from an anchor UE, the target UE may need to provide two different response messages whereby one response message is protected using A and another response message is protected using B.

In an embodiment variant that may be combined with other embodiments or implemented independently, the target UE and/or anchor UE may be provisioned by the network with one or more sets of discovery codes or other codes to identify different ranging, ProSe, V2X or other PC5 services (e.g. Ranging service identifier, ProSe identifiers, V2X service/application identifiers) and/or one or more sets of security materials for the different privacy cases. The anchor UE may select which discovery code or which service/application identifier and/or which security material to expose during discovery (e.g. in a model A announce message or a model B discovery response message) or that it will accept for session setup (e.g. based on a service/application identifier or security material used in a DCR message) based on its privacy profile/configuration/preference/indicator, and/or based the identity or security material used by the discoverer/session initiator (which may be a target UE or other anchor UE) in its discovery message or session initiation message to the anchor UE, and/or based on the situation (e.g. many other anchor UEs or gNBs in vicinity, or anchor UE is overloaded, or anchor UE has lost GNSS signal, so now relying on the network to provide its location), and/or based on user input (e.g. user has temporarily disabled sharing of its location or disabled participate in ranging services with additional target UEs. The network service responsible for provisioning those codes, identifiers and/or security materials (e.g. LMF, PCF, DDNMF) may check the privacy profile/configuration/preference/indicator of an anchor UE (e.g. as stored in the UDM or provided by the anchor UE to the network for example upon registration or capability exchange or ranging session setup) before provisioning the codes, identifiers and/or security materials to target UEs and/or anchor UEs. Additionally or alternatively, a UE (e.g. anchor UE) may include information related to its privacy profile/configuration/preference in a request to be provisioned with codes, identifiers and/or security profile to the respective network service (e.g. as part of a Discovery Key Request to the DDNMF the UE may include an attribute to indicate that is willing and/or able to share its location with other UEs and/or to the LMF, e.g. a privacy profile identifier or other indicator, such as “Location sharing with other UEs not allowed” indicator). Additionally or alternatively, the UEs may be provided with policies to enable the UEs to know with which entity (e.g., target UE or LMF) the location of the anchor UE may be shared and/or policies to indicate which codes, identifiers and/or security profiles based on different conditions. By performing one or more of the above mentioned mechanisms, the Target UE can easily find out if an anchor UE is willing to share its location or not.

For instance:
1. if the target UE wishes to determine its location locally, it will use a service code/keying materials that indicate this (i.e. select code/keying materials corresponding to such privacy profile/configuration/preference/indicator of an anchor UE). The anchor UEs that are ok with sharing its location with the target UE will have related service code/keying materials, and will react to such a discovery procedure. By performing the discovery procedure with such a service code/keying materials, the anchor UE accepts sharing its location with the UE.
2. if the target UE wishes to determine its location with support of the LMF, it will use a service code/keying materials that indicate this (i.e. select code/keying materials corresponding to such privacy profile/configuration/preference/indicator of an anchor UE). The anchor UEs that are ok with sharing its location with the LMF will have related service code/keying materials, and will react to such a discovery procedure. By performing the discovery procedure with such a service code/keying materials, the anchor UE accepts sharing its location with the LMF.

The privacy configuration/profile/preference in the anchor UE and/or a respective indicator provided by an anchor UE may depend on which network the UE is, e.g. if an anchor UE determines that it is currently not operating in its home network (e.g. HPLMN), then the anchor UE may choose to not respond or respond differently (e.g. not share its location, or provide a different “location sharing with other UEs allowed” indicator during capability exchange or during discovery, or provide an error message as response) or select a different service code/keying material for its response to a discovery message of the target UE, and/or may choose to not announce itself or select a different code/keying material in a discovery message to announce itself to a target UE. Similarly, if a target UE determines that it is currently not operating in its home network (e.g. HPLMN), it may select a different code/keying material in a discovery message that it transmits to an anchor UE.

In an embodiment variant that may be combined with other embodiments or implemented independently, the codes, identifiers and/or security materials are provisioned together with information related to a certain privacy profile/configuration/preference value/field (e.g. a mapping between ProSe identifiers and certain values denoting the type of privacy restrictions (e.g. a “location sharing with other UEs allowed” indicator, or “location publicly available”, “location only allowed to be acquired by the network”, “location allowed to be acquired by a head anchor UE (e.g. acting as a proxy for LMF/RMF) or other anchor UE in a constellation”, “location allowed to be acquired by a target UE”), and/or are otherwise pre-configured/pre-determined to be related to a privacy value/field (e.g. a set of standardized V2X service identifiers that indicate certain privacy restrictions). Based on such provisioned or otherwise pre-configured/pre-determined set of codes, identifiers and/or security materials, the UEs involved (e.g. target UE or anchor UE) may determine which value to use based on its current privacy restrictions, information received from other UEs or its situation, and/or interpret the privacy restrictions of a UE that was discovered or with which a ranging/sidelink positioning session was initiated (and hence select a particular/different ranging/sidelink positioning procedure and/or select a different UE to perform ranging/sidelink positioning with). Additionally or alternatively, the code, identifier and/or security material selected/used (e.g. ranging service identifier) may be provided by one of the UEs involved (e.g. target UE or anchor UE) to the LMF/RMF or proxy thereof, DDNMF or other network function, which then selects the appropriate ranging/sidelink positioning procedure and/or select which UEs to involve in the sidelink/positioning procedure based on the received code, identifier and/or security material selected/used.

In an embodiment variant that may be combined with other embodiments or implemented independently, in case a proxy of the LMF/RMF (e.g. as operated by one or more of the anchor UEs or a separate UE) provisions/determines codes, identifiers and/or security material to the involved UEs (e.g. target UE) based on an anchor UE's privacy profile/configuration/preference/indicator and/or which ranging/sidelink positioning procedure to use and/or selecting which UEs to involve in the ranging/sidelink positioning procedure, the anchor UE may provide information about its privacy profile/configuration/preference (e.g. “location sharing with other UEs allowed” indicator) to such proxy (since such proxy may be out of coverage and may not be able to connect to the respective network service (e.g. UDM)). Before sharing information about its privacy profile/configuration/preference, the anchor UE may verify if the proxy is genuine and/or trusted, e.g. by verifying if it is authorized by the network to be able to act as a proxy of LMF/RMF (e.g. using authorization tokens or other mechanism as described in other embodiments).

In an embodiment that may be combined with other embodiments or implemented independently, the entity responsible for verifying the privacy profile/configuration/preference/indicator for the anchor UE (e.g. LMF, PCF, DDNMF, . . . ) may indicate in a field of a message to the UDM (or other entity that stores the privacy profile/configuration/preference/indicator) that the verification is meant for ranging/sidelink positioning service and/or is part of ranging/sidelink positioning procedure, upon which the UDM (or other entity that stores the privacy profile/configuration/preference/indicator) may determine to send ranging related information stored in the privacy profile/configuration/preference/indicator in its response (e.g. whether or not an anchor UE (e.g. identified in another field of the respective message) allows its location to be shared with target UEs). Additionally or alternatively, the entity responsible for verifying the privacy profile/configuration/preference/indicator for the anchor UE (e.g. LMF, PCF, DDNMF, . . . ) may indicate in a field of a message to the UDM (or other entity that stores the privacy profile/configuration/preference/indicator) not only an identifier of the anchor UE, but also an identifier of a target UE or other anchor UE (or separate UE operating as a LMF/RMF proxy), upon which the UDM (or other entity that stores the privacy profile/configuration/preference/indicator) may determine whether or not in the privacy profile/configuration/preference/indicator of the two UEs allow location information to be shared/exchanged with each other, and indicate the outcome of such determination (e.g. boolean which indicates that the respective anchor UE allows its location to be provided to the respective target UE) in its response.

In an embodiment that may be combined with other embodiments or implemented independently, the privacy profile for ranging of an anchor UE (e.g. stored in the UDM) may indicate a request for notifying or confirmation of the user before exposing the location of the anchor UE to another UE, such as target UE or location service proxy (e.g. Sidelink Positioning Server UE). The LCS Privacy profile of Table 7.1-1 of TS 23.273 may be extended with a Privacy Profile Data Type for ranging and/or related UDM data for denoting one or more of the following entries of the privacy profile:

Location sharing allowed with target UEs.

Location sharing allowed with target UEs with notification.

Location sharing allowed with Target UEs with notification and privacy verification; location allowed if no response.

Location sharing allowed with Target UEs with notification and privacy verification; location restricted if no response.

Location sharing allowed with anchor UEs.

Location sharing allowed with anchor UEs with notification.

Location sharing allowed with anchor UEs with notification and privacy verification; location allowed if no response.

Location sharing allowed with anchor UEs with notification and privacy verification; location restricted if no response.

Location sharing allowed with location service proxy (which may be combined with target UE, anchor UE or operated by a separate UE).

Location sharing allowed with location service proxy with notification.

Location sharing allowed with location service proxy with notification and privacy verification; location allowed if no response.

Location sharing allowed with location service proxy with notification and privacy verification; location restricted if no response.

Each of these entries may be further augmented with information related to constellation identifiers or group IDs for which the exposure is valid, and/or coverage situation in which this is valid (e.g. only if other UE is in coverage, which may be further augmented with information about validity time, e.g. only if out-of-coverage for not longer than a certain period of time). Based on the entries in the privacy profile, the network (e.g. network function such as AMF, LMF, RMF) or LMF/RMF proxy may first send a message to the respective anchor UE or target UE that may include a request for notifying of the user and/or confirming by the user (whereby the confirmation or rejection by the user can be provided in a response message by the respective anchor UE or target UE) before initiating a ranging/sidelink positioning procedure and/or before proceeding with an ongoing ranging/sidelink positioning procedure and/or before fetching the Located UE's location and/or before exposing its location to other UEs involved in ranging/sidelink positioning procedure and/or before provisioning other UEs involved in ranging/sidelink positioning with (discovery) codes, identifiers and/or security materials for identifying/discovering/setting up a connection with the respective anchor UE or target UE. In an example, this is done by a LocationNotification message extended for the purpose of requesting sharing location information with another UE (e.g. Target UE or location service proxy), which is sent to an anchor UE, after which the anchor UE responds with a LocationNotificationRes message extended for indicating a positive or negative response to sharing location information with another UE and/or extended to include the location of the anchor UE. If the user confirmation is positive, then the location of the anchor UE may be provided to the LMF and/or another UE, e.g. as a response to a subsequent request for the anchor UE's location from the LMF and/or another UE, or the LMF providing the location of the anchor UE (that it may know already or retrieve from the GMLC) to another UE. If the user confirmation is negative (e.g. user rejects or does not respond), then the location of the anchor UE is not provided to the LMF and/or another UE and/or the anchor UE may send an error message indicating the negative response to the LMF. The anchor UE may provide a positive or negative response based on a check of its internal privacy profile/configuration/preferences without displaying a notification or user confirmation dialog with the user. Such request for notifying of the user and/or confirming by the user may include an identifier of the target UE and/or location service proxy and/or may include a description of the target UE (e.g. friendly name or type of device) or location service proxy which may be shown to the user instead or in addition to an identifier of the target UE or location service proxy. Such description may be based on information stored in the UDM/UDR about the target UE or location service proxy and/or may be provided by the respective target UE or location service proxy during ranging/sidelink positioning procedures (e.g. as attribute in location request, or as LPP message extended for this purpose or as supplementary service message extended for this purpose). Such request for notifying the user and/or confirming by the user may include an indication that the request relates to a ranging/sidelink positioning service and/or is part of ranging/sidelink positioning procedure. For example, it may include the type of ranging/sidelink positioning procedure (e.g. UE-only, Network-assisted or Network-based procedure), or include an indicating that the location of the anchor UE is to be shared with Target UE or LMF/RMF proxy and/or to LMF (e.g. by including an identifier of Target UE or LMF/RMF proxy or LMF. Such request for notifying the user and/or confirming by the user may include a type of ranging/sidelink related location information requested, such as absolute location of the anchor UE with high accuracy, absolute location of the anchor UE with low accuracy, range/distance and/or angle related information. The privacy profile/configuration/preferences of the anchor UE may be different depending on the type of procedure or type of location information requested. Hence, the response of the anchor UE may be different depending on the type of procedure or type of location information requested.

A UE (e.g. anchor UE) may update such privacy profile for ranging and/or indicate its preference to share its location with other UEs (e.g. target UE or location service proxy), which may be augmented with different conditions, by leveraging the UE location privacy setting procedure as specified in TS 23.273.

In general, it is provided an apparatus and/or method that can be implemented in a UE, wherein the apparatus is adapted to perform the following method:
operate as an anchor UE that knows or is able to determine its own location and may assist in obtaining a range or location estimate of a target mobile device within a wireless network;
receive a first message from the network that includes a request for notifying or confirmation of the user before exposing the location of the anchor UE to another UE.
transmit a second message that includes a positive or negative response to the user confirmation request, e.g. based on a user confirmation dialog or based on checking its privacy profile or privacy configuration or privacy preferences, and/or transmit a message that includes the location of the anchor UE if the response to the user confirmation request was positive.

Further, another UE may be the target mobile device or a location service proxy, and/or the request may include one or more of the following:
an indication that the request relates to a ranging/sidelink positioning service
the type of ranging/sidelink procedure
the type of ranging/sidelink location related information requested.
an identifier of one or more UEs to which the location information is to be shared.
a description of one or more UEs to which the location information is to be shared.

In an embodiment that may be combined with other embodiments or implemented independently, if the privacy profile pertaining to ranging/sidelink positioning indicates that it user confirmation/notification is required from an anchor UE about whether or not it is willing to share its location, then if the respective anchor UE is not reachable (e.g. out-of-coverage) by the AMF, LMF/RMF, or LMF/RMF proxy or other managing entity, then the AMF, LMF/RMF, or LMF/RMF proxy or other managing entity may send a message to another UE involved in the ranging/sidelink positioning procedure/session (e.g. target UE) that is in coverage, the message including a request (e.g. an encapsulated LocationNotification message extended for this purpose) for notifying of the user and/or confirming by the user of the respective anchor UE and/or a request to (try to) fetch the location from the respective anchor UE (e.g. an encapsulated Request Location message extended for this purpose), the message/request further including an identifier of the respective anchor UE to which the message/request is to be forwarded/transmitted. After receiving such message/request, the another UE forwards/transmits the message/request (at least part thereof) to the respective anchor UE, after which the respective anchor UE can provide a confirmation request to the user (e.g. show a confirmation dialog on the anchor UEs Graphical User Interface) based on which the user can indicate if the location of the anchor UE can be shared with the Target UE or LMF/RMF proxy and/or check its privacy profile/configuration/preferences (that may override showing a dialog or notification to the user). To this end, the (encapsulated) message/request may include an identifier of the UEs with which the location of the anchor UE will be shared and/or a description of the target UE (e.g. friendlyname or type of device) or location service proxy that can be shown to the user. Based on the anchor UE's privacy configuration/preferences (e.g. privacy profile) and/or security policy and/or after a user confirmation dialog, the anchor UE may in a response message provide information whether or not it will share its location with the Target UE or LMF/RMF proxy or LMF and/or select different security credentials for protecting the location information in the response message if the location information can be shared with the Target UE and/or shared with the LMF/RMF proxy than if the location is not to be shared with the Target UE and/or LMF/RMF proxy and e.g. only to the LMF, e.g. using credentials that enables the Target UE and/or LMF/RMF proxy to decrypt or using credentials (e.g. based on a configured end-to-end encryption key for communication with the LMF, or the core network's public key) that enables only the LMF to decrypt and not the Target UE and/or LMF/RMF proxy. The another UE that is in coverage may after receiving this response message from the anchor UE transmit the received response message (or part thereof) to the respective AMF, LMF/RMF, or LMF/RMF proxy or other managing entity.

In the current architecture specified in TS 23.273, the LMF does not have direct access to the privacy profile information. Instead, the GMLC is responsible for fetching/communicating with the UDM/UDR to check/verify the privacy profiles and enforce the privacy settings in the profile. Furthermore, if the privacy profile indicates notification or verification of a location request is required, the GMLC indicates this in the initial location request sent to the serving AMF and the serving AMF notifies the UE or verifies the location request with the UE when the UE first becomes reachable.

In order to solve this, the following embodiment and embodiment options/variants are presented. In this embodiment that may be combined with other embodiments or implemented independently, the LMF may need to request the GMLC to fetch/check/verify the privacy profiles extended for Ranging/Sidelink Positioning (as described in other embodiments, such as additional privacy profile settings for sharing the location of an anchor UE) and/or to request the GMLC to provide information related to the privacy profiles to the LMF. To this end, the LMF may need to send a message to the GMLC that may include an identifier of the anchor UE for which the ranging/sidelink positioning profile needs to be fetched/checked/verified, possibly including some attributes denoting the information that is requested (e.g. whether or not it is allowed to share the location of the anchor UE with a target UE or an LMF/RMF proxy (e.g. Ranging/Sidelink positioning server UE)), possibly including an identifier of a target UE or other anchor UE or LMF/RMF proxy (e.g. Ranging/Sidelink positioning server UE) or a group identifier, and possibly including a (group) credential used/provided by the respective target UE, other anchor UE or LMF/RMF proxy, and possibly including an indication that the privacy check pertains to ranging/sidelink positioning and not to other positioning methods. The GMLC can use this information to fetch/check/verify—by interacting with the UDM/UDR—the appropriate information stored in the privacy profile of the respective anchor UE, and provide information about this to the LMF in a response message. For example, the identifier of a target UE or other anchor UE or LMF/RMF proxy or group identifier and/or (group) credential used/provided by the target UE, other anchor UE or LMF/RMF proxy may be used to check if sharing with the respective target UE, anchor UE, LMF/RMF proxy is allowed by the privacy profile of the anchor UE (e.g. because the anchor UE and Target UE belong to the same “trusted” group). To this end, the GMLC may need to exchange information with other core network functions (e.g. UDM, AMF) to verify whether the identifier (e.g. application layer ID) used by the target UE, anchor UE, LMF/RMF proxy towards its communication to the LMF corresponds with the identifiers (e.g. SUPI) registered for the respective target UE, anchor UE, LMF/RMF proxy when the respective target UE, anchor UE, LMF/RMF proxy registered to the network. Additionally or alternatively, an additional authentication procedure may be initiated with the respective target UE, anchor UE, LMF/RMF proxy.

In an option, this message/set of attributes sent to the GMLC may be combined with a 5GC-MT-LR request to acquire the location of the respective anchor UE. Additionally or alternatively, the message/set of attributes may include an attribute that indicates whether the LMF plans to use the location of the respective anchor UE for position calculation of a Target UE by itself or plans to share the location of the anchor UE for position calculation of the Target UE by the Target UE itself or by a LMF/RMF proxy (e.g. SL Positioning Server UE). The GMLC can use this information to fetch/check/verify—by interacting with the UDM/UDR—the appropriate information stored in the privacy profile of the respective anchor UE, and provide information to the LMF in a response message whether or not the requested usage of the location of the anchor UE is allowed or not.

In an option, the message sent to the GMLC may include a ranging service identifier associated or allocated to the ranging procedure. For instance, the target UE and anchor UE may be associated with a ranging service and may have been allocated such ranging service identifier that allows the sharing of the location of the anchor UE with the target UE. The discovery of a ranging constellation may be done based on such an identifier. Then the LMF may share this identifier with the GMLC and the GMLC may share it with the UDM/UDR to check whether it is linked with a privacy profile that allows sharing the location of the anchor UE with the target UE, or it does not.

In an option, the privacy profile may be fetched/checked/verified when a UE (target UE or anchor UE) is registering or requesting the access to a given ranging service, i.e., prior to the ranging operation. An anchor UE that allows sharing its location with target UEs may be given/allocated a ranging service identifier indicative of it. Thus, a target UE and anchor UE such that the anchor UE allows sharing of its location with the target UE may, e.g., discover each other. This has the advantage of limiting the access to GMLC/UDM/UDR during the operational ranging phase. It is to be noted that the ranging service identifier may be linked to some security credentials/keys that allow verifying the validity of said identifier, e.g., during discovery.

In an option, if the privacy profile indicates that in order to share the location of the anchor UE to a target UE, LMF/RMF proxy or other UE, it requires the anchor UE to be notified/requested for confirmation, the GMLC may issue a request to do this to the AMF, which will notify the UE or verify the location sharing request (e.g. to a target UE) with the respective anchor UE, before the GMLC provides the information to the LMF. This may e.g. be done using the LocationNotification message extended for the purpose, as described in other embodiments. If the respective anchor UE does not agree with sharing its location (based on the privacy profile or the confirmation that may have been declined or may not have been received), the GMLC can inform the LMF that sharing is not allowed, after which the LMF will not share the location of the anchor UE.

In a further option, based on the Ranging/Sidelink positioning privacy profile information provided by the GMLC, the LMF may issue a notification/request for confirmation to the AMF.

In an embodiment variant, the LMF is provided with a direct interface with the UDM/UDR to fetch/check/verify the privacy profiles extended for Ranging/Sidelink Positioning itself, and the LMF is responsible for issuing the necessary notifications/requests for confirmation to the AMF.

In another embodiment variant, the GMLC may fetch privacy profile related information from the UDM/UDR pertaining to an anchor UE (e.g. whether or not the anchor UE allows sharing its location with Target UE, LMF/RMF proxy or other anchor UE), and provides information related to the privacy profile of the anchor UE to the AMF (e.g. as part of Namf_Location_ProvidePositioningInfo service operation towards the AMF serving UE1 to request Sidelink positioning/ranging location results related to the target UE and that may involve the respective anchor UE), which may include this information in its communication with the LMF (e.g. as part of Nlmf_Location_DetermineLocation service operation towards the LMF in order to obtain the location of a Target UE using a Ranging/Sidelink Positioning procedure that may involve the respective anchor UE).

In an embodiment that may be combined with other embodiments or implemented independently, the GMLC has access to the ranging/privacy profile settings of whether an anchor UE, is willing to share its location with another UE (e.g. target UE) as described in other embodiments. Upon the AMF receiving a service request to perform ranging/sidelink positioning (e.g. receiving a SL-MO-LR request from a target UE that may contain a list of anchor UEs) and/or receiving a separate list of anchor UEs (e.g. receiving a list of discovered anchor UEs from a target UE or LMF), the AMF issues a message to the GMLC that includes such list of anchor UEs, and may further include an identity of another UE (e.g. target UE, LMF proxy). The GMLC, upon receiving a list of anchor UEs from the AMF, will verify the privacy profile of each anchor UE in the list to determine if the respective anchor UE is able/willing to share its location with another UE (e.g. the one matching the identity of the another UE provided by the AMF) or not. The GMLC may return the result of this check whether or not the respective anchor UE is able/willing to share its location or not to the AMF, which may use this information to remove anchor UEs that are not willing to share their location with another UE (e.g. the another UE for which the identity was included) from the list of anchor UEs. For example, if the ranging/sidelink positioning request from the UE or LMF indicated that the ranging/sidelink positioning procedures would include sharing the location of the anchor UE (e.g. due to a UE and not the LMF being responsible to calculate the ranging/sidelink positioning result), then those anchor UEs not willing to share their location with another UE would need to be excluded from being involved in the ranging/sidelink positioning procedures. The AMF may return the reduced list of anchor UEs to the LMF as input for further ranging/sidelink positioning procedure steps. Additionally or alternatively, if the GMLC is provided with a list of anchor UEs by the AMF, then if the respective anchor UE is not able/willing to share its location with another UE, the GMLC may remove the respective anchor UE from the list of anchor UEs, and return the reduced list of anchor UEs to the AMF, which may provide the reduced list to the LMF. In reference to the SL-MO-LR procedure in 6.20.1 of 3GPP TS 23.273 v18.4.0, this would mean that an additional step would be needed between steps 8 and 9 to involve the GMLC in the privacy check.

In an option, if the privacy profile indicates that in order to share the location of the anchor UE to a target UE, LMF/RMF proxy or other UE, it requires the anchor UE to be notified/requested for confirmation, the GMLC may issue a request to do this to the AMF, which will notify the UE or verify the location sharing request (e.g. to a target UE) with the respective anchor UE, before the GMLC provides the information to the LMF. This may e.g. be done using the LocationNotification message extended for the purpose, as described in other embodiments. If the respective anchor UE does not agree with sharing its location (based on the privacy profile or the confirmation that may have been declined or may not have been received), the GMLC can inform the LMF that sharing is not allowed, after which the LMF will not provide the location of the anchor UE.

In general it is provided a system and method that may be implemented in a wireless network, wherein a location service retrieves/receives information on whether an anchor UE will share its location with another UE (e.g. target UE or LMR/RMF proxy) or not based on the privacy profile/configuration/preferences of the anchor UE, and based on this information determine whether or not to provide the anchor UE's location to the another UE.

Further, the location service may receive this information from another service in the network (e.g. AMF) which may have access to a privacy profile/configuration/preferences extended for this purpose and that may be stored in a database (e.g. UDM/UDR) and that may perform a privacy check based on the stored information, or from the anchor UE, which may be requested to confirm whether or not to share the anchor UE's location with another UE.

Further, the location service may receive this information when issuing a 5GC-MT-LR request to acquire the location of the respective anchor UE (e.g. in cooperation with GMLC or AMF), wherein such request may include an identifier of the anchor UE and/or an indication that the privacy check pertains to ranging/sidelink positioning and not to other positioning methods and/or an identifier of another UE with which the anchor UE's location is to be shared and/or an indication whether the LMF plans to use the location of the respective anchor UE for position calculation of a Target UE by the location service itself or plans to share the location of the anchor UE for position calculation of the Target UE by the Target UE or by a LMF/RMF proxy (e.g. SL Positioning Server UE).

In general it is also provided a system and method that may be implemented in a wireless network, wherein a location related service (e.g. GMLC) performs the privacy check and/or receives/retrieves the information by a network service on whether an anchor UE will share its location with another UE may be performed by the network (e.g. GMLC) upon receiving a SL-MO-LR request from a target UE that may contain a list of anchor UEs, based on which the anchor UEs that are not willing to share their location may be removed from the list if the SL-MO-LR request indicates that sharing with another UE would be needed.

In an embodiment that may be combined with other embodiments or implemented independently, an Anchor UE's authorization information (e.g. as provided by the PCF or LMF or UDM) may include different roles for when an Anchor UE supports sharing its location with other UEs and when it does not support sharing its location with other UEs and/or different roles for the different privacy profile/configuration/preference alternatives. For example, an Anchor UE may be authorized for different Located UE roles/variants, e.g. “Located UE with sharing location with other UEs” or “Located UE without sharing location with other UEs”. The authorized role in the anchor UE may depend on which network is serving the UE and may have certain restriction specified for each authorized role. The anchor UE may select a different role depending on which restrictions apply and which restrictions do not apply, e.g. if an anchor UE determines that it is currently not operating in its home network (e.g. HPLMN), then the anchor UE may choose to not share its location with other UEs, and hence may use the “Located UE without sharing location with other UEs' role.

In an embodiment that may be combined with other embodiments or implemented independently, the above mentioned solutions for limiting the exposure of the anchor UE's location to other UEs involved in ranging/sidelink positioning based on an anchor UE's privacy profile/configuration/preference are used for limiting the exposure of the target UE's calculated location to other UEs involved in ranging/sidelink positioning or for limiting which other UEs may be involved in calculating the position of the target UE. For example, the target UE may expose information about its privacy profile/configuration/preference during discovery, or different sets of discovery codes and/or security materials may be provided to the anchor UEs that may be involved in ranging/sidelink positioning of the target UE, etc. Since exposure of a target UE's location is also possible by a set of anchor UEs using the measurements received of a target UE to calculate the target UE's positioning result, restricting the exposure of the target UE's location based on the target UE's privacy profile/configuration/preference also automatically implies restriction on which entity may perform the distance, angle and/or position calculations. Hence, information about the privacy profile/configuration/preference of the target UE may not only be used for selecting which ranging/sidelink positioning procedure to use and/or which anchor UEs to involve in sidelink positioning, but also which entity/entities performs/perform the calculations of the target UE's position (e.g. target UE itself, one of the anchor UEs, LMF/RMF or proxy thereof). For example, if the target UE only allows calculation of its position by the LMF/RMF it may provide a ranging service identifier to the LMF/RMF or proxy thereof that has been provisioned for that purpose (e.g. by using a mapping between ranging service identifier and one or more ranging procedures and/or one or more privacy exposure limitations/capabilities), and/or provide such ranging service identifier to an anchor UE which may forward this ranging service identifier to the LMF/RMF, and/or may use this information to determine which ranging/sidelink procedure to use and/or to determine which entity to send its measurements to and/or which measurements/calculations to perform (e.g. only distance measurements) and/or which entity will perform the positioning calculations.

Additionally or alternatively, the target UE's privacy profile/configuration/preference may have different entries/values for “distance measurements”, “angle measurements”, “relative position calculations”, and/or “absolute positioning calculations”, since the target UE may for example allow distance/angle measurement, but not perform calculating its absolute position.

In an embodiment that may be combined with other embodiments or implemented independently, the LCS privacy profile (e.g. stored in the UDM) of a UE may indicate whether or not it allows exposure of its location to another Entity (e.g. LCS Client) with low accuracy (i.e. lower than the accuracy of the location as it is obtained, stored, or can otherwise be exposed to another entity). To this end the LCS Privacy profile of Table 7.1-1 of TS 23.273 may be extended with a Privacy Profile Data Type and/or related UDM data for denoting one or more of the following entries of the privacy profile:
positioning allowed with low accuracy without notifying the UE user (default case);
positioning allowed with low accuracy with notification to the UE user;
positioning with low accuracy requires notification and verification by the UE user; positioning with low accuracy is allowed only if granted by the UE user or if there is no response to the notification;
positioning with low accuracy requires notification and verification by the UE user; positioning with low accuracy is allowed only if granted by the UE user; Location sharing allowed with low accuracy (e.g. general setting to indicate sharing with external entities, such as LCS Clients which may include third-party applications);
Location sharing allowed with low accuracy with notification to the UE user; Location sharing with low accuracy requires notification and verification by the UE user;
location sharing with low accuracy is allowed only if granted by the UE user or if there is not response to the notification;
Location sharing with low accuracy requires notification and verification by the UE user;
   location sharing with low accuracy is allowed only if granted by the UE user;
   Location sharing allowed with Target UEs with low accuracy.
Location sharing allowed with Target UEs with low accuracy with notification to the UE user;
Location sharing with Target UEs with low accuracy requires notification and verification by the UE user; location sharing with low accuracy with Target UEs is allowed only if granted by the UE user or if there is not response to the notification;
Location sharing with Target UEs with low accuracy requires notification and verification by the UE user; location sharing with low accuracy with Target UEs is allowed only if granted by the UE user Location sharing allowed with Anchor UEs with low accuracy.
Location sharing allowed with Anchor UEs with low accuracy with notification to the UE user;
Location sharing with Anchor UEs with low accuracy requires notification and verification by the UE user; location sharing with low accuracy with Anchor UEs is allowed only if granted by the UE user or if there is not response to the notification;
Location sharing with Anchor UEs with low accuracy requires notification and verification by the UE user; location sharing with low accuracy with Anchor UEs is allowed only if granted by the UE user;
Location sharing allowed with location service proxy with low accuracy.
Location sharing allowed with location service proxy with low accuracy with notification to the UE user;
Location sharing with location service proxy with low accuracy requires notification and verification by the UE user; location sharing with low accuracy with location service proxy is allowed only if granted by the UE user or if there is not response to the notification;
Location sharing with location service proxy with low accuracy requires notification and verification by the UE user; location sharing with low accuracy with location service proxy is allowed only if granted by the UE user

In a related embodiment that may be combined with other embodiments or implemented independently, the privacy profile of a UE are provisioned to the respective UE and/or to other UEs involved in a ranging/sidelink positioning procedure. Such profiles may be combined/stored together with ProSe/V2X security profiles for the respective UEs.

In another related embodiment that may be combined with other embodiments or implemented independently, the privacy profile of a UE or information thereof (e.g. profile identifier, profile type, summary of certain aspects of such profile, subset of values (possibly in a different data format)), a preference or other parameter indicating whether or not a UE is willing to share its location with another UE or e.g. only with the LMF, is provided as part of a Direct Security Mode Command or Direct Security Mode complete message as specified in TS 33.536, extended for this purpose, or other message related to security exchange or message exchange for authorization checking or privacy checking between the involved UEs over PC5. For example, during authorization checking, a Located UE may receive information from the target UE about whether the target UE will request the Located UE's location for calculation of the location of the target UE by the target UE itself or that the calculation will be done by the LMF. The Located UE can check based on its policy or privacy configuration/profile/configuration/preferences stored in the device itself whether or not it is willing to share its location with the requesting target UE, e.g. based on identity or credential information received from the requesting target UE. If it is willing to share, it may send a message to the target UE that includes information to confirm that the Located UE authorizes/approves its location sharing to the target UE, or to deny the authorization/approval (e.g. by sending an error message, such as authorization failed) to the respective target UE. The target UE may include information related to the authorization/approval of whether the Located UE is willing to share its location with target UE or not or e.g. only to LMF, in its location request to the core network (e.g. AMF, LMF).

In an embodiment that may be combined with other embodiments or implemented independently, a UE (e.g. Located UE or Target UE or Server UE) may be configured (e.g. by a policy received from the network) or instructed by the network (e.g. by the LMF/GMLC/AMF which may have access to the UE's privacy profile stored in the network) to make itself discoverable or not discoverable (e.g. through ProSe Model A discovery announcement or transmitting a ProSe Model B discovery response message) in certain conditions, in order to protect the privacy of its location. Such conditions may include but are not limited to one or more of the following:
The UE is out-of-coverage or has bad connection (and hence the LMF may not be used in the procedure, hence it may not make itself discoverable if it does not allow the UE's location to be shared to the discoverer UE e.g. for position calculation outside of the LMF or for exposure to a Client UE or LMF/RMF proxy over PC5).
The UE receives certain attribute values from the discoverer UE (e.g. in a ProSe Model B discovery solicitation message), such as:
   An attribute that indicates that the discoverer UE is in-coverage or out-of-coverage. For example, if the discoverer UE is in-coverage and the UE is out-of-coverage, it may be able to set up an end-to-end protected connection with the network (e.g. to share its location with the LMF that may calculate the position), and hence the UE may make itself discoverable.
   An attribute that indicates that a distance, angle or relative position is/will be requested or is to be calculated. For example, a UE may allow discovery in such case, since it does not require the absolute location of the UE to be exposed.
   An attribute that indicates that the location information that is/will be requested from the UE is above or below a minimum or maximum accuracy. For example, if the requested location information is not needed to be very accurate, then the UE may deem sharing an inaccurate location or location with lower accuracy to be sufficient to protect its privacy.
   An attribute carrying a trusted credential (e.g. credential of a trusted group of UEs, or secure token/authorization token signed by an entity in the network) that the UE may verify before deciding to make itself discoverable to not.
   An attribute indicating an identity of the discoverer UE that is on a whitelist or blacklist of identifiers stored by the UE.
   An attribute indicating that the location request is for an emergency connection.
The UE is in a certain geographical area (e.g. tracking area), for example in an area of deployment that is considered to be sufficiently safe from intruders (e.g. inside a factory or a fenced area).

The conditions as mentioned above may be configured and processed/verified together with the privacy settings stored at the UE, e.g. may be part of a privacy profile for ranging/sidelink positioning. For example, it may first check its privacy profile and then the above mentioned conditions or in reverse order or the conditions may be stored as part of the privacy profiles, e.g.:

For any UE, LCS client or AF not in the trusted UE list or External LCS client list
or otherwise identified for the Call/session Unrelated Class, the following data may
be present:

| | |
|---|---|
| - | One of the following mutually exclusive options: |

| - | Ranging/SL Positioning discovery not allowed (default case) |
|---|---|
| - | Ranging/SL Positioning discovery allowed with notification |
| - | Ranging/SL Positioning discovery with notification and privacy |
| | verification; Ranging/SL Positioning discovery allowed if no response |
| - | Ranging/SL Positioning with notification and privacy verification; |

Ranging/SL Positioning discovery not allowed if no response

| | |
|---|---|
| - | Time period when Ranging/SL Positioning discovery is allowed |
| - | Geographical area where Ranging/SL Positioning discovery is allowed |
| - | Coverage condition (e.g. in coverage) when Ranging/SL Positioning discovery |

is allowed

Trusted UE list or External LCS client list: a list of zero or more UEs, LCS clients,
AFs, with the following data for each entry:

| | |
|---|---|
| - | One of the following mutually exclusive options: |

| - | Ranging/SL Positioning discovery allowed without notification (default |
|---|---|
| | case) |
| - | Ranging/SL Positioning discovery allowed without notification when in |
| | coverage |
| - | Ranging/SL Positioning discovery allowed with notification |
| - | Ranging/SL Positioning discovery allowed with notification when out-of- |
| | coverage |
| - | Ranging/SL Positioning discovery with notification and privacy |
| | verification; Ranging/SL Positioning discovery allowed if no response |
| - | Ranging/SL Positioning with notification and privacy verification; |

Ranging/SL Positioning discovery restricted if no response

| | |
|---|---|
| - | Time period when Ranging/SL Positioning discovery is allowed |
| - | Geographical area where Ranging/SL Positioning discovery is allowed |

The UE may inform the core network (e.g. the LMF/RMF) or a (trusted) LMF/RMF proxy (e.g., server UE) if certain conditions are met and/or that it made itself discoverable or not, possibly together with an identifier of the discoverer UE and/or may inform the core network (e.g. the LMF) about one or more privacy settings for exposing its location to other UEs (e.g. which privacy settings are applied for the respective discoverer UE or for a set of UE identifiers). This information may be used by the core network (e.g. LMF/GMLC) or LMF/RMF proxy to skip certain privacy checks in later parts of the ranging/sidelink positioning procedures. Additionally or alternatively, the core network (e.g. LMF/GMLC) or LMF/RMF proxy may upon receiving such information from the UE verify the conditions that are met and/or check the identifier of the discoverer UE to see if it is a trusted/authorized discoverer UE and/or verify the privacy profile of the UE available to the core network (e.g. LMF/GMLC, typically stored in the UDM) or LMF/RMF proxy to determine which privacy settings apply, and then inform the respective UE about whether the discovery settings (e.g. whether or not the UE made itself discoverable or not) are/were correctly applied and/or which discover setting to apply, and/or to transmit an update to the UE's configuration/policy.

This embodiment may be applicable, e.g., to Procedure of UE privacy verification for UE-only operation described in Clause 6.3.7 in TS 33.533 v.1.0.0. In particular, the privacy check described in that clause may apply to Ranging/SL positioning UE discovery, e.g. when a Target UE selects a UE as the Location UE during discovery or when a Located UE is triggered to announce itself for discovery. During discovery, if the privacy profile allows location exposure to the discoverer UE, the discoveree may include a “Location available to discoverer” attribute in the discovery message to the discoverer, e.g., based on a policy. If the privacy profile of the to-be-discovered UE (e.g. the Located UE) does not, e.g., allow location exposure, it shall discard (as monitoring UE with Model A discovery) or reject (as discoveree UE with Model B discovery) the discovery message. If the UE privacy verification check is performed during discovery, the UE privacy verification does not need to be performed in a later phase based on policy or configuration.

In general, it is proposed an apparatus and method that can be implemented in a UE to provide a fine-grained privacy protection prior to a ranging procedure wherein the apparatus is adapted to:
check a privacy preference,
perform a discovery phase with or without privacy check based on the privacy preference, and
perform a further communication phase with or without privacy check based on the privacy preference.

In an embodiment that may be combined with other embodiments or implemented independently, a Located UE that is not willing to share its location to a Target UE or location service proxy (e.g. SL Positioning Server UE) sends an error message (e.g. “Location sharing failure”) to the respective Target UE or location service proxy if it requests the location of the Located UE (e.g. by the Target UE or location service proxy sending a “RequestLocationInformation” message over PC5 to the Located UE). Before doing so, the Located UE may provide a confirmation request to the user (e.g. show a confirmation dialog on the Located UEs Graphical User Interface) based on which the user can indicate if the location of the Located UE can be shared with the Target UE or location service proxy. To this end, the request message sent by the Target UE or location service proxy may include an identifier of the UEs with which the location of the Located UE will be shared and/or a description of the target UE (e.g. friendlyname or type of device) or location service proxy that can be shown to the user. Additionally or alternatively, the Located UE may be configured with a description of one or more Target UEs or location service proxies and their identifier, upon which the Located UE can retrieve the description of a Target UE or location service proxy if it receives an identifier of the Target UE or location service proxy, and use the retrieved description of the Target UE or location service proxy in its confirmation request to the user.

In an embodiment variant that may be combined with other embodiments or implemented independently, a Located UE that is not willing to share its location to a Target UE or location service proxy (e.g. SL Positioning Server UE) or for which the privacy profile allows sharing location with low accuracy sends a response message (e.g. “ProvideLocationInformation” message over PC5) to the respective Target UE or local proxy if it requests the location of the Located UE (e.g. by the Target UE or location service (i.e. LMF/RMF) proxy (e.g. SL Positioning Server UE) sending a “RequestLocationInformation” message over PC5 to the Located UE) which includes the Located UE's location with low accuracy (e.g. uses a data format with less digits for one or more fields in a location report, use a different location report (e.g. only provide cell identifier instead of detailed location coordinates), omit some fields in the location report (e.g. only x,y coordinates, not z-coordinate, or omit angle information), increase the level of uncertainty.

In another embodiment variant that may be combined with other embodiments or implemented independently, a Target UE or LMF/RMF proxy (e.g., server UE) may issue a request for the Located UE (i.e., anchor UE) to obtain and/or share its location (e.g. requesting the initiation of a 5GC-MO-LR procedure or as an LCS client request extended for Ranging/Sidelink Positioning) in a message over PC5 to the Located UE. Such message may include an attribute indicating that this message is related to a Ranging/Sidelink Positioning procedure and may include a related session identifier and/or group/constellation identifier and/or ranging service identifier, and/or it may have a payload that is protected (e.g., encrypted, integrity protected) or that includes a credential through which the Target UE or LMF/RMF proxy can authenticate itself with the Located UE (e.g. to prove that it belongs to the same group/constellation). Based on the information received, the Located UE may send its location to the requesting Target UE or LMF/RMF proxy (e.g. after verifying that the requesting Target UE or LMF/RMF proxy is part of the same group/constellation or is e.g. part of a whitelist) or send an error message or only send a low accuracy position (e.g. after verifying that the requesting Target UE or LMF/RMF proxy is not part of the same group/constellation or is e.g. not part of a whitelist), e.g. after checking its privacy profile/configuration/preferences and/or providing a confirmation request to the user (e.g. show a confirmation dialog on the Located UEs Graphical User Interface) based on which the user can indicate if the location of the Located UE can be shared with the Target UE or LMF/RMF proxy. To this end, the request message sent by the Target UE or location service proxy may include an identifier of the UEs with which the location of the Located UE will be shared and/or a description of the target UE (e.g. friendlyname or type of device) or location service proxy that can be shown to the user. Additionally or alternatively, the Located UE may be configured (e.g. beforehand) with a description of one or more Target UEs or location service proxies and their identifier, upon which the Located UE can retrieve the description of a Target UE or location service proxy if it receives an identifier of the Target UE or location service proxy, and use the retrieved description of the Target UE or location service proxy in its confirmation request to the user. Additionally or alternatively, the Located UE may decide to send its location only to the LMF/RMF. In such message to the LMF/RMF it may indicate to the LMF to not share the Located UE's location to the respective Target UE or LMF/RMF proxy that requested the location of the Located UE or indicate in general to the LMF/RMF to not share the Located UE's location with a Target UE or LMF/RMF proxy. Additionally or alternatively, the Target UE or LMF/RMF proxy can in a message to the LMF (e.g. as part of a ranging/sidelink location service request or by providing it as assistance data to the LMF) include information (e.g. a subset of Located UE identifiers and their location) about from which Located UEs the Target UE has received the location or from which it can receive the location (or information that indicates the willingness of the Located UE to share its location with the target UE and/or LMF/RMF proxy and/or LMF) and/or from which Located UEs the Target UE is not able to receive the location, before the LMF provides location information of Located UEs to the Target UE or LMF/RMF proxy to calculate the position by one of those UEs (e.g. before the LMF provides assistance to the Target UE or LMF/RMF proxy that includes absolute location of Located UEs). The LMF can use the received information to decide which Located UEs are or are not willing/able to the share their location with the Target UE or LMF/RMF proxy. In that way, the LMF may not have to check the privacy profile of the respective Located UEs stored in the core network (e.g. in the UDM), e.g. because the Located UE has already shared its location with the Target UE anyway, and may only check the privacy profile of Located UEs that have not shared their location with the Target UE, before it decides to share the location of Located UE (e.g. as assistance data) to the Target UE or LMF/RMF proxy for location calculation.

Additionally or alternatively, a Target UE or LMF/RMF proxy (e.g., server UE) may issue a request for the Located UE (i.e., anchor UE) to obtain and/or share its location in a message over PC5 to the Located UE, whereby such message may include an attribute indicating that the location of the Located UE is to be shared with Target UE or LMF/RMF proxy and/or to LMF, e.g. by including the type of ranging/sidelink positioning procedure (e.g. UE-only, Network-assisted or Network-based procedure) and/or identifier of Target UE or LMF/RMF proxy or LMF, and/or may include an attribute indicating a type of ranging/sidelink related location information requested (such as absolute location of the Located UE with high accuracy, absolute location of the Located UE with low accuracy, range/distance and/or angle related information). Based on the Located UE's privacy configuration/preferences (e.g. privacy profile) and/or security policy and/or after a user confirmation dialog, the Located UE may in a response message provide information whether or not it will share its location with the Target UE or LMF/RMF proxy or LMF and/or select different security credentials for protecting the location information in the response message if the location information can be shared with the Target UE and/or shared with the LMF/RMF proxy than if the location is not to be shared with the Target UE and/or LMF/RMF proxy and e.g. only to the LMF, e.g. using credentials that enables the Target UE and/or LMF/RMF proxy to decrypt or using credentials (e.g. based on a configured end-to-end encryption key for communication with the LMF, or the core network's public key) that enables only the LMF to decrypt and not the Target UE and/or LMF/RMF proxy. The privacy profile/configuration/preferences of the Located UE may be different depending on the type of procedure or type of location information requested. Hence, the response of the Located UE may be different depending on the type of procedure or type of location information requested.

In general, it is provided an apparatus and/or method that can be implemented in a UE, wherein the apparatus is adapted to perform the following method:
operate as an anchor UE aware of its own location with a first level of accuracy and may assist in obtaining a range or location estimate of a target mobile device within a wireless network;
receive a message from a second wireless device that includes a request to obtain and/or share its location and the request is a message over PC5 interface;
send a first message to the second wireless device and/or a second message to a location service in the core network wherein
   the first message includes one or more of
      an error message,
      the apparatus' location with a second level of accuracy, said second level of accuracy being lower than the first level of accuracy,
      the apparatus' location protected with different security credentials if the location information is to be shared with the second and/or third wireless device than if the location information is to be shared with a location service,
   and the second message includes
      whether to share the apparatus' location or not with the second and/or third wireless device,
         wherein the second wireless device may be the target mobile device or a location service proxy or the third wireless device may be the target mobile device or a location service proxy, and/or
         wherein the request may include one or more of the following:
an indication that the request relates to a ranging/sidelink positioning service
the type of ranging/sidelink procedure
the type of ranging/sidelink location related information requested.
an identifier of the second and/or a third wireless device to which the location information is to be shared.
a description of the second and/or a third wireless device to which the location information is to be shared.

The apparatus and/or method may be further adapted to determine the contents of the first and second messages based on the privacy profile or privacy configuration or privacy preferences of the apparatus and/or based on a confirmation dialog with the user of the apparatus.

### Section: Further Details on Providing Positioning/Ranging Data to Out-of-Coverage UEs

In some scenarios, (target) UE location may be performed by relying on Network based SL positioning whereby the (target) UE may not be able to establish a NAS connection. Such a scenario occurs, e.g., in clause 5.5.3 of TS 23.586. In this case, (target) UE may share ranging measurements/results with an anchor UE (or located UE) so that the located UE can share them with the LMF. However, privacy profile may not allow sharing those results or the location result with located UEs. To address these problems, the following embodiments and procedures may apply:

In an embodiment that may be used independently, the following steps may be performed:

Step 1: the Target UE may establish a secure unicast direct communication, if not available, with the located UE by using the procedure in Clause 6.4.4 in TS 33.533

Step 2: If the privacy profile of the target UE does not allow sharing Ranging Measurement data/Results or Resulting Location with the located UE, then steps 2a, 2b, and 2c may be performed:

Step 2a: The Target UE may establish, if not available, a key KSLP-LMF for end-to-end communication with the LMF.

Step 2b: The Target UE may protect the unprotected Ranging Measurement data/Results to be end-to-end protected with the LMF, e.g., with SLPIK and SLPEK derived from KSLP-LMF, obtaining protected end-to-end_protected TargetUE_LMF_Ranging Measurement data/Results.

Step 2c: The Target UE may securely send end-to-end_protected_TargetUE_LMF_Ranging_Measurement data/Results to the located UE based on the established KSLP as per Step 1.

Otherwise, If the privacy profile of the target UE does allow sharing Ranging_Measurement data/Results or Resulting Location with the located UE, the Target UE may securely send Ranging_Measurement data/Results to the located UE based on the established KSLP as per Step 1.

Step 3: Located UE may send the received end-to-end_protected_TargetUE_LMF_Ranging_Measurement data/Results or Ranging_Measurement data/Results LMF in a secure manner via NAS.

Step 4: The LMF may provide the Resulting_Location via the Located UE to the target UE. If provided, and if the LMF received end-to-end_protected_TargetUE_LMF_Ranging_Measurement data/Results/the privacy profile of the (target) UE does not allow sharing the Resulting Location with the anchor UE/located UE, the Resulting_Location is protected with SLPIK and SLPEK derived from KSLP-LMF resulting in end-to-end_protected_TargetUE_LMF_Resulting Location. The LMF sends end-to-end_protected_TargetUE_LMF_Resulting_Location or Resulting_Location that is sent NAS protected to the located UE, that further forwards it to the target UE protected with SLPIK and SLPEK derived from KSLP.

In a variant of the embodiment, it is possible in Step 2a to reuse the security procedures defined for 5G ProSe UE-to-Network Relay communication in clause 6.3.3.2 of TS 33.503 with the following one or more of the following modifications:
The SLPKMF instead of 5G PKMF is used to generate and provision the key materials for secure unicast direct communication of Ranging/SL Positioning services between target UE and LMF;
UE SLP Key Request/Response are used instead of ProSe Remote User Key Request/Response;
SL Positioning service identifier is used instead of RSC;
SLPK and SLPK ID are used instead of UP-PRUK and UP-PRUK ID;
SLP Key Request/Response are used instead of Key Request/Response;
KSLP is used instead of KNRP;
KDF of KSLP uses SL Positioning service identifier as input instead of RSC.
The Direct Communication Request (Step 3 in clause 6.3.3.2 of TS 33.503) and Key Request (Step 4a in clause 6.3.3.2 of TS 33.503) include a SL Positioning service identifier indicating the establishment of a secure connection with the LMF.
The Key Response (Step 4e in clause 6.3.3.2 of TS 33.503) is modified as follows:
   A first Key Response is sent to the LMF containing KSLP-LMF. Note that this requires an interface between SLPKMF and LMF so that this message containing KSLP-LMF can be sent to the LMF.
   A second Key Response is sent to the Located UE acting as UE-to-Network relay. This second Key Response does not contain KSLP-LMF, but includes a Message Integrity Code MICSLP-LMF derived from integrity key SLPIK that is derived from session key KSLP-SESS derived from KSLP-LMF, or from KSLP-LMF itself, or from other key derived from KSLP-LMF.
Message 5a contains KSLP-LMF Freshness Parameter 2 and MICSLP-LMF and is sent by the Located UE to the target UE.
KSLP-LMF is verified in Step 5b in clause 6.3.3.2. in TS 33.503 by checking the correctness of MICSLP-LMF.

In an embodiment variant, steps 1 and 2 may be performed simultaneously. For instance, the direct communication request includes the parameters required to obtain both KSLP (for Step 1) and KSLP-LMF (for Step 2a). For instance, message 5a is a Direct Security Mode Command message as per TS 33.503 Clause 6.3.3.2.2 that includes KSLP Freshne ss Parameter 2, KSLP-LMF Freshness Parameter 2 and MICSLP-LMF. The first parameter relates to the establishment of KSLP between target UE and anchor UE while the two last parameters relate to the establishment of KSLP-LMF between target UE and LMF.

Establishing a new key KSLP-LMF in every interaction (i.e., every time a target UE needs to exchange ranging measurements/results) has the advantage that the (target) UE does not need to keep track of counters, etc required for the exchange of the data (measurements or results). Alternatively, this key KSLP-LMF may be preconfigured (by the SL-PKMF) or computed from time to time, or for a given time period. Every time that it is used, it is used to protect the exchanged data together with an increasing counter (e.g., a time based counter) or a nonce to prevent replay attacks. This counter may be kept in memory at the UE (ME or USIM) and/or core network (e.g., LMF).

In a variant of the embodiment, it is possible in Step 2a to adapt the security procedures and/or reuse keying materials used to protect location assistance information (e.g. as part of a PosSIB) to protect the data exchanged between the target UE and the LMF. To this end, the target UE needs to be configured with corresponding cryptographic keys (e.g., as in TS 37.355 or as in other embodiments and procedures in this application). At a later stage, when data needs to be sent to the LMF protected in a way that the located UE cannot access the protected data, the configured keys are used to protect (encrypt/integrity protect) it.

In an embodiment that may be used independently, if the privacy profile of a target UE does not allow sharing ranging measurements or location results with a located UE, then the target UE shall use the Network based SL Positioning for UE with NAS connection as per Clause 5.5.2 in TS 23.586. If it does allow sharing ranging measurements or location results with a located UE, then the target UE may use the Network based SL Positioning for UE without NAS connection.

In general, it is proposed a method that may be implemented in a UE for securely determining the location of a target UE by means of a network based sidelink positioning whereby the method is adapted to:
checking in the privacy profile of the target UE whether the target UE is allowed to share ranging results or location results with an anchor UE, and if it requires protection and requires a network based sidelink positioning,
does one of:
   choosing a network based sidelink positioning procedure with NAS protection (and rejecting the usage of a network based sidelink positioning procedure without NAS protection),
   or
   choosing a network based sidelink positioning without NAS protection and storing, establishing, and using a key KSLP-LMF to security protect and verify the ranging measurements sent to and/or location results received from the LMF.
      Section: Securely Providing Capabilities and Other Infor Ation of/for Anchor UEs Via Target Ue to Cor Network (LMF/RMF) or LMF/RMF Proxy

In some cases, only a single UE is served by the LMF/RMF or LMF/RMF proxy or other entity that performs a Ranging/Sidelink Positioning procedure. In such cases, the LMF/RMF or LMF/RMF proxy or other entity do not communicate directly with the other UEs involved in the Ranging/Sidelink Positioning procedure. That single UE (typically target UE in case all UEs are in coverage) may be requested to collect the capability information and possibly other information/messages (e.g. ranging/sidelink positioning measurements) of other UEs involved in the Ranging/Sidelink Positioning procedure or in general other UEs in range of that single UE (e.g. discoverable through ProSe discovery) and transmit it to the LMF/RMF or LMF/RMF proxy or other entity. Similarly, the single UE may be requested to forward assistance information and possibly other information/messages (e.g. privacy notification) to the other UEs involved in the Ranging/Sidelink Positioning procedure or in general other UEs in range of that single UE. To this end, the single UE may perform discovery and/or connect to the other UEs over PC5. The information that the single UE collects and transmits to the LMF/RMF or LMF/RMF proxy or other entity may include some security or privacy sensitive information. For example, the other UEs may include information in their discovery or capability exchange over PC5 some privacy related information, such as whether the other UE is willing to share its location with the target UE or LMF/RMF proxy or only to LMF (as described in other embodiments). The single UE that collects from the other UEs and transmits this information to the LMF/RMF or LMF/RMF proxy or other entity, can manipulate such security or privacy sensitive information, before providing the information to the LMF/RMF or LMF/RMF proxy or other entity.

Therefore, in an embodiment the other UEs may have been preconfigured with security keys that can be used for (or from which a key can be derived for) encrypting the security or privacy sensitive information end-to-end. In an example, it may use the keys that have been pre-configured for ProSe UE-to-Network Relay communication (e.g. as specified in TS 33.503), whereby the keys may be preconfigured by the SLPKMF instead of the 5G PKMF. In another example, the keying materials/procedures to protect positioning assistance data (e.g. as broadcasted in posSIB and described in TS 37.355 and in embodiments/procedures in this application) may be reused to protect the exchange of this data between other UEs, the single UE (e.g. target UE) and LMF/RMF. The encrypted/security processed/integrity protected security and privacy sensitive information can be added to the payload of the message to be transmitted (e.g. from the LMF/RMF via the single UE to other UEs, or from other UEs via the single UE to the LMF/RMF) to the single UE (and may further include an identifier of the other UE and/or an identifier of a key that has been used). In this way, the respective security and privacy sensitive information can only be decrypted/security processed/integrity verified by the respective LMF/RMF or LMF/RMF proxy or other entity, but not by the single UE.

In the case that a single UE collects from a first UE (e.g., located UE) and transmits this information to the LMF/RMF proxy, in particular, when at least some or all those devices are out of coverage, other procedures may be used to securely exchange the data, e.g., using the procedures in Clause 6.2.3 in TS 33.503/Clause 5.3.3.1.3.2 in TS 33.536 to perform key establishment between located UE and LMF/RMF proxy (server UE).

Once a shared key is generated, the data to be exchanged can be protected by the first UE so that only the LMF/RMF proxy can access it. In another example, this data may be exchanged over, e.g., IPSec, where the IPSec connection may be established between the first UE and LMF/RMF proxy. In another example, the LMF/RMF proxy may have been configured with keying materials owned by the LMF/RMF, e.g., keying materials as derived from UE-to-Network security establishment procedure or based on TS 37.355.

In some cases, the security and privacy sensitive information may actually also be useful for the single UE, for example if the single UE is a Target UE and the privacy/security sensitive information is information about whether or not an anchor UE is willing to share its location with the Target UE or not, then the Target UE could use such information for selecting which Ranging/Sidelink Positioning procedure to use (e.g. network-based procedure in which the LMF calculates the position of the Target UE, or network-assisted procedure in which the Target UE itself calculates the position). Therefore, in an additional aspect of the embodiment, the other UEs may provide also an unencrypted copy of the privacy/security sensitive information to the single UE in addition to the encrypted privacy/security sensitive information.

Additionally or alternatively, the respective LMF/RMF or LMF/RMF proxy or other entity to which the single UE is connected, provides the decrypted/security processed/integrity verified security/privacy sensitive information or information related to the decrypted/security processed/integrity verified security/privacy sensitive information to the single UE after it has decrypted/security processed/integrity verified the information it has received from the single UE. In this way, the LMF/RMF or LMF/RMF proxy or other entity can ensure that the information was not manipulated or observed or disclosed by the single UE (in the specific example to ensure that it will not share the location of the anchor UE unwillingly to the single UE), whilst still entrusting it with a copy or indication of this information for use by the single UE for other purposes.

### Section: Further Details on Providing Positioning/Ranging Data to Out-of-Coverage UEs (Continued)

A UE for which the location needs to be determined (e.g. using ranging/sidelink positioning, assisted GNSS, multi-RTT or other positioning technique) may be (temporarily) out-of-coverage of a base station, and hence may not be able to receive/send positioning/ranging data, e.g., assistance data, from, e.g., RAN or a location service (e.g. LMF, RMF) in the network, whereby the positioning/ranging data, e.g., assistance data, may be used by the UE to position itself or with help of base stations, other UEs and/or the location service. A location service may determine based on several criteria, such as supported positioning techniques or the service area, whether to instruct the radio access network (e.g. using LTE Positioning Protocol A (LPPa) as defined in 3GPP TS 36.455 or NR Positioning Protocol A (NRPPa) as defined in 3GPP TS 38.455) to provide positioning/ranging data, e.g., assistance data (e.g. using Positioning System Information Blocks (PosSIBs) that can be broadcasted by a base station) and/or to obtain measurements from the radio access network for UEs in the service area, and/or whether to use a unicast link (e.g. using LTE Positioning Protocol (LPP) as defined in 3GPP TS 37.355) with the respective UE(s) to provide assistance data. However, UEs that are out-of-coverage (OOC) may not be able to easily obtain assistance data. An OOC device may refer to a device that exchanges positioning/ranging data with/via an access device such as a gNB through any type of relay devices, e.g., a ProSe relay or a (smart) RF repeater, or a mobile base station, or a RIS, etc. As described in other embodiments in this disclosure, an OOC UE may be able to obtain the positioning/ranging data, e.g. assistance data, via another UE (e.g. relay UE or anchor UE) that is in coverage of the network and that may forward the assistance data (e.g. LPP messages or PosSIBs) to the OOC UE. In order for the location service to provide or configure the usage of the required or relevant positioning/ranging data, e.g., assistance data, the location service may receive an indication from the radio access network or from the AMF or GMLC or other network function that a UE for which the position/location needs to be determined is OOC. However, a simple indication may be insufficient as other factors may also determine which assistance data needs to be provided and how the assistance data needs to be provided. For example, a Remote UE connected via a ProSe Layer-2 UE-to-Network relay may be able to receive PosSIBs, but a Remote UE connected via a ProSe Layer-3 UE-to-Network relay may not be able to receive PosSIBs. Also, the manner in which the location of the OOC UE is determined by the location service may depend on how the OOC UE connects to the network, e.g., whether the OOC UE connects to the network over a (smart) RF repeater or a VMR. The following embodiments address these shortcomings.

In an embodiment variant that may be combined with other embodiments or implemented independently, the location service (e.g. LMF or proxy thereof) receives information from, e.g., an (OOC) UE, and/or RAN and/or a relay device, and/or AMF or another core network service (i.e. one or more of those entities send information to the location service), about one or more of the following:
The type of relay device used between an OOC UE or set of OOC UEs and the network, for example a Layer-2 ProSe UE-to-Network relay, a Layer-3 ProSe UE-to-Network relay (with or without connection to Non-3GPP Interworking Function (N3IWF)), (smart) RF repeater, Reconfigurable Intelligent Surface, mobile base station;
The capabilities of a relay device used between an OOC UE or set of OOC UEs and the network, for example the ability to exchange positioning/ranging data, e.g., to forward SIBs and/or Positioning Reference Signals (PRS) and/or Sounding Reference Signals (SRS), support for broadcast/unicast/groupcast to provide assistance data (e.g. PosSIBs), supported positioning mechanisms (e.g. ability to support ranging/sidelink positioning), signal range, ability to act as a synchronization source, ability to determine its location and/or act as anchor UE;
The number of OOC UEs served/connected/reachable by a relay device used between a set of OOC UEs and the network, for example number of Remote UEs connected to a ProSe UE-to-Network relay, number of target UEs or other anchor UEs in vicinity of an in-coverage anchor UE (e.g. target UEs/anchor UEs discovered/discoverable via ProSe discovery);
The number of OOC UEs that are subscribed to a location service, are authorized, and require positioning/ranging data e.g., assistance data and are served/connected/reachable by a relay device used between an OOC UE or set of OOC UEs and the network.
The number of OOC target UEs for which the location needs to be determined;

The number of relay devices (i.e. number of hops minus 1) between a set of OOC UEs and the network, e.g., an access device such as a gNB at a fixed location;
Location information and/or distance/angle information related to one or more relay devices used between a set of OOC UEs and the network,
and based on one or more of the above received information

Selects/determines the positioning/ranging data to exchange, e.g., assistance data, and/or
how to exchange/deliver the selected positioning/ranging data (e.g., the assistance data) to an OOC UE or set of OOC UEs.

Note that an anchor UE forwarding messages (e.g. LPP messages) to/from the network on behalf of a target UE can also be seen as a relay device.

In an embodiment variant, determining the positioning/ranging data (e.g., assistance data) for a set of OOC UEs may involve determining
whether or not the relay devices used between a set of OOC UEs and the network are able to support certain positioning methods such as ranging/sidelink positioning and/or
an initial approximation how far away from a reference point (e.g. a gNB serving/operating the relay device) an OOC UE may be, based on the number of hops and/or signal range or other capabilities of the relay devices and/or
the distance between the relay devices used between the OOC UE(s) and the network, since this may influence the timing of e.g. the positioning signals.

In an embodiment variant, determining how to deliver the assistance data for a set of OOC UEs may involve determining
whether or not the relay devices used between a set of OOC UEs and the network are able to (transparently) exchange positioning/ranging data, e.g., forward assistance data in the form of PosSIBs to the OOC UEs and/or
whether multiple OOC UEs are served by the relay device, and if so it may be useful to provide the assistance data using PosSIBs that may be broadcasted/multicasted to the multiple OOC UEs.

In an embodiment variant, the location service (e.g. LMF or proxy thereof) may receive this information as part of a location request or other message (e.g. LPP message) from an (OOC) UE, a relay device, AMF, GMLC or other network function which may collect/aggregate/provide this information and/or the location service may receive this information from a database or other storage or service whereby the location service may request this information based on an identifier of an OOC UE or an identifier of a relay device.

In an embodiment variant, the location service (e.g. LMF or proxy thereof) may, after determining the positioning/ranging data (e.g., assistance data) and/or how to deliver it, configure the radio access network (e.g. using LPPa/NRPPa extensions) and/or the relay devices (e.g. by directly communicating with relay devices using LPP extensions, or indirectly through AMF or NG-RAN by having the AMF provide a message or NG-RAN provide a SIB or RRC message containing configuration information for the relay devices, or by requesting a PCF or other network entity to provide some policies to the relay devices) accordingly. For example, it may provide a policy or message field to the relay devices that determines whether a broadcast message (R-SIB, . . . ) is to be rebroadcasted and how it is to be rebroadcasted over the local interface, as described in more detail in other embodiments. Additionally, the location service may provide the relay devices used between the OOC UE and the network with assistance information on how to perform a positioning procedure with the OOC UE (e.g. using ranging/sidelink positioning). The location service may also indicate in a message to the AMF, NG-RAN, relay devices or the OOC UE that the positioning/ranging data (e.g. assistance data) pertains to positioning of an OOC UE and hence may need to be interpreted/used in a particular way (e.g. forward the data to other entities involved in the positioning of an OOC UE, or initiate a certain set of actions to locate the OOC UE (e.g. may use the positioning/ranging data to trigger a relay device to engage in a ranging/positioning procedure with the OOC UE, for example determining a range between the relay device and the OOC UE), or apply the data to a certain set of actions to locate the OOC UE, or decide to use a particular positioning method or position estimate calculation to locate the OOC UE) that supports the positioning of an OOC UE, e.g. by adding an attribute in the message on how to forward the data and/or an indication of the type of data and/or the destination (e.g., being a OOC UE) and/or an identifier of the OOC UE.

In a particular embodiment related to a Remote UE (OOC UE) that connects to the network via a Layer-3 ProSe UE-to-Network relay and N3IWF, the Layer-3 ProSe UE-to-Network relay, or the N3IWF, or the AMF to which the PDU session via the N3IWF is established, or the AMF to which the Layer-3 ProSE UE-to-Network relay establishes its PDU session, or the Remote UE itself indicates to the location service that the Remote UE is indirectly connected to the network via a UE-to-Network Relay by using N3IWF. The indication may further include information about the UE-to-Network Relay device that is used. This is necessary, since otherwise the location service would have no way of knowing that the UE is a Remote UE that requires special treatment regarding the assistance data and/or how to reach or configure the UE-to-Network Relay device that is used between the Remote UE and the network. The location service in this case may provide positioning/ranging data (e.g., assistance data) related to the Remote UE (e.g. in the form of PosSIBs) to the N3IWF (e.g. using an NRPPa message or by using a Network Positioning message in an N2 Transport message containing the assistance information) that the N3IWF may then provide to the Remote UE (e.g. using a message encapsulating the PosSIB data via a tunneled connection with the Remote UE), or the location service may use a unicast connection with the Remote UE via the N3IWF to provide the assistance data (e.g. using an LPP message). Since the N3IWF is used for multiple purposes, the location service may need to indicate to the N3IWF that the assistance data is meant for a Remote UE, e.g. by adding a attribute in the message to the N3IWF on how to forward the assistance data and/or that indicates the type of assistance data and/or the destination being a Remote UE and/or the type of UE being a Remote UE and/or an identifier of the Remote UE. Since the N3IWF itself is not an NG-RAN node, the N3IWF is not involved in positioning itself, and hence, the location service would need to provide the NG-RAN to which the UE-to-Network Relay device is connected or the UE-to-Network Relay device directly with assistance information on how to perform a positioning procedure with the Remote UE (e.g. using ranging/sidelink positioning).

In an embodiment variant that may be combined with other embodiments or implemented independently, the above mentioned relay related information is received by the location service or AMF or other network function, and based on this information the location service or AMF or other network function determines whether or not the location of an OOC UE can be verified by the network, and if not, prevent the OOC UE from connecting to the core network or trigger a disconnect of the OOC UE, and if yes, initiate verification of the location of the OOC UE by the network. To this end, the location service or AMF or other network function may be configured with a set of policies/criteria to determine that/whether the location of a OOC UE cannot be verified by the network and/or cannot be verified with sufficient accuracy and/or that risk of the location of the OOC UE to be outside of a country or area is too high and may be used to determine the actions to take if/when this occurs. Examples of such policies/criteria may include:
Number of hops used between the OOC UE and the network is above a certain amount.
The capabilities of the relay devices used between the OOC UE and the network do not support the required positioning techniques, such as ranging/sidelink positioning with other relay devices, or determining their position (e.g. using GNSS).
The distance between the location of a relay device and the borders of a country or area is less or more than a certain minimum/maximum value.

In an embodiment related to positioning services for OOC UE (e.g., remote UEs) during emergency services, the OOC UE (e.g., a remote UE) may send an indication (e.g., emergency relay service code (eRSC)) to indicate to a relay device (e.g., a UE to Network relay) and/or RAN the need to establish an emergency connection. The exchange of said indication (e.g., eRSC) implicitly indicates the requirement to determine the location of the OOC UE. This indication may be transmitted/forwarded (e.g. by the relay) to the location service (e.g., in a LPP message to LMF or local positioning server (e.g. LMF/RMF proxy), or as part of NAS message to AMF which may forward such indication to the LMF) and the location service may use it to determine the positioning/ranging data (e.g., assistance data) and/or how the data is to be exchanged/forwarded.

In a related embodiment related to positioning services for OOC UE (e.g., remote UEs) during emergency services, the OOC UE (e.g., a remote UE) may send a message including an indication (e.g., emergency relay service code (eRSC)) to indicate to a relay device (e.g., a UE to Network relay) or RAN the need to establish an emergency connection. However, since the OOC UE requires the establishment of an emergency service, the OOC UE may or may not be capable of (fully) performing a positioning/ranging procedure. In this situation:
Whether an OOC UE is capable or not of (fully) performing a positioning/ranging procedure may be indicated by the indication so that the location service can take it into account. It may also depend on a policy/configuration related to the UE identity (the UE identity may be included in the message sent by the OOC UE to the relay UE).
Since an OOC UE may not be capable of (fully) performing a positioning/ranging procedure, the location service may choose a positioning method of a lower accuracy or may determine the need to locate the relay instead (e.g., a UE to network relay) and/or the relay (e.g., a UE to network relay) may be configured with a policy to provide its location/engage in a positioning/ranging procedure upon reception of such an emergency services indication.

In another embodiment related to positioning services for OOC UE (e.g., remote UE) during emergency services, the OOC UE (e.g., remote UE) may also send its signaling security policy and/or security capabilities that may implicitly/explicitly indicate or include a preference for null ciphering/integrity protection during the emergency session to indicate to a relay device (e.g., UE-to-Network Relay) and/or RAN and/or CN that it supports/will accept null ciphering/integrity algorithms and/or unprotected communication. An indication of OOC UE (e.g., remote UE) preference for null security algorithms may be transmitted/forwarded (e.g. by the relay) to the location service (e.g., in a LPP message to LMF or local positioning server (e.g. LMF/RMF proxy), or as part of NAS message to AMF which may forward such indication to the LMF), which determines whether positioning/ranging data (e.g., assistance data) may be protected and/or exchanged/forwarded without protection.

RAN (e.g., gNB) may also be provisioned with a policy that allows/prohibits the use of null security algorithms, based on which it is determined whether the positioning/ranging data (e.g., assistance data) may be exchanged/forwarded without protection.

In another related embodiment related to positioning services for IC UE during emergency services, the emergency indication of the IC UE may be forwarded to the location service (e.g., LMF) which determines whether positioning/ranging data (e.g., assistance data) may be protected and/or exchanged and/or accepted by the UE without protection.

In general, it is described an apparatus and method for locating an OOC UE that may be implemented in a location service whereby the apparatus is adapted to:

Receive a positioning request from an OOC UE (e.g. transmitted/forwarded by a relay) whereby the request may include the relay type used by the OOC UE or an emergency indication or a preference for null security algorithms to connect to the network, Determine at least one of (1) the positioning/ranging data to be provided to the OOC UE and/or relay device and (2) the method for exchanging the positioning/ranging data based on the relay type or emergency indication or preference for null security algorithms and a policy. Embodiment and embodiment variants may be combined with each other.

Section: Further Details on Dealing with Partial/Fluctuating Coverage Situations

In some scenarios illustrated by FIG. 5, the device UE 10 may not be aware of the coverage situation of one or more of the anchor devices 14, or the coverage situation has changed or is changing at the moment a ranging operation has just been initiated. This may not only lead to potential solution mismatch (e.g. if a device selects using centralized location whereas the other devices may expect out-of-coverage operation or vice versa, as described earlier, but also may lead to issues in selecting which procedure to select and also issues in handing over an ongoing ranging session from a centralized location procedure (e.g. using LMF/RMF of the core network) to a decentralized procedure (e.g. using local proxy of the LMF, e.g. using Sidelink Positioning Server UE).

In the following embodiment that may be combined with other embodiments or implemented independently, the following ranging/sidelink positioning procedures are distinguished:

UE-only operation: procedure not involving the LMF, but using a SL Positioning server UE acting as a local proxy of the LMF.

Network-based operation: procedure involves the LMF e.g. for position calculation, whereby two variants may be distinguished:

Network based operation with Target UE having NAS connection.

Network based operation with Target UE not having NAS connection, but whereby one or more other UEs (e.g. Anchor UEs) have a NAS connection or are capable of setting up a NAS connection on behalf/in support of the Target UE (e.g. an Anchor UE acting as relay or communication with the LMF on behalf of the Target UE).

Network-assisted/UE-based operation: procedure involves the LMF, but the LMF triggers some of the procedures to be handled by one or more of the UEs involved (e.g. position calculation performed by the Target UE itself), whereby the LMF may provide information to the respective UEs involved (e.g. collected measurement information or known location of certain anchor UEs). This is a mix between using a local proxy of the LMF and some assistance by the LMF itself. Also for this operation type, two variants may be distinguished:

Network assisted/UE-based operation with Target UE having NAS connection.

Network assisted/UE-based operation with Target UE not having NAS connection, but whereby one or more other UEs (e.g. Anchor UEs) have a NAS connection or are capable of setting up a NAS connection on behalf/in support of the Target UE (e.g. an Anchor UE acting as relay or communication with the LMF on behalf of the Target UE).

The decision of which ranging/sidelink positioning procedure (including which variant thereof) to use, e.g. UE-only sidelink positioning instead of network assisted, or Network-based sidelink positioning with NAS connection instead of without NAS connection is based on whether the Target UE and/or one or more Anchor UEs are in coverage and served by a suitable LMF (e.g. LMF capable of supporting ranging/sidelink positioning) or not. However, the coverage situation may change/fluctuate, in particular in partial coverage scenarios and/or when the UEs are moving, it could be that some of the UEs involved are in coverage and have access to the LMF at the moment a decision for a particular procedure was taken, but may move out of coverage afterwards. It may not be possible to handover the procedure from the LMF to an LMF proxy (e.g. sidelink positioning server) given that the LMF may not be able to reach any of the involved UEs anymore. It would be desirable to avoid such situations. To this end, in one embodiment, the target UE may be configured with a set of policies/criteria, whereby such policies/criteria may indicate a minimum number of UEs in vicinity (e.g. Anchor UEs) that have indicated that they are in coverage and/or are served by a suitable LMF (e.g. by adding information about this in discovery or capability exchange messages) as a condition to select a certain procedure, e.g. a procedure that involves the core network (e.g. LMF). The target UE may receive information about a number of UEs that are in coverage and/or served by a suitable LMF (e.g. during discovery) and determine, e.g. based on these policies, whether to accept/initiate/switch to a network-based or network-assisted sidelink positioning/ranging procedure or a UE-only based sidelink positioning/ranging procedure. Similarly, the LMF may use the number of UEs that are in coverage and/or served by the LMF (e.g. based on the discovery information received from one or more of the UEs, or by number of these UEs registered to the network or by number of these UEs communicating with the LMF or by receiving information from the NWDAF about the number of UEs registered in an area) to determine whether to accept/initiate/switch to a network assisted sidelink positioning/ranging procedure or a UE-only based sidelink positioning/ranging procedure, upon which the LMF may inform the target UE or an Anchor UE or Sidelink positioning server UE about this.

In an embodiment variant, a target UE may determine whether or not an Anchor UE is served by an LMF capable of supporting ranging/sidelink positioning by discovering information about the serving PLMN (e.g. which may be separate attribute provided during discovery by the Anchor UE or part of another attribute provided during discovery by the Anchor UE, such as NR Cell Global Identity (NCGI) to which the Anchor UE is connected that contains the PLMN identifier as part of its value), and using information about the serving PLMN to derive/determine that the serving PLMN supports one or more LMFs that support ranging/sidelink positioning. This may be done by comparing the serving PLMN of the Anchor UE with the target UE's serving PLMN or PLMN to which it is subscribed, and if the target UE is served by an LMF that supports ranging/sidelink positioning or it knows that the PLMN to which it is registered/subscribed supports ranging/sidelnk positioning, then it can determine that the Anchor UE is also connected to a PLMN that support ranging/sidelink positioning. This may also be done by using information configured/stored in the target UE or provided by the network about the respective serving PLMN of the Anchor UE, such as policy information that includes the list of PLMNs in which ranging/sidelink positioning is enabled/authorized. If the Anchor UE omits including information about its serving PLMN during discovery, the target UE may determine that the the respective Anchor UE is currently out-of-coverage and hence not served by an LMF capable of supporting ranging/sidelink positioning. The Target UE may initiate a different ranging/sidelink positioning procedure (e.g. UE only procedure with a LMF/RMF proxy) and/or exclude/include the respective Anchor UE from/in its ranging/sidelink positioning procedures/session.

In an embodiment variant, the target UE, anchor UE or Sidelink positioning server UE are requested to measure and/or provide information to the other UEs about signal strength or velocity or validity time of location information, based on which the target UE, anchor UE or Sidelink positioning server UE determine whether or not the “constellation” is sufficiently stable/robust and use the outcome of this determination to decide which procedure to initiate/accept/switch to (e.g. to initiate a network assisted ranging/sidelink positioning procedure if at least 3 of the UEs involved (e.g. Target UE and 2 Anchor UEs or 3 Anchor UEs) have strong/stable signal to a RAN node (e.g. gNB) and/or may not be moving or very slowly, e.g. with RSRP/RSRQ above a certain minimum threshold and/or measured velocity below a maximum threshold and/or validity time above a minimum threshold). If not sufficient stable (e.g. according to some preconfigured policies/criteria), then a UE-only ranging/sidelink position procedure may be selected instead. Similarly, one of the UEs involved or a RAN node (e.g. gNB) or core network function/service that may collect measurement information from UEs may provide relevant measurement information to the LMF or other core network function/service, which can use this to determine whether or not the “constellation” is sufficiently stable/robust, and use the outcome of this determination to decide which procedure to initiate/accept/switch to, e.g. accept/initiate a network assisted sidelink positioning/ranging procedure or use a UE-only based sidelink positioning/ranging procedure, upon which the LMF may inform the target UE or an Anchor UE or Sidelink positioning server UE about this.

In an embodiment variant, in case a network-based/network-assisted ranging/sidelink positioning procedure was selected and/or the LMF is currently involved in a ranging/sidelink positioning procedure, the LMF may get informed that one or more of the UEs involved (e.g. Target UEs, Anchor UEs, SL Positioning Server UEs) are getting out of coverage or are expected to get out-of-coverage within a certain amount of time and hand over the session before it cannot reach the involved UEs anymore. The LMF may get informed e.g. by
receiving a message from the respective UEs (e.g. which may send a message because the RSRP/RSRQ of the signal to a RAN node is getting close to a minimum threshold), or
receiving a message from a RAN-node/AMF or other network function based on measurement reports received/interpreted by a RAN node or forwarded to the LMF (whereby these measurement reports may show a steady decline in RSRP/RSRQ which may indicate the UE is moving away from a RAN node or steady decline in RSRP/RSRQ over sidelink which may indicate that two or more UEs are moving apart (which may lead to failure in a sidelink connection to an in-coverage UE that may act as relay)), or
receiving a message from NWDAF (which may collect information from multiple UEs and perform analysis on multiple aspects which may show bad coverage in a certain area in which multiple UEs of a constellation may be located), or
based on location information of the UEs (which may be received/calculated/updated by the LMF or GMLC and which may show that one or more UEs involved are moving away or apart (which may lead to failure in a sidelink connection to an in-coverage UE that may act as relay)).

If based on the received information that one or more of the UEs involved (e.g. Target UEs, Anchor UEs, SL Positioning Server UEs) are getting out of coverage or are expected to get out-of-coverage within a certain amount of time, the LMF may send a message to one or more of the UEs involved that may include information related to an ongoing ranging/sidelink procedure (e.g. session id, intermediate results, list of performed measurements/measurement reports, list of remaining measurement or other actions to be taken, configuration information (e.g. frequencies used, PRS signal configuration), list of UEs involved, constellation information (e.g. constellation identifier), location of anchor UEs, security material, etc.) and may further provide an instruction to hand over/take over/continue the ongoing procedure.

### Section: Further Details on Discovery for Ranging/Sidelink Positioning

In some cases, the exchange of capabilities and parameters may be carried out in different procedures including Discovery. A type A Discovery procedure comprises an unsolicited Discovery Announce message issued by an announcing UE towards a monitoring UE while a type B Discovery procedure comprises a Discovery Solicitation message from a Discoverer UE (assumed in this description to be a Target UE) and a plurality of Discovery Response messages from Discoveree UEs (assumed in this description to be primarily Anchor UEs). Such information can be carried in a metadata field in the Discovery message. Information to be carried in Discovery Announce and Discovery Response messages may be decided by the UEs themselves, by a network policy or, in the case of Discovery Response messages, may be requested by the Discovery Solicitation message that is being responded to.

However, a number of problems need to be solved, including, inter alia,
how to determine the information that needs to be exchanged or provided,
which entities are supposed to request or reply with what information, or
how such information should be processed or prioritized.

This is challenging because a UE receiving a discovery message may need to be able to figure out whether it is a suitable UE in an efficient manner and the UE sending the request may wish to express its request in such a way that only the suitable candidates reply to its discovery message.

It is an aim to address above challenges by means of the following embodiments and embodiment variants:

In an embodiment that can be combined with other embodiments or implemented independently, a UE (e.g. Target UE) can include in a discovery request for ranging/sidelink positioning (e.g.

ProSe model B solicitation message) to another UE (e.g. Anchor UE) a set of data, whereby such set of data may include one or more requests for certain ranging/sidelink positioning related information to be included in the discovery response (e.g. an attribute indicating that the responding UE should include information about its supported positioning methods), or may include one or more criteria to be fulfilled or desired capabilities to be supported (e.g. an attribute indicating whether or not the responding UE supports a certain positioning method (e.g. support for Sidelink Round-Trip Time method=“true”), or an attribute that indicates whether or not the responding UE is in coverage or not (e.g. in-coverage condition=“true”), or an attribute indicating a particular accuracy value or value range or minimum accuracy to support for calculating ranging measurements, position estimates, or of the location of an Anchor UE (e.g. requestedaccuracy <1 m horizontal and <3 m vertical in 95% of cases), or an attribute indicating a desire for a certain positioning method to be supported by the responding UE (e.g. preferred SL positioning method=“Sidelink Time-Difference Of Arrival method”) that indicate to the responding UE to only respond with a discovery response, or to only include certain information in the discovery response, or to respond with an answer whether or not if it meets one or more criteria indicated in the request in the discovery response.

In other words, a Discoverer UE may send different types of requests of information: Type 1 request, the Discoverer UE requests information from other UEs/nodes (e.g., Discoverees) in their respective discovery response messages, such as:
Presence/absence of certain feature or status
Current value of a specified metric

Such request for information (i.e. type 1 request) can be included as metadata in a discovery request transmitted by the Discoverer UE. If the Discoveree receives such information/metadata in a discovery request, the Discoveree is expected to include the requested information in a Discovery Response.

Type 2 request, the Discoverer UE can request other UEs/nodes (i.e. Discoverees) to respond or not respond and/or include or not include certain information if it:
Supports or does not support a certain requested feature, or has or does not have a requested status
A certain metric falls above/below a specified threshold.

Such request for information (i.e. type 2 request) can be included as metadata in a discovery request transmitted by the Discoverer UE. If the Discoveree receives such information/metadata in a discovery request, the Discoveree is expected or not expected to include information in Discovery Response depending on the type of request.

A discoverer may combine both kinds of requests (i.e. type 1 and 2) in a single Discovery Request message.

An advantage of the above construction is that it allows a UE receiving such a request to evaluate it in an efficient way.

Another aspect to consider is that in certain cases a number of criteria need to be jointly fulfilled, e.g., (criteria A, B and C) or (criteria A and E). The request may include such conditions to help the receiving UE to determine whether it is a suitable UE and whether its reply is required, or not. Such conditions may be expressed explicitly, through a codebook, or implicitly, e.g., when using a specific criterion that may imply that a second criterion also needs to be fulfilled.

Reference is made in parts of this description to the exchange of capabilities and parameters in different procedures including Discovery. To expand on this, it may be noted that a type A Discovery procedure comprises an unsolicited Discovery Announce message issued by an announcing node or UE towards a monitoring node or UE while a type B Discovery procedure comprises a Discovery Solicitation message from a Discoverer node (assumed in this description to be a Target UE) and a plurality of Discovery Response messages from Discoveree nodes (assumed in this description to be primarily Anchor UEs).

Such information can be carried in a metadata field in the Discovery message. Information to be carried in Discovery Announce and Discovery Response messages may be decided by the node itself, by a network policy or, in the case of Discovery Response messages, may be requested by the Discovery Solicitation message that is being responded to.

Allowing the Target UE to request information from prospective Anchor UEs can be useful because it allows the Target to request only the information that it needs. In installations in which the network establishes a default list of parameters that should be sent by Anchors, a Target UE need then only include a specific request for information that is not included on the default list. Anchors should supply the requested information whether it is on the default list or not.

Alternatively or additionally, the Target UE can use a Discovery Request to filter out prospective Anchors that do not fulfil the specified criteria for positioning. Again, the network might establish a default list. If not, or additionally, a Target may set criteria that should be met by an Anchor in order to respond to a Discovery Solicitation message.

In the general case, the Anchor should meet all criteria imposed by the Target and/or network before responding.

To maintain signalling efficiency, the Anchor in general, need not include values for the parameters that form the criteria. A Target that is nevertheless curious about the exact value of a given parameter may include a flag that requests the value if the Anchor responds.

Since the majority of parameters can be either requested by the Target UE or used by the Target UE to filter Anchor UEs, it may be stored with each parameter a first flag indicating that the value of the parameter is requested and a second flag indicating that a value or threshold must be met before the Anchor UE is to respond.

If the second flag is set, a value or threshold is also specified. Such flag may be implicitly sent if the value or threshold is included. If only the second flag is set, a responding Anchor UE does not include the parameter value in its response. If both flags are set, it does include the parameter value in its response.

In some cases, some criteria might be considered independently or with a given priority. The criteria evaluation may also be carried out according to said priority. For instance, an in-coverage feature may have the highest priority. For example, an Anchor that is in coverage might be requested by means of a flag, for example, to respond even if it does not fulfil other criteria that might be set. The reason why such a criterion has higher priority is that an anchor UE with this capability might allow an out-of-coverage Target to access the LMF and this might have sufficient value on its own.

Some examples of parameters that may be included in Discovery metadata are discussed in the context of a Target and responding Anchors using Type B discovery. A Type A Discovery Announce message may also carry the same kind of metadata as a Type B Discovery Response message.

A Target UE may limit its search to nodes that can perform a particular role by indicating the required role in Discovery Solicitation. In this description, it is assumed that the Target is limiting its search to Anchor UEs but other roles, like positioning server may also be important.

The coverage status of an Anchor UE may be important because an in-coverage Anchor UE might allow an out-of-coverage Target UE to access the LMF. The Target UE may request the coverage status of the Anchor UE or may specify a coverage status that it expects respond Anchor UEs to have. An Anchor UE supplying this information may include an in-coverage/out-of-coverage flag or may include an in-coverage status indicator if it is in coverage and leave it out otherwise.

The same type of signalling may also be employed to indicate/request the location status of an Anchor UE.

Since Anchor UEs are not necessarily physically fixed, the stability of the Anchor's location can be important.

An Anchor may indicate, for example, a volume of uncertainty around its nominal location, a velocity and a duration for which these readings are expected to be valid, or a related measurement such as the variance of its location. A Target may request any of these or may place thresholds that must be met or exceeded (or kept below in the case of volume of uncertainty and velocity).

The Anchor may advertise available positioning methods and some capabilities (e.g., degree of precision, sampling rate, etc.) associated with each. Similarly, the Target UE may specify one or more positioning methods that the Anchor should support, together with necessary capabilities.

The Anchor may indicate on which bands it is capable of performing positioning and capabilities (e.g., bandwidth, minimum and maximum power, etc.). Similarly, the Target UE may specify bands and expected capabilities within each band. An Anchor would not be expected to respond unless it can fulfil the requirements in at least one band.

The Anchor UE may need to return a measurement of the received signal strength of the incoming Discovery Solicitation message. Similarly, a Target UE may specify a minimum value signal strength below which the Anchor is not expected to respond. Similarly, the Anchor UE may return some measurements or the target UE may make some measurements that may give an initial indication to the target UE whether the anchor UE is a good target, or not. For instance, it may give an indication of/or measure the relative position so that the target UE can select, e.g., anchor UEs that are not along a same line, or it may give an indication of or measure the round-trip time of the message exchange.

The Anchor may indicate its own identity and the identity of any constellation it belongs to. Similarly, a Target UE may request responses from specific Anchors or from Anchors that belong to at least one of the constellations requested by the Target.

### Section: Post-Discovery Selection of Anchor UEs

An anchor can indicate whether it capable of acting as a Located UE (i.e., an Anchor UE for which a location is known or can be determined) during discovery. A Target UE may want to limit its discovery to only find Anchor UEs that are capable of being a Located UE. If it is not clear at time of discovery that a discovered Anchor UE is or is capable of being a Located UE, the Target UE has to spend time and resources to try to set up a connection with each discovered Anchor UE to determine whether it is a Located UE or not. It can also be the case that the ‘quality’ of the Anchor UE's location information is not static and may change depending on the situation. For example, even if an Anchor UE includes a GNSS module in order to get a position fix, it may be out of coverage of the GNSS satellite network (e.g., indoors or in a tunnel), and hence may not be able to act as a Located UE. Similarly, if the UE is out-of-coverage of the NG-RAN it may not be able to act as a Located UE. Also, the position of a UE may be too unstable to be used as Located UE (e.g., UE is moving too fast or shaking too much). To this end, it needs to be considered how a policy can be configured and applied by which an Anchor UE can determine whether it can act as a Located UE. Such a policy may be configured by the LMF (or PCF or other core network function) or by the Target UE. Possible criteria/conditions to consider for an Anchor UE to switch on/off its role as a Located UE and/or switch on/off indicating that its position is known or can be determined and/or switch on/off its ability/feature to provide a location service proxy include:
Whether or not the UE has a position fix (e.g. through GNSS), how long the location is expected to remain valid, when was the last time the location was determined and/or how often the location gets updated,
Which methods/capabilities are used to determine the UE's location (e.g. support for GNSS) and/or the accuracy of such method/capability,
Whether or not the UE's position is stable (e.g. UE is stationary or moving, which may be determined by means of a set of limits/thresholds (e.g. it moves at very slow or constant speed or its position fluctuates within a small limited area), the limits/thresholds of which may be determined by a set of criteria),
Whether or not the UE is in coverage of a base station,
Whether or not the UE is connected to an LMF,
Whether or not it receives enough positioning/ranging reference signals.

If the situation changes during a ranging procedure, also the role of an Anchor UE may change. The other UE(s) involved in the ranging procedure and if in coverage also the LMF (or other managing entity) need be notified of such role change. An Anchor UE may announce or stop announcing itself as a Located UE and/or announce or stop announcing that its position is known or can be determined and/or announce or stop announcing that it can provide a location service proxy, depending on one or more of the above described criteria/conditions. A target UE, location service proxy, LMF and/or one or more Anchor UEs may decide to not use the location of an Anchor UE, depending on one or more of the above-described criteria/conditions; An Anchor UE may indicate to a target UE, location service proxy, LMF and/or one or more other Anchor UEs an accuracy measure of its location estimate (e.g. maximum deviation). This may depend on the methods/capabilities that are used to determine the Anchor UE's location.

An Anchor UE may provide more details related to the stability and accuracy of the location of the Anchor UE in a message exchange with Target UE or LMF or location service proxy or managing entity, and/or may notify or express to the Target UE or LMF or location service proxy about a change to this capability (e.g. when it is no longer able to provide its location anymore, i.e. no longer able to perform the role of Located UE anymore, e.g., because it lost GNSS coverage) e.g. by extending the “ProvideCapabilities” message of the LPP or SLPP protocol, whereby the capabilities may be described by using a field/argument defining the current role of the Anchor UE (e.g. role=“Located UE”) and/or whether or not it has a known location or its location can be determined (e.g. location=“available”), and whereby the same or similar field/argument may be used to define a role change (e.g. role=“Reference UE” or rolechange=“Reference UE” or location=“unavailable”).

Similarly, it could indicate in such capability exchange an (average) accuracy of its location (e.g. accuracy=“10 meters”), an (average) refresh time between location updates/new location fix (e.g. refresh=“1 second”), an (average) validity time in which the position is stable (e.g. validity time=“10 seconds”), an (average) latency to determine an update of its position (e.g. latency=“0.5 second”), and/or other related parameters. Similarly, an Anchor UE may provide more details related to the stability and accuracy of the location of the Anchor UE in a message exchange with Target UE or LMF or location service proxy or managing entity, and/or may notify or express to the Target UE or LMF or location service proxy about a change to this capability (e.g. when it is no longer able to provide its location anymore, i.e. no longer able to perform the role of Located UE anymore, e.g. because it lost GNSS coverage) by using e.g. an extended ProvideAssistanceData or ProvideLocationInformation or other (LPP-based or SLPP-based) message. Note that determining whether or not the position of an anchor UE is stable may be done relative to other UEs, e.g., UEs that are part of a constellation (e.g. a device UE or an anchor UE). For example, if other UEs are moving in the same direction, e.g., UEs that are present in the same vehicle, the absolute velocity of ranging UE is less important than the relative velocity. To this end, the UE may receive velocity and direction information from one or more device UEs or anchor UEs in vicinity or may receive such information from a location service. The UE may compare the received velocity and direction information, and then based on a (pre-configured) policy (e.g. a policy that indicates a maximum relative speed difference or maximum direction difference) determine if the UE can become an anchor UE. A UE, e.g., a Located UE, may indicate by means of a message, e.g., during discovery (e.g. in a message/message field in a model A/B discovery message over PC5), that its location is currently known (e.g. through GNSS), whereby it may indicate a validity time for which this location or its location is expected to remain valid and/or known. The validity time may depend on the absolute speed of the Anchor UE or relative speed of the Anchor UE in relation to the Target UE or reference point, and/or direction of the Anchor UE in relation to the Target UE or reference point. This can be useful since the anchor UE may be mobile and therefore its location may not always be stable. Additionally, or alternatively, it may indicate a speed and/or direction in a message, e.g., its discovery message or subsequent message after connection setup, between a target UE and an anchor UE.

In an embodiment that can be combined with other embodiments or implemented independently, a Target UE may issue a Discovery Request or Solicitation message with a flag set indicating that it is searching for Located UEs. On receiving the message, Located UEs that choose to respond send a Discovery Response (e.g. ProSe Model B response message) message with a flag set indicating that it is a Located UE. The Target UE may then seek more information about the location information of the Anchor UE. For example, it may send a Request Capabilities or Request Assistance Data message to the Anchor UE containing an information element (IE) comprising a request for the location or location status or other related information of the Anchor UE. The Anchor UE prepares an IE in response capturing the requested information and returns it to the Target UE in the corresponding Provide Capabilities or Provide Assistance Data message.

The IE prepared by the Anchor UE may comprise any of the Anchor UE's location, a measure of uncertainty of the location, an estimate of the velocity of the Anchor UE, time since the last location estimate, time until the next location estimate, the positioning method or methods use to derive the location estimate and so on. Information elements that supply some of this information can be based on the coding specification of TS 23.032. One set encodes the Anchor UE location coordinates and spatial location uncertainty with different IEs coding for different uncertainty ‘shapes’, e.g., circular, ellipse or ellipsoid. Another set encodes the UE velocity with variants covering different ways of expressing velocity, e.g., horizontal, horizontal and vertical, and so on. Variants of these IEs can be envisaged, optimised to carry different sets of information. For example, in a variant of the preceding embodiment, a modified set of IEs that only codes for the location uncertainty is used when the Anchor UE location coordinates are not required. Said IEs may comprise one that encodes the radius of a circular zone of uncertainty, one that captures the major and minor axes of an elliptical zone of uncertainty and so on. In another variant, when information on the timing of Anchor UE location estimates is required, an IE is chosen from a set that codes this information in various ways, for example, time since the last location estimation, expected time before the next location estimation and so on.

For convenience in operation, the various smaller IEs may be collected into a larger meta location information IE that brings together requested information concerning an Anchor's location coordinates or location uncertainty.

Additionally or alternatively. if an anchor UE is requested to provide its location to a target UE, location service proxy or LMF, and the anchor UE determines one or more of the following situations/states:
the anchor UE switched off its role as a Located UE
the anchor UE's location is currently not available (e.g. lost position fix, etc.)
the last time since the location was determined or the last time since the UE had a position fix is more than a certain time duration, or is more than a maximum time duration as requested/indicated by the requesting target UE, location service proxy or LMF
the accuracy of the location information gets below a minimum threshold or is lower than the accuracy requested/indicated by the requesting target UE, location service proxy or LMF.
the anchor UE is moving above a certain minimum speed then the Located UE may respond with an error message (“e.g. location not available”) to the requesting target UE, location service proxy or LMF, and/or it may respond with its last known location together with an indication that it is outdated or not valid anymore and/or it may responds with location information with low accuracy (i.e. lower accuracy than the last known location stored by the anchor UE). This can be done by reducing the number of digits/bits to represent the location information, use higher uncertainty level, or use a different location report (e.g. only provide cell identifier instead of detailed location coordinates), or omit some fields in the location report (e.g. only x,y coordinates, not z-coordinate, or omit angle information). In other words, the anchor UE determines its response (e.g. in the meta IE) to the requesting Target UE, location service proxy or LMF based on whether or not the anchor UE has encountered the above states/situations.

In a further embodiment that may be combined with other embodiments or used independently, this same IEs (e.g. meta IE) may also be used by the Target UE or another network element, e.g., the gNB or the LMF, to place thresholds that must be met (or exceeded or kept below as appropriate) by the Anchor UE in order to consider itself a Located UE; that is, an Anchor UE whose location is known or is able to be known. An Anchor UE that does not meet the threshold requirements is not allowed to declare itself to be a Located UE, even if it does in fact know its location albeit to a wider degree of uncertainty. This allows the Target UE to be sure that any Anchor UE that declares itself to be a Located UE always knows its location to within, say 3 metres and is moving no faster than, say, 1 cm/s.

In a variant of the above embodiment, the target might include an IE (e.g. the meta IE) in the Request message it sends to the Anchor UE. Alternatively, or additionally, the network may send the IE via, for example, RRC as part of a configuration process.

In a further variant, an anchor UE that does not meet the threshold requirements may consider itself as a Reference UE; that is, an Anchor UE whose location is not able to be known and may report itself as such to the Target UE. It will also not respond to Discovery Request messages if a flag requesting responses from Located UEs only is set. Otherwise, it may respond to Discovery messages or transmit a Model A Announcement discovery message with the Located UE flag reset to indicate that it is not acting as a Located UE.

In a further embodiment that may be combined with other embodiments or implemented independently, an Anchor that reported itself as a Located UE continues to monitor its location uncertainty against the threshold requirements. The Anchor UE may report changes in the location uncertainty using unsolicited Provide Capabilities or Provide Assistance Data messages (e.g., containing a meta location information IE as described earlier) to a Target UE or LMF/RMF or proxy thereof. If at any point it falls below them or it loses its location coordinates (e.g., it goes out of GNSS range), it immediately issues a message informing the Target UE or LMF/RMF or proxy thereof of the new situation. It may do this via an unsolicited Provide Capabilities or Provide Assistance Data message or error message carrying an information element that may comprise an indication of a location failure and/or information on the nature of the failure, e.g., loss of primary location information, degradation of location uncertainty below threshold, and/or information about which threshold has been exceeded (e.g., velocity) and so on. Alternatively, or additionally, it may issue a Discovery Announce message with the Located UE flag reset.

In another embodiment, the information element(s) containing information about the location uncertainty and/or velocity of an Anchor UE's location is provided together with the location of the Anchor UE when provided as assistance data to a Target UE, LMF/RMF or proxy thereof. Also, in this case the Anchor UE may monitor its location uncertainty and inform the Target UE, LMF/RMF or proxy thereof e.g., by using unsolicited Provide Capabilities or Provide Assistance Data message. The Target UE or LMF/RMF or proxy thereof may use this information to recalculate the location of a Target UE or use this to include/exclude the location of the respective Anchor UE from the location calculations.

Note that the benefit of informing the Target UE, LMF/RMF or proxy thereof during capability exchange of the Anchor UE's location uncertainty or whether or not it meets certain thresholds, rather than as assistance information or later in the ranging/sidelink positioning procedures is that the Target UE, LMF/RMF or proxy thereof can include/exclude the respective Anchor UE in the sidelink/positioning procedures early on and hence not waste unnecessary communication resources if the Anchor UE's location does not meet the desired requirements.

Section: SIB(s) and posSIB(s) on Demand Request for UEs

In TEI17, 3GPP agreed in the CR R2-2203993 to support an enhanced System Information (SI) scheduling method by defining a new field si-SchedulingInfo-v1700 in SIB1 to allow SIB(s) and/or posSIB(s) to be configured by schedulingInfoList2, in addition to the original SI scheduling method defined from R15 by schedulingInfoList in si-SchedulingInfo. TS 38.331, V17.6.0 has the following SIB1 ASN.1 definition.

SIB1 contains information relevant when evaluating if a UE is allowed to access a cell and defines the scheduling of other system information. It also contains radio resource configuration information that is common for all UEs and barring information applied to the unified access control.
Signalling radio bearer: N/A
RLC-SAP: TM
Logical channels: BCCH
Direction: Network to UE

Contents of SIB1 message are as follows:

-- ASN1START
-- TAG-SIB1-START

| | |
|---|---|
| SIB1 ::= | SEQUENCE { |
| cellSelectionInfo | SEQUENCE { |
| q-RxLevMin | Q-RxLevMin, |

| | |
|---|---|
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S
}
OPTIONAL, -- Cond Standalone

| | |
|---|---|
| cellAccessRelatedInfo | CellAccessRelatedInfo, |

| | |
|---|---|
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |

| | |
|---|---|
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |
| uac-AccessCategory1-SelectionAssistanceInfo | CHOICE { |

| | |
|---|---|
| plmnCommon | UAC-AccessCategory1- |

SelectionAssistanceInfo,

| | |
|---|---|
| individualPLMNList | SEQUENCE (SIZE (2..maxPLMN)) |

```
OF UAC-AccessCategory1-SelectionAssistanceInfo
    }
OPTIONAL -- Need S
  }
OPTIONAL, -- Need R
```

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL
}

| | |
|---|---|
| SIB1-v1610-IEs ::= | SEQUENCE { |

| | |
|---|---|
| idleModeMeasurementsEUTRA-r16 | ENUMERATED {true} |

OPTIONAL, -- Need R

| | |
|---|---|
| idleModeMeasurementsNR-r16 | ENUMERATED {true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | SIB1-v1630-IEs |

OPTIONAL
}

| | |
|---|---|
| SIB1-v1630-IEs ::= | SEQUENCE { |
| uac-BarringInfo-v1630 | SEQUENCE { |
| uac-AC1-SelectAssistInfo-r16 | SEQUENCE (SIZE (2..maxPLMN)) OF UAC- |

AC1-SelectAssistInfo-r16
}
OPTIONAL, -- Need R

| | |
|---|---|
| nonCriticalExtension | SIB1-v1700-IEs |

OPTIONAL
}

| | |
|---|---|
| SIB1-v1700-IEs ::= | SEQUENCE { |

| | |
|---|---|
| hsdn-Cell-r17 | ENUMERATED {true} |

OPTIONAL, -- Need R

| | |
|---|---|
| uac-BarringInfo-v1700 | SEQUENCE { |
| uac-BarringInfoSetList-v1700 | UAC-BarringInfoSetList-v1700 |

}
OPTIONAL, -- Cond MINT

| | |
|---|---|
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB-r17 |

OPTIONAL, -- Need R

| | |
|---|---|
| featurePriorities-r17 | SEQUENCE { |

| | |
|---|---|
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

OPTIONAL -- Need R
}
OPTIONAL, -- Need R

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, notAllowed} |
| OPTIONAL, -- Need S | |
| cellBarredNTN-r17 | ENUMERATED {barred, notBarred} |

OPTIONAL, -- Need S

| | |
|---|---|
| nonCriticalExtension | SIB1-v1740-IEs |

OPTIONAL
}

| | |
|---|---|
| SIB1-v1740-IEs ::= | SEQUENCE { |

| | |
|---|---|
| si-SchedulingInfo-v1740 | SI-SchedulingInfo-v1740 |

OPTIONAL, -- Need R

| | |
|---|---|
| nonCriticalExtension | SEQUENCE { } |

OPTIONAL
}

| | |
|---|---|
| UAC-AccessCategory1-SelectionAssistanceInfo := | ENUMERATED {a, b, c} |
| UAC-AC1-SelectAssistInfo-r16 ::= | ENUMERATED {a, b, c, notConfigured} |
| SDT-ConfigCommonSIB-r17 ::= | SEQUENCE { |

| | |
|---|---|
| sdt-RSRP-Threshold-r17 | RSRP-Range |

OPTIONAL, -- Need R

| | |
|---|---|
| sdt-LogicalChannelSR-DelayTimer-r17 | ENUMERATED { sf20, sf40, sf64, |

| | |
|---|---|
| sf128, sf512, sf1024, sf2560, spare1} | OPTIONAL, -- Need R |

| | |
|---|---|
| sdt-DataVolumeThreshold-r17 | ENUMERATED {byte32, byte100, byte200, |

byte400, byte600, byte800, byte1000, byte2000, byte4000,

byte8000, byte9000,

byte10000, byte12000, byte24000, byte48000, byte96000},

| | |
|---|---|
| t319a-r17 | ENUMERATED { ms100, ms200, ms300, |

ms400, ms600, ms1000, ms2000,

ms3000, ms4000,

spare7, spare6, spare5, spare4, spare3, spare2, spare1}
}
RedCap-ConfigCommonSIB-r17 ::= SEQUENCE {

| | |
|---|---|
| halfDuplexRedCapAllowed-r17 | ENUMERATED {true} |

OPTIONAL, -- Need R

| | |
|---|---|
| cellBarredRedCap-r17 | SEQUENCE { |
| cellBarredRedCap1Rx-r17 | ENUMERATED {barred, notBarred}, |
| cellBarredRedCap2Rx-r17 | ENUMERATED {barred, notBarred} |

```
  }
OPTIONAL, -- Need R
  ...
}
FeaturePriority-r17 ::= INTEGER (0..7)
-- TAG-SIB1-STOP
-- ASN1STOP
```

The JE SI-SchedulingInfo contains information needed for acquisition of SI messages.

-- ASN1START
-- TAG-SI-SCHEDULINGINFO-START

| | |
|---|---|
| SI-SchedulingInfo ::= | SEQUENCE { |

| | |
|---|---|
| schedulingInfoList | SEQUENCE (SIZE (1..maxSI-Message)) OF |

SchedulingInfo,

| | |
|---|---|
| si-WindowLength | ENUMERATED {s5, s10, s20, s40, s80, |

s160, s320, s640, s1280, s2560-v1710, s5120-v1710 },

| | |
|---|---|
| si-RequestConfig | SI-RequestConfig |

OPTIONAL, -- Cond MSG-1

| | |
|---|---|
| si-RequestConfigSUL | SI-RequestConfig |

OPTIONAL, -- Cond SUL-MSG-1

| | |
|---|---|
| systemInformationAreaID | BIT STRING (SIZE (24)) |

OPTIONAL, -- Need R
...
}

| | |
|---|---|
| SchedulingInfo ::= | SEQUENCE { |

| | |
|---|---|
| si-BroadcastStatus | ENUMERATED {broadcasting, |

notBroadcasting},

| | |
|---|---|
| si-Periodicity | ENUMERATED {rf8, rf16, rf32, rf64, |

rf128, rf256, rf512},

| | |
|---|---|
| sib-MappingInfo | SIB-Mapping |

}

| | |
|---|---|
| SI-SchedulingInfo-v1700 ::= | SEQUENCE { |

| | |
|---|---|
| schedulingInfoList2-r17 | SEQUENCE (SIZE (1..maxSI-Message)) OF |

SchedulingInfo2-r17,

| | |
|---|---|
| dummy | SI-RequestConfig |

OPTIONAL
}

| | |
|---|---|
| SI-SchedulingInfo-v1740 ::= | SEQUENCE { |

| | |
|---|---|
| si-RequestConfigRedCap-r17 | SI-RequestConfig |

OPTIONAL -- Cond REDCAP-MSG-1
}

| | |
|---|---|
| SchedulingInfo2-r17 ::= | SEQUENCE { |

| | |
|---|---|
| si-BroadcastStatus-r17 | ENUMERATED {broadcasting, |

notBroadcasting},

| | |
|---|---|
| si-WindowPosition-r17 | INTEGER (1..256), |

| | |
|---|---|
| si-Periodicity-r17 | ENUMERATED {rf8, rf16, rf32, rf64, |

rf128, rf256, rf512},

| | |
|---|---|
| sib-MappingInfo-r17 | SIB-Mapping-v1700 |

}

| | |
|---|---|
| SIB-Mapping ::= | SEQUENCE (SIZE (1..maxSIB)) OF SIB- |

TypeInfo

| | |
|---|---|
| SIB-Mapping-v1700 ::= | SEQUENCE (SIZE (1..maxSIB)) OF SIB- |

TypeInfo-v1700

| | |
|---|---|
| SIB-TypeInfo ::= | SEQUENCE { |

| | |
|---|---|
| type | ENUMERATED {sibType2, sibType3, |

sibType4, sibType5, sibType6, sibType7, sibType8, sibType9,

sibType10-v1610,

sibType11-v1610, sibType12-v1610, sibType13-v1610,

sibType14-v1610,

spare3, spare2, spare1,... },

| | |
|---|---|
| valueTag | INTEGER (0..31) |

OPTIONAL, -- Cond SIB-TYPE

| | |
|---|---|
| areaScope | ENUMERATED {true} |

OPTIONAL -- Need S
}

| | |
|---|---|
| SIB-TypeInfo-v1700 :: = | SEQUENCE { |
| sibType-r17 | CHOICE { |

| | |
|---|---|
| type1-r17 | ENUMERATED {sibType15, sibType16, |

sibType17, sibType18, sibType19, sibType20, sibType21,

spare9, spare8,

spare7, spare6, spare5, spare4, spare3, spare2, spare1,...},

| | |
|---|---|
| type2-r17 | SEQUENCE { |

| | |
|---|---|
| posSibType-r17 | ENUMERATED {posSibType1-9, |

posSibType1-10, posSibType2-24, posSibType2-25,

posSibType6-4,

posSibType6-5, possibType6-6, spare9, spare8, spare7, spare6,

spare5, spare4,

spare3, spare2, spare1,...},

| | |
|---|---|
| encrypted-r17 | ENUMERATED { true } |

OPTIONAL, -- Need R

| | |
|---|---|
| gnss-id-r17 | GNSS-ID-r16 |

OPTIONAL, -- Need R

| | |
|---|---|
| sbas-id-r17 | SBAS-ID-r16 |

```
OPTIONAL -- Need R
    }
  },
```

| | |
|---|---|
| valueTag-r17 | INTEGER (0..31) |

OPTIONAL, -- Cond NonPosSIB

| | |
|---|---|
| areaScope-r17 | ENUMERATED {true} |

OPTIONAL -- Need S
}
-- TAG-SI-SCHEDULINGINFO-STOP
-- ASN1STOP

Similarly, the JE PosSIJ-SchedulingInfo contains information needed for acquisition of PosSIB messages.

-- ASN1START
-- TAG-POSSI-SCHEDULINGINFO-START

| | |
|---|---|
| PosSI-SchedulingInfo-r16 ::= | SEQUENCE { |

| | |
|---|---|
| posSchedulingInfoList-r16 | SEQUENCE (SIZE (1..maxSI- |

Message)) OF PosSchedulingInfo-r16,

| | |
|---|---|
| posSI-RequestConfig-r16 | SI-RequestConfig |

OPTIONAL, -- Cond MSG-1

| | |
|---|---|
| posSI-RequestConfigSUL-r16 | SI-RequestConfig |

```
OPTIONAL, -- Cond SUL-MSG-1
  ...,
  [[
```

| | |
|---|---|
| posSI-RequestConfigRedCap-r17 | SI-RequestConfig |

OPTIONAL -- Cond REDCAP-MSG-1
]]
}
PosSchedulingInfo-r16 ::= SEQUENCE {

| | |
|---|---|
| offsetToSI-Used-r16 | ENUMERATED {true} |

OPTIONAL, -- Need R

| | |
|---|---|
| posSI-Periodicity-r16 | ENUMERATED {rf8, rf16, rf32, rf64, rf128, |

rf256, rf512},

| | |
|---|---|
| posSI-BroadcastStatus-r16 | ENUMERATED {broadcasting, notBroadcasting}, |

| | |
|---|---|
| posSIB-MappingInfo-r16 | PosSIB-MappingInfo-r16, |

...
}

| | |
|---|---|
| PosSIB-MappingInfo-r16 ::= | SEQUENCE (SIZE (1..maxSIB)) OF PosSIB-Type-r16 |

PosSIB-Type-r16 ::= SEQUENCE {

| | |
|---|---|
| encrypted-r16 | ENUMERATED { true } |

OPTIONAL, -- Need R

| | |
|---|---|
| gnss-id-r16 | GNSS-ID-r16 |

OPTIONAL, -- Need R

| | |
|---|---|
| sbas-id-r16 | SBAS-ID-r16 |

OPTIONAL, -- Cond GNSS-ID-SBAS

| | |
|---|---|
| posSibType-r16 | ENUMERATED { possibType1-1, posSibType1-2, |

posSibType1-3, posSibType1-4, posSibType1-5, posSibType1-6,

posSibType1-7, posSibType1-8,

posSibType2-1, posSibType2-2, posSibType2-3, posSibType2-4,

posSibType2-5, posSibType2-6,

posSibType2-7, posSibType2-8, posSibType2-9, posSibType2-10,

posSibType2-11, posSibType2-

12, posSibType2-13, posSibType2-14, posSibType2-15,

posSibType2-16, posSibType2-

17, posSibType2-18, posSibType2-19, posSibType2-20,

posSibType2-21, posSibType2-

22, possibType2-23, posSibType3-1, posSibType4-1,

posSibType5-1,posSibType6-1,

possibType6-2, posSibType6-3,... },

| | |
|---|---|
| areaScope-r16 | ENUMERATED {true} |

OPTIONAL -- Need S
}

| | |
|---|---|
| GNSS-ID-r16 ::= | SEQUENCE { |

| | |
|---|---|
| gnss-id-r16 | ENUMERATED{gps, sbas, qzss, galileo, glonass, |

bds, ..., navic-v1760} ,
...
}
SBAS-ID-r16 ::= SEQUENCE {

| | |
|---|---|
| sbas-id-r16 | ENUMERATED { waas, egnos, msas, gagan, ...}, |

...
}
-- TAG-POSSI-SCHEDULINGINFO-STOP
-- ASN1STOP

From the above ASN.1 definition, the following observations may be listed:
schedulingInfoListin si-SchedulingInfo in SIB1 is defined from R15 to support SI scheduling for SIB(s), where si-BroadcastStatus is defined to indicate whether the corresponding SI is being broadcasted or not, i.e., broadcasting or notBroadcasting;
posSchedulingInfoList in posSI-SchedulingInfo in SIB1 is defined from R16 to support positioning related SI scheduling for posSIB(s), where posSI-BroadcastStatus is defined to indicate whether the corresponding positioning related SI is broadcasting or notBroadcasting;
schedulingInfoList2 in si-SchedulingInfo-v1700 is defined from R17 in the work item TEI17 to support the enhanced SI scheduling for SIB(s) and/or posSIB(s), where sib type 1 for SIB(s) and sib type 2 for posSIB(s) and si-BroadcastStatus is defined to indicate whether the corresponding SI is broadcasting or notBroadcasting.

Further, it can be observed that SIB(s) can be scheduled by either si-SchedulingInfo, or si-SchedulingInfo-v1700, or both, and the si-BroadcastStatus of si-SchedulingInfo and/or the type 1 SIB configured by si-SchedulingInfo-v1700 indicate the broadcasting status of either broadcasting or notBroadcasting. Further, it can be observed that posSIB(s) can be scheduled by either posSI-SchedulingInfo, or si-SchedulingInfo-v1700, or both, and the posSI-BroadcastStatus of posSI-SchedulingInfo and/or si-BroadcastStatus of the type 2 SIB configured by si-SchedulingInfo-v1700 indicate the broadcasting status of either broadcasting or notBroadcasting.

A problem is that in the current 5GNR RRC specification TS 38.331, V17.6.0, si-SchedulingInfo-v1700 is not checked in the acquisition of SIB(s), therefore, SIB(s) scheduled by si-SchedulingInfo-v1700 may not be appropriately handled in the SIB(s) acquisition. A further problem is that in the current 5G NR RRC specification TS 38.331, V17.6.0, si-SchedulingInfo-v1700 is not checked in the acquisition of posSIB(s), therefore, posSIB(s) scheduled by si-SchedulingInfo-v1700 may not be appropriately handled in the posSIB(s) acquisition.

Thus, it is an aim of the invention to address above problems, and others arising from them.

In one embodiment, in the on demand request of posSIB(s) in RRC_IDLE/RRC_INACTIVE as specified in TS 38.331, V17.6.0, clause 5.2.2.3.3a, the UE shall, while SDT procedure is not ongoing:

```
1> if SIB1 includes posSI-SchedulingInfo containing posSI-RequestConfigSUL and criteria to select
supplementary uplink as defined in TS 38.321[3], clause 5.1.1 is met:
  2> trigger the lower layer to initiate the Random Access procedure on supplementary uplink in
accordance with TS 38.321 [3] using the PRACH preamble(s) and PRACH resource(s) in posSI-
RequestConfigSUL corresponding to the SI message(s) that the UE upper layers require for positioning
operations, and for which posSI-BroadcastStatus in posSchedulingInfoList in posSI-SchedulingInfo or si-
BroadcastStatus of the type 2 SIB configured by schedulingInfoList2 in si-SchedulingInfo-v1700 if present
is set to notBroadcasting;
  2> if acknowledgement for SI request is received from lower layers:
    3> acquire the requested SI message(s) as defined in clause 5.2.2.3.2, immediately;
1> else if the UE is a RedCap UE and if initialUplinkBWP-RedCap is configured in
UplinkConfigCommonSIB and if SIB1 includes posSI-SchedulingInfo containing posSI-
RequestConfigRedCap and criteria to select normal uplink as defined in TS 38.321[3], clause 5.1.1 is met:
  2> trigger the lower layer to initiate the Random Access procedure on normal uplink in accordance
with TS 38.321 [3] using the PRACH preamble(s) and PRACH resource(s) in posSI-
RequestConfigRedCap corresponding to the SI message(s) that the UE upper layers require for positioning
operations, and for which posSI-BroadcastStatus in posSchedulingInfoList in posSI-SchedulingInfo or si-
BroadcastStatus of the type 2 SIB configured by schedulingInfoList2 in si-SchedulingInfo-v1700 if present
is set to notBroadcasting;
  2> if acknowledgement for SI request is received from lower layers:
    3> acquire the requested SI message(s) as defined in clause 5.2.2.3.2, immediately;
1> else:
  2> if the UE is not a RedCap UE and if SIB1 includes posSI-SchedulingInfo containing posSI-
RequestConfig and criteria to select normal uplink as defined in TS 38.321[3], clause 5.1.1 is met; or
  2> if the UE is a RedCap UE and if initialUplinkBWP-RedCap is not configured in
UplinkConfigCommonSIB and if SIB1 includes posSI-SchedulingInfo containing posSI-RequestConfig and
criteria to select normal uplink as defined in TS 38.321[3], clause 5.1.1 is met:
    3> trigger the lower layer to initiate the Random Access procedure on normal uplink in
accordance with TS 38.321 [3] using the PRACH preamble(s) and PRACH resource(s) in posSI-
RequestConfig corresponding to the SI message(s) that the UE upper layers require for positioning
operations , and for which posSI-BroadcastStatus in posSchedulingInfoList in posSI-SchedulingInfo or si-
BroadcastStatus of the type 2 SIB configured by schedulingInfoList2 in si-SchedulingInfo-v1700 if present
is set to notBroadcasting;
    3> if acknowledgement for SI request is received from lower layers:
      4> acquire the requested SI message(s) as defined in clause 5.2.2.3.2, immediately;
  2> else:
    3> apply the default L1 parameter values as specified in corresponding physical layer
specifications except for the parameters for which values are provided in SIB1;
    3> apply the default MAC Cell Group configuration as specified in 9.2.2;
    3> apply the timeAlignmentTimerCommon included in SIB1;
    3> apply the CCCH configuration as specified in 9.1.1.2;
    3> initiate transmission of the RRCSystemInfoRequest message with rrcPosSystemInfoRequest
in accordance with 5.2.2.3.4;
    3> if acknowledgement for RRCSystemInfoRequest message with rrcPosSystemInfoRequest is
received from lower layers:
      4> acquire the requested SI message(s) as defined in clause 5.2.2.3.2, immediately;
1> if cell reselection occurs while waiting for the acknowledgment for SI request from lower layers:
  2> reset MAC;
  2> if SI request is based on RRCSystemInfoRequest message with rrcPosSystemInfoRequest:
    3> release RLC entity for SRB0.
NOTE: After RACH failure for SI request it is up to UE implementation when to retry the SI request.
```

In one embodiment, in the actions related to transmission of RRCSystemInfoRequest message as specified in TS 38.331, V17.6.0, clause 5.2.2.3.4, the UE shall set the contents of RRCSystemInfoRequest message as follows:

```
1> if the procedure is triggered to request the required SI message(s) other than positioning:
  2> set the requested-SI-List to indicate the SI message(s) that the UE requires to operate within the
cell, and for which si-BroadcastStatus is set to notBroadcasting;
1> else if the procedure is triggered to request the required SI message(s) for positioning:
  2> set the requestedPosSI-List to indicate the SI message(s) that the UE upper layers require for
positioning operations, and for which posSI-BroadcastStatus in posSchedulingInfoList in posSI-
SchedulingInfo or si-BroadcastStatus of the type 2 SIB configured by schedulingInfoList2 in si-
SchedulingInfo-v1700 if present is set to notBroadcasting.
The UE shall submit the RRCSystemInfoRequest message to lower layers for transmission.
```

In one embodiment, in the acquisition of SIB(s) and/or posSIB(s) in RRC_CONNECTED as specified in TS 38.331, V17.6.0, clause 5.2.2.3.5, the UE shall:

```
1> if the UE is in RRC_CONNECTED with an active BWP not configured with common search space
with the field searchSpaceOtherSystemInformation and the UE has not stored a valid version of a SIB or
posSIB, in accordance with clause 5.2.2.2.1, of one or several required SIB(s) or posSIB(s) in accordance
with clause 5.2.2.1, or
1> if the UE is in RRC_CONNECTED and acting as a L2 U2N Remote UE and the UE has not stored a
valid version of a SIB, in accordance with clause 5.2.2.2.1, of one or several required SIB(s) in accordance
with clause 5.2.2.1:
  2> for the SI message(s) that, according to the si-SchedulingInfo, si-SchedulingInfo-v1700 if present
or posSI-SchedulingInfo in the stored SIB1, contain at least one required SIB or requested posSIB:
    3> if onDemandSIB-Request is configured and timer T350 is not running:
      4> initiate transmission of the DedicatedSIBRequest message in accordance with 5.2.2.3.6;
      4> start timer T350 with the timer value set to the onDemandSIB-RequestProhibitTimer;
1> else if the UE is in RRC_CONNECTED with an active BWP configured with common search space
with the field searchSpaceOtherSystemInformation and the UE has not stored a valid version of a SIB or
posSIB, in accordance with clause 5.2.2.2.1, of one or several required SIB(s) or posSIB(s) in accordance
with clause 5.2.2.1:
  2> for the SI message(s) that, according to the si-SchedulingInfo or si-SchedulingInfo-v1700 if
present in the stored SIB1, contain at least one required SIB and for which si-BroadcastStatus is set to
broadcasting:
    3> acquire the SI message(s) as defined in clause 5.2.2.3.2;
  2> for the SI message(s) that, according to the si-SchedulingInfo or si-SchedulingInfo-v1700 if
present in the stored SIB1, contain at least one required SIB and for which si-BroadcastStatus is set to
notBroadcasting:
    3> if onDemandSIB-Request is configured and timer T350 is not running:
      4> initiate transmission of the DedicatedSIBRequest message in accordance with 5.2.2.3.6;
      4> start timer T350 with the timer value set to the onDemandSIB-RequestProhibitTimer;
      4> acquire the requested SI message(s) corresponding to the requested SIB(s) as defined
in clause 5.2.2.3.2.
  2> for the SI message(s) that, according to the posSI-SchedulingInfo or si-SchedulingInfo-v1700 if
present in the stored SIB1, contain at least one requested posSIB and for which posSI-BroadcastStatus is
set to broadcasting or at least one requested type 2 SIB configured by schedulingInfoList2 in si-
SchedulingInfo-v1700 if present and for which si-BroadcastStatus is set to broadcasting:
    3> acquire the SI message(s) as defined in clause 5.2.2.3.2;
  2> for the SI message(s) that, according to the posSI-SchedulingInfo or si-SchedulingInfo-v1700 if
present in the stored SIB1, contain at least one requested posSIB and for which posSI-BroadcastStatus is
set to notBroadcasting or at least one requested type 2 SIB configured by schedulingInfoList2 in si-
SchedulingInfo-v1700 if present and for which si-BroadcastStatus is set to notBroadcasting:
    3> if onDemandSIB-Request is configured and timer T350 is not running:
      4> initiate transmission of the DedicatedSIBRequest message in accordance with 5.2.2.3.6;
      4> start timer T350 with the timer value set to the onDemandSIB-RequestProhibitTimer;
      4> acquire the requested SI message(s) corresponding to the requested posSIB(s) as defined
in clause 5.2.2.3.2.
NOTE: UE may include on demand request for SIB and/or posSIB(s) in the same DedicatedSIBRequest
message.
```

In one embodiment, in the actions upon reception of the SIB1 as specified in TS 38.331, V17.6.0, clause 5.2.2.4.2, upon receiving the SIB1 the UE shall:

```
  1> if the UE has not stored a valid version of a SIB, in accordance with clause 5.2.2.2.1, of one or
several required SIB(s), in accordance with clause 5.2.2.1:
    2> for the SI message(s) that, according to the si-SchedulingInfo or si-SchedulingInfo-v1700 if
present, contain at least one required SIB and for which si-BroadcastStatus is set to broadcasting:
      3> acquire the SI message(s) as defined in clause 5.2.2.3.2;
    2> for the SI message(s) that, according to the si-SchedulingInfo or si-SchedulingInfo-v1700 if
present, contain at least one required SIB and for which si-BroadcastStatus is set to notBroadcasting:
      3> trigger a request to acquire the SI message(s) as defined in clause 5.2.2.3.3;
1> if the UE has a stored valid version of a posSIB, in accordance with clause 5.2.2.2.1, of one or several
required posSIB(s), in accordance with clause 5.2.2.1:
    2> use the stored version of the required posSIB;
1> if the UE has not stored a valid version of a posSIB, in accordance with clause 5.2.2.2.1, of one or
several posSIB(s) in accordance with clause 5.2.2.1:
    2> for the SI message(s) that, according to the posSI-SchedulingInfo or si-SchedulingInfo-v1700 if
present, contain at least one requested posSIB and for which posSI-BroadcastStatus is set to broadcasting
or at least one requested type 2 SIB configured by schedulingInfoList2 in si-SchedulingInfo-v1700 if
present and for which si-BroadcastStatus is set to broadcasting:
      3> acquire the SI message(s) as defined in clause 5.2.2.3.2;
    2> for the SI message(s) that, according to the posSI-SchedulingInfo or si-SchedulingInfo-v1700 if
present, contain at least one requested posSIB for which posSI-BroadcastStatus is set to notBroadcasting
or at least one requested type 2 SIB configured by schedulingInfoList2 in si-SchedulingInfo-v1700 if
present and for which si-BroadcastStatus is set to notBroadcasting:
      3> trigger a request to acquire the SI message(s) as defined in clause 5.2.2.3.3a.
```

In one embodiment, in the introduction of system information as specified in TS 38.331, V17.6.0, clause 5.2.1, System Information (SI) is divided into the MIB and a number of SIBs and posSIBs where:

| | |
|---|---|
| - | the MIB is always transmitted on the BCH with a periodicity of 80 ms and repetitions made within 80 ms |
| | (TS 38.212 [17], clause 7.1) and it includes parameters that are needed to acquire SIB1 from the cell. The |
| | first transmission of the MIB is scheduled in subframes as defined in TS 38.213 [13], clause 4.1 and |
| | repetitions are scheduled according to the period of SSB; |

| | |
|---|---|
| NOTE 1: | If the period of SSB is larger than 80 ms, the MIB is transmitted with the same periodicity as that |
| | of SSB. |

| | |
|---|---|
| - | the SIB1 is transmitted on the DL-SCH with a periodicity of 160 ms and variable transmission repetition |
| | periodicity within 160 ms as specified in TS 38.213 [13], clause 13. The default transmission repetition |
| | periodicity of SIB1 is 20 ms but the actual transmission repetition periodicity is up to network |
| | implementation. For SSB and CORESET multiplexing pattern 1, SIB1 transmission repetition period is 20 |
| | ms. For SSB and CORESET multiplexing pattern 2/3, SIB1 transmission repetition period is the same as |
| | the SSB period (TS 38.213 [13], clause 13). SIB1 includes information regarding the availability and |
| | scheduling (e.g. mapping of SIBs to SI message, periodicity, SI-window size) of other SIBs with an |
| | indication whether one or more SIBs are only provided on-demand and, in that case, the configuration |
| | needed by the UE to perform the SI request. SIB1 is cell-specific SIB; |
| - | SIBs other than SIB1 and posSIBs are carried in SystemInformation (SI) messages, which are transmitted |
| | on the DL-SCH. Only SIBs or posSIBs having the same periodicity can be mapped to the same SI message. |
| | SIBs and posSIBs are mapped to different SI messages, i.e. an SI message contains either only SIBs or |
| | only posSIBs. Each SI message is transmitted within periodically occurring time domain windows |
| | (referred to as SI-windows with same length for all SI messages). Each SI message is associated with an |
| | SI-window and the SI-windows of different SI messages do not overlap. That is, within one SI-window |
| | only the corresponding SI message is transmitted. An SI message may be repeated with the same content |
| | a number of times within the SI-window. Any SIB or posSIB except SIB1 can be configured to be cell |
| | specific or area specific, using an indication in SIB1. The cell specific SIB is applicable only within a cell |
| | that provides the SIB while the area specific SIB is applicable within an area referred to as SI area, which |
| | consists of one or several cells and is identified by systemInformationAreaID; |
| - | The mapping of SIBs to SI messages is configured in schedulingInfoList and schedulingInfoList2, while |
| | the mapping of posSIBs to SI messages is configured in posSchedulingInfoList and schedulingInfoList2. |
| | Each SIB and each posSIB is mapped to a single SI message. posSIBs of the same posSibType carrying |
| | GNSS Generic Assistance Data for different GNSS/SBAS (identified by gnss-id/sbas-id, see TS 37.355 |
| | [49]) are mapped to different SI messages. |
| | Each SIB and posSIB is contained at most once in an SI message. |
| | For SIBs and posSIBs with segments, the segments contained in SI messages are transmitted according to |
| | the SI message periodicity, with one segment of a particular sibType/posSibType in each SI message; |

NOTE1a: In the current specification, if si-SchedulingInfo-v1700 is present in SIB1, when the specification

requires to check si-BroadcastStatus of the required SIB(s), it shall check the si-BroadcastStatus
configured by schedulingInfoList in si-SchedulingInfo and si-BroadcastStatus of the type 1 SIB configured
by schedulingInfoList2 in si-SchedulingInfo-v1700.

NOTE1b: In the current specification, if si-SchedulingInfo-v1700 is present in SIB1, when the specification

| | |
|---|---|
| | requires to check posSI-BroadcastStatus of the required posSIB(s), it shall check the posSI- |
| | BroadcastStatus configured by posSchedulingInfoList in posSI-SchedulingInfo and si-BroadcastStatus of |
| | the type 2 SIB configured by schedulingInfoList2 in si-SchedulingInfo-v1700. |
| - | For a UE in RRC_CONNECTED, the network can provide system information through dedicated signalling |
| | using the RRCReconfigurationmessage, e.g. if the UE has an active BWP with no common search space |
| | configured to monitor system information, paging, or upon request from the UE. |
| - | For PSCell and SCells, the network provides the required SI by dedicated signalling, i.e. within an |
| | RRCReconfiguration message. Nevertheless, the UE shall acquire MIB of the PSCell to get SFN timing of |
| | the SCG (which may be different from MCG). Upon change of relevant SI for SCell, the network releases |
| | and adds the concerned SCell. For PSCell, the required SI can only be changed with Reconfiguration with |
| | Sync. |

NOTE 2: The physical layer imposes a limit to the maximum size a SIB can take. The maximum SIB1 or SI
message size is 2976 bits.

Thus, in accordance with a more general definition of this embodiment, which can be implemented independently or in addition to any of the other embodiments described here, it is proposed a method for operating a wireless device, wherein the method comprises
the wireless device determining a need for a set of System Information messages,
upon determination of a required set of System Information messages, the wireless device determining for each System Information message of the required set a respective broadcasting status indicative of a transmission mode of the System Information message from a network entity (e.g. broadcast periodically, broadcast upon request, unicast upon request), wherein the determination of the transmission mode includes
   determining whether an Information Element si-SchedulingInfo-v1700 is stored in the wireless device (e.g. received in System Information Block 1),
   and upon determining that an advanced set of information (e.g. si-SchedulingInfo-v1700) is stored in the wireless device, determining the respective broadcasting status in both a legacy Information element (e.g. schedulingInfoList in si-SchedulingInfo) and in the advanced Information Element.

In a variant of this embodiment, the advanced Information Element includes a schedulingInfoList2 Information Element.

In another variant of this embodiment, the System Information messages are at least one of a System Information Block or a posSIB.

In one embodiment, in the PRACH based system information request, posSI-RequestConfig, posSI-RequestConfigRedCap, posSI-RequestConfigSUL configured Msg1 resources may be used for UE and/or RedCap UE for requesting SI-messages for which posSI-BroadcastStatus in posSchedulingInfoList in posSI-SchedulingInfo and/or si-BroadcastStatus in schedulingInfoList2 in si-SchedulingInfo-v1700 is set to notBroadcasting.

In one embodiment, the L2 U2N Remote UE in RRC_IDLE/RRC_INACTIVE state may request PC5 unicast link connected L2 U2N Relay UE to monitor/request SIB(s) and/or posSIB(s) on its behalf, the L2 U2N Remote UE could include the sl-RequestedSIB-List in the RemoteUEInformationSidelink to indicate the requested SIB(s) and/or posSIB(s), and set sl-RequestedSIB-List to the value setup, then submit RemoteUEInformationSidelink message to lower layers for transmission to the L2 U2N Relay UE.

In one embodiment, the L2 U2N Remote UE in RRC_IDLE/RRC_INACTIVE state may request PC5 unicast link connected L2 U2N Relay UE to monitor paging related information on its behalf, the L2 U2N Remote UE could include the sl-PagingldentityRemoteUE in sl-PagingInfo-RemoteUE in the RemoteUEInformationSidelink to indicate the UE ID for paging, and set sl-PagingInfo-RemoteUE to the value setup, then submit RemoteUEInformationSidelink message to lower layers for transmission to the L2 U2N Relay UE.

In one embodiment, since it can be observed that (a) SIB(s) can be scheduled by either si-SchedulingInfo, or si-SchedulingInfo-v1700, or both, and the si-BroadcastStatus of si-SchedulingInfo and/or the type 1 SIB configured by si-SchedulingInfo-v1700 indicate the broadcasting status of either broadcasting or notBroadcasting and (b) posSIB(s) can be scheduled by either posSI-SchedulingInfo, or si-SchedulingInfo-v1700, or both, and the posSI-BroadcastStatus of posSI-SchedulingInfo and/or si-BroadcastStatus of the type 2 SIB configured by si-SchedulingInfo-v1700 indicate the broadcasting status of either broadcasting or notBroadcasting, the access device has a policy or configuration to enforce that si-SchedulingInfo-v1700 is only used in some scenarios (on demand system information request in RRC idle/inactive state and/or dedicated system information request in RRC connected state) or not used in certain cases, e.g., when a UE is in connected state. This may have the advantage of reducing changes/processing of UEs as well as the limiting the size increase of SIBs.

### SECTION:MAPPING SIBs T0 OTHER IDS (INCL. SUPPORT FOR NPNs)

As mentioned in other embodiments in this disclosure, SIBs received by a UE from a gNB may be forwarded (e.g. broadcasted) to other UEs, e.g. based on policies that may be configured by the network or based on RRC configuration. However, in some cases the forwarding of a SIB may be inefficient, e.g. because it is bulky. And thus, in order to address this problem, the SIBs may be mapped to other identifier (ID). In other words, the SIBs may need to be mapped to other IDs instead of being forwarded. In an embodiment that can be combined with other embodiments or implemented independently, a UE is configured to transmit (e.g. using broadcast mechanism) an identifier (e.g. Relay Service Code, ProSe/V2X application/service identifier, location/ranging service related identifier, group identifier) to another UE upon receiving a particular SIB or for a particular SIB value (e.g. for one or more specific fields of the SIB), whereby the transmission may be performed over PC5 interface (e.g. using ProSe discovery messages).

Thus, in accordance with general definition of this embodiment, it is proposed a method and apparatus that can be implemented on a wireless device (e.g. UE), comprising the wireless device receiving a broadcast message such as an element of System Information,
the wireless device converting part or all of the broadcast message, e.g., element of System Information, into an identifier (since the identifier is used locally between wireless devices, such identifier can be called “local identifier”), and
transmitting said converted identifier to at least one other wireless device.

In an example, a UE may be configured (e.g. by means of policies or RRC configuration) with a set of location/ranging service related identifiers and a set of conditions/mappings between SIBs and location/ranging service related identifiers (e.g. different identifiers for different accuracy levels or different positioning methods or different Luffs involved, different application identifiers, different constellation identifiers, different session IDs/correlation IDs), whereby if the UE receives a PosSIB or SIB containing tracking area information or SIB containing timing information or SIB containing certain NPN related identifier (e.g. Closed Access Group (CAG) Identifier (e.g. as per 3GPP TS 23.501 clause 5.30) or an Non-Public Network (NPN) identifier (e.g. PLMN Identifier combined with a Network Identifier as per 3GPP TS 23.501 clause 5.30) or a Group ID for Network Selection (GIN) (e.g. as per 3GPP TS 23.501 clause 5.30)), the UE transmits in a ProSe or V2X discovery message to other UEs a (set of) location/ranging service related identifiers onto which the received PosSIB or SIB or value thereof (e.g. of a field of the SIB) is mapped and/or for which a set of conditions apply that indicate which particular location/ranging service related identifier is to be transmitted if a SIB containing a particular PosSIB or SIB or value thereof is received. This allows a discoverer UE that wants to be located or perform ranging with the network and/or with the discovered UE to select and/or configure the appropriate location/ranging service and/or switch to NPN based location/ranging operation (e.g. switch to SNPN access mode, select UEs to perform location/ranging with based on whether these are registered (or can be registered) to the same NPN, register to a particular CAG cell or local AMF or local LMF (e.g. operated by the respective NPN), select and perform the positioning/ranging methods and/or accuracy/KPIs configured for that NPN, select a particular server/application for location/ranging service exposure, select a particular network slice/data network for that NPN, select a particular privacy profile/configuration (e.g. pertaining to that NPN, which may be different from a privacy profile for PLMN operation), select a particular set of security keys (e.g. pertaining to that NPN, which may be different for PLMN operation), etc.).

In another example, a relay UE may be configured (e.g. by means of policies or RRC configuration) to forward one or multiple identifiers (e.g., an RSC or a set of RSCs) included in or related to the received SIB. For instance, a PWS SIB may include an RSC indicative of an emergency situation. For instance, a PosSIB may include an RSC indicative of a given NPN. For instance, a SIB19 may include an RSC indicative of the type of NTN connectivity service offered.

In another example, a relay UE may be configured (e.g. by means of policies or RRC configuration) with a set of RSCs and a set of conditions/mappings between SIBs and RSCs, whereby if the relay UE receives a SIB which includes that an NPN supports emergency communication (e.g. if SIB1 SNPN-AccessInfo field includes imsEmergencySupportForSNPN indicator), the relay UE transmits an emergency RSC in a ProSe discovery message to other UEs (e.g. ProSe remote UEs). The configuration may be different for layer-3 relays than for layer-2 relays, i.e. for layer-2 relay the relay UE may transmit/forward the SNPN-AccessInfo field to a remote UE instead or in addition to the emergency RSC. This allows a layer-2 remote UE to select a relay UE to initiate an emergency communication with an NPN via the relay UE as if it were to connect directly via Uu to the network, but also allows a layer-3 remote UE to select a relay UE to initiate an emergency communication with an NPN via the relay UE, but without having to rely on SIB information, since a layer-3 remote UE does not register directly with the network, but relies on the layer-3 Relay UE's registration.

In another example, a relay UE may be configured (e.g. by means of policies or RRC configuration) with a set of RSCs and a set of conditions/mappings between SIBs and RSCs, whereby if an RSC pertains to Layer-3 relay functionality, if the relay UE receives a SIB containing a Closed Access Group (CAG) Identifier (e.g. as per 3GPP TS 23.501 clause 5.30) or an Non-Public Network (NPN) identifier (e.g. PLMN Identifier combined with a Network Identifier as per 3GPP TS 23.501 clause 5.30) or a Group ID for Network Selection (GIN) (e.g. as per 3GPP TS 23.501 clause 5.30) for example as part of the NPN-IdentityInfoList in SIB1 (e.g. as per 3GPP TS 38.331), the relay UE transmits in a ProSe discovery message to other UEs (e.g. ProSe Layer-3 remote UEs) a Relay Service Code onto which the NPN or CAG identifier or GIN is mapped and/or for which a set of conditions apply that indicate which particular Relay Service Code is to be transmitted/used if a SIB containing a certain NPN identifier or CAG identifier or GIN is received (e.g. configured by a list of RSCs that are only allowed/enabled/authorized or that are disallowed/disabled to be transmitted/used by the relay UE and/or remote UE if the relay UE or remote UE is registered/connected or can connect/register to a cell supporting a particular CAG ID), and/or whereby if an RSC pertains to Layer-2 relay functionality, if the relay UE receives a SIB containing a CAG Identifier, NPN Identifier or GIN, the relay UE may transmit the received SIB or one or more of its fields/values in a ProSe discovery message to other UEs (e.g. ProSe Layer-2 remote UEs) without performing a mapping to another identifier. This allows a Layer-2 remote UE to select and register with an NPN as if it were to connect directly via Uu to the network (e.g. switch to SNPN access mode, select the appropriate NPN from a preferred NPN list, select a particular network slice/data network for that NPN, select a particular set of security keys and/or perform a particular authorization/authentication procedure for that NPN (e.g. EAP-TLS instead of EAP-AKA), etc.), but also allows a Layer-3 remote UE to select a relay UE to connect to a preferred NPN, but without having to rely on SIB information, since a Layer-3 remote UE does not register directly with the network, but relies on the Layer-3 Relay UE's registration. Using RSCs in this way also provides a first level of authorization/filtering of Remote UEs that connect to an RSC that is only allowed/enabled to be used if a relay UE receives a SIB containing a certain CAG Identifier, NPN Identifier or GIN, since existing security mechanisms for RSC authorization of Remote UEs can be reused, i.e. only Remote UEs that are authorized for such particular RSC may use the cell belonging to/operated by that NPN. Additionally or alternatively, the relay UE may indicate to remote UEs (e.g. using an additional attribute as part of a ProSe discovery message or concatenated to an existing attribute (e.g. NCGI) provided during ProSe discovery) one or more CAG identifiers or NPN identifiers or GINs of NPNs that the current serving cell of the relay UE provides access to or that the current serving cell belongs to or that indicates the current serving NPN that the relay UE is connected to/registered with. Additionally or alternatively, the relay UE may be configured to only provide information about such CAG identifiers or NPN identifiers or GINs, forward a SIB containing a CAG identifier, NPN identifier or GIN or to only transmit a particular RSC to which the NPN or CAG identifier or GIN is mapped and/or a particular Relay Service Code that is configured to be transmitted if a certain NPN identifier or CAG identifier or GIN is received, and/or if the relay UE is connected/registered to the respective NPN or CAG cell or onboarding network, and/or to do this also if the relay UE is not connected/registered to the respective NPN or CAG cell or onboarding network. The relay UE may indicate to remote UEs whether or not it always forwards/transmits the related information or only when it is connected/registered to the respective NPN or CAG cell or onboarding network and/or whether or not it is currently connected/registered to the respective NPN or CAG cell or onboarding network and/or whether or not the relay UE is located within a certain tracking area (e.g. gNB transmits certain Tracking Area Identifier (TAI)), e.g. by including an additional attribute (e.g. flag) as part of a ProSe discovery message. Such further configuration and/or related indication may be configured differently for layer-2 relays than for layer-3 relays, for example, in case of layer-2 relay, the tracking area identifier received from a gNB may be forwarded by a layer-2 relay to a layer-2 remote UE, which can use this information to determine if the remote UE and/or relay UE is located in the related tracking area, but for layer-3 relays this information may not be forwarded to a remote UE. In case the remote UE connects to a relay UE, the remote UE may provide information about which NPN or CAG cell or onboarding network (e.g. by including an RSC onto which an NPN identifier was mapped, or providing a related NPN/CAG identifier or GIN) it would like to connect, and the relay UE may upon receiving such information connect/register to the indicated NPN, CAG cell or onboarding network. If the relay UE is not authorized to connect to the indicated NPN, CAG cell or onboarding network, the relay UE may transmit an error message to the remote UE and/or block traffic to/from the remote UE to the respective NPN, CAG cell or onboarding network. Additionally or alternatively, a relay UE may be configured with a mapping between NPN/CAG identifiers and ProSe/V2X/application groups, for example a list of ProSe/V2X/application layer group identifiers and/or a set of groupcast/broadcast layer 2 identifiers and/or a set of group keys/key identifiers and/a set of conditions indicating which particular ProSe/V2X/application layer group identifiers and/or a set of groupcast/broadcast layer 2 identifiers and/or a set of group keys/key identifiers is to be transmitted or used if a particular NPN/CAG identifier is received by the relay UE or that the relay UE is connected/registered to, and use this mapping and/or conditions to transmit or use the relevant group identifiers and/or a set of groupcast/broadcast layer 2 identifiers and/or a set of group keys/key identifiers towards its communication to a remote UE (e.g. transmit such information using ProSe discovery). In this way, only remote UEs that are allowed to connect to the respective NPN may communicate with/via the respective relay UE.

The mapping of SIB to an RSC may also be useful for a Layer-2 Relay and may be used in addition to forwarding/transmitting a SIB or one or more of its fields/values to enable a relay UE to indicate to a remote UE that the relay UE actually can register/camp on the CAG cell that the remote UE wishes to use, since the list of CAG IDs provided in SIB1 may include more CAG IDs than the relay UE is actually able/allowed to use. In a particular example, the relay UE and/or remote UE are configured with a set of RSCs and a set of CAG IDs per RSC to indicate one or more of these CAG IDs need to be received by the relay UE and/or that the relay UE can register/connect to, whereby the inclusion of a CAG ID in such list of CAG IDs per RSC may indicate that the use and/or transmission of that RSC is enabled/disabled/allowed/disallowed/authorized if the CAG ID is received by the relay UE from the gNB and/or if the relay UE can register/connect to a CAG cell operating such CAG ID. An empty list of CAG IDs indicate that the RSC is available to be used by remote UEs without the relay UE being required to be receive a particular CAG ID and/or register/connect to a particular CAG cell (e.g. a Public Network Integrated NPN (PNI-NPN) does not always need to use CAG cells, since access to PNI-NPNs may also be provided through non-CAG cells). The remote UE may check whether a CAG ID within the SIB information that is received from a relay UE during discovery (e.g. SIB1 information such as cellAccessRelatedInfo received by the relay UE and then forwarded/transmitted by the relay UE) relates to a CAG ID configured for an RSC, and only if the respective RSC is obtained from the relay UE, then the PNI-NPN related to the CAG ID is considered available for PLMN/NPN selection, e.g. if communication to PNI-NPN is restricted to CAG cells.

In an embodiment that can be combined with other embodiments or implemented independently, a UE (e.g. ProSe relay UE or ProSe remote UE) is configured (e.g. by means of policies or RRC configuration) with a set of resources or frequency bands or carrier frequencies to use for ProSe discovery and/or communication for NPNs, which may be different for the case when the UE is in coverage and out-of-coverage, and which may be different for the case of a standalone NPN (SNPN) or Public Network Integrated NPN (PNI-NPN), and/or may receive a set of resources or frequency bands or carrier frequencies to use for ProSe discovery/communication from a CAG cell, whereby the UE:
a) if the UE receives a SIB with a NPN/CAG identifier or GIN, the UE transmits/receives discovery messages in a configured set of resources or frequency bands or carrier frequency for the NPN that corresponds/relates to the NPN/CAG identifier or GIN and/or in a set of resources or frequency bands or carrier frequency received from a CAG cell, and may additionally transmit/receive discovery messages in a default set of resources, frequency bands or carrier frequency configured at the UE (e.g. by a PLMN). This enables a Remote UE/Relay UE that has already switched to NPN access mode or that can only operate in a particular NPN (and e.g. not in a PLMN) to be able to perform ProSe discovery, but also allow Remote UE/Relay UE that have not switched to NPN access mode to perform ProSe discovery.
b) If the UE is a relay UE and receives a request from a remote UE to register/connect to a certain NPN (e.g. via a CAG cell), the set of resources or frequence bands or carrier frequencies configured for that NPN or received by a CAG cell for that NPN may be solely for the purpose of relaying, and hence may be used by the relay UE to register/connect to the requested NPN for the purpose of relay communication, but not be allowed/enabled to use these resources to register/connect to an NPN for non-relay communication (e.g. messages originating from the relay UE itself may be blocked by the gNB or core network, e.g. based on the frame format, encapsulated information, security keys, identifiers, addresses that are used in these messages).

In general it is proposed an apparatus and method that can be implemented on a relay device (e.g. UE), wherein the apparatus relays traffic between a wireless network and a set of wireless devices, and wherein the apparatus is configured with a set of mappings between NPN identifiers or CAG identifiers or GINs and Relay Service Codes/Identifiers and/or conditions that indicate which particular Relay Service Code/Identifier is to be transmitted/used if a SIB containing an NPN identifier or CAG identifier or GIN is received, and wherein if the apparatus receives a SIB containing an NPN identifier or CAG identifier or GIN, then the apparatus transmits in a ProSe discovery message to one or more other wireless devices a Relay Service Code/Identifier onto which the NPN or CAG identifier or GIN is mapped and/or for which a set of conditions apply that indicate which particular Relay Service Code/Identifier is to be transmitted/used.

It is further proposed that the above mentioned configuration with a set of Relay Service Codes/Identifiers and/or a set of conditions/mappings between SIBs and RSCs can be different for layer-3 relays than for layer-2 relays.

In general, it is also proposed an apparatus and method that can be implemented on a relay device (e.g. UE), wherein the apparatus relays traffic between a wireless network and a set of wireless devices, and wherein the apparatus is configured with mapping between NPN identifiers or CAG identifiers and ProSe/V2X/application layer groups, and use this mapping to transmit or use the relevant group identifiers and/or a set of groupcast/broadcast layer 2 identifiers and/or a set of group keys/key identifiers to communicate with one or more other wireless devices (e.g. transmit or use such information during ProSe discovery to a remote UE).

In general, it is also proposed an apparatus and method that can be implemented on a relay device (e.g. UE), wherein the apparatus relays traffic between a wireless network and a set of wireless devices, and wherein the apparatus is configured to include in an attribute as part of a ProSe discovery message one or more CAG identifiers or NPN identifiers or GINs of NPNs that indicates the current serving NPN that the relay device is connected to/registered with, wherein the apparatus may be further configured to only include one or more CAG identifiers or NPN identifiers or GINs only if the relay device is connected/registered to the respective NPN or CAG cell or onboarding network.

To summarize, a wireless system, devices and methods for supporting positioning services have been described. In particular, the use of PosSIBs for positioning of out-of-coverage UEs (e.g. to support location estimation of UEs connected via a relay device to the network or UEs that support ranging) have been described, how SIBs and PosSIBs are forwarded/broadcasted to UEs involved in positioning or how these may be mapped to other identifiers, how privacy of location information related to UEs can be ensured, and various other features have been described.

In accordance with another general definition of a first aspect of this embodiment, it is proposed a method for determining a transmission mode of a system information message wherein the method comprises an apparatus performing the steps of
determining a need for a set of System Information messages,
determining for each System Information message of the required set a respective broadcasting status indicative of a transmission mode of the System Information message from a network entity, wherein the determination of the transmission mode includes
   determining whether an advanced Information Element is stored in or has been received by the apparatus,
   and upon determining that an advanced set of information is stored in or has been received by the apparatus, determining the respective transmission mode of the system information message in both a legacy Information element and/or in the advanced Information Element.

Thus, in accordance with a general definition of another aspect of this embodiment, it is proposed a wireless device, wherein the wireless device comprises
a transmitter,
a receiver,
a controller
a storage medium comprising instructions of a program for causing the wireless device to
   determine a need for a set of System Information messages,
   determine for each System Information message of the required set a respective broadcasting status indicative of a transmission mode of the System Information message from a network entity, wherein the determination of the transmission mode includes
      determining whether an advanced Information Element is stored in or has been received by the wireless device,
      and upon determining that an advanced set of information is stored in or has been received by the wireless device, determining the respective transmission mode of the system information message in both a legacy Information element and/or in the advanced Information Element.

In a first variant of this first or second aspects of this embodiment, the advanced Information Element may include a schedulingInfoList2 Information Element within si-SchedulingInfo-v1700 Information Element.

Further, the System Information messages may be at least one of a System Information Block or a posSIB. Additionally, the transmission mode may be at least one of a periodic broadcast, an on-demand request and broadcast, or a dedicated request and broadcast.

Optionally, for posSIB acquisition, the transmission mode may be determined by the posSI-BroadcastStatus field in the legacy Information Element, wherein the legacy information element corresponds to posSchedulingInfoList in posSI-SchedulingInfo, or the transmission mode may be determined by the si-BroadcastStatus field in the advance information element corresponds to schedulingInfoList2 in si-SchedulingInfo-v1700. Optionally, the transmission mode may be determined by the si-BroadcastStatus field in the legacy information element corresponding to schedulingInfoList in si-SchedulingInfo, or by the si-BroadcastStatus field in the advance information element corresponding to schedulingInfoList2 in si-SchedulingInfo-v1700. In an option, if the transmission mode is set to:
broadcasting, then the system information message is acquired as defined in Clause 5.2.2.3.2 in TS 38.331,
notBroadcasting, and the apparatus is in RRC_IDLE or RRC_INACTIVE state, then initiate transmission of the RRCSystemInfoRequest message in accordance with 5.2.2.3.3a and 5.2.2.3.4, and
notBroadcasting, and the apparatus is in RRC_CONNECTED state, then initiate transmission of the DedicatedSIBRequest message in accordance with 5.2.2.3.5 and 5.2.2.3.6 if onDemandSIB-Request is configured.

In another option, if the transmission mode is set to:
broadcasting, then the system information message is acquired as defined in Clause 5.2.2.3.2 in TS 38.331,
notBroadcasting, and the apparatus is in RRC_IDLE or RRC_INACTIVE state, then initiate transmission of the RRCSystemInfoRequest message in accordance with 5.2.2.3.3 and 5.2.2.3.4, and
notBroadcasting, and the apparatus is in RRC_CONNECTED state, then initiate transmission of the DedicatedSIBRequest message in accordance with 5.2.2.3.5 and 5.2.2.3.6 if onDemandSIB-Request is configured.

In another example of this embodiment, wherein if the transmission mode is set to notBroadcasting and onDemandSIB-Request is not configured, the apparatus sends a message to request the configuration of the onDemandSIB-Request parameter by means of a RRCReconfiguration message.

Further, if the transmission mode of the system information message in the legacy Information element and in the advanced Information Element differs, a transmission mode may be selected based on a policy or configuration wherein one or more of the following preferences or conditions may be checked:
whether broadcasting or on-demand is preferred,
whether the transmission mode in the legacy Information element or in the advanced Information Element is preferred;
whether the UE is in RRC_IDLE/INACTIVE state or in RRC_CONNECTED state.

While the invention has been illustrated and described in detail in the drawings and foregoing description, such illustration and description are to be considered illustrative or exemplary and not restrictive.

The invention is not limited to the disclosed embodiments. The proposed enhanced ranging-based positioning services can be implemented in all types of wireless networks, e.g. it can be applied to devices communicating using cellular wireless communication standards, specifically the 3rd Generation Partnership Project (3GPP) 5G and New Radio (NR) specifications. The 5G wireless communication devices can be different types of devices, e.g. mobile phones, smart watches, smart tags for location tracking and logistics, vehicles (for vehicle-to-vehicle (V2V) communication or more general vehicle-to-everything (V2X) communication), V2X devices, IoT hubs, IoT devices, including low-power medical sensors for health monitoring, medical (emergency) diagnosis and treatment devices, for hospital use or first-responder use, virtual reality (VR) headsets, etc. Furthermore, some of the embodiments may find application in UAVs (unmanned aerial vehicles), e.g., as studied in TR 23.700 or TR 33.891. For instance, ranging embodiments may allow UAVs to detect their range for collision avoidance. For instance, some embodiments related to secure groupcast/broadcast might allow secure broadcast/groupcast communication over the PC5 interface, and may be applicable to, e.g., solutions such as Solution #5 in TR 23.700.

Although some embodiments are described for ProSe relay and sidelink communication, the invention also applies to other types of relay devices, such as (smart) repeater devices, Integrated Access and Backhaul (IAB) nodes, or Wi-Fi Mesh APs.

Furthermore, the invention can be applied in medical applications or connected healthcare in which multiple wireless (e.g. 4G/5G) connected sensor or actuator nodes participate, in medical applications or connected healthcare in which a wireless (e.g. 4G/5G) connected equipment consumes or generates occasionally a continuous data stream of a certain average data rate, for example video, ultrasound, X-Ray, Computed Tomography (CT) imaging devices, real-time patient sensors, audio or voice or video streaming devices used by medical staff, in general IoT applications involving wireless, mobile or stationary, sensor or actuator nodes (e.g. smart city, logistics, farming, etc.), in emergency services and critical communication applications, in V2X systems, in systems for improved coverage for 5G cellular networks using high-frequency (e.g. mmWave) RF, and any other application areas of 5G communication where relaying is used.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The foregoing description details certain embodiments of the invention.

It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Moreover, it will be understood by those skilled in the art that, in general, terms used herein, and especially in the appended claims, are generally intended as “open” terms, e.g., the term “including” should be interpreted as “including but not limited to, “the term “having” should be interpreted as “having at least, “the term “comprises” should be interpreted as “comprises but is not limited to, “etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an, “e.g., “a” and/or “an” should be interpreted to mean “at least one” or “one or more; “the same holds true for the use of definite articles used to introduce claim recitations. Furthermore, in those instances where a convention analogous to “at least one of A, B, and C, etc. “is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc. “is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms.

For example, the phrase “A or B” will be understood to include the possibilities of “A” or “B” or “A and B.

A single unit or device may fulfill the functions of several items recited in the claims. The mere fact that certain measures are recited in mutually different dependent claims does not indicate that a combination of these measures cannot be used to advantage.

The described operations like those indicated in FIG. 7 can be implemented as program code means of a computer program and/or as dedicated hardware of the commissioning device or luminaire device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising:
a processor circuit and a memory circuit, wherein the memory circuit is arranged to store instructions for the processor circuit,
wherein the processor circuit is arranged to request a ranging or positioning service from a ranging constellation, wherein the ranging constellation comprises at least one ranging capable anchor devices,
wherein the processor circuit is arranged to receive at least one groupcast/broadcast message over a PC5 communication interface,
wherein the processor circuit is arranged to perform a range or location estimate or a ranging measurement based on the information in the at least one groupcast/broadcast message,
wherein the groupcast/broadcast message comprises:
an encrypted data, wherein the encrypted data is arranged to protect the information of the groupcast/broadcast message;
a a group member ID assigned by a managing entity or generated at random by a sender of the groupcast/broadcast message; and
a a MIC set to a random number if the chosen integrity algorithm is the NULL algorithm.

2. The apparatus of claim 1, wherein the groupcast/broadcast message comprises a counter, wherein the counter is an input for an encryption algorithm and/or integrity algorithm.

3. The apparatus of claim 1, wherein the processor circuit is arranged to determine whether the group member ID is generated by the managing entity or the sender based on a group member ID length.

4. The apparatus of claim 1, wherein the MIC is not set to zero if the chosen integrity algorithm is the NULL algorithm.

5. The apparatus of claim 1, wherein the processor circuit is arranged to verify a message freshness by checking the counter.

6. The apparatus of claim 1, wherein the message comprises a device specific identifier that is randomized or scrambled.

7. An apparatus comprising:
a processor circuit and a memory circuit, wherein the memory circuit is arranged to store instructions for the processor circuit,
wherein the processor circuit is arranged to request a ranging or positioning service from a positioning constellation, wherein the ranging constellation comprises at least one ranging capable anchor devices, and access devices of the wireless network;
wherein the processor circuit is arranged to receive at least one groupcast/broadcast message from an access device,
wherein the processor circuit is arranged to perform a range or location estimate or a ranging measurement based on the information in the at least one response groupcast/broadcast message.

8. The apparatus of claim 7, wherein the ranging or positioning request comprises at least one of:
the ranging positioning capabilities of the apparatus;
a (ranging) group ID;
a type of requested service (ranging/positioning);
a type of reply (unicast/broadcast/ . . . ) requested;
an identification/authentication/authorization credentials;
an indication of emergency service; and
a preference for NULL security algorithms.

9. The apparatus of claim 7,
wherein the processor circuit is arranged to receive at least one configuration message
wherein the at least one configuration message comprises configuration parameters,
wherein the configuration parameters designate how to receive the at least one groupcast/broadcast message through an access device,
wherein the configuration parameters compromise at least one groupcast/broadcast keys, or chosen security algorithms, or security parameters to be used to protect groupcast/broadcast messages in the RAN and in the ranging constellation.

10. The apparatus of claim 7, wherein the groupcast/broadcast message is an MBS message or an RRC broadcast message or a SIB.

11. The apparatus of claim 7, wherein the groupcast/broadcast message comprises an indication of a ranging positioning capability or assistance data of the anchor devices and/or devices in the positioning constellation or cryptographic values.

12. The apparatus of claim 7,
wherein the groupcast/broadcast message is protected by at least one of encryption, scrambling, and integrity protection,
wherein the processor circuit is arranged to process the protected groupcast/broadcast message so as to decode successfully the groupcast/broadcast message.

13. The apparatus of claim 7, wherein a key used to protect the groupcast/broadcast message is used to securely transport or as a seed to obtain a group key used for subsequent groupcast/broadcast communication in the ranging constellation.

14. The apparatus of claim 7,
wherein the processor circuit is arranged to obtain a counter C1 by combining a value C0 received in a protected message or derived from the whole or part of another counter and/or a value D0 received in the broadcast message and/or a data segment counter,
wherein the processor circuit is arranged to obtain a decryption key and/or integrity key by applying a key derivation function to a pre configured key and the counter C1,
wherein the processor circuit is arranged to apply an encryption algorithm together with the counter C1 and a decryption using the key to decrypt the data in the broadcast message,
wherein the processor circuit is arranged to apply the counter C1 and an integrity key to compute a MIC using a KDF or a NIA algorithm and verify the integrity of the received response broadcast message,
wherein the processor circuit is arranged to pass the decrypted data to upper layers if the integrity verification is successful.

15. The apparatus of previous claim 7, wherein the ranging service is bound to an MBS service.

16. An apparatus comprising:
a processor circuit and a memory circuit, wherein the memory circuit is arranged to store instructions for the processor circuit,
wherein the processor circuit is arranged to receive from a requesting device a ranging or positioning request for a ranging or positioning service from a requesting device,
wherein a ranging constellation formed by at least one ranging capable anchor devices comprises the requesting device,
wherein the processor circuit is arranged to transmit at least one groupcast/broadcast message over a PC5 communication interface,
wherein the processor circuit is arranged to perform a range or location estimate or a ranging measurement based on the information in the at least one groupcast/broadcast message,
wherein the groupcast/broadcast message comprises:
an encrypted data, wherein the encrypted data is arranged to protect the information of the groupcast/broadcast message;
a a group member ID assigned by a managing entity or generated at random by the apparatus of the groupcast/broadcast message; and
a a MIC set to a random number if the chosen integrity algorithm is the NULL algorithm.

17. A method comprising:
requesting a ranging or positioning service from a ranging constellation, wherein the ranging constellation comprises at least one ranging capable anchor devices;
receiving at least one groupcast/broadcast message over a PC5 communication interface; and
performing a range or location estimate or a ranging measurement based on the information in the at least one groupcast/broadcast message,
wherein the groupcast/broadcast message comprises:
an encrypted data protecting the information contained in the groupcast/broadcast message;
a a group member ID assigned by a managing entity or generated at random by a sender of the groupcast/broadcast message; and
a a MIC set to a random number if the chosen integrity algorithm is the NULL algorithm.

18. A method comprising:
receiving a ranging or positioning request from a ranging constellation, wherein the ranging constellation comprises at least one ranging capable anchor devices;
transmitting at least one groupcast/broadcast message over a PC5 communication interface; and
performing a range or location estimate or a ranging measurement based on the information in the at least one groupcast/broadcast message,
wherein the groupcast/broadcast message comprises:
an encrypted data protecting the information contained in the groupcast/broadcast message;
a a group member ID assigned by a managing entity or generated at random by the apparatus of the groupcast/broadcast message; and
a a MIC set to a random number if the chosen integrity algorithm is the NULL algorithm.

19. A method comprising:
requesting a ranging service from a positioning constellation, wherein the ranging constellation comprises at least one ranging capable anchor devices and access devices;
receiving at least one groupcast/broadcast message from an access device; and
performing a range or location estimate or a ranging measurement based on the at least one groupcast/broadcast message.

20. An apparatus comprising:
a processor circuit and a memory circuit, wherein the memory circuit is arranged to store instructions for the processor circuit,
wherein the processor circuit is arranged to receive a ranging or positioning request for a ranging or positioning service,
wherein the ranging or positioning service uses a positioning constellation,
wherein the ranging constellation comprises at least one ranging capable anchor devices and access devices,
wherein the processor circuit is arranged to transmit at least one groupcast/broadcast message,
wherein the processor circuit is arranged to perform a range or location estimate or a ranging measurement based on the information in the at least one response groupcast/broadcast message.

21. A method comprising:
receiving a request for a ranging service involving a positioning constellation, wherein the ranging constellation comprises at least one ranging capable anchor devices and access devices;
transmitting at least one groupcast/broadcast message; and
performing a range or location estimate or a ranging measurement based on information contained in the groupcast/broadcast message.

22.-51. (canceled)

52. A non-transitory computer-readable medium storing a computer program, wherein the computer program when executed on a processor performs the method as claimed in claim 17.

53. A non-transitory computer-readable medium storing a computer program, wherein the computer program when executed on a processor performs the method as claimed in claim 18.

54. A non-transitory computer-readable medium storing a computer program, wherein the computer program when executed on a processor performs the method as claimed in claim 21.
